(19) United States
(12) Patent Application Publication
(10) Pub. No.: US 2024/0403081 A1
(43) Pub. Date: Dec. 5, 2024

(54) USER INTERFACES FOR RESOURCE TRANSFERS

(71) Applicant: Apple Inc., Cupertino, CA (US)

(72) Inventors: Thomas J. MILLER, San Jose, CA (US); Lori Kimiko Fujikawa CHOY, San Jose, CA (US); Alla KHOLMATOVA, Cambridge (GB); Allie M. PERRY, San Jose, CA (US)

(21) Appl. No.: 18/731,318

(22) Filed: Jun. 2, 2024

Related U.S. Application Data
(60) Provisional application No. 63/540,594, filed on Sep. 26, 2023.
(60) Provisional application No. 63/470,973, filed on Jun. 4, 2023.

(51) Int. Cl. G06F 9/451; H04L 51/216

(52) U.S. Cl. CPC G06F 9/451; H04L 51/216

(57) ABSTRACT

The present disclosure generally relates to displaying user interfaces for resource transfers, including displaying a resource transfer message in a communication application, setting up different types of resource transfer accounts, displaying user interfaces for different applications to authorize auto-reload resource transfers, controlling the display of an account options affordance, controlling display of dynamic account information, initiating a return via different applications, linking a payment transfer account with an external account, and releasing secured information.

### CROSS-REFERENCE TO RELATED APPLICATIONS

This application claims priority to U.S. Provisional Patent Application Ser. No. 63/540,594, entitled “USER INTERFACES FOR RESOURCE TRANSFERS,” filed on Sep. 26, 2023, and U.S. Provisional Patent Application Ser. No. 63/470,973, entitled “USER INTERFACES FOR RESOURCE TRANSFERS,” filed on Jun. 4, 2023, the contents of which are hereby incorporated by reference in their entirety.

### FIELD

The present disclosure relates generally to computer user interfaces, and more specifically to techniques for displaying resource transfer user interfaces.

### BACKGROUND

Computer systems allocate resources, such as computer memory, to accounts (e.g., resource accounts). Resource accounts are optionally provisioned onto devices and are used by applications, which allocate resources associated with the resource account.

### BRIEF SUMMARY

Some techniques for displaying resource transfer user interfaces using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for displaying resource transfer user interfaces. Such methods and interfaces optionally complement or replace other methods for displaying resource transfer user interfaces. Such methods and interfaces optionally streamline how various applications interact to transfer resources. Such methods and interfaces reduce the cognitive burden on a user and produce a more efficient human-machine interface. For battery-operated computing devices, such methods and interfaces conserve power and increase the time between battery charges.

In accordance with some embodiments, a method performed at a computer system that is in communication with a display generation component is described. The method comprises: displaying, via the display generation component, a transcript of a conversation between a first user and a second user that is different from the first user; detecting first information associated with a first recurring resource transfer; in response to detecting the first information for the first recurring resource transfer, displaying, via the display generation component, a first representation of the first recurring resource transfer in the transcript of the conversation between the first user and the second user; after displaying the representation of the first recurring resource transfer in the transcript of the conversation between the first user and the second user, detecting respective information for a respective recurring resource transfer; and in response to detecting the respective information for the respective recurring resource transfer, displaying, via the display generation component, a respective representation of the respective recurring resource transfer in the conversation between the first user and the second user.

In accordance with some embodiments, a non-transitory computer-readable storage medium is described. The non-transitory computer-readable storage medium stores one or more programs configured to be executed by one or more processors of a computer system that is in communication with a display generation component, the one or more programs including instructions for: displaying, via the display generation component, a transcript of a conversation between a first user and a second user that is different from the first user; detecting first information associated with a first recurring resource transfer; in response to detecting the first information for the first recurring resource transfer, displaying, via the display generation component, a first representation of the first recurring resource transfer in the transcript of the conversation between the first user and the second user; after displaying the representation of the first recurring resource transfer in the transcript of the conversation between the first user and the second user, detecting respective information for a respective recurring resource transfer; and in response to detecting the respective information for the respective recurring resource transfer, displaying, via the display generation component, a respective representation of the respective recurring resource transfer in the conversation between the first user and the second user.

In accordance with some embodiments, a transitory computer-readable storage medium is described. The transitory computer-readable storage medium stores one or more programs configured to be executed by one or more processors of a computer system that is configured to communicate with a display generation component, the one or more programs including instructions for: displaying, via the display generation component, a transcript of a conversation between a first user and a second user that is different from the first user; detecting first information associated with a first recurring resource transfer; in response to detecting the first information for the first recurring resource transfer, displaying, via the display generation component, a first representation of the first recurring resource transfer in the transcript of the conversation between the first user and the second user; after displaying the representation of the first recurring resource transfer in the transcript of the conversation between the first user and the second user, detecting respective information for a respective recurring resource transfer; and in response to detecting the respective information for the respective recurring resource transfer, displaying, via the display generation component, a respective representation of the respective recurring resource transfer in the conversation between the first user and the second user.

In accordance with some embodiments, a computer system that is configured to communicate with a display generation component is described. The computer system comprises: one or more processors; and memory storing one or more programs configured to be executed by the one or more processors, the one or more programs including instructions for: displaying, via the display generation component, a transcript of a conversation between a first user and a second user that is different from the first user; detecting first information associated with a first recurring resource transfer; in response to detecting the first information for the first recurring resource transfer, displaying, via the display generation component, a first representation of the first recurring resource transfer in the transcript of the conversation between the first user and the second user; after displaying the representation of the first recurring resource transfer in the transcript of the conversation between the first user and the second user, detecting respective information for a respective recurring resource transfer; and in response to detecting the respective information for the respective recurring resource transfer, displaying, via the display generation component, a respective representation of the respective recurring resource transfer in the conversation between the first user and the second user.

In accordance with some embodiments, a computer system that is configured to communicate with a display generation component is described. The computer system comprises: means for displaying, via the display generation component, a transcript of a conversation between a first user and a second user that is different from the first user; means for detecting first information associated with a first recurring resource transfer; means for, in response to detecting the first information for the first recurring resource transfer, displaying, via the display generation component, a first representation of the first recurring resource transfer in the transcript of the conversation between the first user and the second user; means for, after displaying the representation of the first recurring resource transfer in the transcript of the conversation between the first user and the second user, detecting respective information for a respective recurring resource transfer; and means for, in response to detecting the respective information for the respective recurring resource transfer, displaying, via the display generation component, a respective representation of the respective recurring resource transfer in the conversation between the first user and the second user.

In accordance with some embodiments, a computer program product is described. The computer program product comprises one or more programs configured to be executed by one or more processors of a computer system that is that is in communication with a display generation component. The one or more programs include instructions for: displaying, via the display generation component, a transcript of a conversation between a first user and a second user that is different from the first user; detecting first information associated with a first recurring resource transfer; in response to detecting the first information for the first recurring resource transfer, displaying, via the display generation component, a first representation of the first recurring resource transfer in the transcript of the conversation between the first user and the second user; after displaying the representation of the first recurring resource transfer in the transcript of the conversation between the first user and the second user, detecting respective information for a respective recurring resource transfer; and in response to detecting the respective information for the respective recurring resource transfer, displaying, via the display generation component, a respective representation of the respective recurring resource transfer in the conversation between the first user and the second user.

In accordance with some embodiments, a method performed at a computer system that is in communication with a display generation component and one or more input devices is described. The method comprises: detecting, via one or more input devices, a request to add an account corresponding to a service provider; in response to detecting the request to add the account: displaying, via the display generation component: a first selectable interface object that, when selected, initiates a process to enable the account to participate in a first type of automatic resource transfer; and a second selectable interface object that, when selected, initiates a process to enable the account to participate in a second type of automatic resource transfer; while displaying the first selectable interface object and the second selectable interface object, detecting, via the one or more input devices, an input; and in response to detecting the input: in accordance with a determination that the input is directed to the first selectable interface object, initiating a first process to enable the account to participate in the first type of automatic resource transfer, wherein the first process includes: displaying, via the display generation component, a representation of a source for the first type of automatic resource transfer; and displaying, via the display generation component, a second user interface object for configuring an amount for an automatic resource transfer; and in accordance with a determination that the input is directed to the second selectable interface object, initiating a second process to enable the account to participate in the second type of automatic resource transfer, wherein the second process includes: displaying, via the display generation component, a representation of a source of the second type of automatic resource transfer without displaying a third user interface object for configuring an amount for an automatic resource transfer.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: detecting, via one or more input devices, a request to add an account corresponding to a service provider; in response to detecting the request to add the account: displaying, via the display generation component: a first selectable interface object that, when selected, initiates a process to enable the account to participate in a first type of automatic resource transfer; and a second selectable interface object that, when selected, initiates a process to enable the account to participate in a second type of automatic resource transfer; while displaying the first selectable interface object and the second selectable interface object, detecting, via the one or more input devices, an input; and in response to detecting the input: in accordance with a determination that the input is directed to the first selectable interface object, initiating a first process to enable the account to participate in the first type of automatic resource transfer, wherein the first process includes: displaying, via the display generation component, a representation of a source for the first type of automatic resource transfer; and displaying, via the display generation component, a second user interface object for configuring an amount for an automatic resource transfer; and in accordance with a determination that the input is directed to the second selectable interface object, initiating a second process to enable the account to participate in the second type of automatic resource transfer, wherein the second process includes: displaying, via the display generation component, a representation of a source of the second type of automatic resource transfer without displaying a third user interface object for configuring an amount for an automatic resource transfer.

In accordance with some embodiments, a transitory computer-readable storage medium is described. The transitory computer-readable storage medium stores one or more programs configured to be executed by one or more processors of a computer system that is configured to communicate with a display generation component and one or more input devices, the one or more programs including instructions for: detecting, via one or more input devices, a request to add an account corresponding to a service provider; in response to detecting the request to add the account: displaying, via the display generation component: a first selectable interface object that, when selected, initiates a process to enable the account to participate in a first type of automatic resource transfer; and a second selectable interface object that, when selected, initiates a process to enable the account to participate in a second type of automatic resource transfer; while displaying the first selectable interface object and the second selectable interface object, detecting, via the one or more input devices, an input; and in response to detecting the input: in accordance with a determination that the input is directed to the first selectable interface object, initiating a first process to enable the account to participate in the first type of automatic resource transfer, wherein the first process includes: displaying, via the display generation component, a representation of a source for the first type of automatic resource transfer; and displaying, via the display generation component, a second user interface object for configuring an amount for an automatic resource transfer; and in accordance with a determination that the input is directed to the second selectable interface object, initiating a second process to enable the account to participate in the second type of automatic resource transfer, wherein the second process includes: displaying, via the display generation component, a representation of a source of the second type of automatic resource transfer without displaying a third user interface object for configuring an amount for an automatic resource transfer.

In accordance with some embodiments, a computer system that is configured to communicate with a display generation component and one or more input devices is described. The computer system comprises: one or more processors; and memory storing one or more programs configured to be executed by the one or more processors, the one or more programs including instructions for: detecting, via one or more input devices, a request to add an account corresponding to a service provider; in response to detecting the request to add the account: displaying, via the display generation component: a first selectable interface object that, when selected, initiates a process to enable the account to participate in a first type of automatic resource transfer; and a second selectable interface object that, when selected, initiates a process to enable the account to participate in a second type of automatic resource transfer; while displaying the first selectable interface object and the second selectable interface object, detecting, via the one or more input devices, an input; and in response to detecting the input: in accordance with a determination that the input is directed to the first selectable interface object, initiating a first process to enable the account to participate in the first type of automatic resource transfer, wherein the first process includes: displaying, via the display generation component, a representation of a source for the first type of automatic resource transfer; and displaying, via the display generation component, a second user interface object for configuring an amount for an automatic resource transfer; and in accordance with a determination that the input is directed to the second selectable interface object, initiating a second process to enable the account to participate in the second type of automatic resource transfer, wherein the second process includes: displaying, via the display generation component, a representation of a source of the second type of automatic resource transfer without displaying a third user interface object for configuring an amount for an automatic resource transfer.

In accordance with some embodiments, a computer system that is configured to communicate with a display generation component and one or more input devices is described. The computer system comprises: means for detecting, via one or more input devices, a request to add an account corresponding to a service provider; means for, in response to detecting the request to add the account: displaying, via the display generation component: a first selectable interface object that, when selected, initiates a process to enable the account to participate in a first type of automatic resource transfer; and a second selectable interface object that, when selected, initiates a process to enable the account to participate in a second type of automatic resource transfer; means for, while displaying the first selectable interface object and the second selectable interface object, detecting, via the one or more input devices, an input; and means for, in response to detecting the input: in accordance with a determination that the input is directed to the first selectable interface object, initiating a first process to enable the account to participate in the first type of automatic resource transfer, wherein the first process includes: displaying, via the display generation component, a representation of a source for the first type of automatic resource transfer; and displaying, via the display generation component, a second user interface object for configuring an amount for an automatic resource transfer; and in accordance with a determination that the input is directed to the second selectable interface object, initiating a second process to enable the account to participate in the second type of automatic resource transfer, wherein the second process includes: displaying, via the display generation component, a representation of a source of the second type of automatic resource transfer without displaying a third user interface object for configuring an amount for an automatic resource transfer.

In accordance with some embodiments, a computer program product is described. The computer program product comprises one or more programs configured to be executed by one or more processors of a computer system that is that is in communication with a display generation component and one or more input devices. The one or more programs include instructions for: detecting, via one or more input devices, a request to add an account corresponding to a service provider; in response to detecting the request to add the account: displaying, via the display generation component: a first selectable interface object that, when selected, initiates a process to enable the account to participate in a first type of automatic resource transfer; and a second selectable interface object that, when selected, initiates a process to enable the account to participate in a second type of automatic resource transfer; while displaying the first selectable interface object and the second selectable interface object, detecting, via the one or more input devices, an input; and in response to detecting the input: in accordance with a determination that the input is directed to the first selectable interface object, initiating a first process to enable the account to participate in the first type of automatic resource transfer, wherein the first process includes: displaying, via the display generation component, a representation of a source for the first type of automatic resource transfer; and displaying, via the display generation component, a second user interface object for configuring an amount for an automatic resource transfer; and in accordance with a determination that the input is directed to the second selectable interface object, initiating a second process to enable the account to participate in the second type of automatic resource transfer, wherein the second process includes: displaying, via the display generation component, a representation of a source of the second type of automatic resource transfer without displaying a third user interface object for configuring an amount for an automatic resource transfer.

In accordance with some embodiments, a method performed at a computer system that is in communication with a display generation component and one or more input devices is described. The method comprises: displaying, via the display generation component, a first user interface of a first application, wherein the first user interface includes a first selectable interface object to modify a first future scheduled resource transfer for an account provisioned on the first application; while displaying the first selectable interface object, detecting, via the one or more input devices, an input directed at the first selectable interface object; and in response to detecting the input directed at the first selectable interface object, displaying, via the display generation component, a second user interface, different from the first user interface, of the first application, wherein displaying the second user interface includes: in accordance with a determination that the first future scheduled resource transfer is authorized via a second application that is different from the first application, displaying a second selectable interface object that, when selected, initiates a process to modify the first future scheduled resource transfer via the second application; and in accordance with a determination that the first future scheduled resource transfer is authorized via the first application, displaying, via the display generation component, a third selectable interface object without displaying the second selectable interface object, wherein the third selectable interface object, when selected, initiates a process to modify the first future scheduled resource transfer via the first application.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: displaying, via the display generation component, a first user interface of a first application, wherein the first user interface includes a first selectable interface object to modify a first future scheduled resource transfer for an account provisioned on the first application; while displaying the first selectable interface object, detecting, via the one or more input devices, an input directed at the first selectable interface object; and in response to detecting the input directed at the first selectable interface object, displaying, via the display generation component, a second user interface, different from the first user interface, of the first application, wherein displaying the second user interface includes: in accordance with a determination that the first future scheduled resource transfer is authorized via a second application that is different from the first application, displaying a second selectable interface object that, when selected, initiates a process to modify the first future scheduled resource transfer via the second application; and in accordance with a determination that the first future scheduled resource transfer is authorized via the first application, displaying, via the display generation component, a third selectable interface object without displaying the second selectable interface object, wherein the third selectable interface object, when selected, initiates a process to modify the first future scheduled resource transfer via the first application.

In accordance with some embodiments, a transitory computer-readable storage medium is described. The transitory computer-readable storage medium stores one or more programs configured to be executed by one or more processors of a computer system that is configured to communicate with a display generation component and one or more input devices, the one or more programs including instructions for: displaying, via the display generation component, a first user interface of a first application, wherein the first user interface includes a first selectable interface object to modify a first future scheduled resource transfer for an account provisioned on the first application; while displaying the first selectable interface object, detecting, via the one or more input devices, an input directed at the first selectable interface object; and in response to detecting the input directed at the first selectable interface object, displaying, via the display generation component, a second user interface, different from the first user interface, of the first application, wherein displaying the second user interface includes: in accordance with a determination that the first future scheduled resource transfer is authorized via a second application that is different from the first application, displaying a second selectable interface object that, when selected, initiates a process to modify the first future scheduled resource transfer via the second application; and in accordance with a determination that the first future scheduled resource transfer is authorized via the first application, displaying, via the display generation component, a third selectable interface object without displaying the second selectable interface object, wherein the third selectable interface object, when selected, initiates a process to modify the first future scheduled resource transfer via the first application.

In accordance with some embodiments, a computer system that is configured to communicate with a display generation component and one or more input devices is described. The computer system comprises: one or more processors; and memory storing one or more programs configured to be executed by the one or more processors, the one or more programs including instructions for: displaying, via the display generation component, a first user interface of a first application, wherein the first user interface includes a first selectable interface object to modify a first future scheduled resource transfer for an account provisioned on the first application; while displaying the first selectable interface object, detecting, via the one or more input devices, an input directed at the first selectable interface object; and in response to detecting the input directed at the first selectable interface object, displaying, via the display generation component, a second user interface, different from the first user interface, of the first application, wherein displaying the second user interface includes: in accordance with a determination that the first future scheduled resource transfer is authorized via a second application that is different from the first application, displaying a second selectable interface object that, when selected, initiates a process to modify the first future scheduled resource transfer via the second application; and in accordance with a determination that the first future scheduled resource transfer is authorized via the first application, displaying, via the display generation component, a third selectable interface object without displaying the second selectable interface object, wherein the third selectable interface object, when selected, initiates a process to modify the first future scheduled resource transfer via the first application.

In accordance with some embodiments, a computer system that is configured to communicate with a display generation component and one or more input devices is described. The computer system comprises: means for displaying, via the display generation component, a first user interface of a first application, wherein the first user interface includes a first selectable interface object to modify a first future scheduled resource transfer for an account provisioned on the first application; means for, while displaying the first selectable interface object, detecting, via the one or more input devices, an input directed at the first selectable interface object; and means for, in response to detecting the input directed at the first selectable interface object, displaying, via the display generation component, a second user interface, different from the first user interface, of the first application, wherein displaying the second user interface includes: in accordance with a determination that the first future scheduled resource transfer is authorized via a second application that is different from the first application, displaying a second selectable interface object that, when selected, initiates a process to modify the first future scheduled resource transfer via the second application; and in accordance with a determination that the first future scheduled resource transfer is authorized via the first application, displaying, via the display generation component, a third selectable interface object without displaying the second selectable interface object, wherein the third selectable interface object, when selected, initiates a process to modify the first future scheduled resource transfer via the first application.

In accordance with some embodiments, a computer program product is described. The computer program product comprises one or more programs configured to be executed by one or more processors of a computer system that is that is in communication with a display generation component and one or more input devices. The one or more programs include instructions for: displaying, via the display generation component, a first user interface of a first application, wherein the first user interface includes a first selectable interface object to modify a first future scheduled resource transfer for an account provisioned on the first application; while displaying the first selectable interface object, detecting, via the one or more input devices, an input directed at the first selectable interface object; and in response to detecting the input directed at the first selectable interface object, displaying, via the display generation component, a second user interface, different from the first user interface, of the first application, wherein displaying the second user interface includes: in accordance with a determination that the first future scheduled resource transfer is authorized via a second application that is different from the first application, displaying a second selectable interface object that, when selected, initiates a process to modify the first future scheduled resource transfer via the second application; and in accordance with a determination that the first future scheduled resource transfer is authorized via the first application, displaying, via the display generation component, a third selectable interface object without displaying the second selectable interface object, wherein the third selectable interface object, when selected, initiates a process to modify the first future scheduled resource transfer via the first application.

In accordance with some embodiments, a method performed at a computer system that is in communication with a display generation component and one or more input devices is described. The method comprises: displaying, via the display generation component, a user interface of an electronic wallet including: a representation of a first account; and an indication for authorizing a resource transfer; while displaying the user interface of the electronic wallet, detecting, via the one or more input devices, a respective input; and in response to detecting the respective input: in accordance with a determination that the respective input corresponds to a request to authorize a resource transfer using the first account, authorizing the resource transfer using the first account without displaying a first selectable interface object that, when selected, displays a second user interface object for managing a set of one or more accounts of the electronic wallet; and in accordance with a determination that the respective input corresponds to a request to navigate the user interface of the electronic wallet: displaying, via the display generation component, the first selectable interface object; and ceasing display of the indication for authorizing the resource transfer.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: displaying, via the display generation component, a user interface of an electronic wallet including: a representation of a first account; and an indication for authorizing a resource transfer; while displaying the user interface of the electronic wallet, detecting, via the one or more input devices, a respective input; and in response to detecting the respective input: in accordance with a determination that the respective input corresponds to a request to authorize a resource transfer using the first account, authorizing the resource transfer using the first account without displaying a first selectable interface object that, when selected, displays a second user interface object for managing a set of one or more accounts of the electronic wallet; and in accordance with a determination that the respective input corresponds to a request to navigate the user interface of the electronic wallet: displaying, via the display generation component, the first selectable interface object; and ceasing display of the indication for authorizing the resource transfer.

In accordance with some embodiments, a transitory computer-readable storage medium is described. The transitory computer-readable storage medium stores one or more programs configured to be executed by one or more processors of a computer system that is configured to communicate with a display generation component and one or more input devices, the one or more programs including instructions for: displaying, via the display generation component, a user interface of an electronic wallet including: a representation of a first account; and an indication for authorizing a resource transfer; while displaying the user interface of the electronic wallet, detecting, via the one or more input devices, a respective input; and in response to detecting the respective input: in accordance with a determination that the respective input corresponds to a request to authorize a resource transfer using the first account, authorizing the resource transfer using the first account without displaying a first selectable interface object that, when selected, displays a second user interface object for managing a set of one or more accounts of the electronic wallet; and in accordance with a determination that the respective input corresponds to a request to navigate the user interface of the electronic wallet: displaying, via the display generation component, the first selectable interface object; and ceasing display of the indication for authorizing the resource transfer.

In accordance with some embodiments, a computer system that is configured to communicate with a display generation component and one or more input devices is described. The computer system comprises: one or more processors; and memory storing one or more programs configured to be executed by the one or more processors, the one or more programs including instructions for: displaying, via the display generation component, a user interface of an electronic wallet including: a representation of a first account; and an indication for authorizing a resource transfer; while displaying the user interface of the electronic wallet, detecting, via the one or more input devices, a respective input; and in response to detecting the respective input: in accordance with a determination that the respective input corresponds to a request to authorize a resource transfer using the first account, authorizing the resource transfer using the first account without displaying a first selectable interface object that, when selected, displays a second user interface object for managing a set of one or more accounts of the electronic wallet; and in accordance with a determination that the respective input corresponds to a request to navigate the user interface of the electronic wallet: displaying, via the display generation component, the first selectable interface object; and ceasing display of the indication for authorizing the resource transfer.

In accordance with some embodiments, a computer system that is configured to communicate with a display generation component and one or more input devices is described. The computer system comprises: means for displaying, via the display generation component, a user interface of an electronic wallet including: a representation of a first account; and an indication for authorizing a resource transfer; means for, while displaying the user interface of the electronic wallet, detecting, via the one or more input devices, a respective input; and means for in response to detecting the respective input: in accordance with a determination that the respective input corresponds to a request to authorize a resource transfer using the first account, authorizing the resource transfer using the first account without displaying a first selectable interface object that, when selected, displays a second user interface object for managing a set of one or more accounts of the electronic wallet; and in accordance with a determination that the respective input corresponds to a request to navigate the user interface of the electronic wallet: displaying, via the display generation component, the first selectable interface object; and ceasing display of the indication for authorizing the resource transfer.

In accordance with some embodiments, a computer program product is described. The computer program product comprises one or more programs configured to be executed by one or more processors of a computer system that is that is in communication with a display generation component and one or more input devices. The one or more programs include instructions for: displaying, via the display generation component, a user interface of an electronic wallet including: a representation of a first account; and an indication for authorizing a resource transfer; while displaying the user interface of the electronic wallet, detecting, via the one or more input devices, a respective input; and in response to detecting the respective input: in accordance with a determination that the respective input corresponds to a request to authorize a resource transfer using the first account, authorizing the resource transfer using the first account without displaying a first selectable interface object that, when selected, displays a second user interface object for managing a set of one or more accounts of the electronic wallet; and in accordance with a determination that the respective input corresponds to a request to navigate the user interface of the electronic wallet: displaying, via the display generation component, the first selectable interface object; and ceasing display of the indication for authorizing the resource transfer. displaying, via the display generation component, a user interface of an electronic wallet including: a representation of a first account; and an indication for authorizing a resource transfer; while displaying the user interface of the electronic wallet, detecting, via the one or more input devices, a respective input; and in response to detecting the respective input: in accordance with a determination that the respective input corresponds to a request to authorize a resource transfer using the first account, authorizing the resource transfer using the first account without displaying a first selectable interface object that, when selected, displays a second user interface object for managing a set of one or more accounts of the electronic wallet; and in accordance with a determination that the respective input corresponds to a request to navigate the user interface of the electronic wallet: displaying, via the display generation component, the first selectable interface object; and ceasing display of the indication for authorizing the resource transfer.

In accordance with some embodiments, a method performed at a computer system that is in communication with a display generation component and one or more input devices is described. The method comprises: receiving data corresponding to a first account provisioned on an electronic wallet, the data including first information, second information that is different from the first information, and third information that is different from the first information and the second information; subsequent to receiving the data, detecting, via the one or more input devices, a request to display a representation of the first account; and in response to detecting the request to display the representation of the first account, displaying, via the display generation component, the representation of the first account based on the received data, wherein displaying the representation of the first account includes: displaying the first information at a first display location; in accordance with a determination that a first set of criteria is satisfied, displaying the second information at a second display location that is different from the first display location; and in accordance with a determination that a second set of criteria is satisfied, displaying the third information at the second display location, wherein the second set of criteria is different from the first set of criteria.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: receiving data corresponding to a first account provisioned on an electronic wallet, the data including first information, second information that is different from the first information, and third information that is different from the first information and the second information; subsequent to receiving the data, detecting, via the one or more input devices, a request to display a representation of the first account; and in response to detecting the request to display the representation of the first account, displaying, via the display generation component, the representation of the first account based on the received data, wherein displaying the representation of the first account includes: displaying the first information at a first display location; in accordance with a determination that a first set of criteria is satisfied, displaying the second information at a second display location that is different from the first display location; and in accordance with a determination that a second set of criteria is satisfied, displaying the third information at the second display location, wherein the second set of criteria is different from the first set of criteria.

In accordance with some embodiments, a transitory computer-readable storage medium is described. The transitory computer-readable storage medium stores one or more programs configured to be executed by one or more processors of a computer system that is configured to communicate with a display generation component and one or more input devices, the one or more programs including instructions for: receiving data corresponding to a first account provisioned on an electronic wallet, the data including first information, second information that is different from the first information, and third information that is different from the first information and the second information; subsequent to receiving the data, detecting, via the one or more input devices, a request to display a representation of the first account; and in response to detecting the request to display the representation of the first account, displaying, via the display generation component, the representation of the first account based on the received data, wherein displaying the representation of the first account includes: displaying the first information at a first display location; in accordance with a determination that a first set of criteria is satisfied, displaying the second information at a second display location that is different from the first display location; and in accordance with a determination that a second set of criteria is satisfied, displaying the third information at the second display location, wherein the second set of criteria is different from the first set of criteria.

In accordance with some embodiments, a computer system that is configured to communicate with a display generation component and one or more input devices is described. The computer system comprises: one or more processors; and memory storing one or more programs configured to be executed by the one or more processors, the one or more programs including instructions for: receiving data corresponding to a first account provisioned on an electronic wallet, the data including first information, second information that is different from the first information, and third information that is different from the first information and the second information; subsequent to receiving the data, detecting, via the one or more input devices, a request to display a representation of the first account; and in response to detecting the request to display the representation of the first account, displaying, via the display generation component, the representation of the first account based on the received data, wherein displaying the representation of the first account includes: displaying the first information at a first display location; in accordance with a determination that a first set of criteria is satisfied, displaying the second information at a second display location that is different from the first display location; and in accordance with a determination that a second set of criteria is satisfied, displaying the third information at the second display location, wherein the second set of criteria is different from the first set of criteria.

In accordance with some embodiments, a computer system that is configured to communicate with a display generation component and one or more input devices is described. The computer system comprises: means for receiving data corresponding to a first account provisioned on an electronic wallet, the data including first information, second information that is different from the first information, and third information that is different from the first information and the second information; means for, subsequent to receiving the data, detecting, via the one or more input devices, a request to display a representation of the first account; and means for, in response to detecting the request to display the representation of the first account, displaying, via the display generation component, the representation of the first account based on the received data, wherein displaying the representation of the first account includes: displaying the first information at a first display location; in accordance with a determination that a first set of criteria is satisfied, displaying the second information at a second display location that is different from the first display location; and in accordance with a determination that a second set of criteria is satisfied, displaying the third information at the second display location, wherein the second set of criteria is different from the first set of criteria.

In accordance with some embodiments, a computer program product is described. The computer program product comprises one or more programs configured to be executed by one or more processors of a computer system that is that is in communication with a display generation component and one or more input devices. The one or more programs include instructions for: receiving data corresponding to a first account provisioned on an electronic wallet, the data including first information, second information that is different from the first information, and third information that is different from the first information and the second information; subsequent to receiving the data, detecting, via the one or more input devices, a request to display a representation of the first account; and in response to detecting the request to display the representation of the first account, displaying, via the display generation component, the representation of the first account based on the received data, wherein displaying the representation of the first account includes: displaying the first information at a first display location; in accordance with a determination that a first set of criteria is satisfied, displaying the second information at a second display location that is different from the first display location; and in accordance with a determination that a second set of criteria is satisfied, displaying the third information at the second display location, wherein the second set of criteria is different from the first set of criteria.

In accordance with some embodiments, a method performed at a computer system that is in communication with a display generation component and one or more input devices is described. The method comprises: displaying, via the display generation component, a user interface of an electronic wallet, the user interface including a representation of a first resource transfer and a representation of a second resource transfer; while displaying the user interface, detecting, via the one or more input devices, a selection of a respective resource transfer; and in response to detecting the selection of the respective resource transfer: in accordance with a determination that a first set of criteria is satisfied and that the respective resource transfer corresponds to the first resource transfer, displaying, via the display generation component, a first user interface object that initiates a process to return a first item, wherein initiating the process to return the first item includes displaying a first user interface of a first application that is different from the electronic wallet; and in accordance with a determination that a second set of criteria is satisfied and that the respective resource transfer corresponds to the second resource transfer, displaying, via the display generation component, a second user interface object that initiates a process to return a second item, wherein initiating the process to return the second item includes displaying a second user interface of a second application that is different from the electronic wallet and the first application.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: displaying, via the display generation component, a user interface of an electronic wallet, the user interface including a representation of a first resource transfer and a representation of a second resource transfer; while displaying the user interface, detecting, via the one or more input devices, a selection of a respective resource transfer; and in response to detecting the selection of the respective resource transfer: in accordance with a determination that a first set of criteria is satisfied and that the respective resource transfer corresponds to the first resource transfer, displaying, via the display generation component, a first user interface object that initiates a process to return a first item, wherein initiating the process to return the first item includes displaying a first user interface of a first application that is different from the electronic wallet; and in accordance with a determination that a second set of criteria is satisfied and that the respective resource transfer corresponds to the second resource transfer, displaying, via the display generation component, a second user interface object that initiates a process to return a second item, wherein initiating the process to return the second item includes displaying a second user interface of a second application that is different from the electronic wallet and the first application.

In accordance with some embodiments, a transitory computer-readable storage medium is described. The transitory computer-readable storage medium stores one or more programs configured to be executed by one or more processors of a computer system that is configured to communicate with a display generation component and one or more input devices, the one or more programs including instructions for: displaying, via the display generation component, a user interface of an electronic wallet, the user interface including a representation of a first resource transfer and a representation of a second resource transfer; while displaying the user interface, detecting, via the one or more input devices, a selection of a respective resource transfer; and in response to detecting the selection of the respective resource transfer: in accordance with a determination that a first set of criteria is satisfied and that the respective resource transfer corresponds to the first resource transfer, displaying, via the display generation component, a first user interface object that initiates a process to return a first item, wherein initiating the process to return the first item includes displaying a first user interface of a first application that is different from the electronic wallet; and in accordance with a determination that a second set of criteria is satisfied and that the respective resource transfer corresponds to the second resource transfer, displaying, via the display generation component, a second user interface object that initiates a process to return a second item, wherein initiating the process to return the second item includes displaying a second user interface of a second application that is different from the electronic wallet and the first application.

In accordance with some embodiments, a computer system that is configured to communicate with a display generation component and one or more input devices is described. The computer system comprises: one or more processors; and memory storing one or more programs configured to be executed by the one or more processors, the one or more programs including instructions for: displaying, via the display generation component, a user interface of an electronic wallet, the user interface including a representation of a first resource transfer and a representation of a second resource transfer; while displaying the user interface, detecting, via the one or more input devices, a selection of a respective resource transfer; and in response to detecting the selection of the respective resource transfer: in accordance with a determination that a first set of criteria is satisfied and that the respective resource transfer corresponds to the first resource transfer, displaying, via the display generation component, a first user interface object that initiates a process to return a first item, wherein initiating the process to return the first item includes displaying a first user interface of a first application that is different from the electronic wallet; and in accordance with a determination that a second set of criteria is satisfied and that the respective resource transfer corresponds to the second resource transfer, displaying, via the display generation component, a second user interface object that initiates a process to return a second item, wherein initiating the process to return the second item includes displaying a second user interface of a second application that is different from the electronic wallet and the first application.

In accordance with some embodiments, a computer system that is configured to communicate with a display generation component and one or more input devices is described. The computer system comprises: means for displaying, via the display generation component, a user interface of an electronic wallet, the user interface including a representation of a first resource transfer and a representation of a second resource transfer; means for, while displaying the user interface, detecting, via the one or more input devices, a selection of a respective resource transfer; and means for, in response to detecting the selection of the respective resource transfer: in accordance with a determination that a first set of criteria is satisfied and that the respective resource transfer corresponds to the first resource transfer, displaying, via the display generation component, a first user interface object that initiates a process to return a first item, wherein initiating the process to return the first item includes displaying a first user interface of a first application that is different from the electronic wallet; and in accordance with a determination that a second set of criteria is satisfied and that the respective resource transfer corresponds to the second resource transfer, displaying, via the display generation component, a second user interface object that initiates a process to return a second item, wherein initiating the process to return the second item includes displaying a second user interface of a second application that is different from the electronic wallet and the first application.

In accordance with some embodiments, a computer program product is described. The computer program product comprises one or more programs configured to be executed by one or more processors of a computer system that is that is in communication with a display generation component and one or more input devices. The one or more programs include instructions for: displaying, via the display generation component, a user interface of an electronic wallet, the user interface including a representation of a first resource transfer and a representation of a second resource transfer; while displaying the user interface, detecting, via the one or more input devices, a selection of a respective resource transfer; and in response to detecting the selection of the respective resource transfer: in accordance with a determination that a first set of criteria is satisfied and that the respective resource transfer corresponds to the first resource transfer, displaying, via the display generation component, a first user interface object that initiates a process to return a first item, wherein initiating the process to return the first item includes displaying a first user interface of a first application that is different from the electronic wallet; and in accordance with a determination that a second set of criteria is satisfied and that the respective resource transfer corresponds to the second resource transfer, displaying, via the display generation component, a second user interface object that initiates a process to return a second item, wherein initiating the process to return the second item includes displaying a second user interface of a second application that is different from the electronic wallet and the first application.

In accordance with some embodiments, a method performed at a computer system that is in communication with a display generation component and one or more input devices is described. The method comprises: while a first set of one or more resource transfers associated with a first account provisioned on an electronic wallet are not enabled for sharing with a respective application: displaying, via the display generation component, the first set of one or more resource transfers in a first user interface of the electronic wallet, wherein the first set of one or more resource transfers were performed via the first account provisioned on the electronic wallet, wherein the first user interface does not include a second set of one or more resources transfers; and detecting, via the one or more input devices, a request to link the first account with a first external account; and while the first account is linked with the first external account: displaying, via the display generation component: the first set of one or more resource transfers in the first user interface of the electronic wallet; and the second set of one or more resource transfers in the first user interface of the electronic wallet, wherein the second set of one or more resource transfers were not performed via the first account provisioned on the electronic wallet; and enabling the first set of one or more resource transfers and the second set of one or more resource transfers for sharing with the respective application.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: while a first set of one or more resource transfers associated with a first account provisioned on an electronic wallet are not enabled for sharing with a respective application: displaying, via the display generation component, the first set of one or more resource transfers in a first user interface of the electronic wallet, wherein the first set of one or more resource transfers were performed via the first account provisioned on the electronic wallet, wherein the first user interface does not include a second set of one or more resources transfers; and detecting, via the one or more input devices, a request to link the first account with a first external account; and while the first account is linked with the first external account: displaying, via the display generation component: the first set of one or more resource transfers in the first user interface of the electronic wallet; and the second set of one or more resource transfers in the first user interface of the electronic wallet, wherein the second set of one or more resource transfers were not performed via the first account provisioned on the electronic wallet; and enabling the first set of one or more resource transfers and the second set of one or more resource transfers for sharing with the respective application.

In accordance with some embodiments, a transitory computer-readable storage medium is described. The transitory computer-readable storage medium stores one or more programs configured to be executed by one or more processors of a computer system that is configured to communicate with a display generation component and one or more input devices, the one or more programs including instructions for: while a first set of one or more resource transfers associated with a first account provisioned on an electronic wallet are not enabled for sharing with a respective application: displaying, via the display generation component, the first set of one or more resource transfers in a first user interface of the electronic wallet, wherein the first set of one or more resource transfers were performed via the first account provisioned on the electronic wallet, wherein the first user interface does not include a second set of one or more resources transfers; and detecting, via the one or more input devices, a request to link the first account with a first external account; and while the first account is linked with the first external account: displaying, via the display generation component: the first set of one or more resource transfers in the first user interface of the electronic wallet; and the second set of one or more resource transfers in the first user interface of the electronic wallet, wherein the second set of one or more resource transfers were not performed via the first account provisioned on the electronic wallet; and enabling the first set of one or more resource transfers and the second set of one or more resource transfers for sharing with the respective application.

In accordance with some embodiments, a computer system that is configured to communicate with a display generation component and one or more input devices is described. The computer system comprises: one or more processors; and memory storing one or more programs configured to be executed by the one or more processors, the one or more programs including instructions for: while a first set of one or more resource transfers associated with a first account provisioned on an electronic wallet are not enabled for sharing with a respective application: displaying, via the display generation component, the first set of one or more resource transfers in a first user interface of the electronic wallet, wherein the first set of one or more resource transfers were performed via the first account provisioned on the electronic wallet, wherein the first user interface does not include a second set of one or more resources transfers; and detecting, via the one or more input devices, a request to link the first account with a first external account; and while the first account is linked with the first external account: displaying, via the display generation component: the first set of one or more resource transfers in the first user interface of the electronic wallet; and the second set of one or more resource transfers in the first user interface of the electronic wallet, wherein the second set of one or more resource transfers were not performed via the first account provisioned on the electronic wallet; and enabling the first set of one or more resource transfers and the second set of one or more resource transfers for sharing with the respective application.

In accordance with some embodiments, a computer system that is configured to communicate with a display generation component and one or more input devices is described. The computer system comprises: means for, while a first set of one or more resource transfers associated with a first account provisioned on an electronic wallet are not enabled for sharing with a respective application: means for displaying, via the display generation component, the first set of one or more resource transfers in a first user interface of the electronic wallet, wherein the first set of one or more resource transfers were performed via the first account provisioned on the electronic wallet, wherein the first user interface does not include a second set of one or more resources transfers; and means for detecting, via the one or more input devices, a request to link the first account with a first external account; and means for, while the first account is linked with the first external account: displaying, via the display generation component: the first set of one or more resource transfers in the first user interface of the electronic wallet; and the second set of one or more resource transfers in the first user interface of the electronic wallet, wherein the second set of one or more resource transfers were not performed via the first account provisioned on the electronic wallet; and enabling the first set of one or more resource transfers and the second set of one or more resource transfers for sharing with the respective application.

In accordance with some embodiments, a computer program product is described. The computer program product comprises one or more programs configured to be executed by one or more processors of a computer system that is that is in communication with a display generation component and one or more input devices. The one or more programs include instructions for: while a first set of one or more resource transfers associated with a first account provisioned on an electronic wallet are not enabled for sharing with a respective application: displaying, via the display generation component, the first set of one or more resource transfers in a first user interface of the electronic wallet, wherein the first set of one or more resource transfers were performed via the first account provisioned on the electronic wallet, wherein the first user interface does not include a second set of one or more resources transfers; and detecting, via the one or more input devices, a request to link the first account with a first external account; and while the first account is linked with the first external account: displaying, via the display generation component: the first set of one or more resource transfers in the first user interface of the electronic wallet; and the second set of one or more resource transfers in the first user interface of the electronic wallet, wherein the second set of one or more resource transfers were not performed via the first account provisioned on the electronic wallet; and enabling the first set of one or more resource transfers and the second set of one or more resource transfers for sharing with the respective application.

In accordance with some embodiments, a method performed at a computer system that is in communication with a display generation component and one or more input devices is described. The method comprises: displaying, via the display generation component, a first user interface of a first application; while displaying the first user interface of the first application, detecting, via one or more input devices, a first input, directed at the first user interface, to initiate a resource transfer using the first account selected via the first application; in response to detecting the first input to initiate the resource transfer, partially obscuring of the first user interface with a second user interface of a second application, wherein the second user interface includes: an indication to authorize a resource transfer using the first account; and a user interface object that corresponds to the first application.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: displaying, via the display generation component, a first user interface of a first application; while displaying the first user interface of the first application, detecting, via one or more input devices, a first input, directed at the first user interface, to initiate a resource transfer using the first account selected via the first application; in response to detecting the first input to initiate the resource transfer, partially obscuring of the first user interface with a second user interface of a second application, wherein the second user interface includes: an indication to authorize a resource transfer using the first account; and a user interface object that corresponds to the first application.

In accordance with some embodiments, a transitory computer-readable storage medium is described. The transitory computer-readable storage medium stores one or more programs configured to be executed by one or more processors of a computer system that is configured to communicate with a display generation component and one or more input devices, the one or more programs including instructions for: displaying, via the display generation component, a first user interface of a first application; while displaying the first user interface of the first application, detecting, via one or more input devices, a first input, directed at the first user interface, to initiate a resource transfer using the first account selected via the first application; in response to detecting the first input to initiate the resource transfer, partially obscuring of the first user interface with a second user interface of a second application, wherein the second user interface includes: an indication to authorize a resource transfer using the first account; and a user interface object that corresponds to the first application.

In accordance with some embodiments, a computer system that is configured to communicate with a display generation component and one or more input devices is described. The computer system comprises: one or more processors; and memory storing one or more programs configured to be executed by the one or more processors, the one or more programs including instructions for: displaying, via the display generation component, a first user interface of a first application; while displaying the first user interface of the first application, detecting, via one or more input devices, a first input, directed at the first user interface, to initiate a resource transfer using the first account selected via the first application; in response to detecting the first input to initiate the resource transfer, partially obscuring of the first user interface with a second user interface of a second application, wherein the second user interface includes: an indication to authorize a resource transfer using the first account; and a user interface object that corresponds to the first application.

In accordance with some embodiments, a computer system that is configured to communicate with a display generation component and one or more input devices is described. The computer system comprises: means for displaying, via the display generation component, a first user interface of a first application; means for, while displaying the first user interface of the first application, detecting, via one or more input devices, a first input, directed at the first user interface, to initiate a resource transfer using the first account selected via the first application; means for, in response to detecting the first input to initiate the resource transfer, partially obscuring of the first user interface with a second user interface of a second application, wherein the second user interface includes: an indication to authorize a resource transfer using the first account; and a user interface object that corresponds to the first application.

In accordance with some embodiments, a computer program product is described. The computer program product comprises one or more programs configured to be executed by one or more processors of a computer system that is that is in communication with a display generation component and one or more input devices. The one or more programs include instructions for: displaying, via the display generation component, a first user interface of a first application; while displaying the first user interface of the first application, detecting, via one or more input devices, a first input, directed at the first user interface, to initiate a resource transfer using the first account selected via the first application; in response to detecting the first input to initiate the resource transfer, partially obscuring of the first user interface with a second user interface of a second application, wherein the second user interface includes: an indication to authorize a resource transfer using the first account; and a user interface object that corresponds to the first application.

In accordance with some embodiments, a method is described. The method comprises: at a computer system that is in communication with a display generation component and one or more input devices: during a set up process for configuring the computer system: receiving, via the one or more input devices, account information for a user account of a service; after logging into the user account of the service using the account information, displaying, via the display generation component, an option to initiate a process to transfer credentials of a stored-value account from an external computer system to the computer system; detecting, via the one or more input devices, activation of the option to initiate the process to transfer credentials of the stored-value account from the external computer system to the computer system; and in response to detecting activation of the option to initiate the process to transfer credentials of the stored-value account from the external computer system to the computer system, initiating the process to transfer credentials of the stored-value account from the external computer system to the computer system.

In accordance with some embodiments, a method is described. The method comprises: at a computer system that is in communication with a display generation component, a secure element, and one or more input devices: receiving, via the one or more input devices, a request to provision a first account onto the computer system, wherein provisioning the first account onto the computer system includes storing credentials of the first account on the secure element; in accordance with a determination that the secure element has insufficient storage space to store credentials of the first account, displaying, via the display generation component, storage usage information about the secure element and a first option that initiates a process to delete information of a second account from the secure element, wherein the second account is different from the first account; while displaying the first option, detecting, via the one or more input devices, activation of the first option; and in response to detecting activation of the first option, initiating a process to delete information of the second account from the secure element.

In accordance with some embodiments, a method is described. The method comprises: at a computer system that is in communication with a display generation component and one or more input devices: receiving, via the one or more input devices, a request to provision a first account onto the computer system; in response to receiving the request to provision the first account on the computer system, initiating a process to provision the first account onto the computer system, wherein the process to provision the first account onto the computer system includes receiving, via the one or more input devices, account information about the first account; provisioning, using the account information about the first account, the first account onto the computer system; and subsequent to provisioning the first account onto the computer system, displaying, via the display generation component, an external provisioning user interface that includes an option to initiate a process to provision the first account onto a plurality of external computer systems, other than the computer system, wherein: in accordance with a determination that a set of one or more provisioning criteria is met for a respective external computer system, the plurality of external computer systems includes the respective external computer system; and in accordance with a determination that the set of one or more provisioning criteria is not met for the respective external computer system, the plurality of external computer systems does not include the respective external computer system.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for displaying resource transfer user interfaces, thereby increasing the effectiveness, efficiency, and user satisfaction with such devices. Such methods and interfaces may complement or replace other methods for displaying resource transfer user interfaces.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIG. 5C illustrates exemplary devices connected via one or more communication channels, in accordance with some embodiments.

FIGS. 6A-6D illustrate exemplary user interfaces for controlling display of updates to memory transfer messages, in accordance with some embodiments.

FIGS. 7A-7R illustrate exemplary user interfaces for displaying updates to fund transfer messages, in accordance with some embodiments.

FIG. 8 is a flow diagram illustrating a method for displaying a resource transfer message in a communication application, in accordance with some embodiments.

FIGS. 9A-9J illustrate exemplary user interfaces for setting up different types of resource transfer accounts for computer memory, in accordance with some embodiments.

FIGS. 10A-10Q illustrate exemplary user interfaces for setting up different types of resource transfer accounts for funds, in accordance with some embodiments.

FIGS. 11A-11B are flow diagrams illustrating a method for setting up different types of resource transfer accounts, in accordance with some embodiments.

FIGS. 12A-12D illustrate exemplary user interfaces for different applications authorizing auto-reload transfers for allocation of computer memory, in accordance with some embodiments.

FIGS. 13A-13J illustrate exemplary user interfaces for different applications authorizing auto-reload transfers for funds, in accordance with some embodiments.

FIG. 14 is a flow diagram illustrating a method for different applications authorizing auto-reload resource transfers, in accordance with some embodiments.

FIGS. 15A-15I illustrate exemplary user interfaces for controlling the display of an account options affordance, in accordance with some embodiments.

FIG. 16 is a flow diagram illustrating a method for controlling the display of an account options affordance, in accordance with some embodiments.

FIGS. 17A-17K illustrate exemplary user interfaces for controlling the display of dynamic account information, in accordance with some embodiments.

FIG. 18 is a flow diagram illustrating a method for controlling display of dynamic account information, in accordance with some embodiments.

FIGS. 19A-19E illustrate exemplary user interfaces for initiating a return of computer memory via different applications, in accordance with some embodiments.

FIGS. 20A-20R illustrate exemplary user interfaces for initiating a return of a physical item via different applications, in accordance with some embodiments.

FIG. 21 is a flow diagram illustrating a method for initiating a return via different applications, in accordance with some embodiments.

FIGS. 22A-22D illustrate exemplary user interfaces for linking a computer transfer account with an external account, in accordance with some embodiments.

FIGS. 23A-23T illustrate exemplary user interfaces for linking a payment transfer account with an external account, in accordance with some embodiments.

FIG. 24 is a flow diagram illustrating a method for linking a resource account with an external account, in accordance with some embodiments.

FIGS. 25A-25I illustrate exemplary user interfaces for releasing secured information, in accordance with some embodiments.

FIG. 26 is a flow diagram illustrating a method for releasing secured information, in accordance with some embodiments.

FIGS. 27A-27W illustrate exemplary user interfaces for provisioning accounts onto computer systems, in accordance with some embodiments.

FIG. 28 is a flow diagram illustrating a method for provisioning an account onto a computer system in accordance with some embodiments.

FIG. 29 is a flow diagram illustrating a method for provisioning an account onto a computer system in accordance with some embodiments.

FIG. 30 is a flow diagram illustrating a method for provisioning an account onto a computer system in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

Resource accounts are provisioned onto electronic devices, such as computer systems. The resource accounts are optionally accessible by one or more applications of the electronic devices. The applications are used to transfer and/or receive resources between electronic devices. Sending or receiving resources optionally includes interacting with different applications. There is a need for electronic devices that provide efficient methods and interfaces for displaying resource transfer user interfaces. Such techniques can reduce the cognitive burden on a user who accesses resource accounts, thereby enhancing productivity. Further, such techniques can reduce processor and battery power otherwise wasted on redundant user inputs.

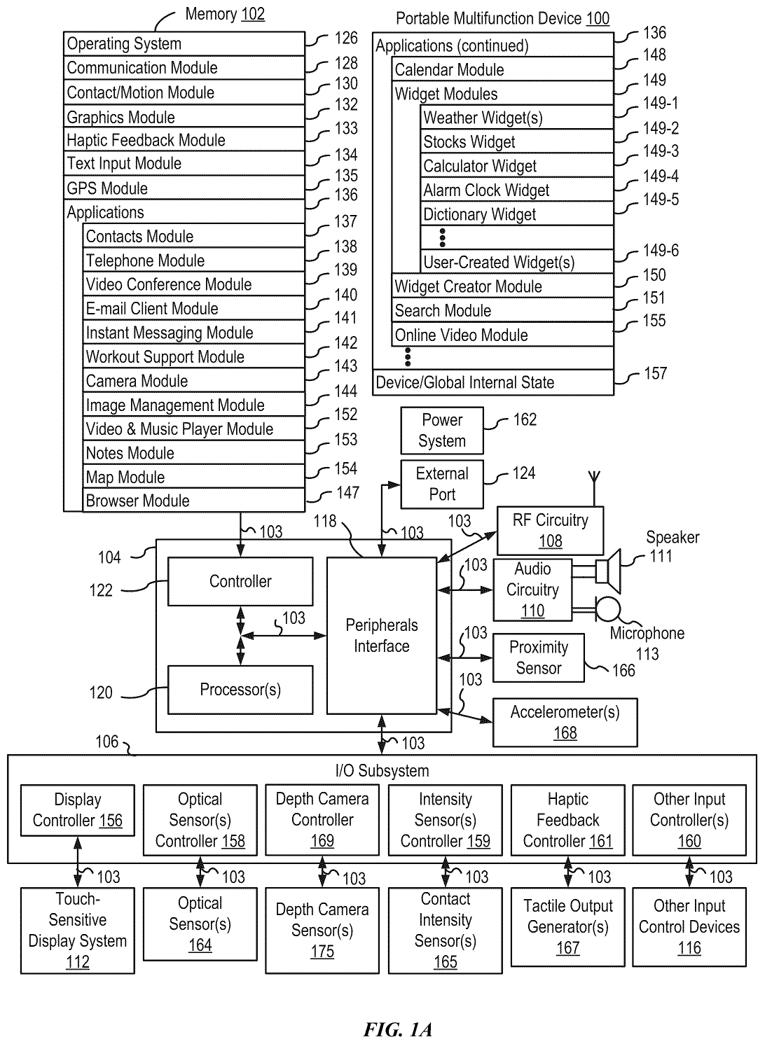

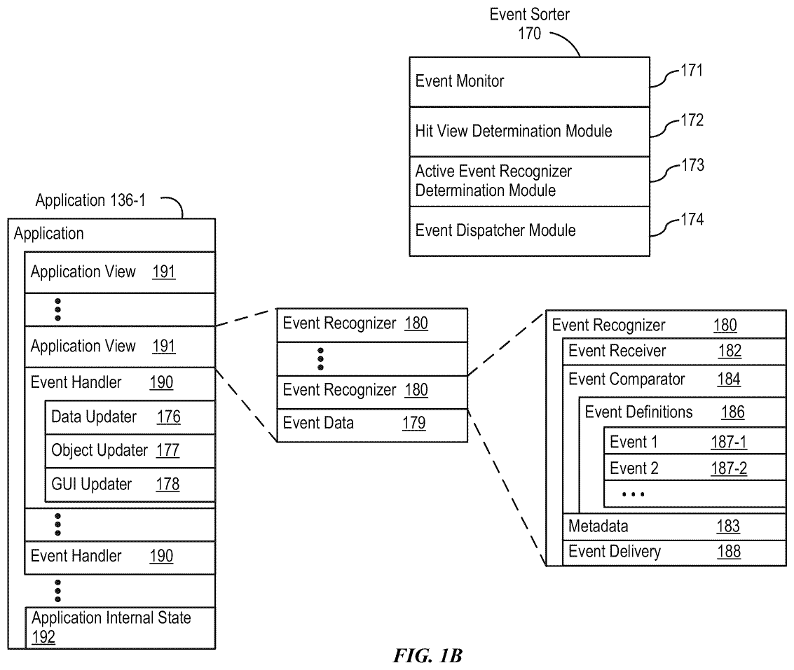

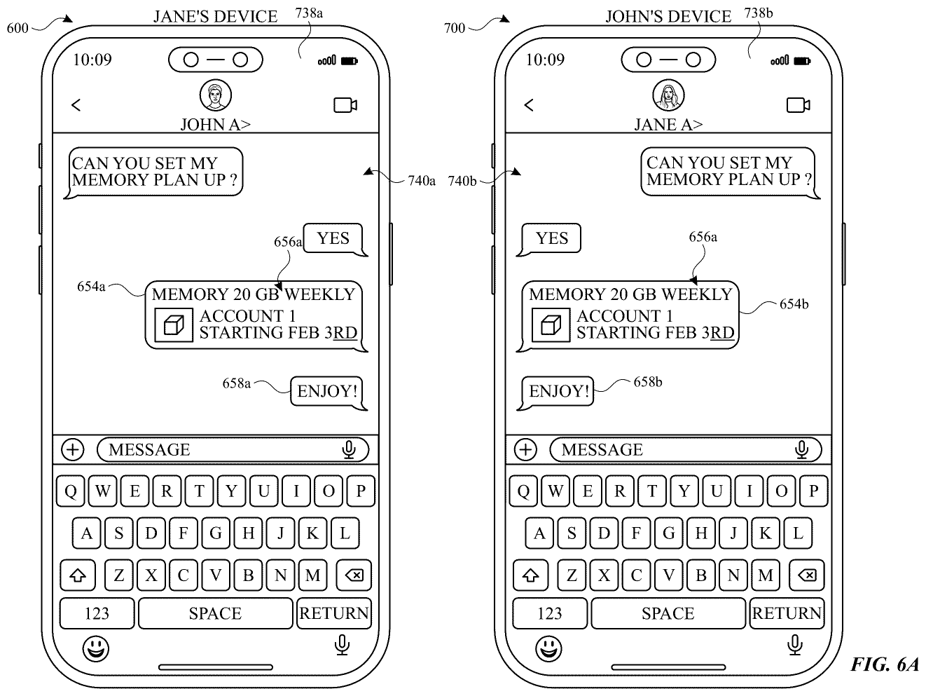

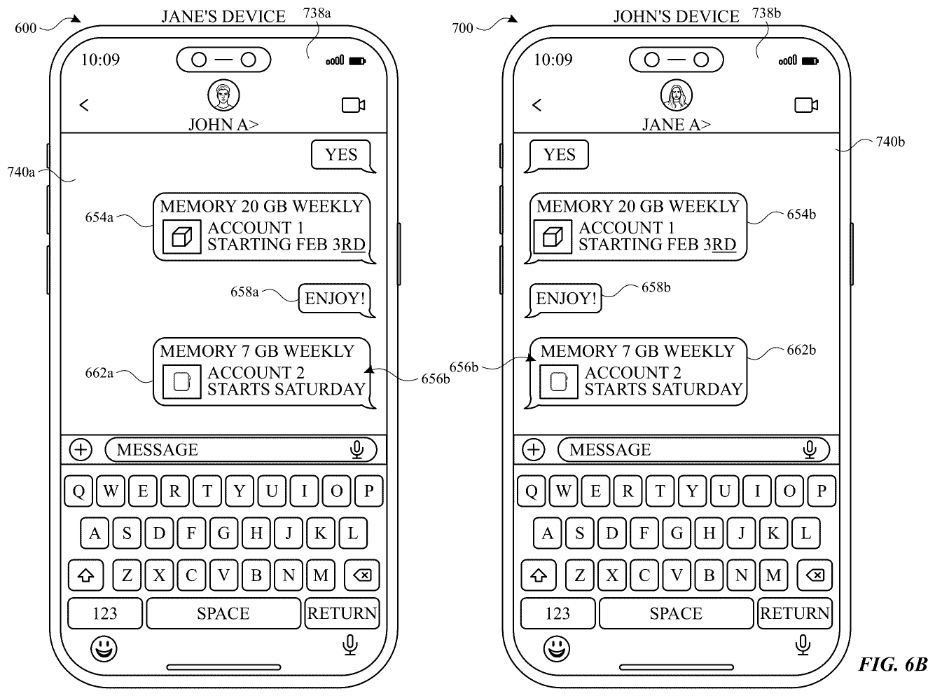

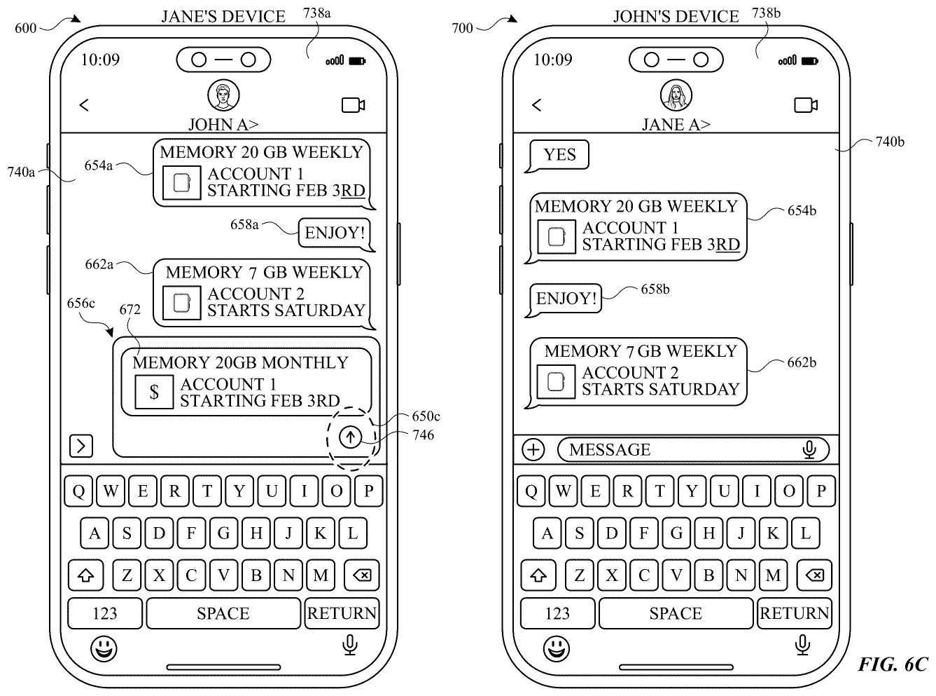

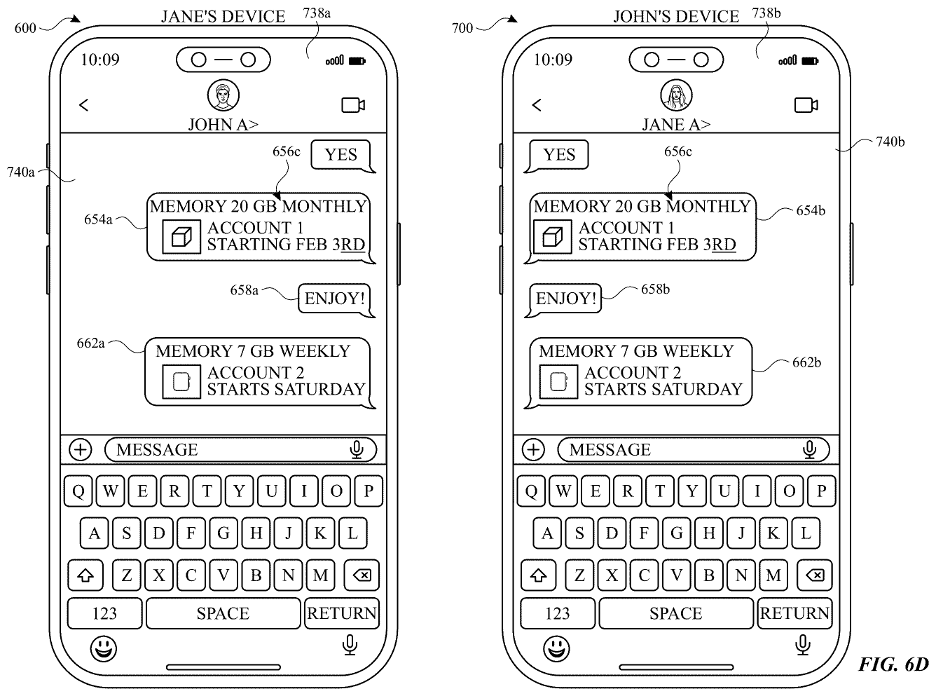

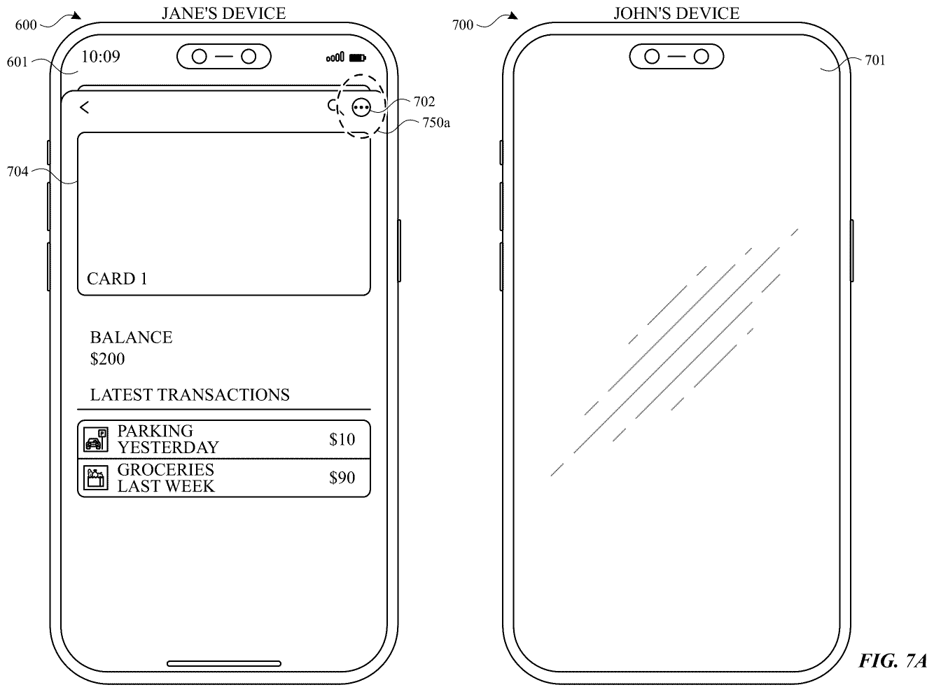

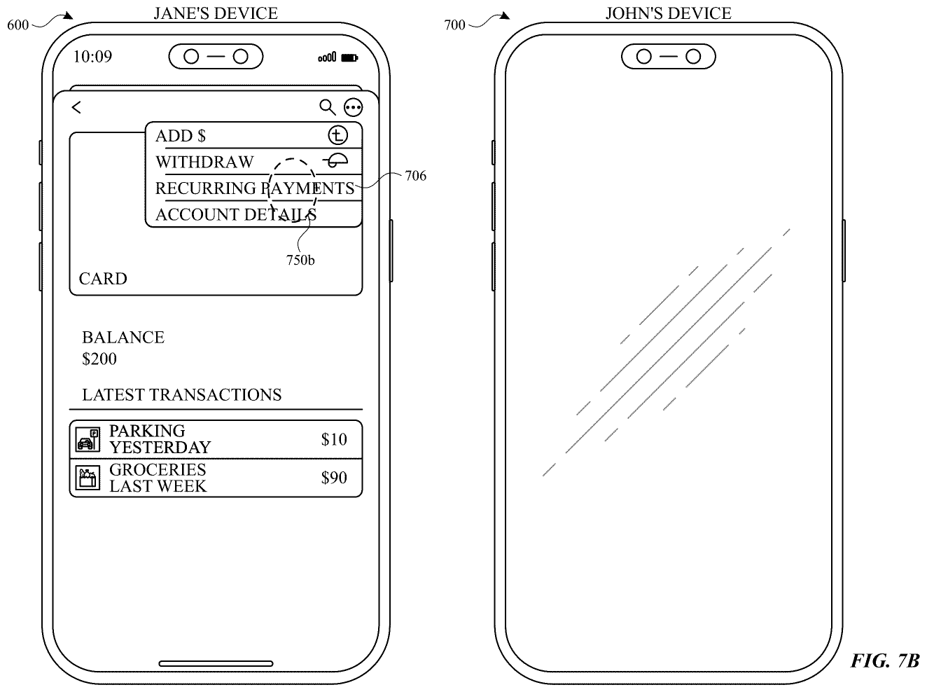

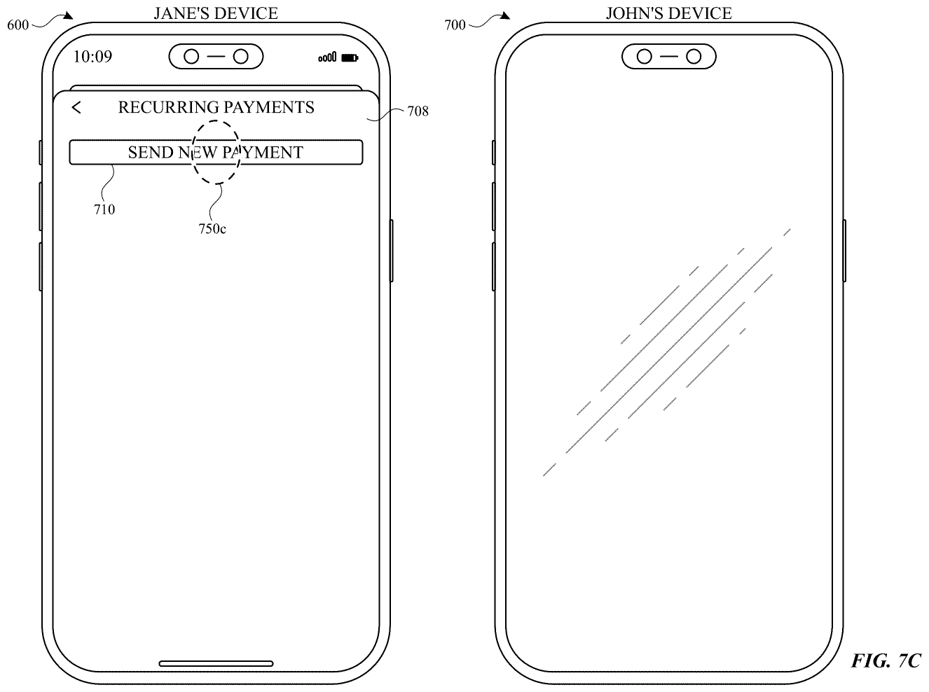

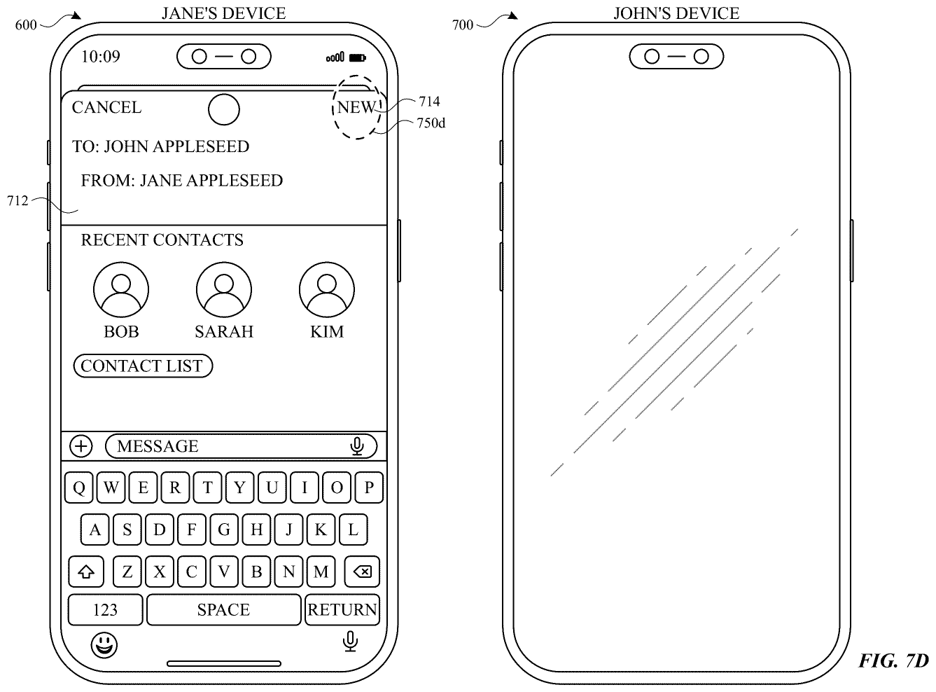

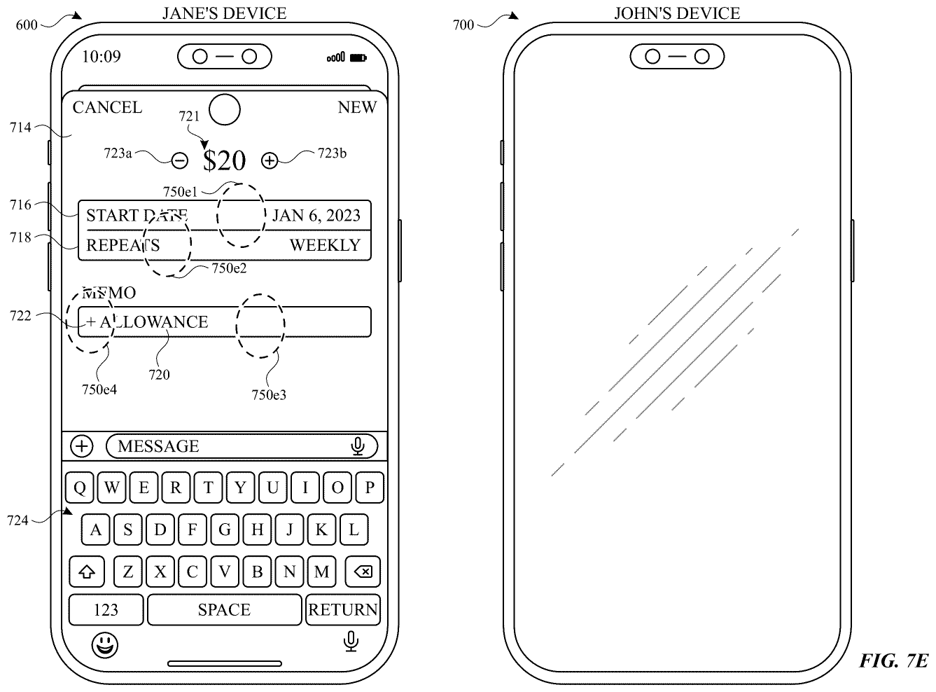

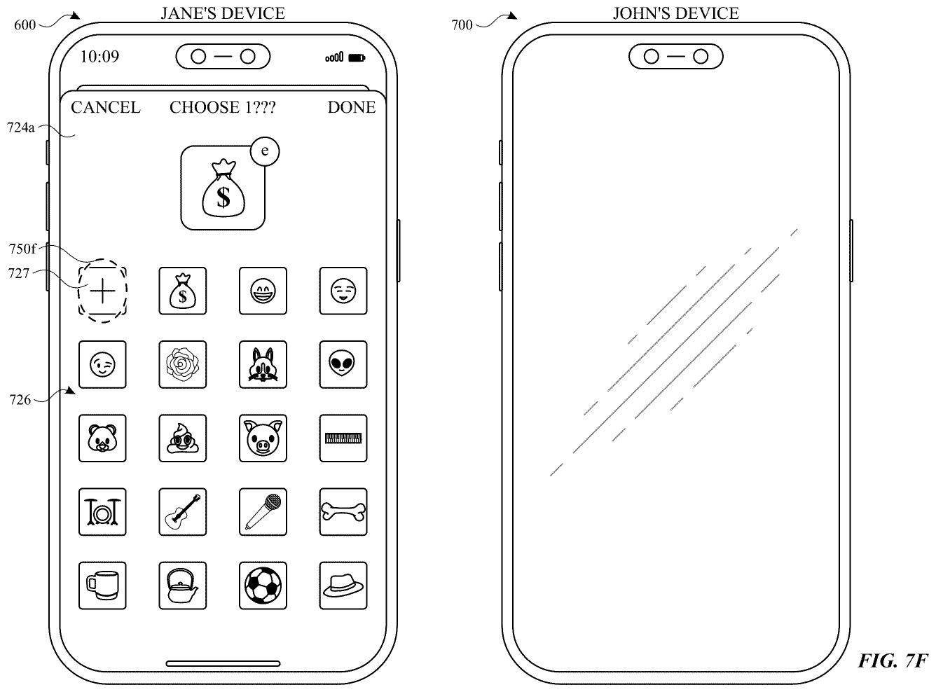

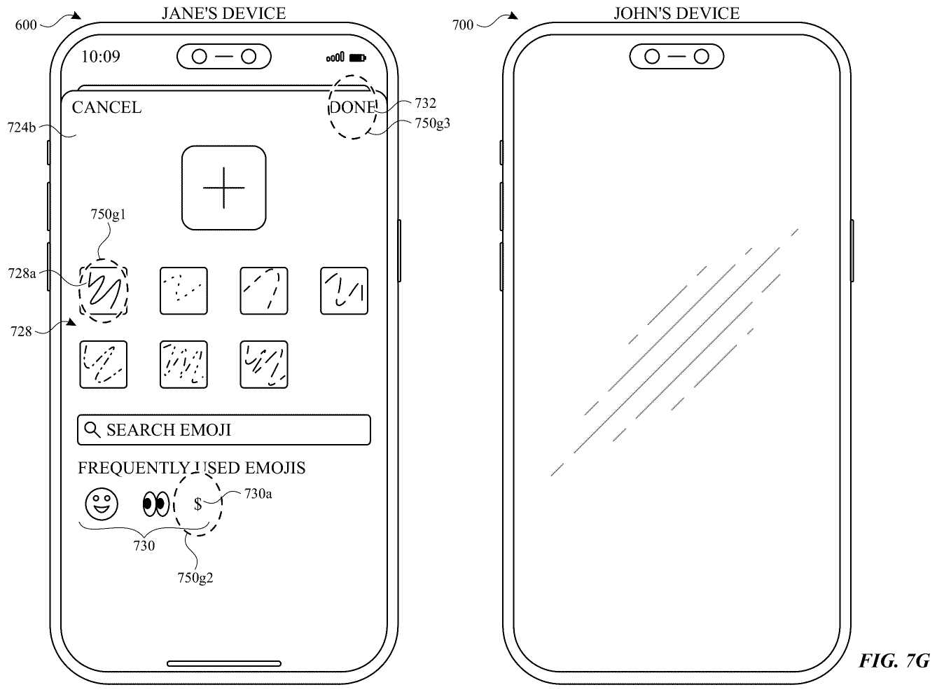

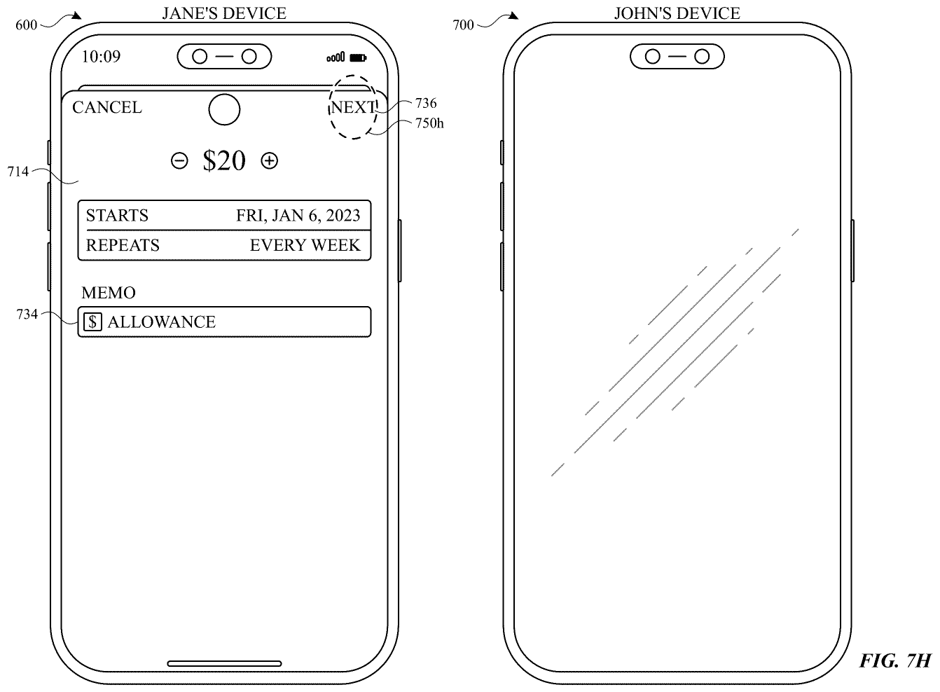

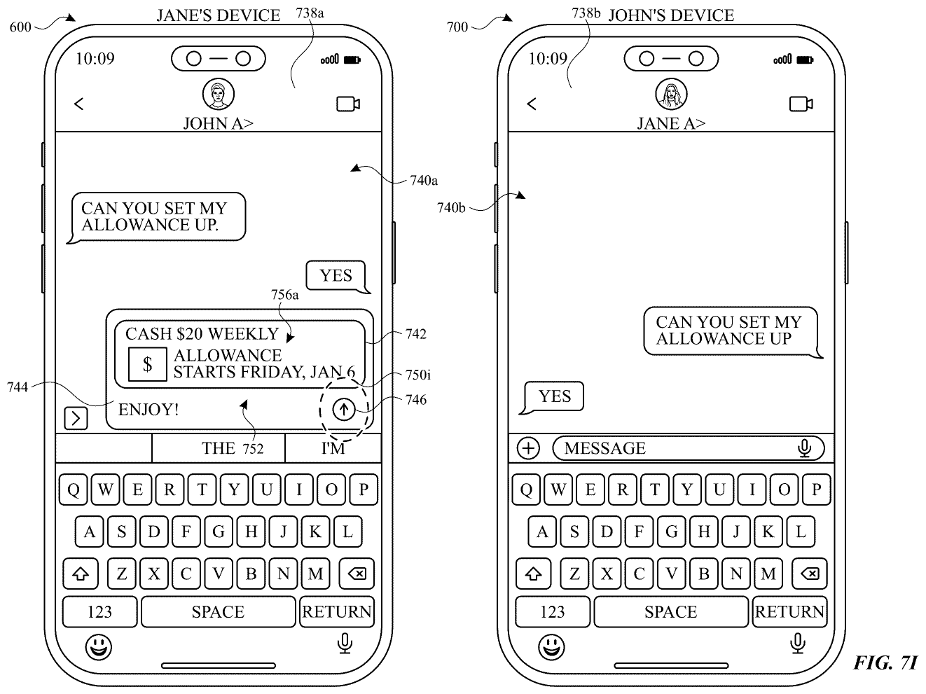

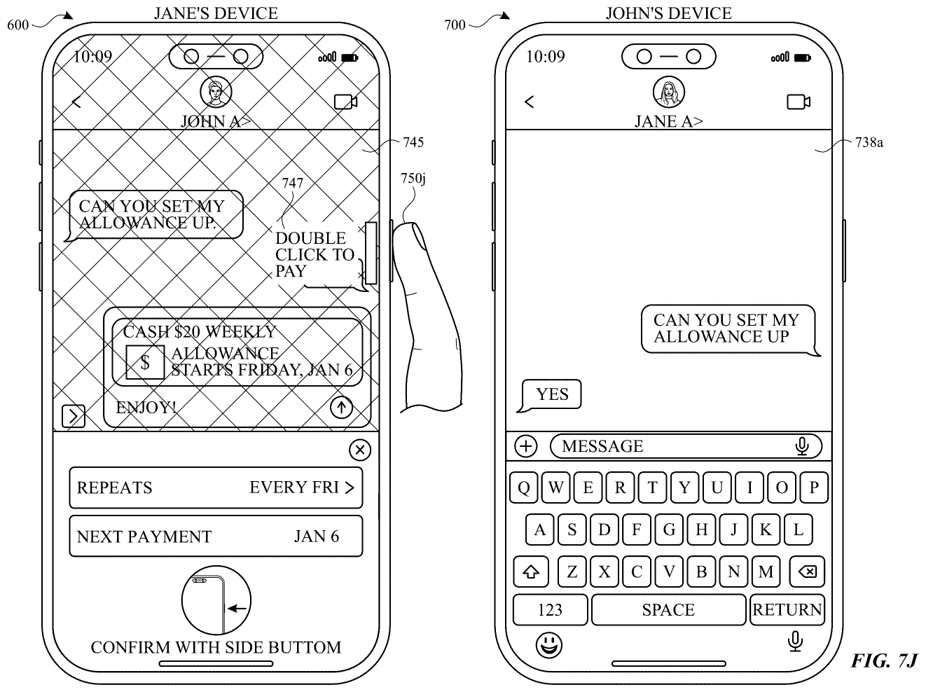

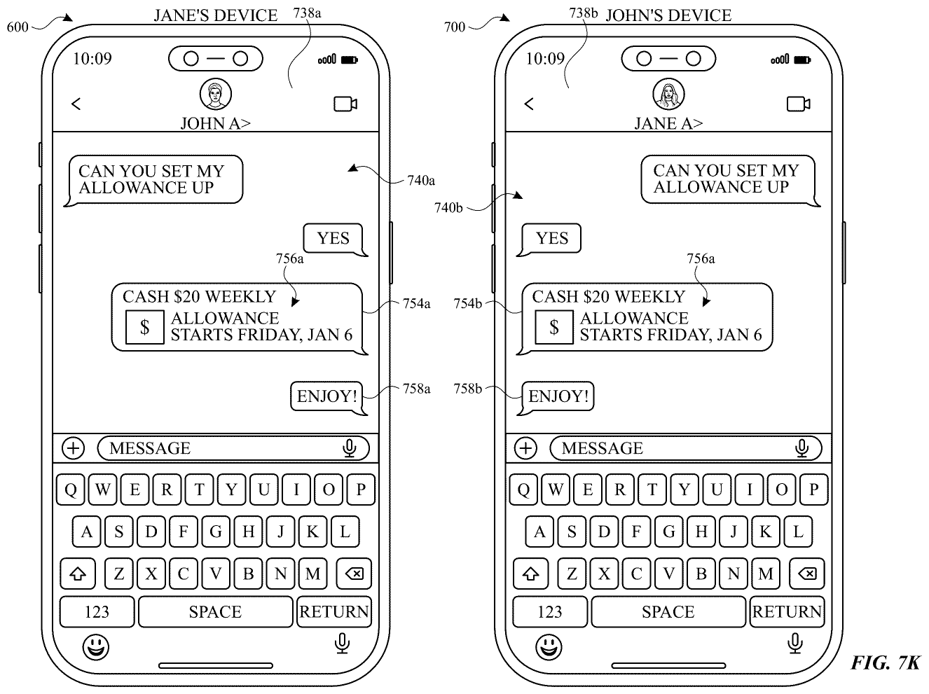

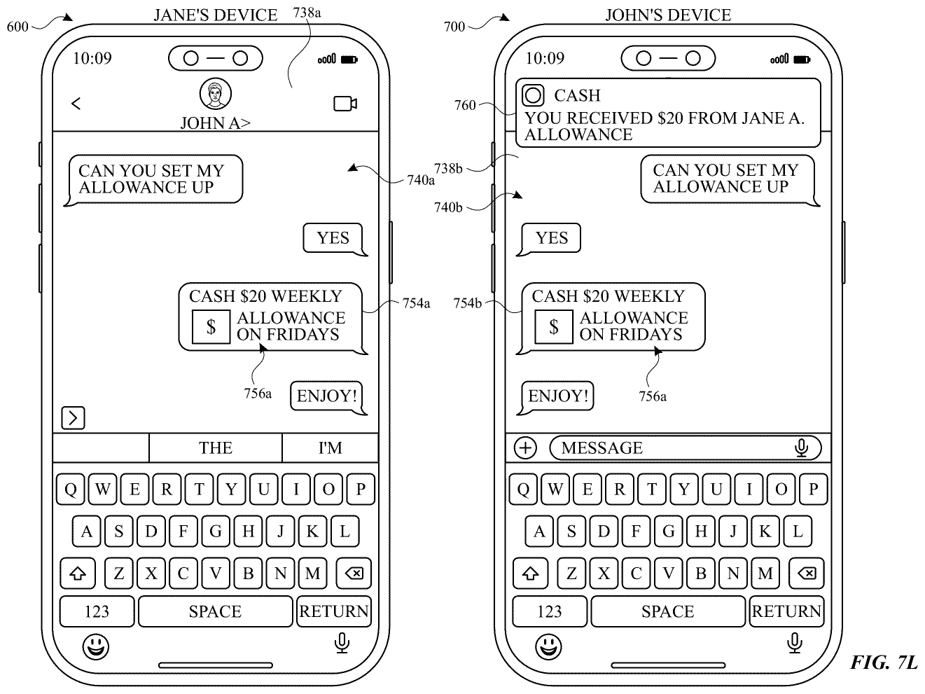

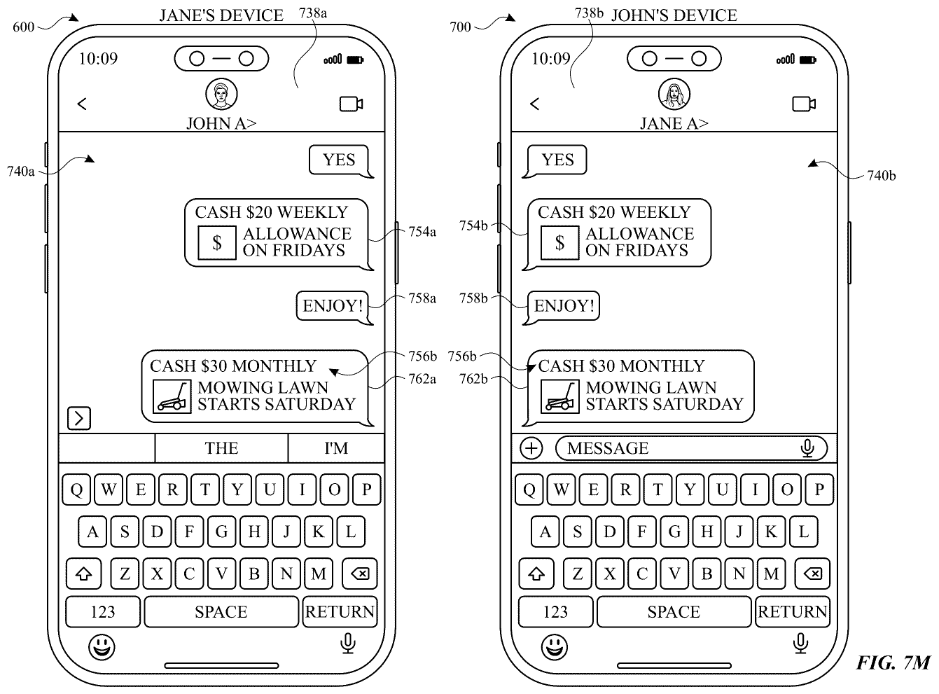

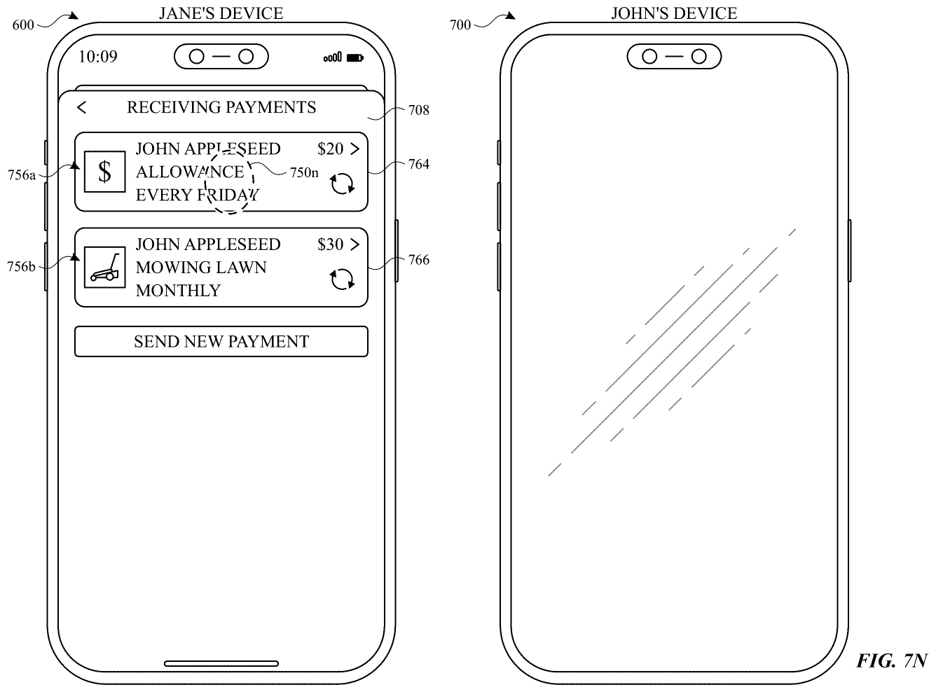

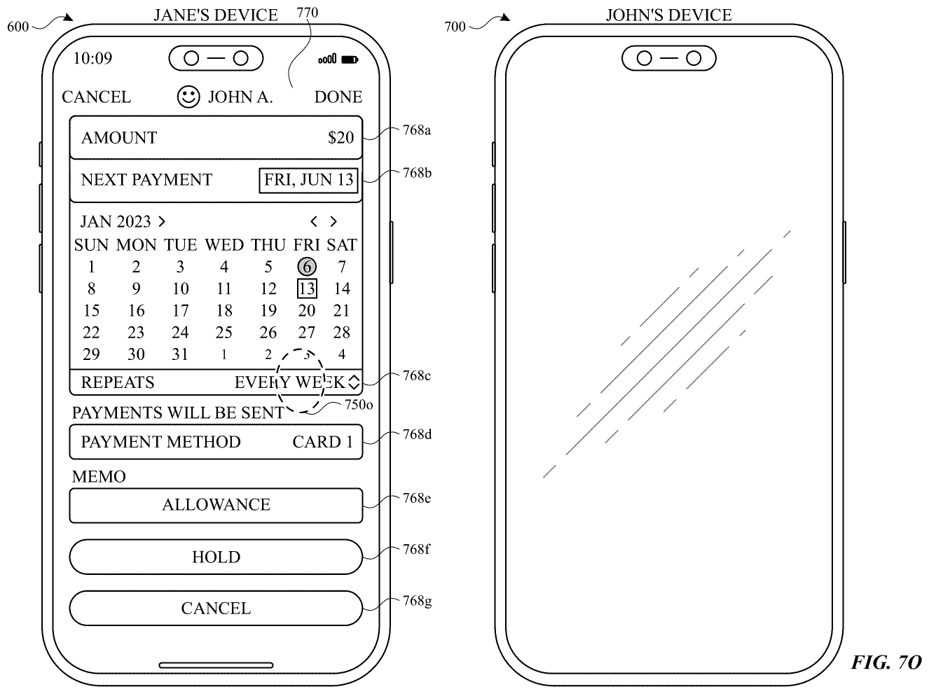

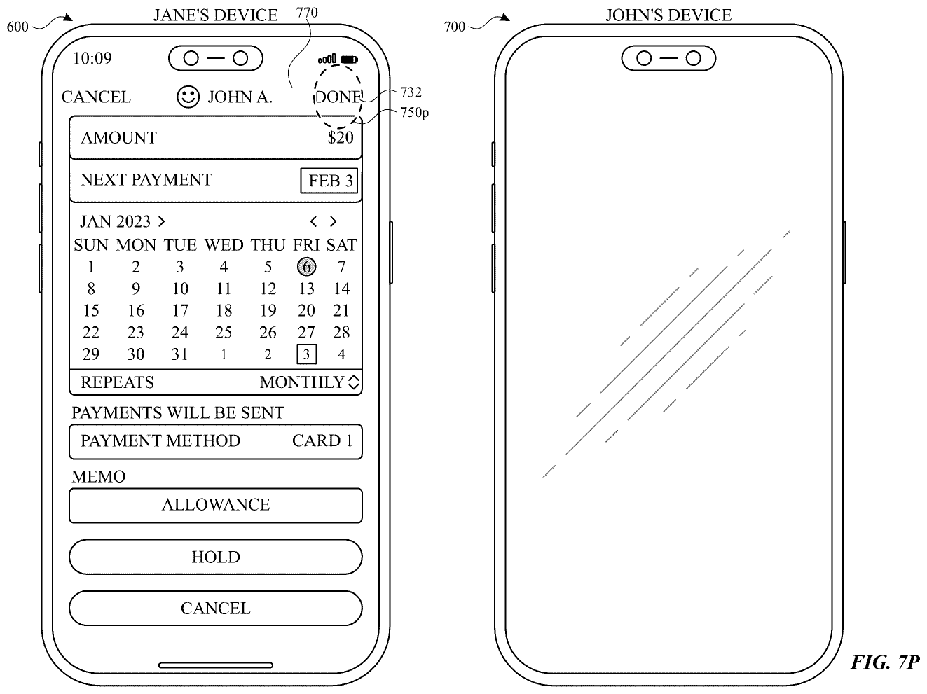

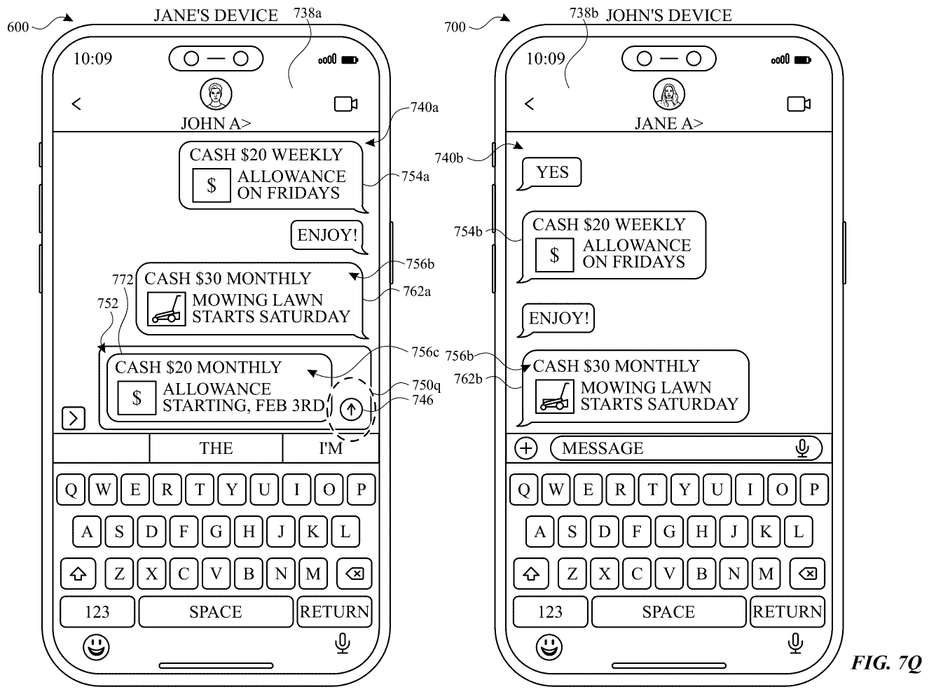

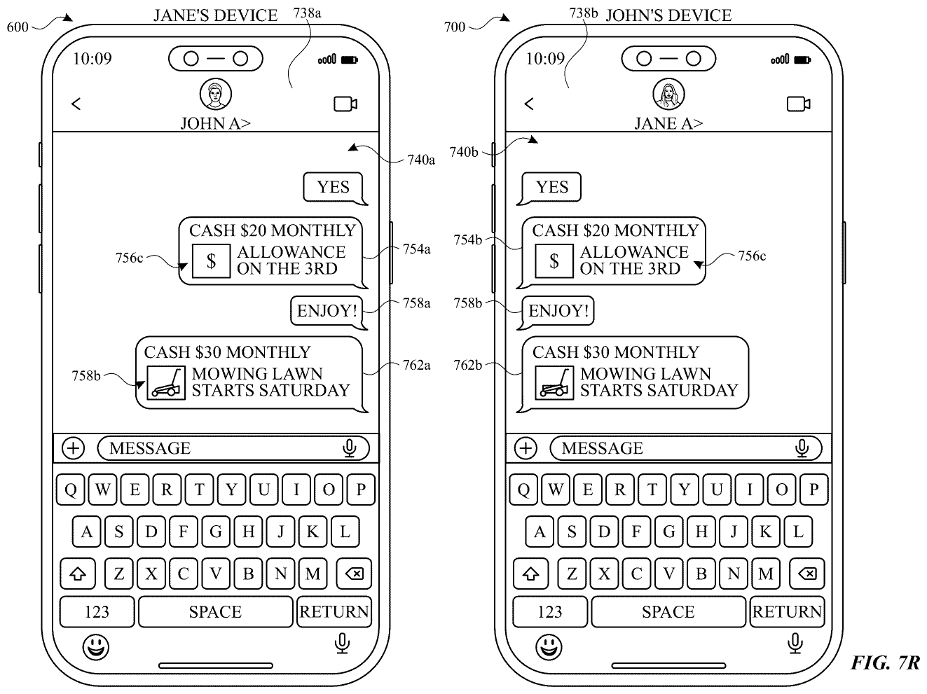

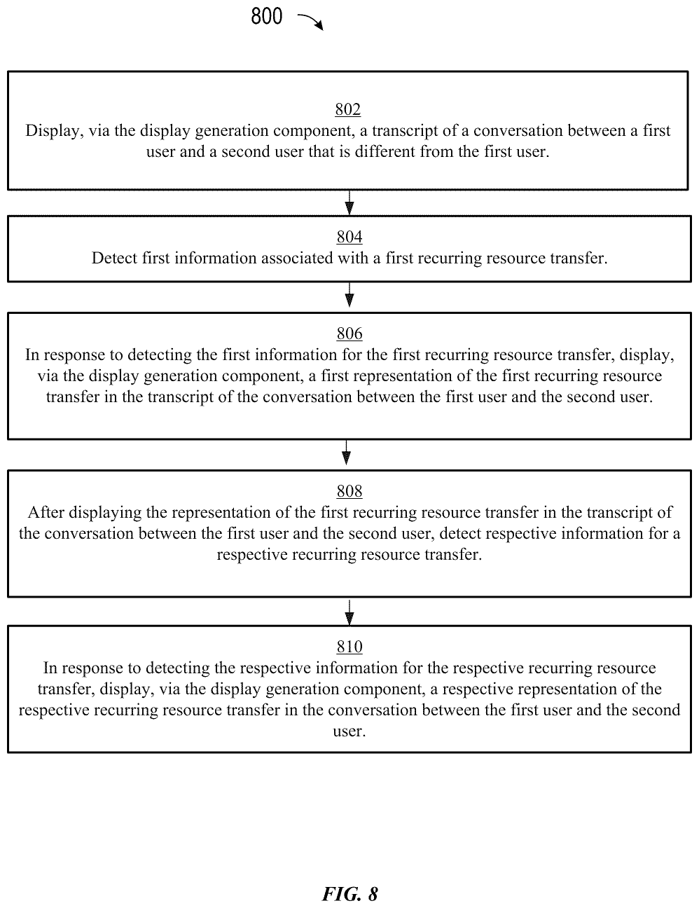

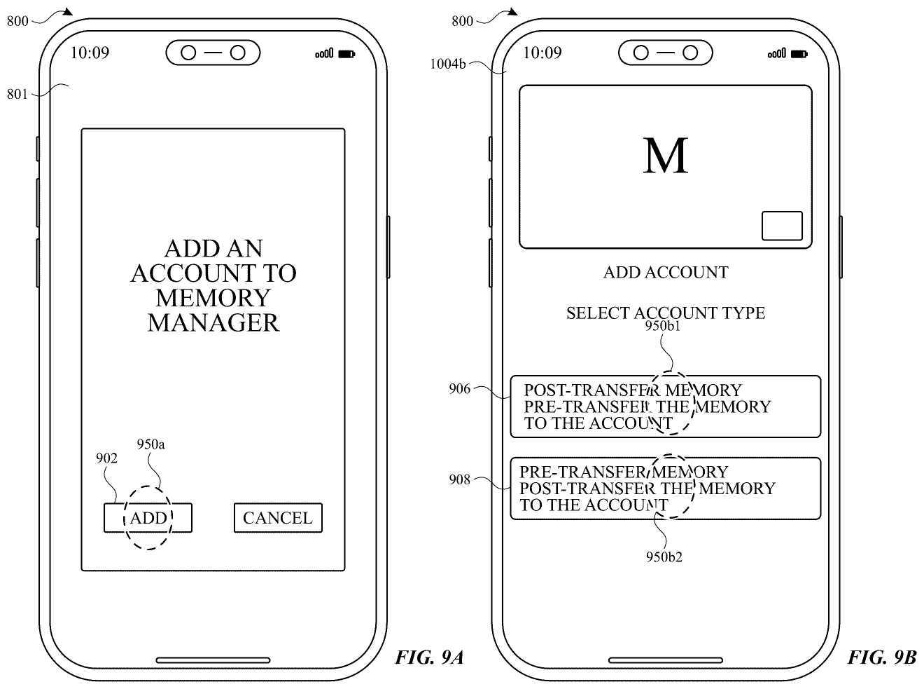

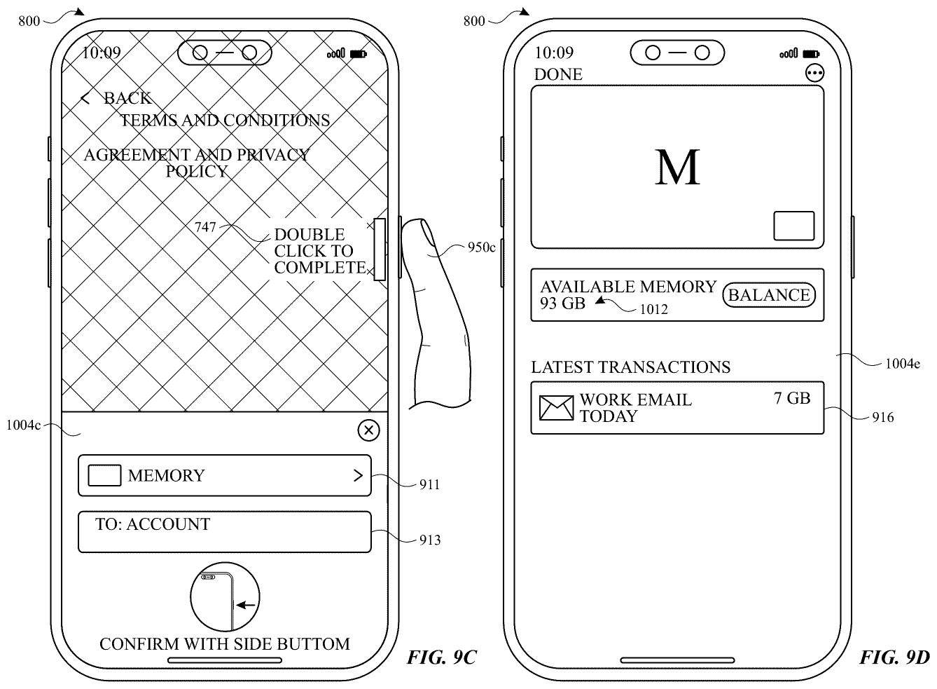

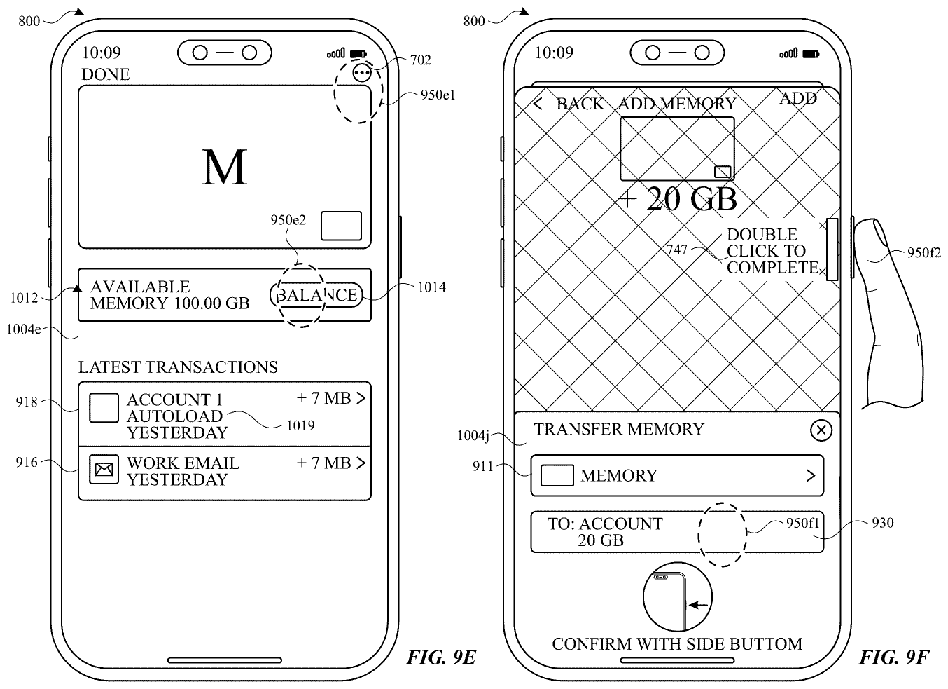

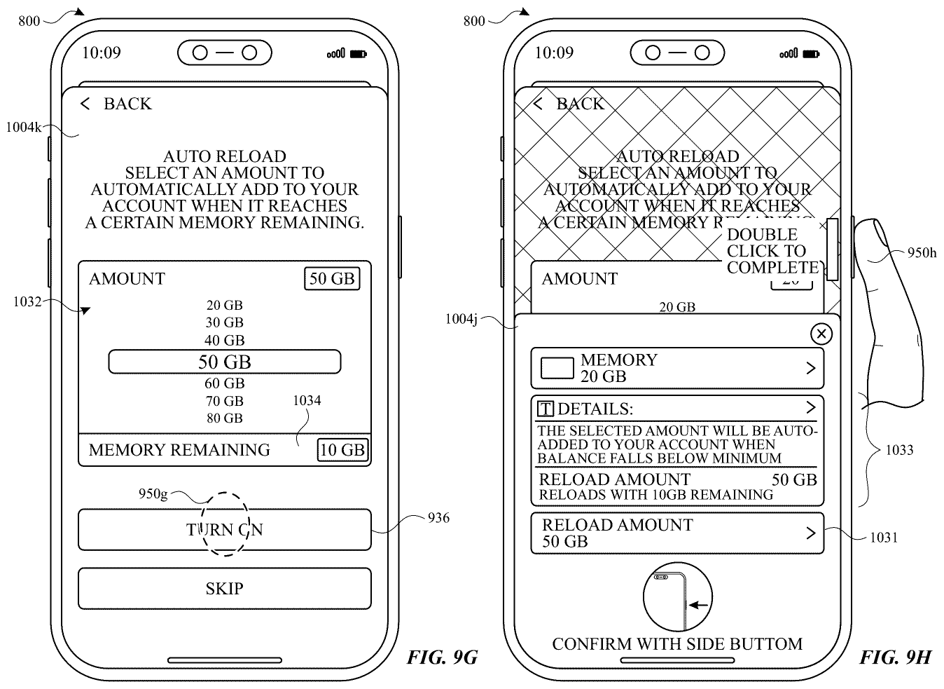

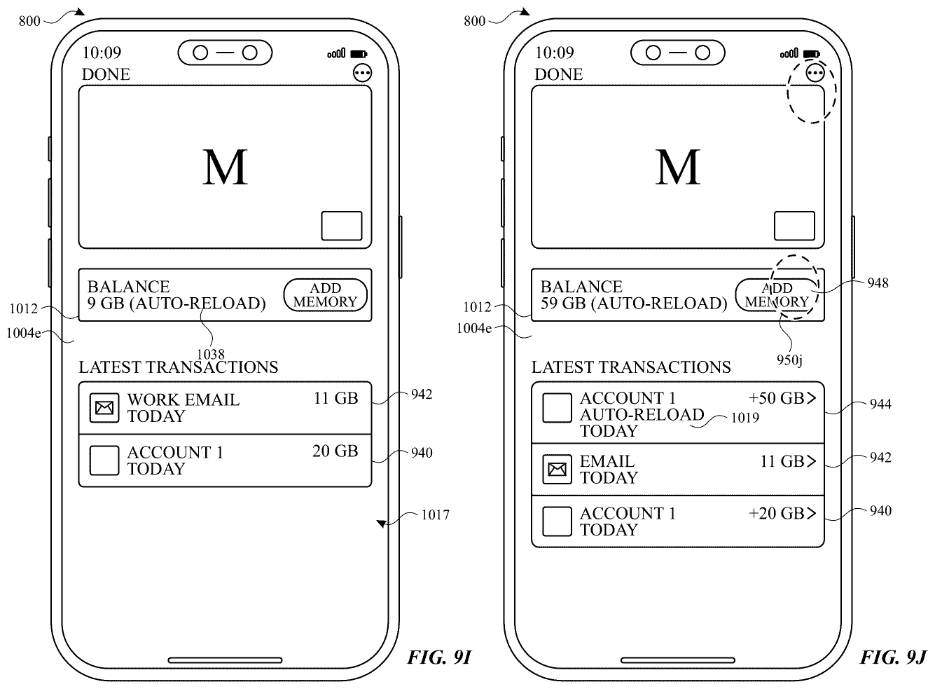

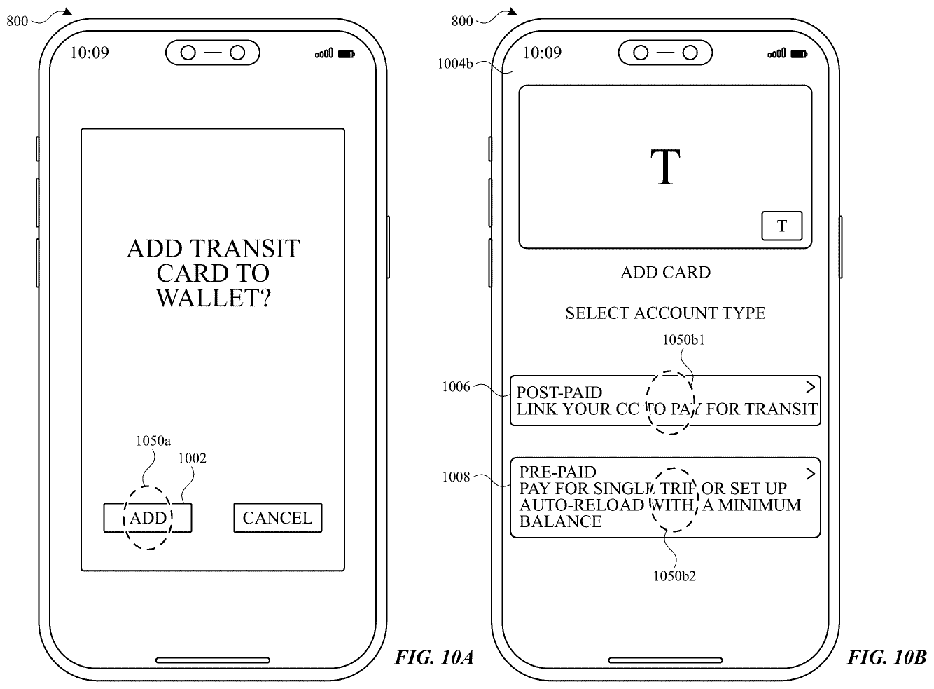

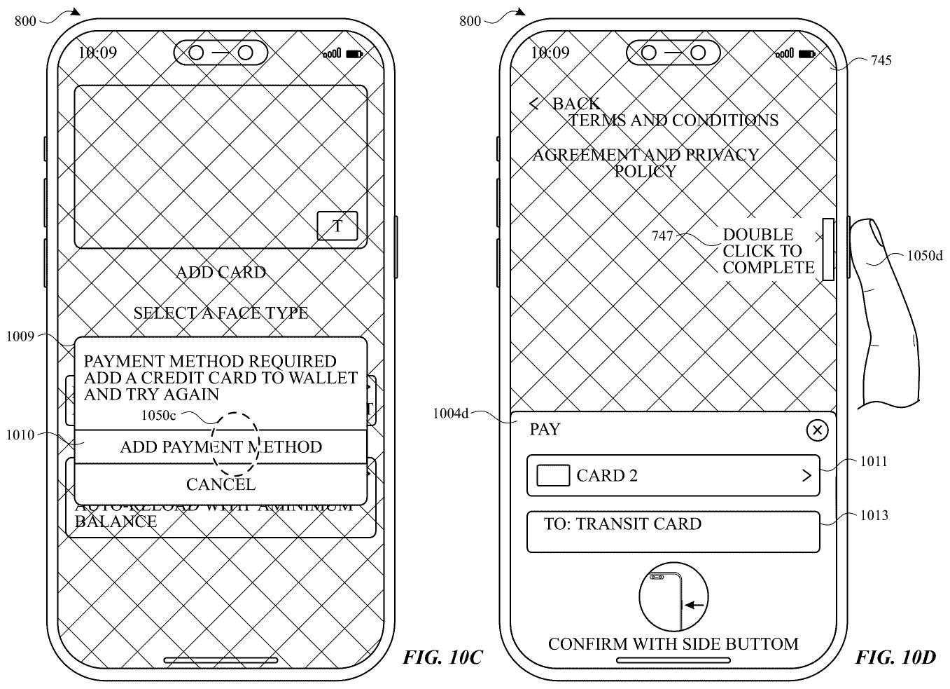

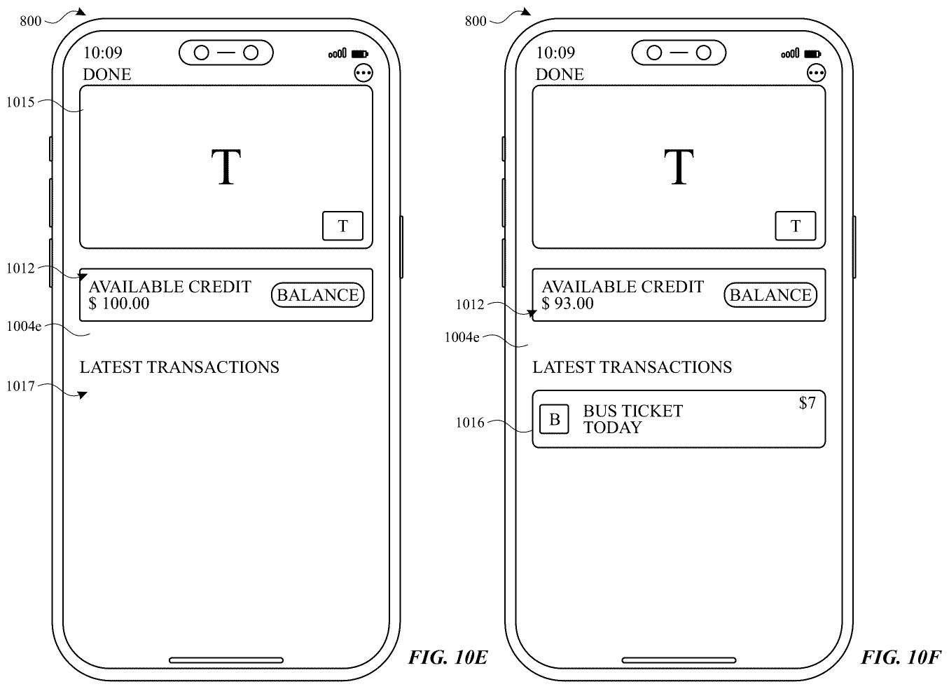

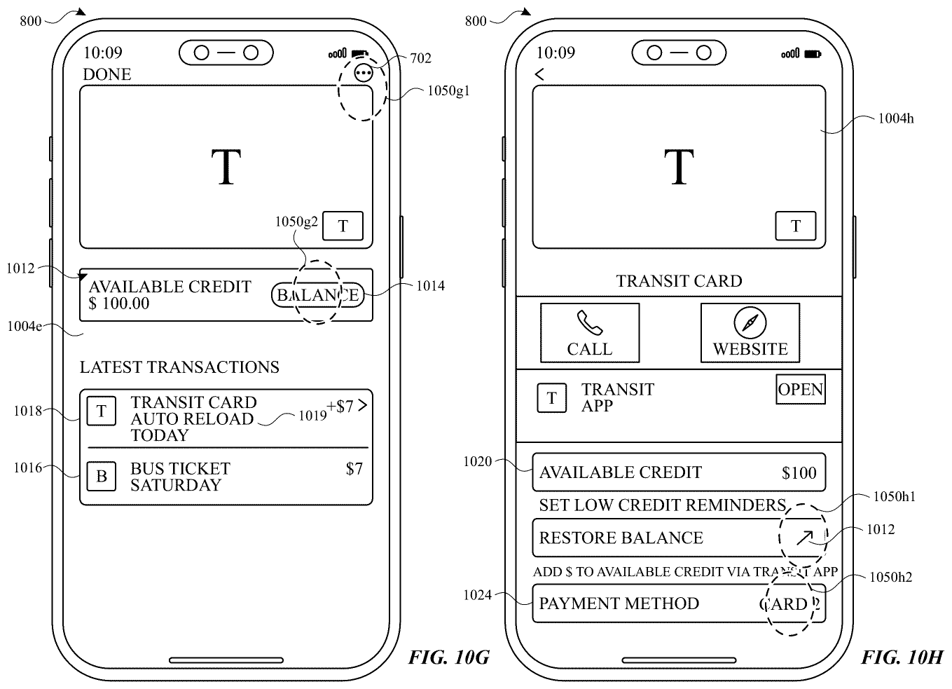

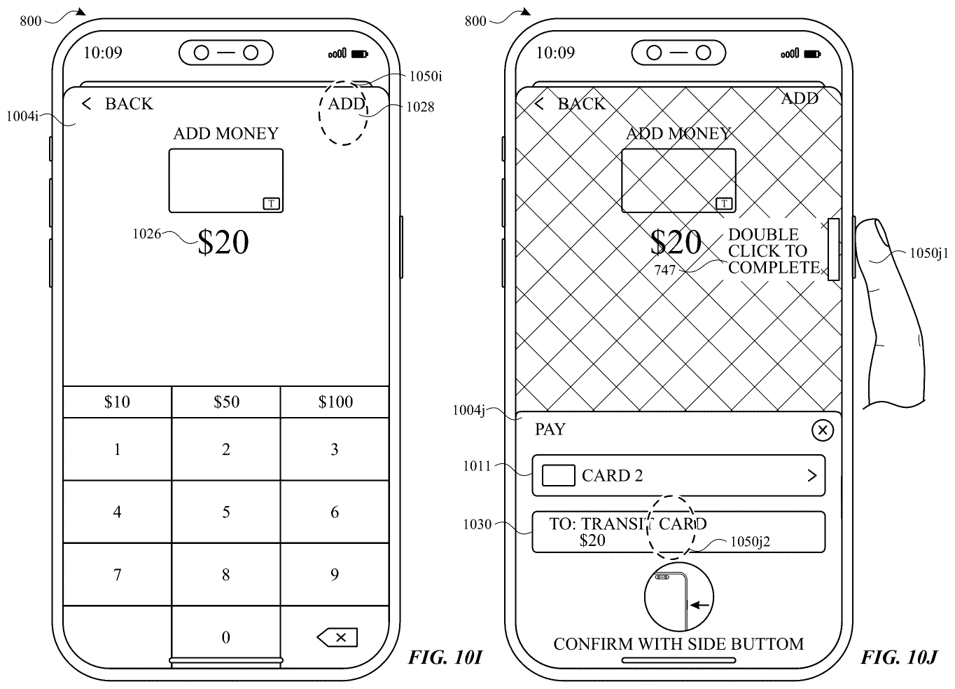

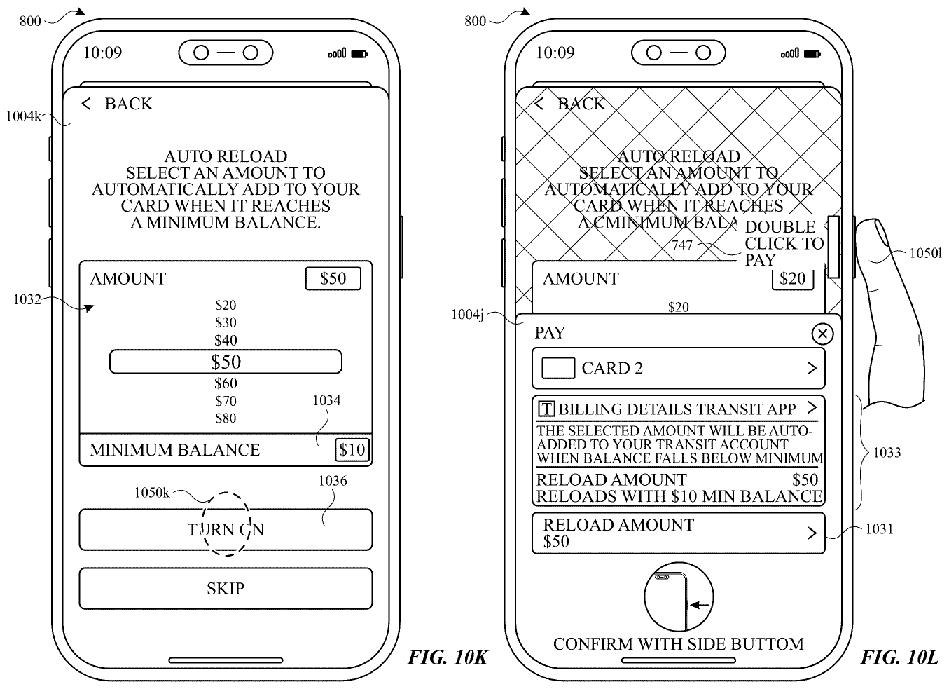

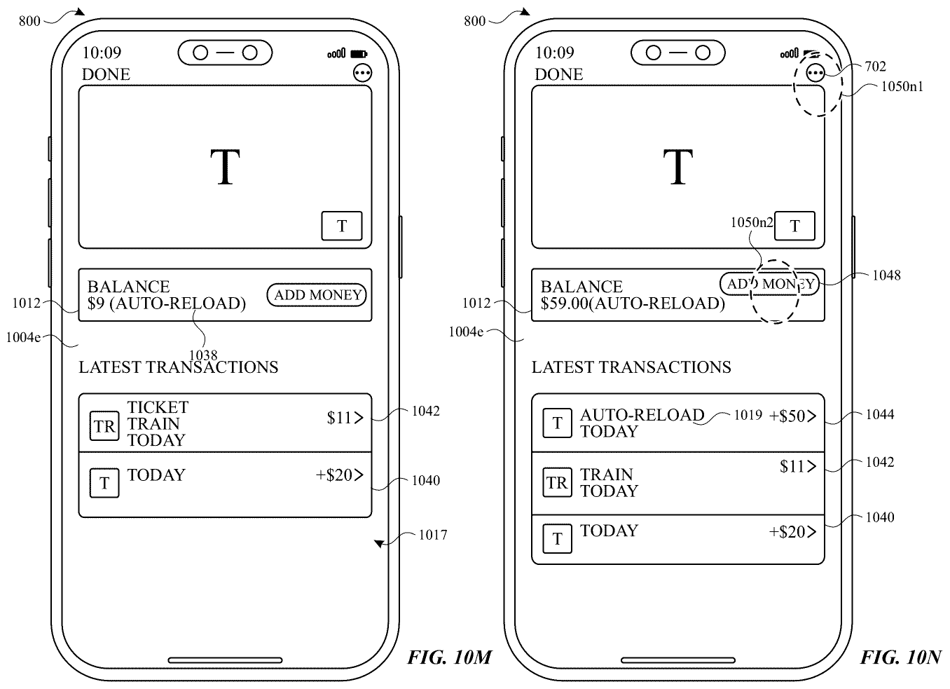

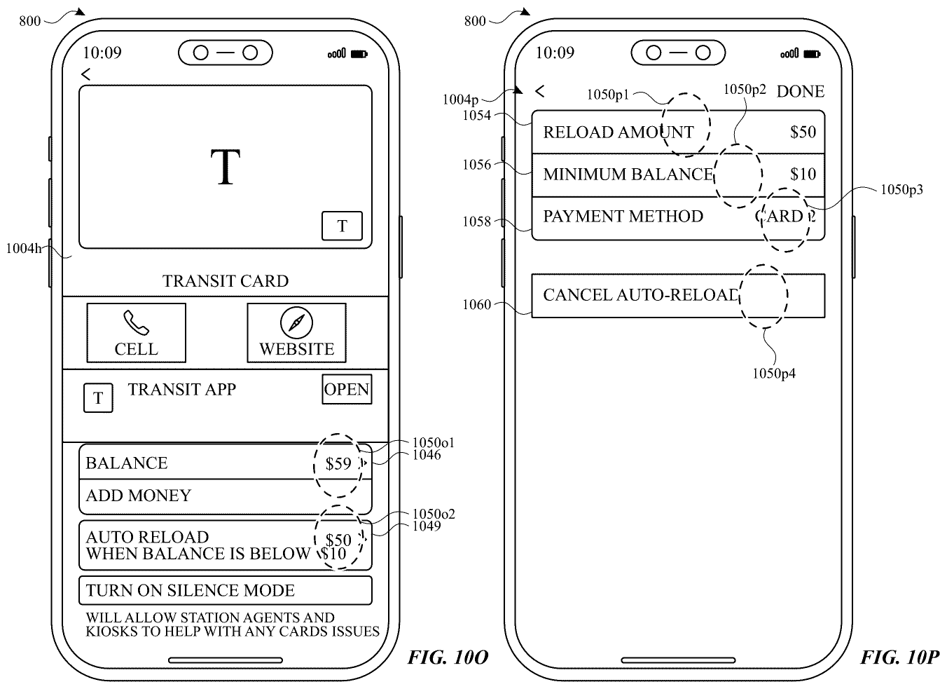

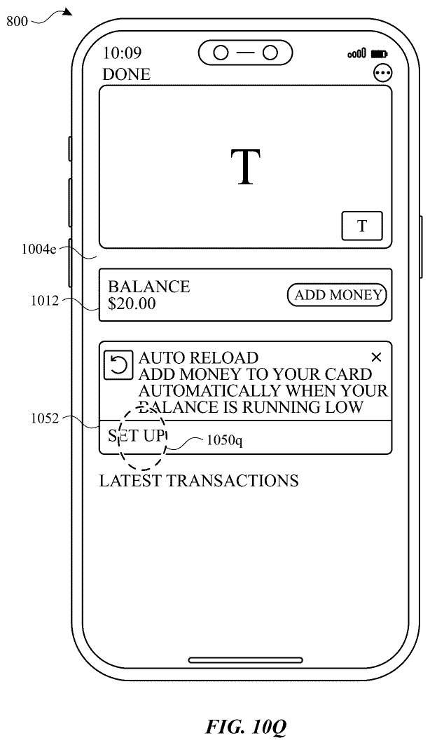

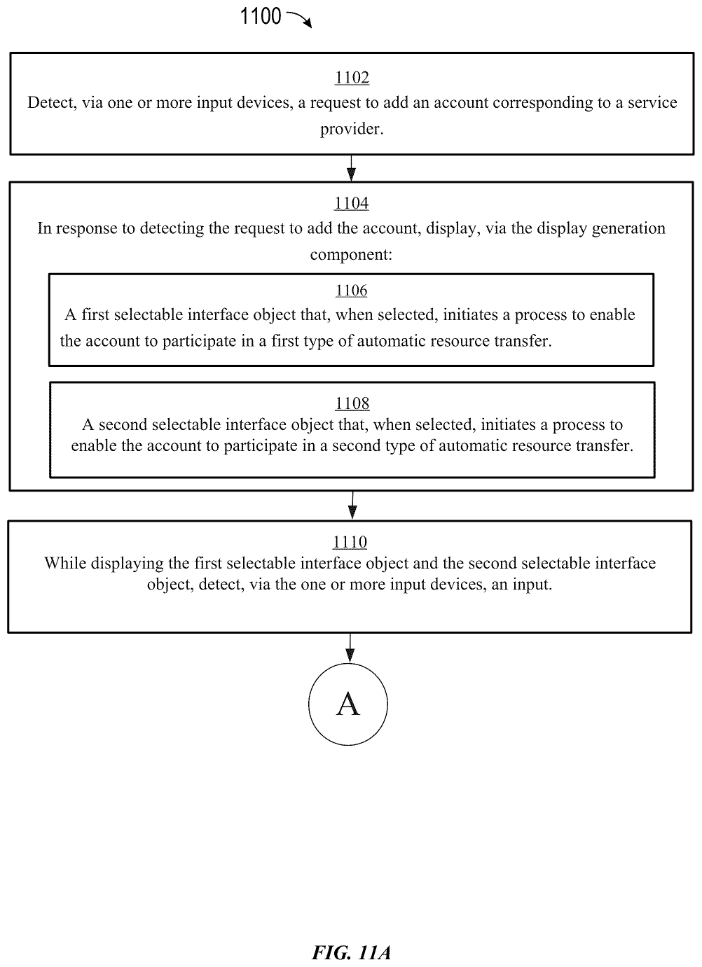

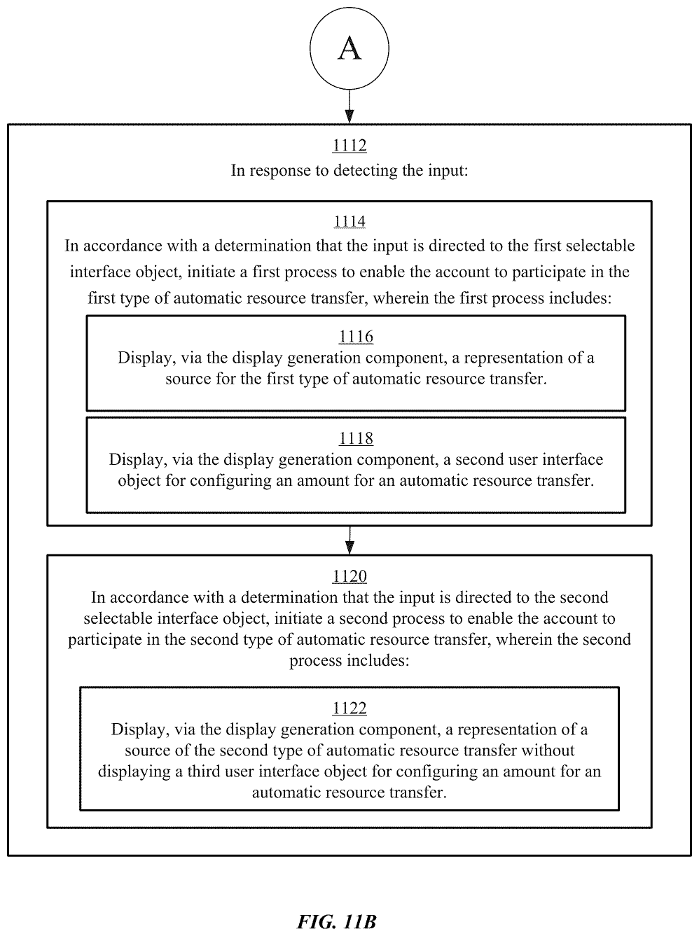

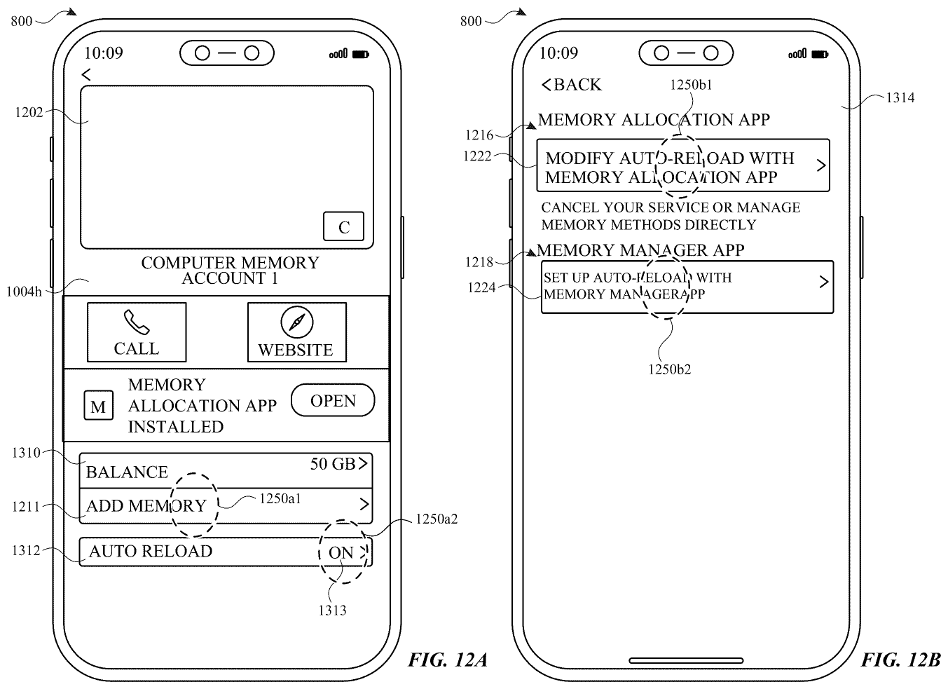

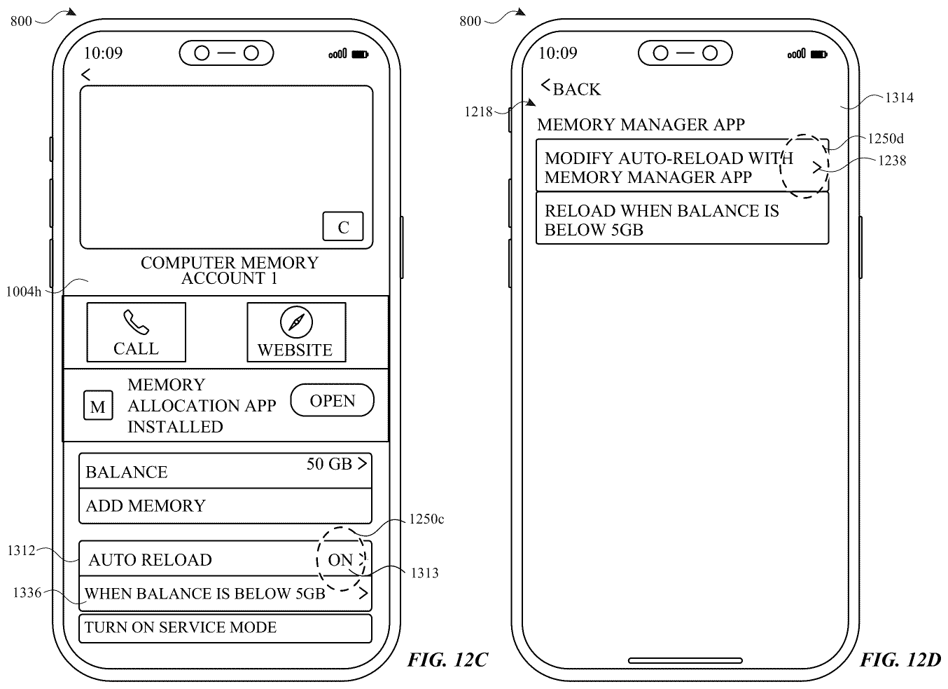

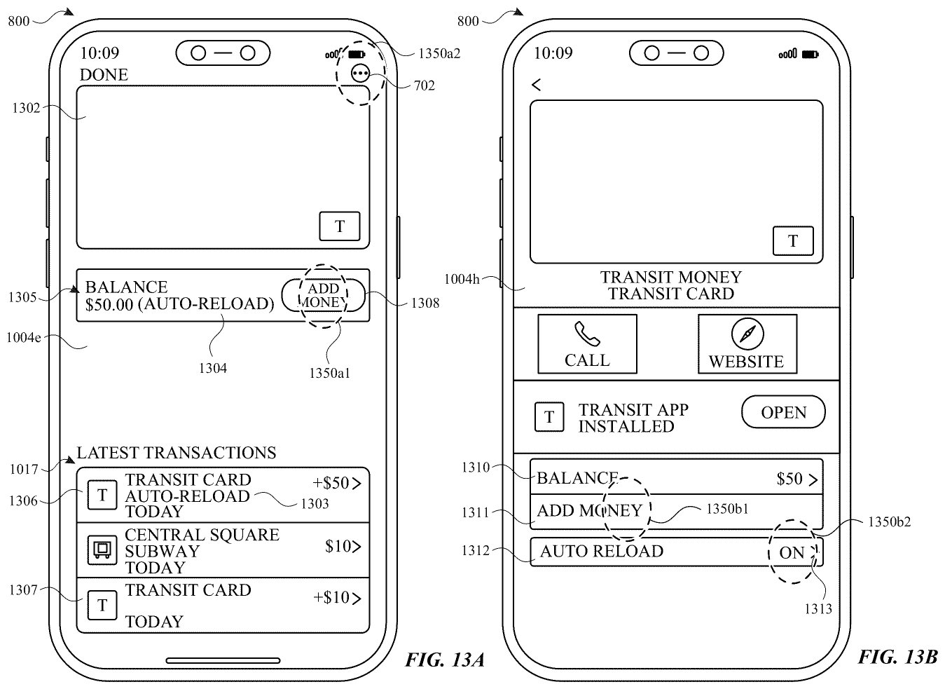

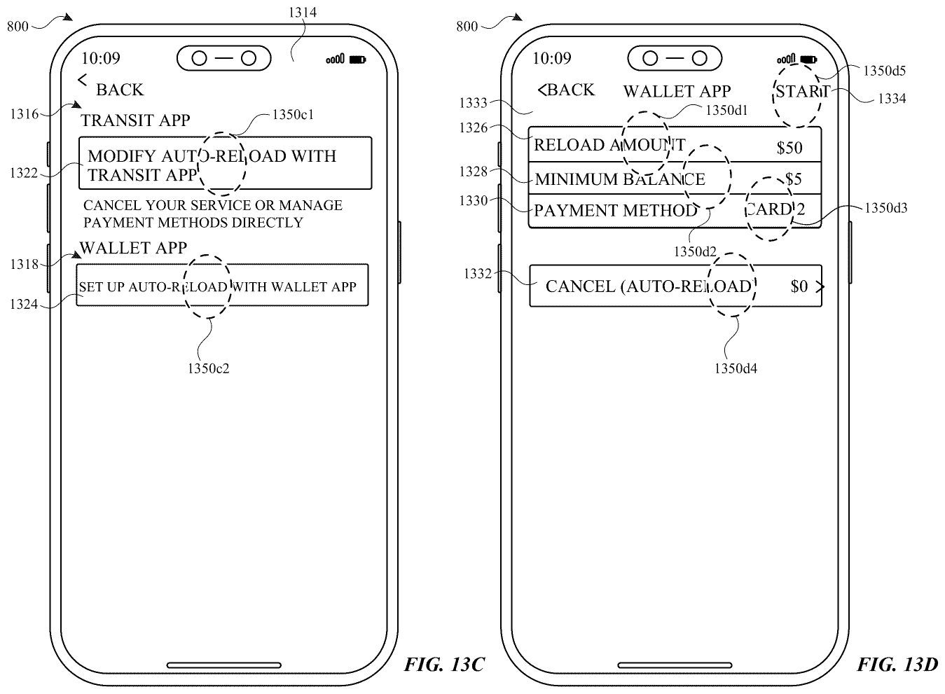

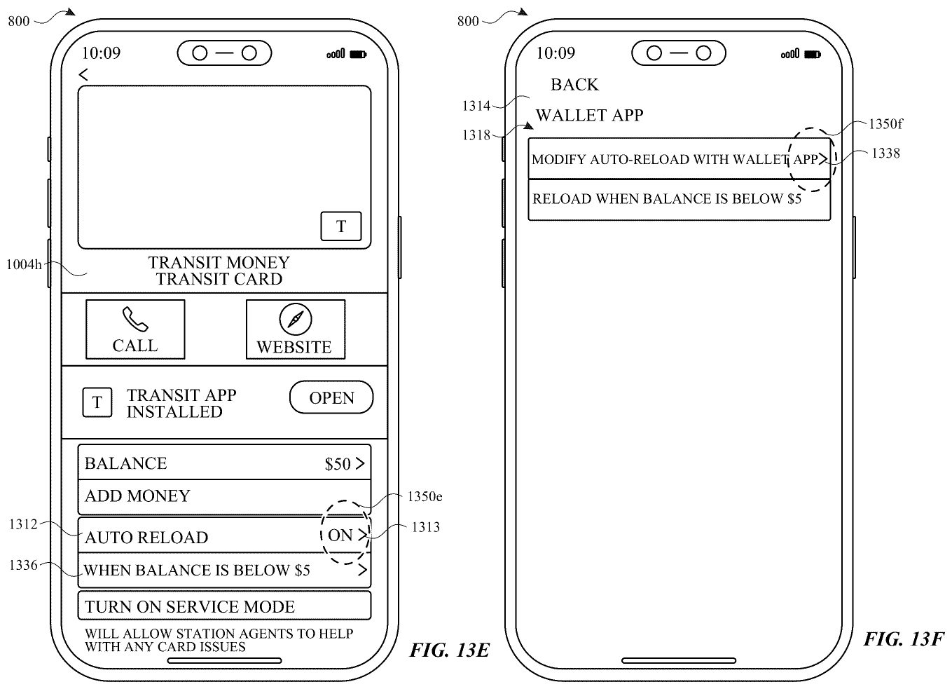

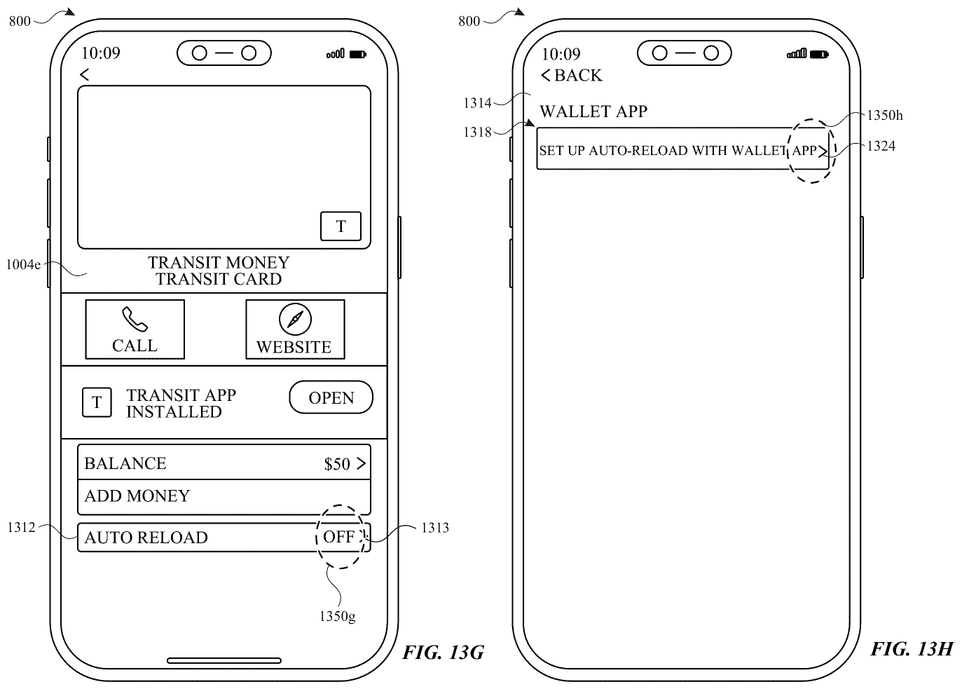

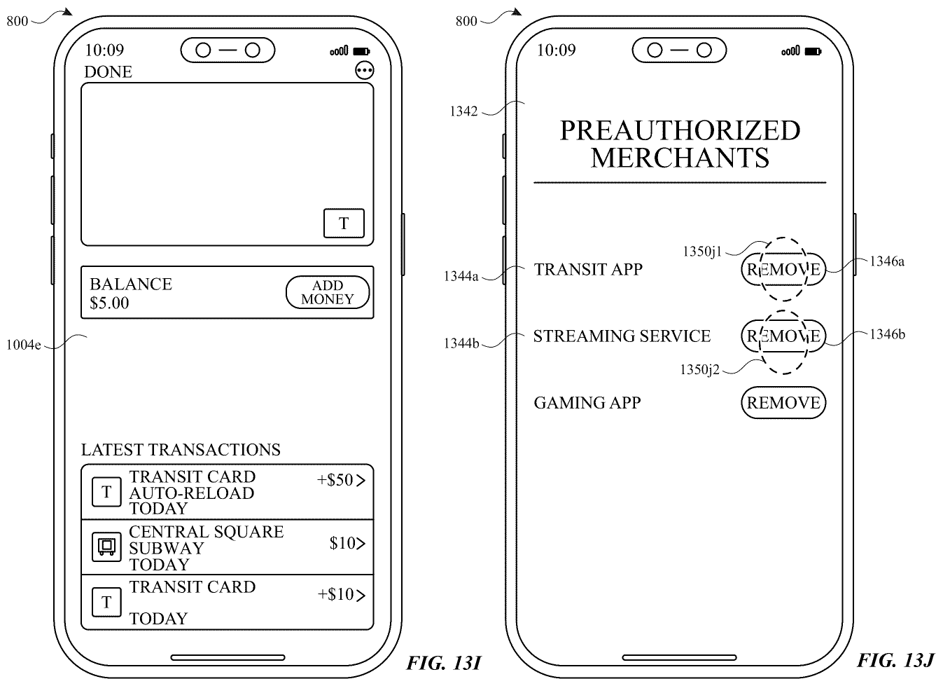

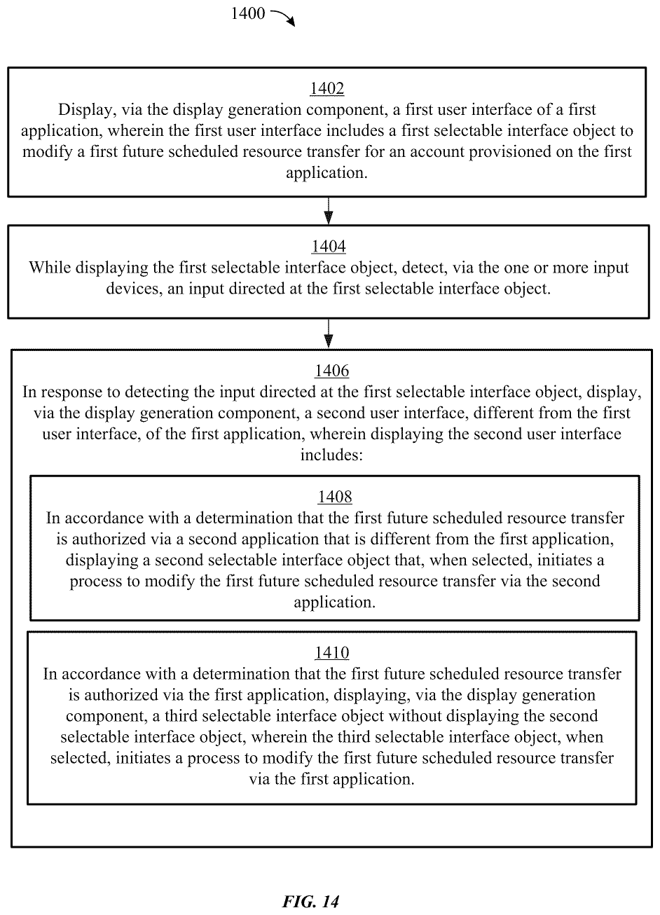

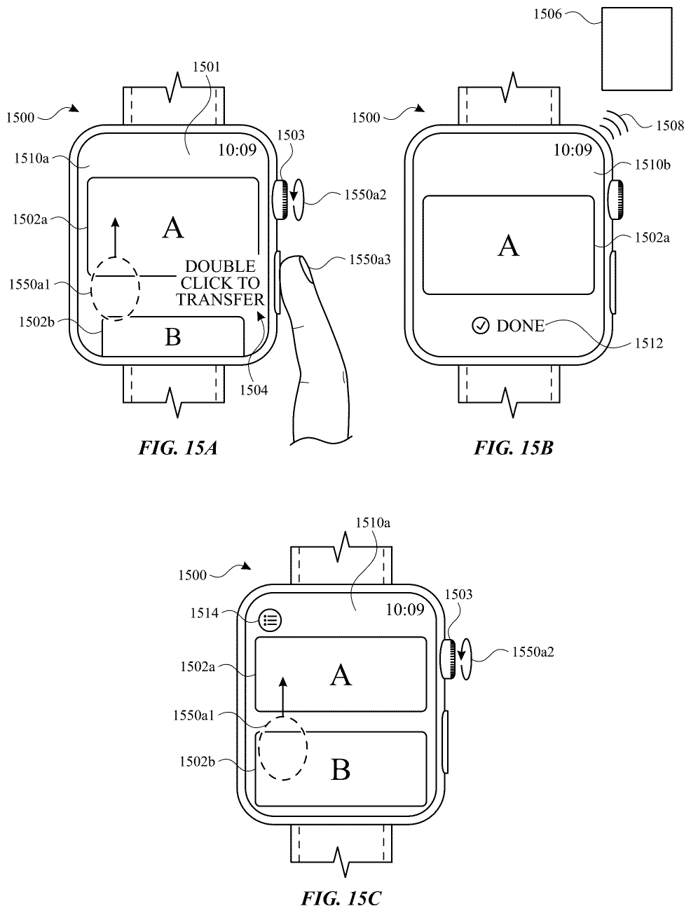

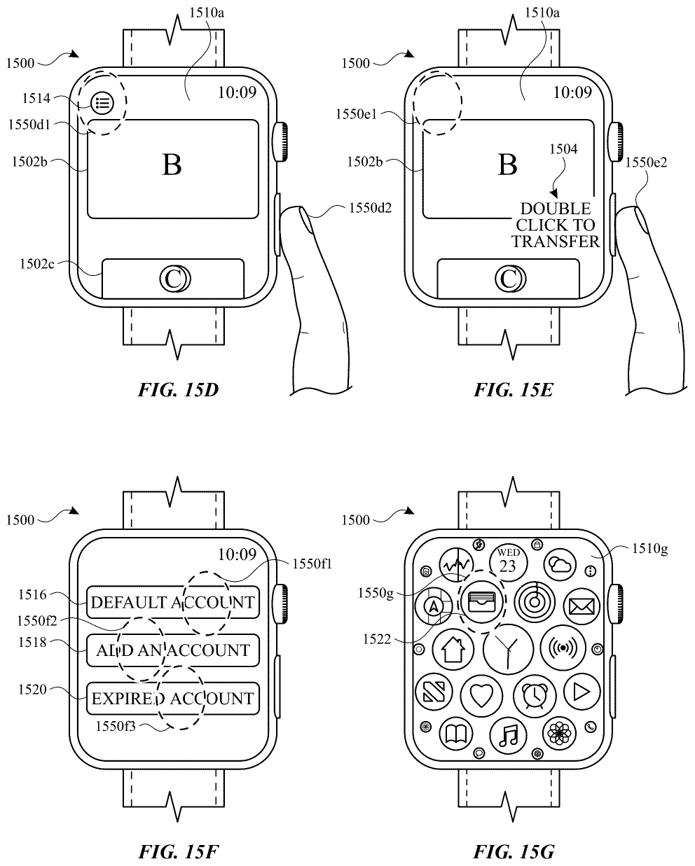

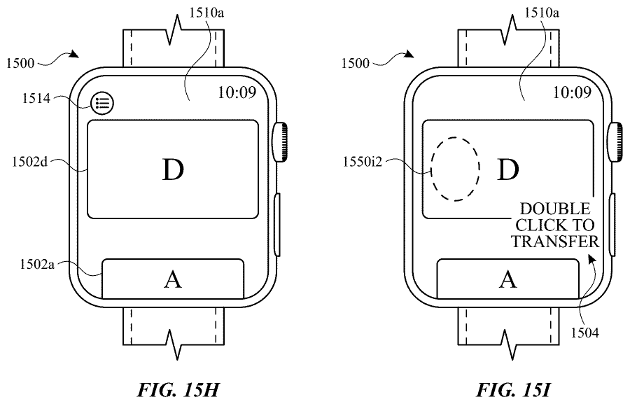

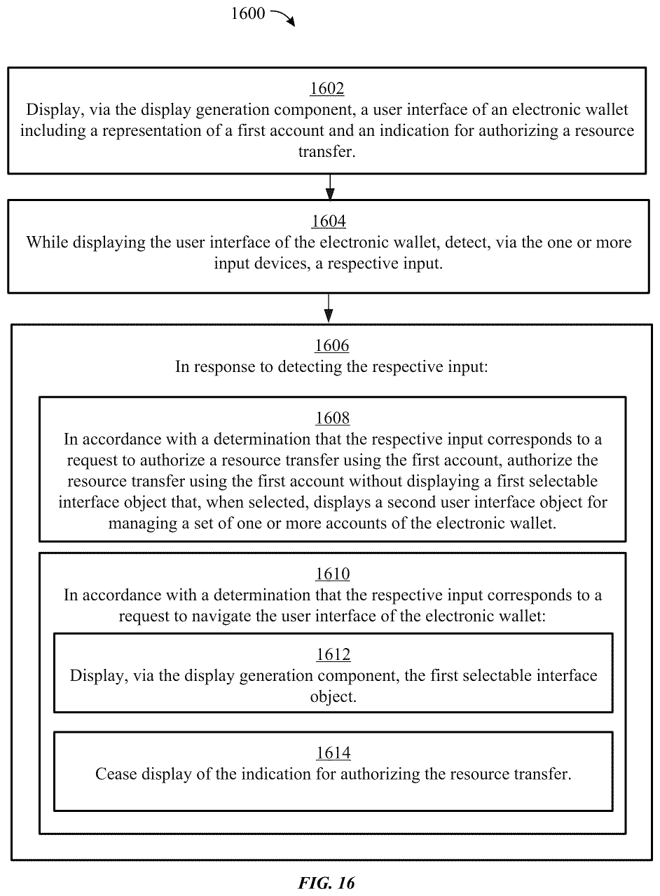

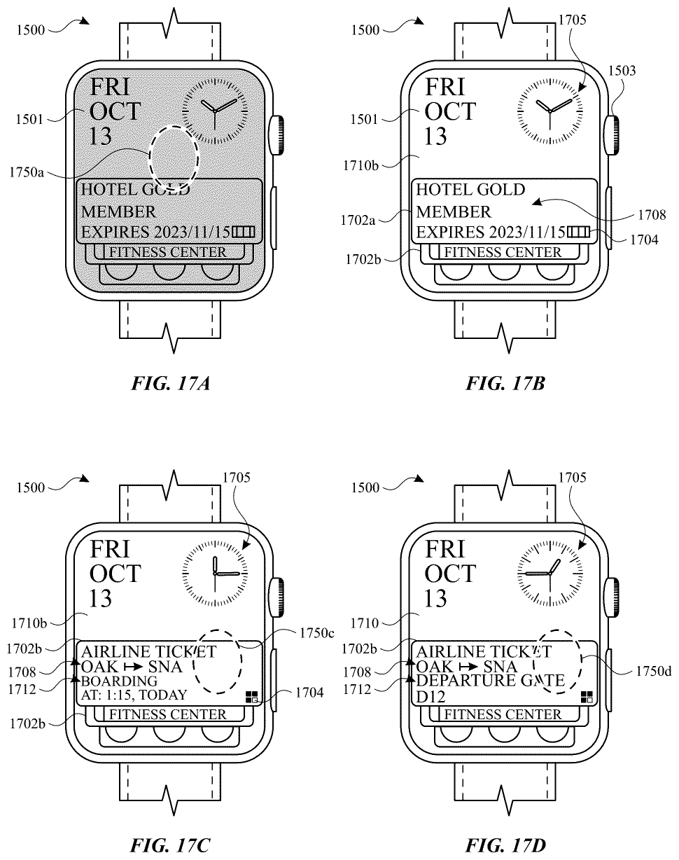

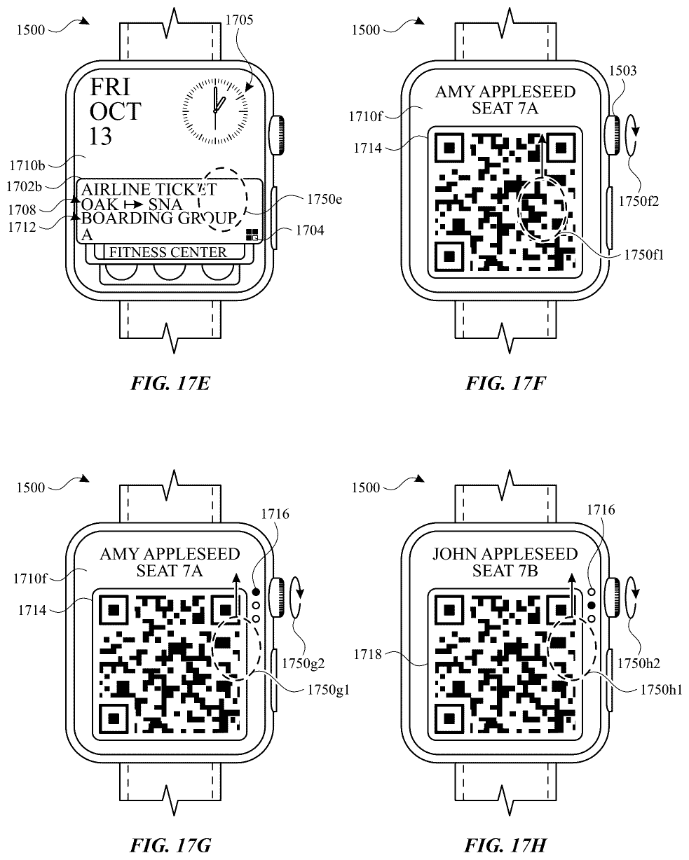

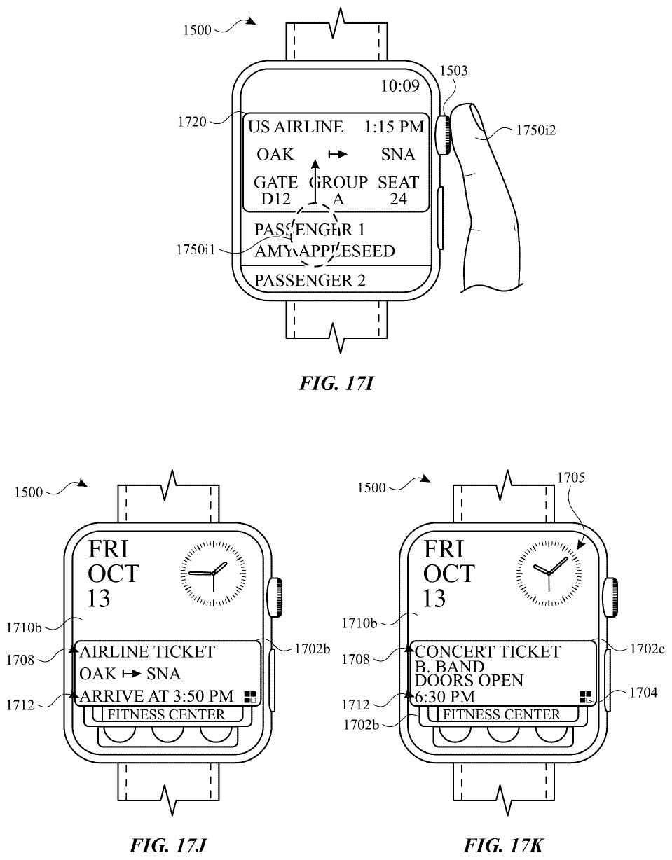

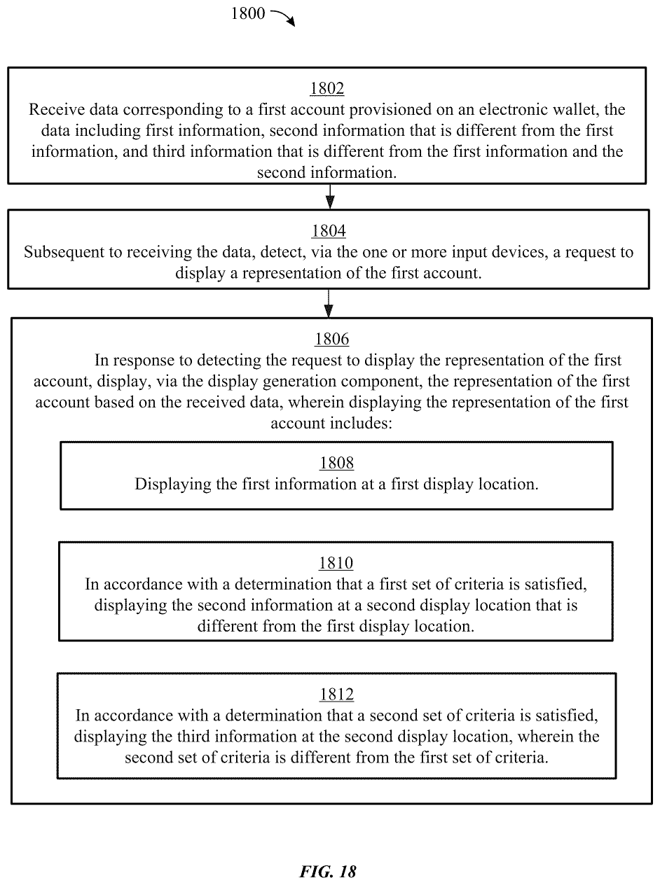

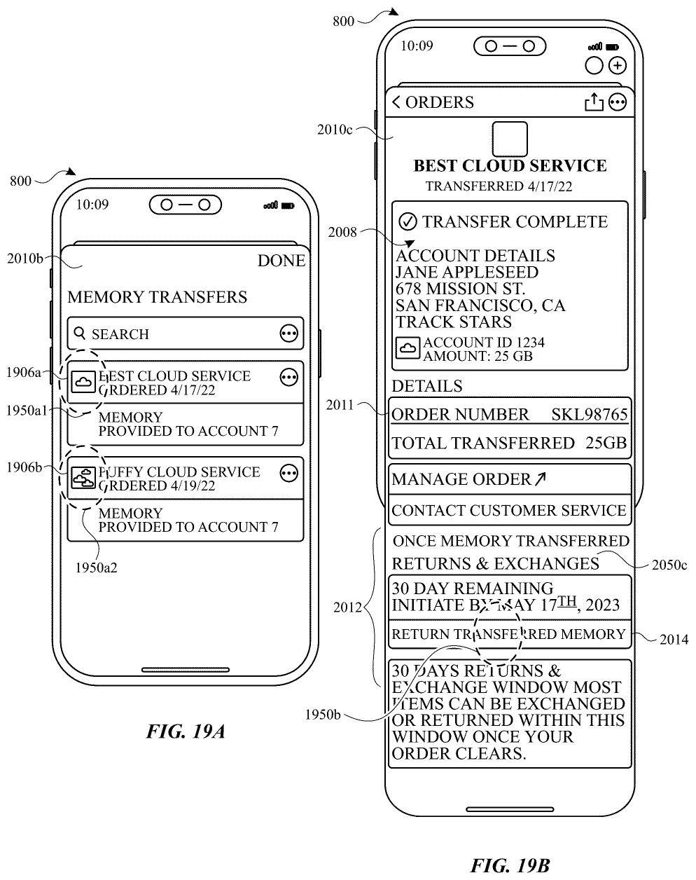

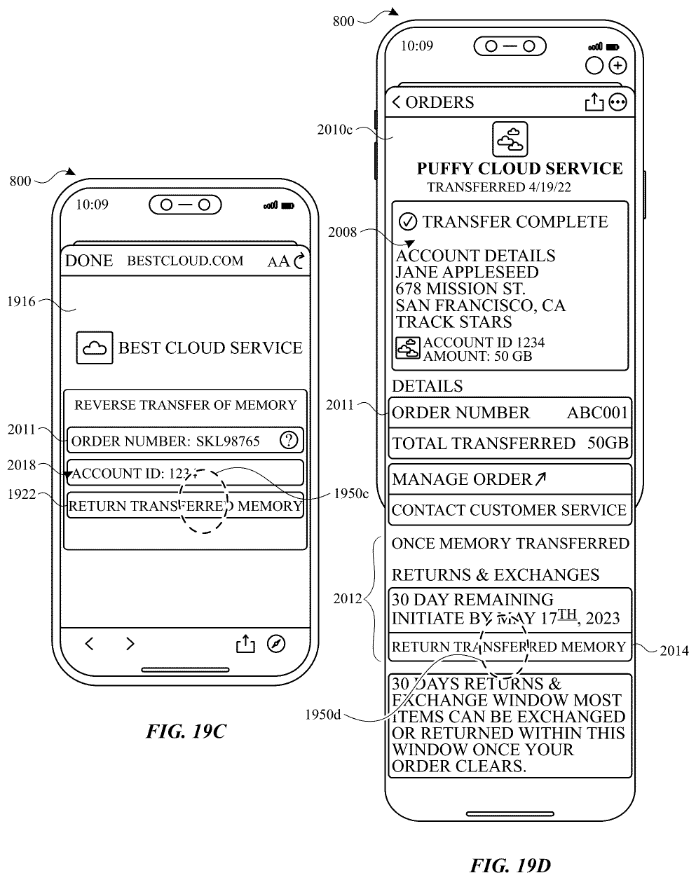

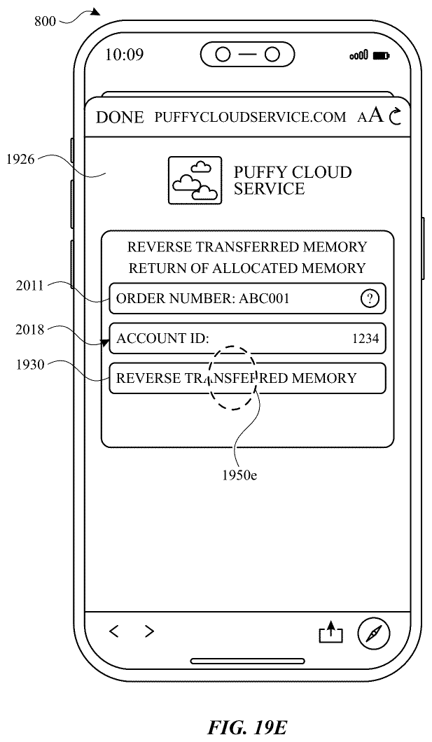

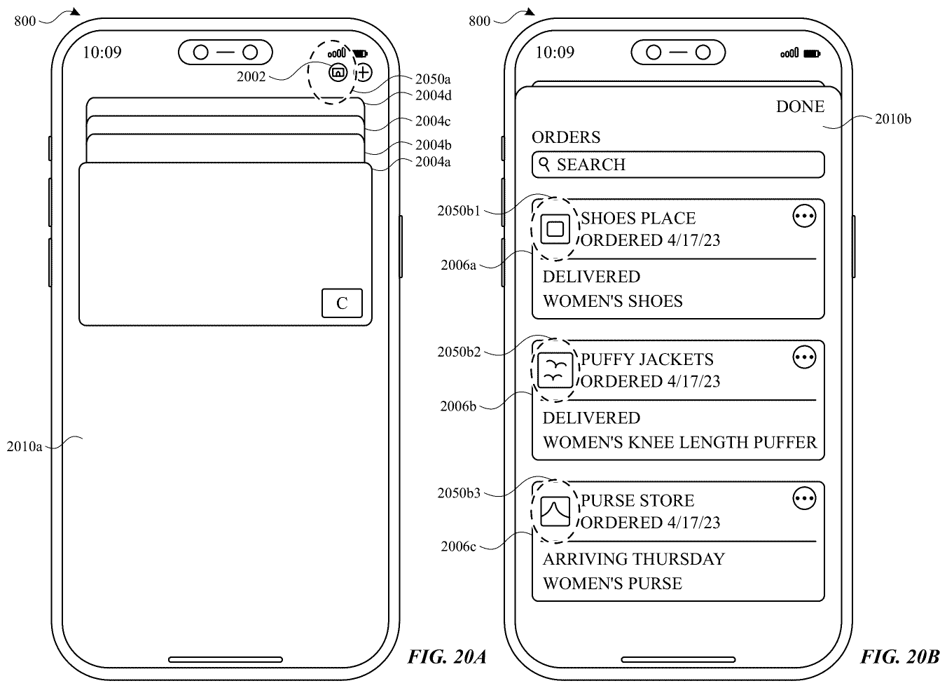

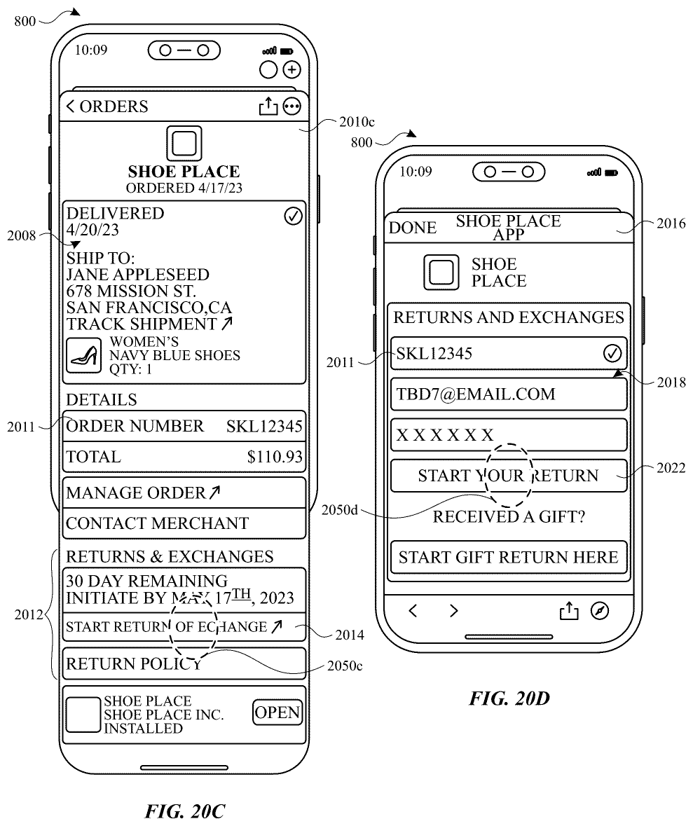

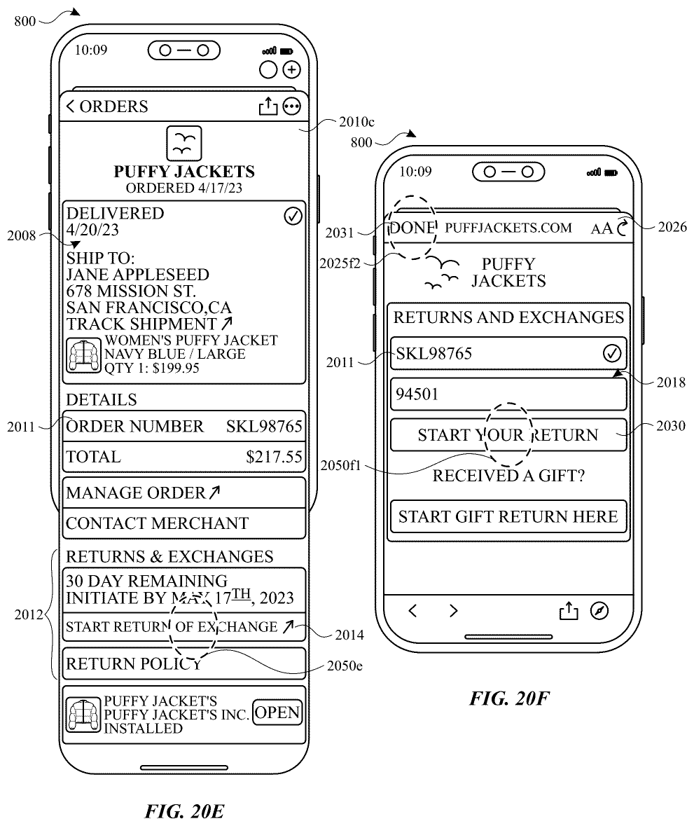

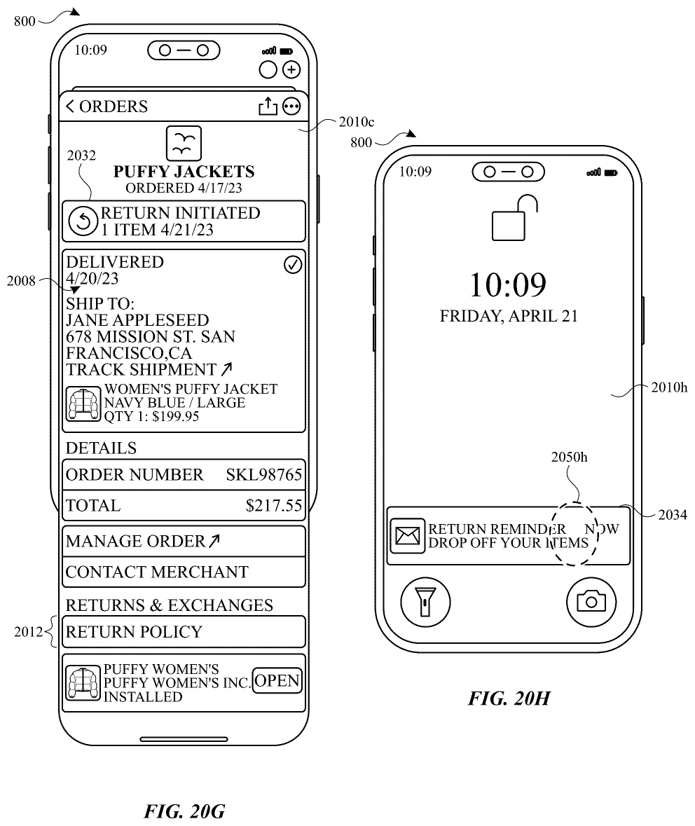

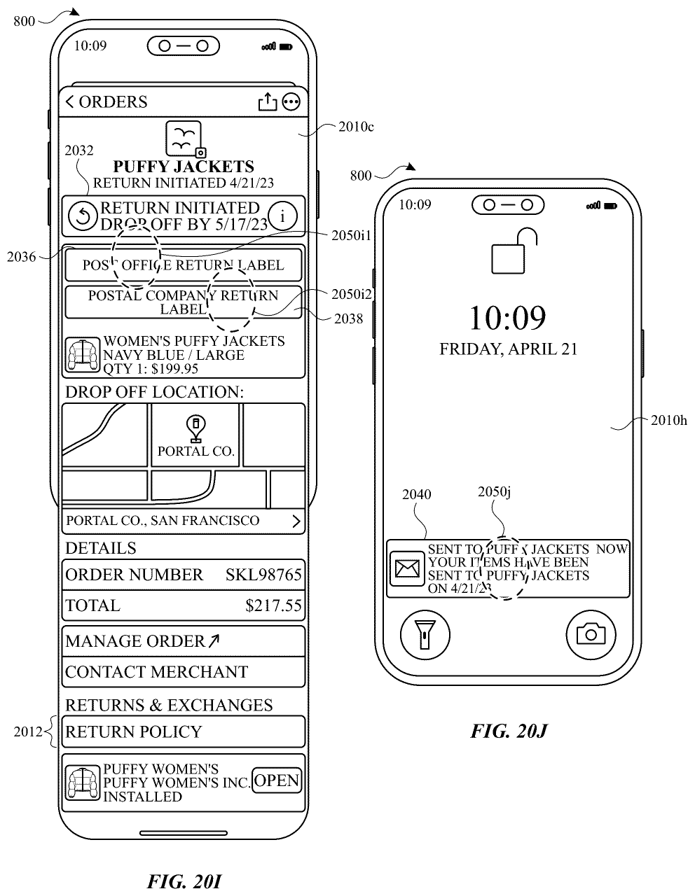

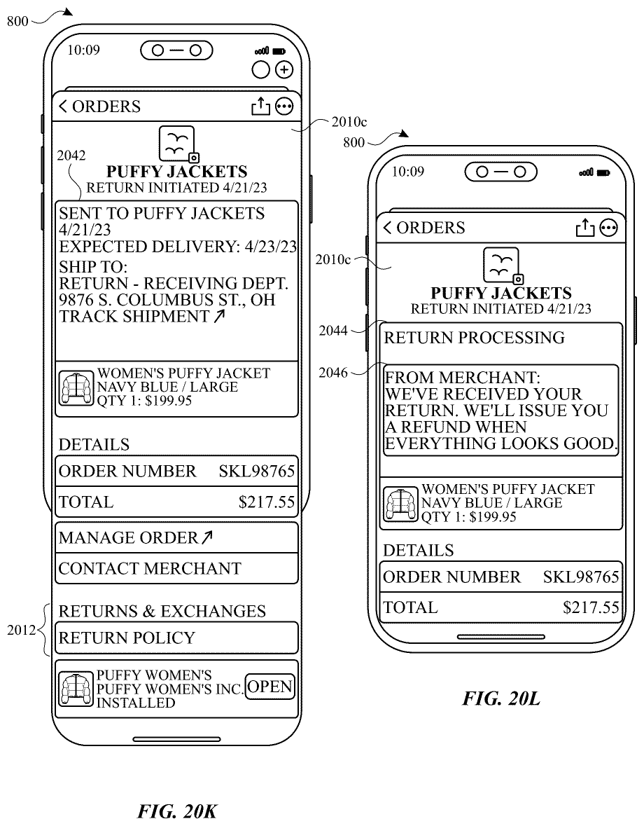

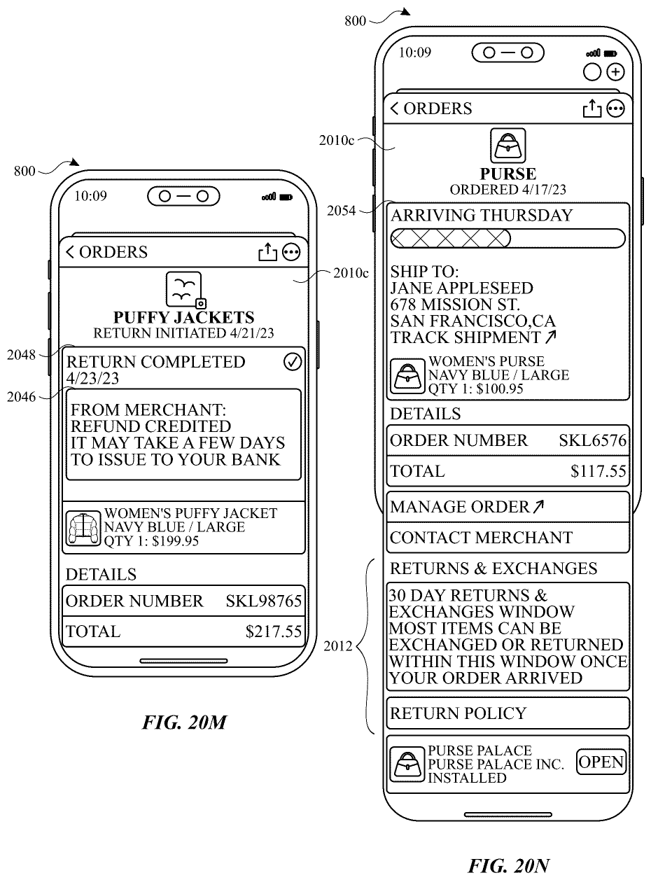

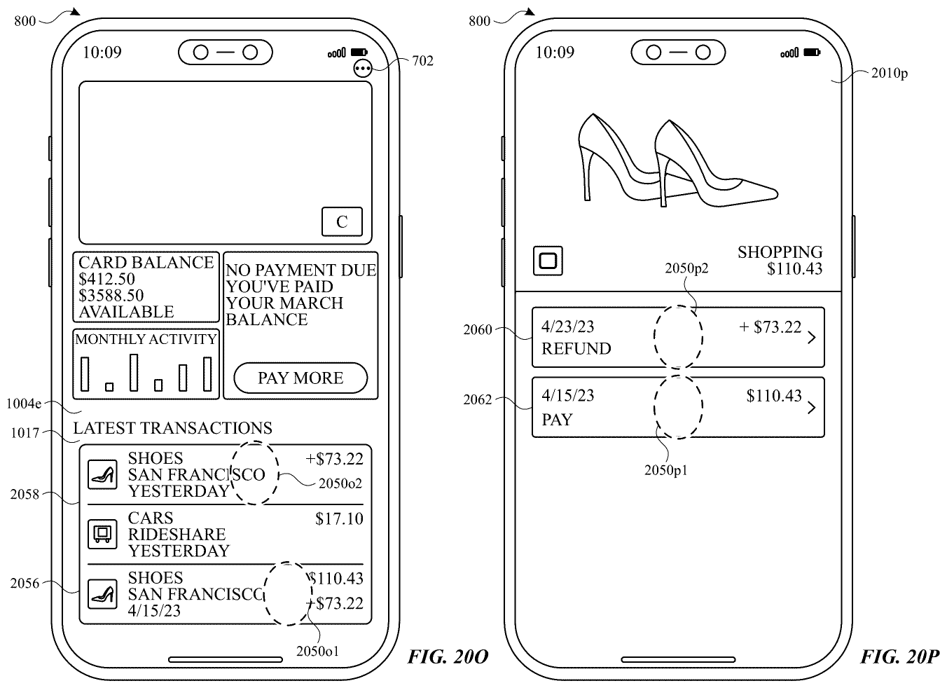

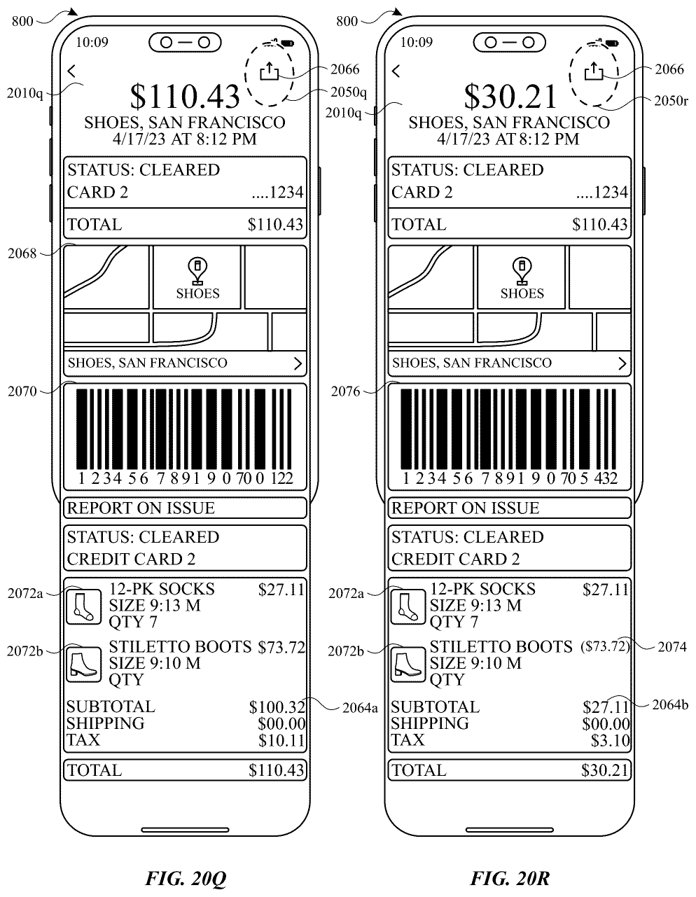

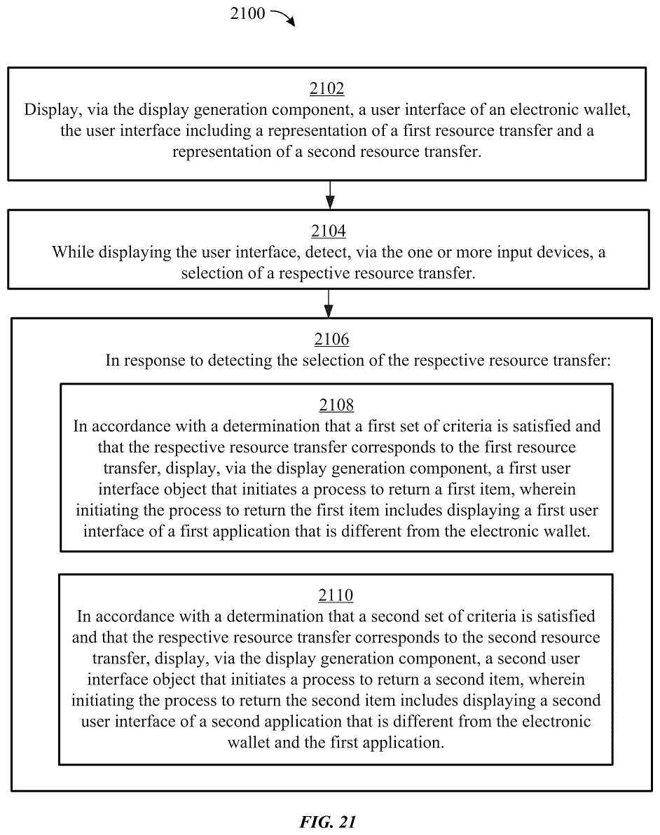

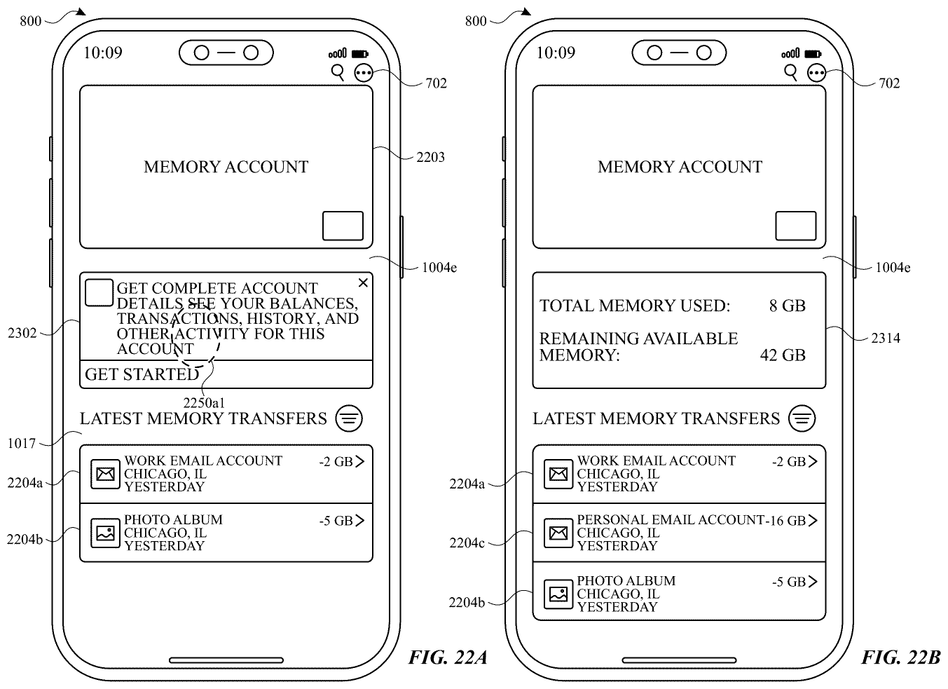

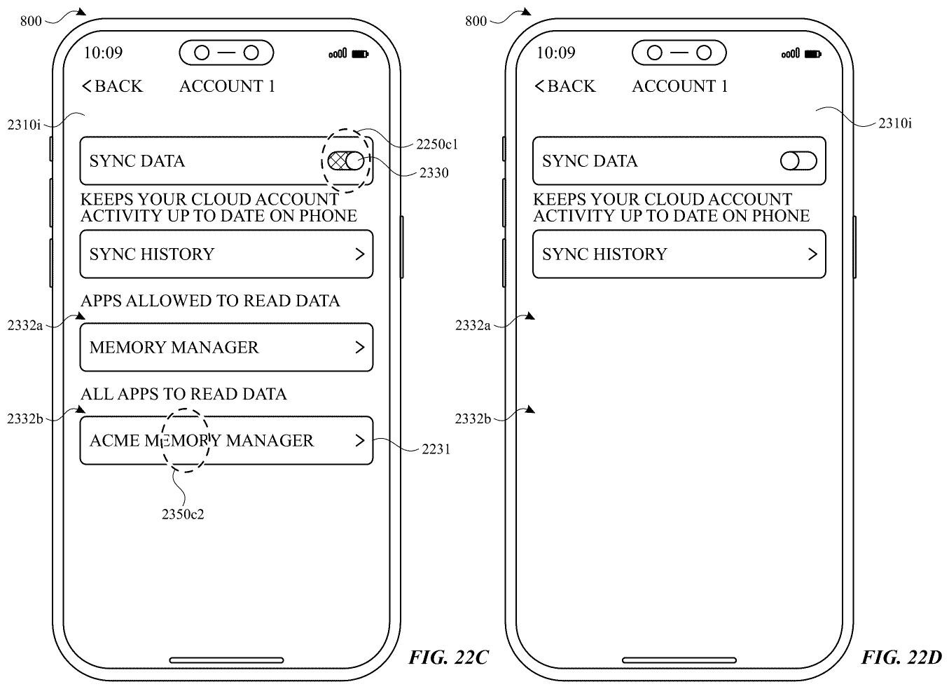

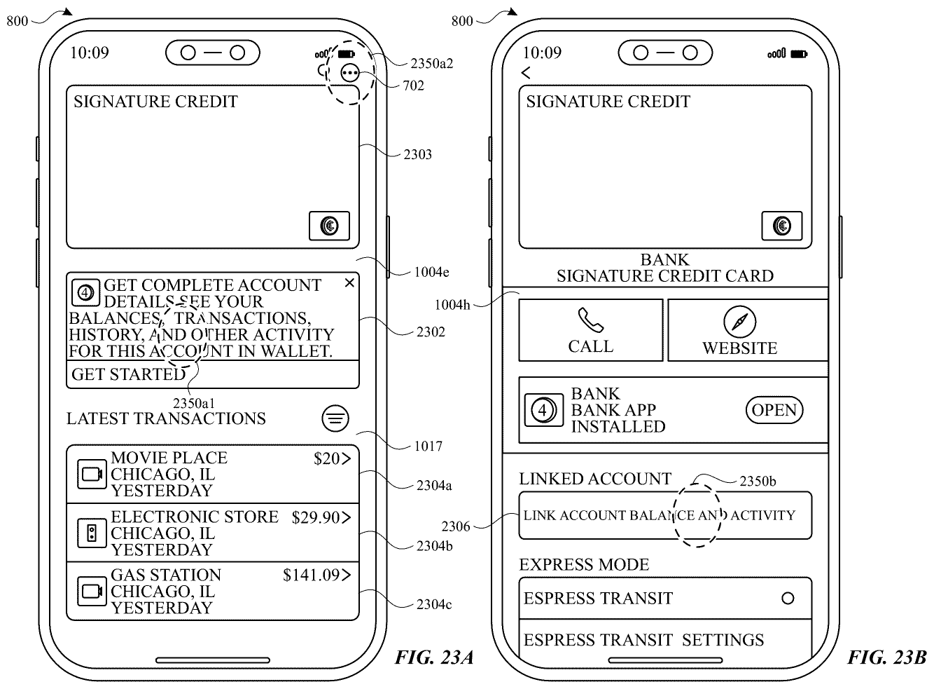

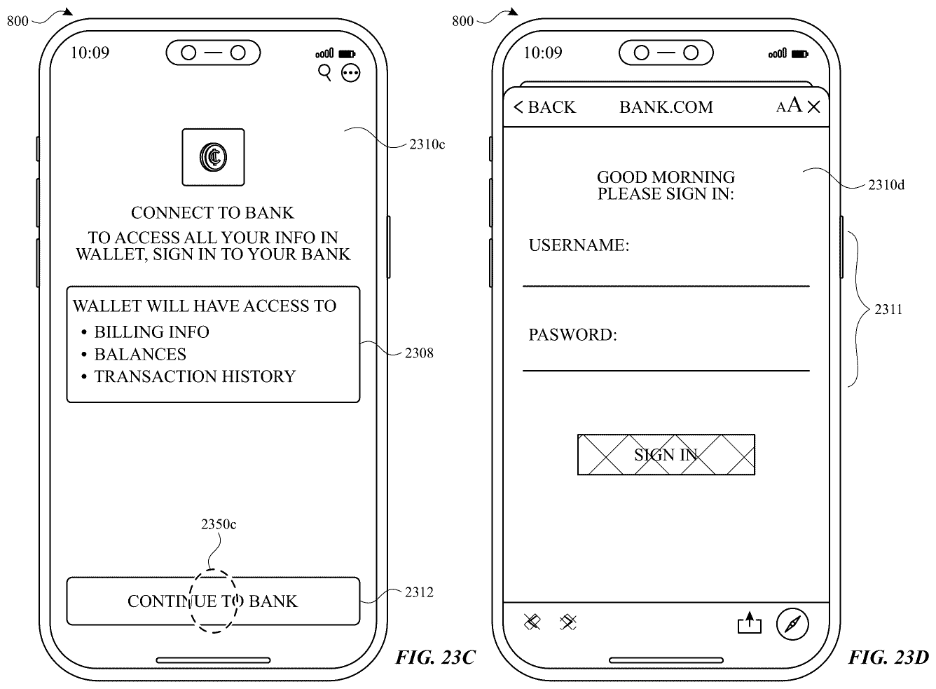

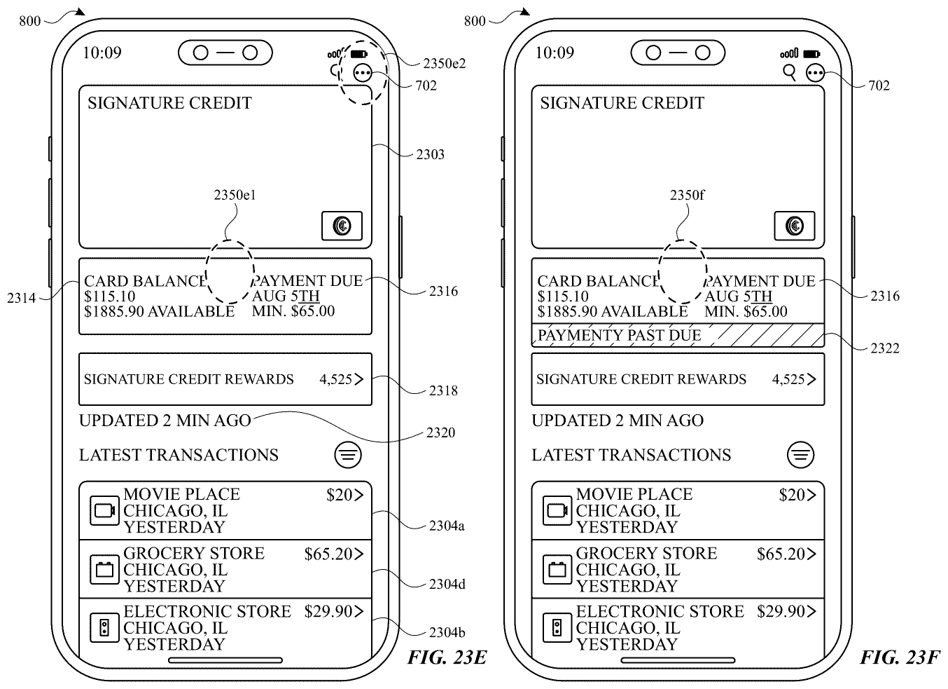

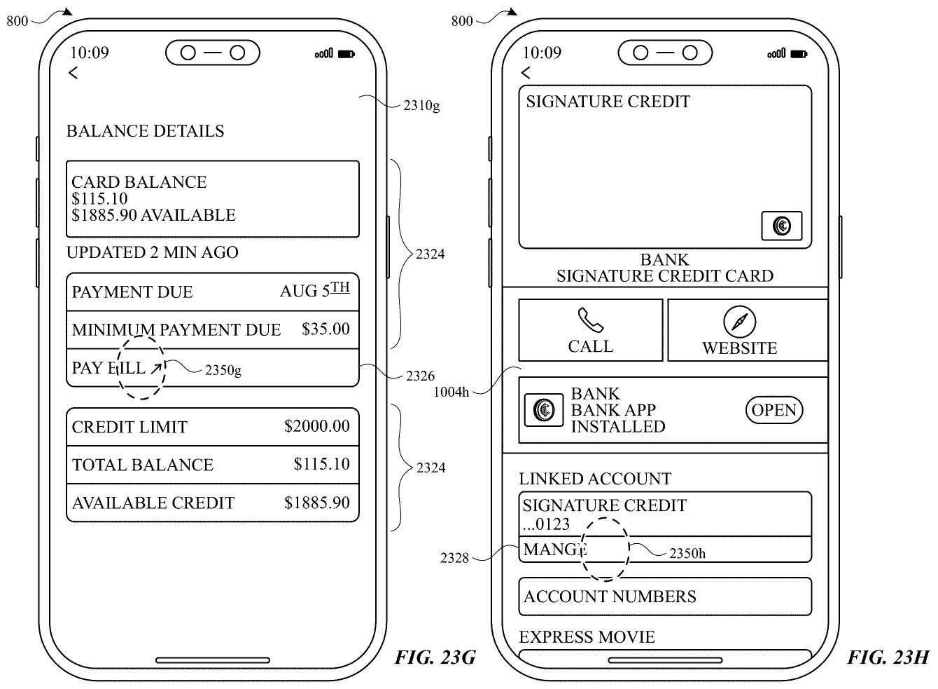

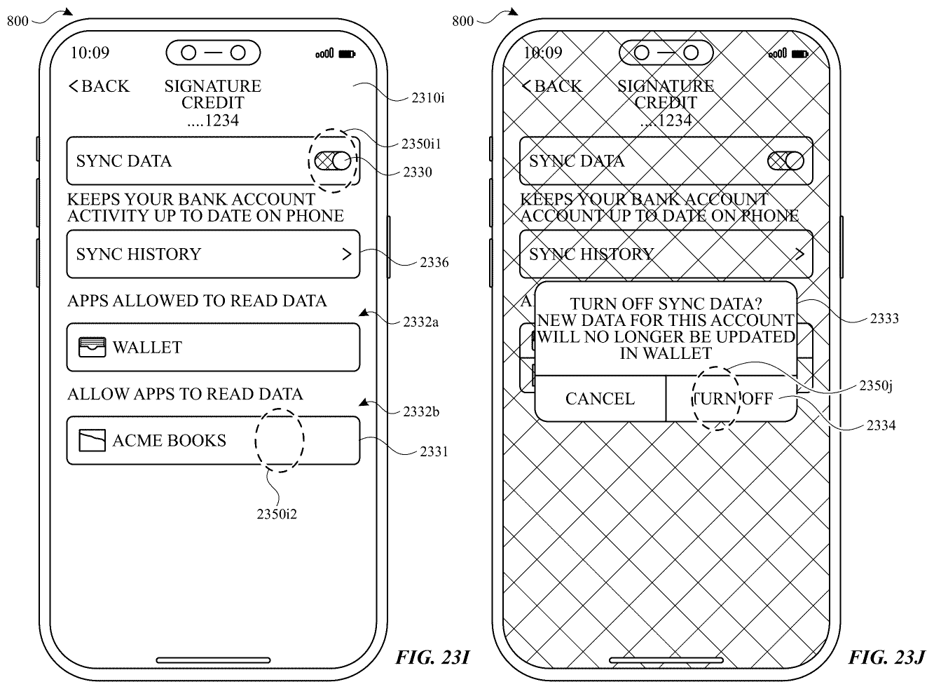

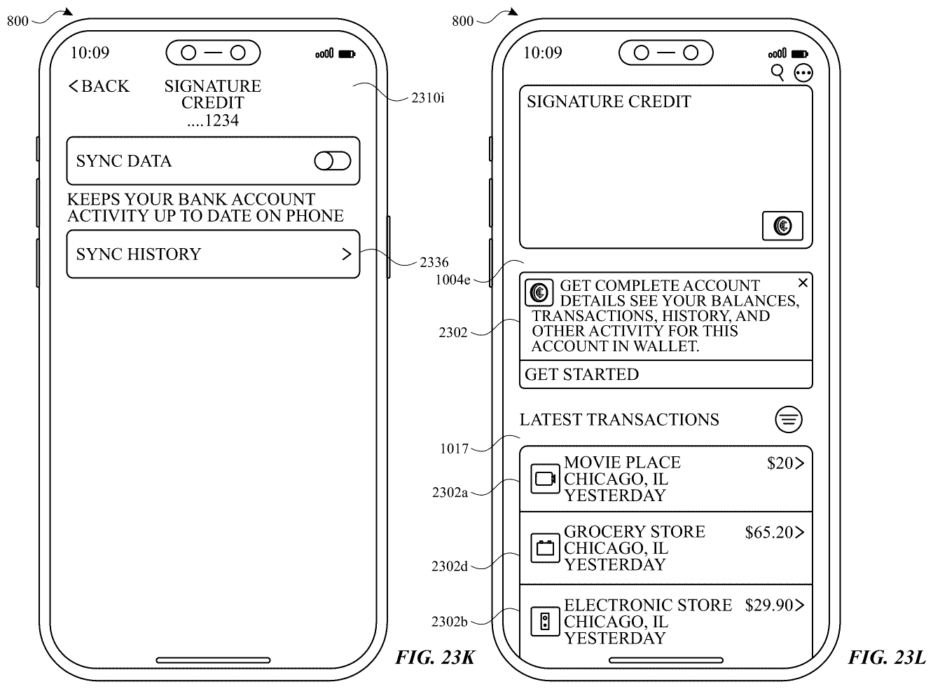

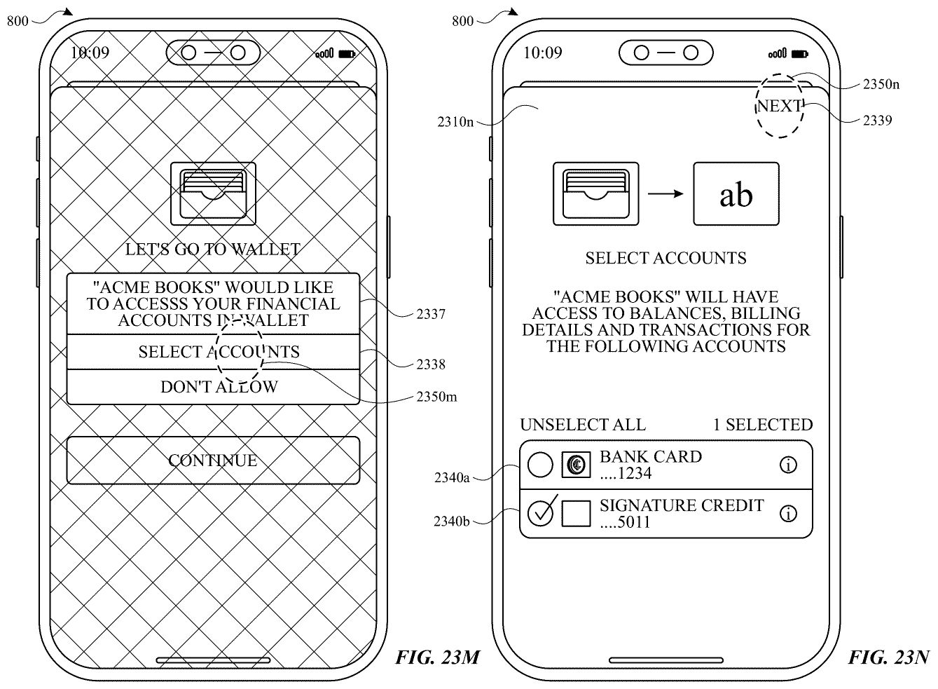

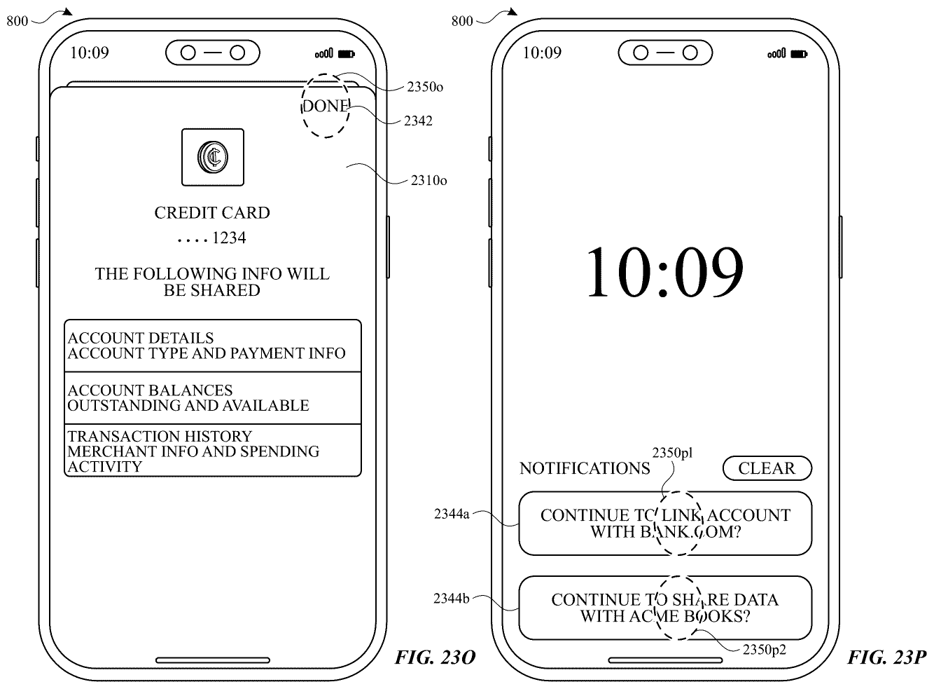

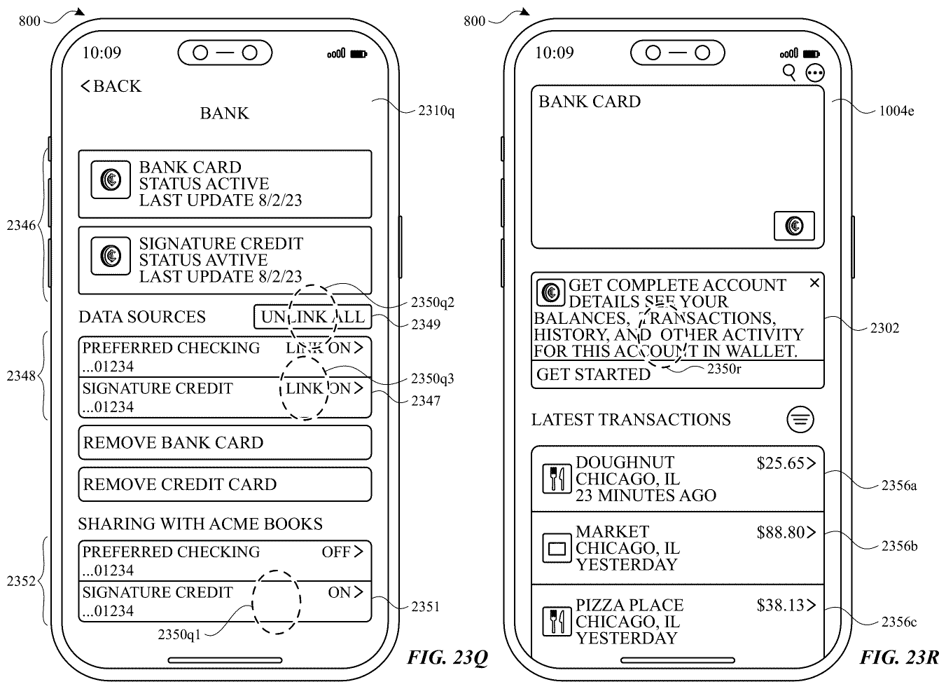

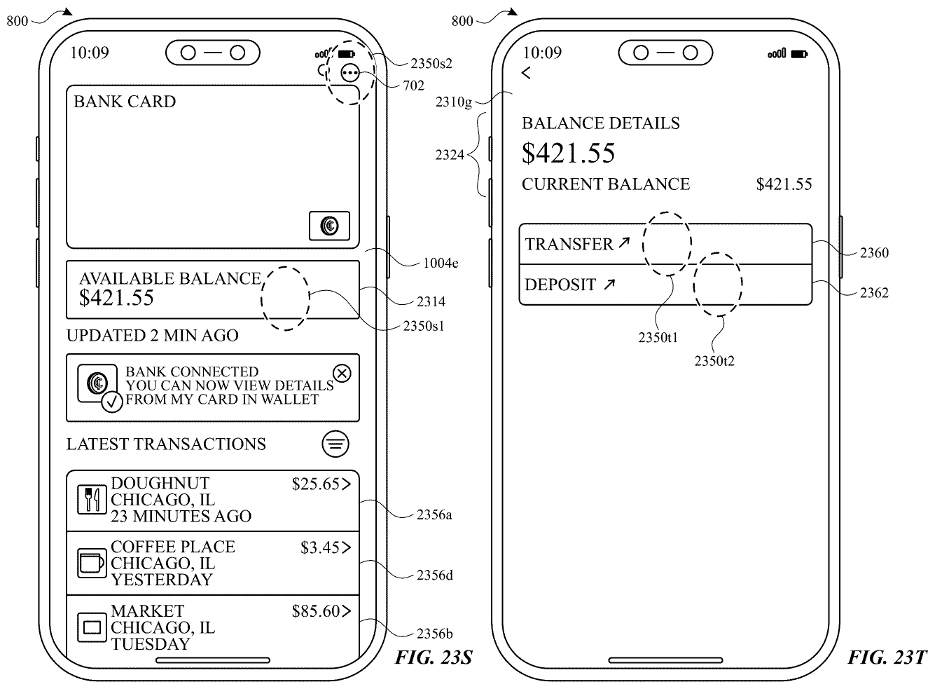

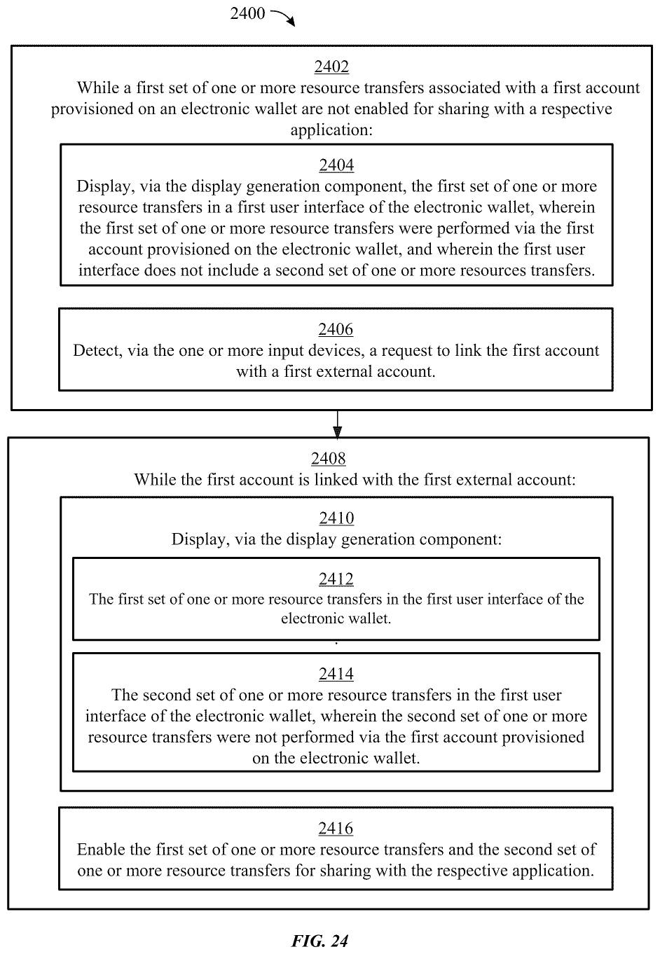

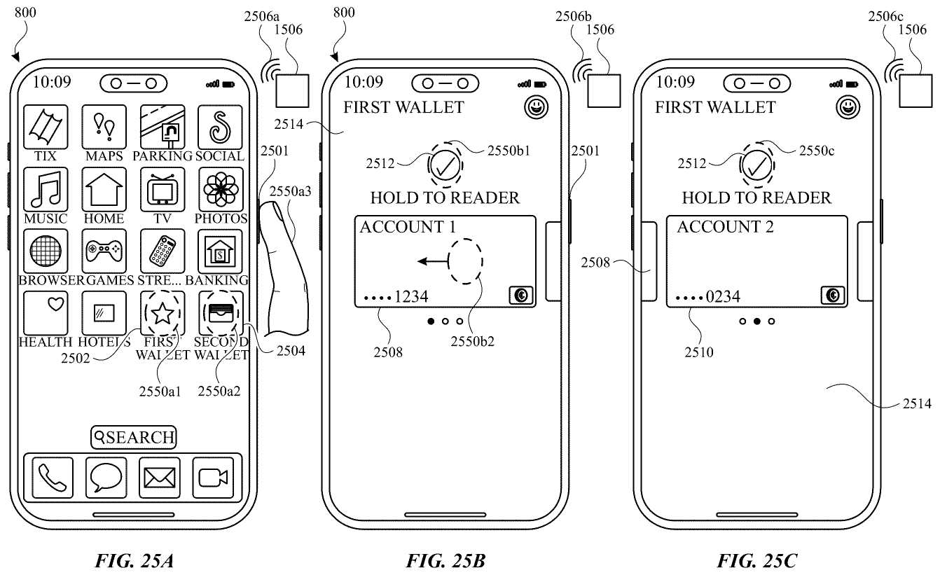

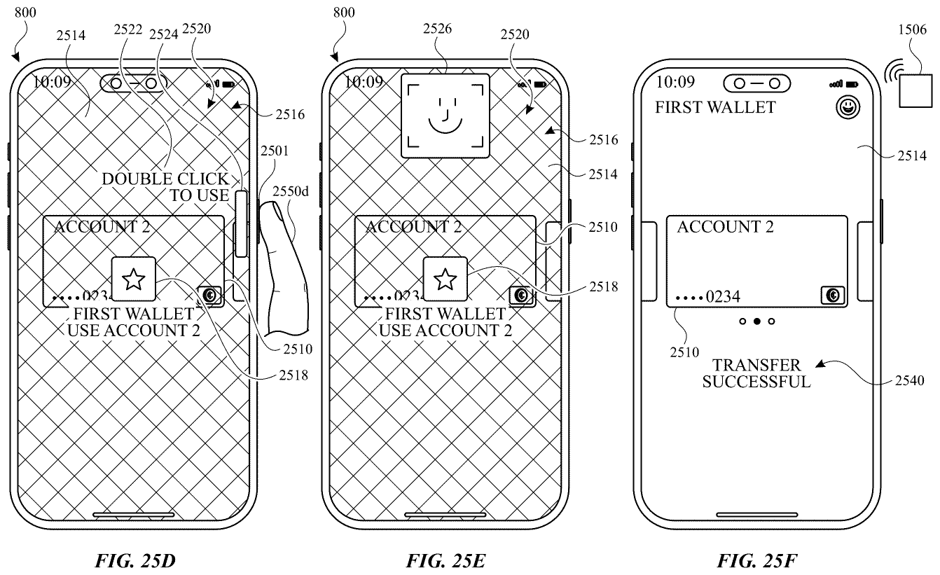

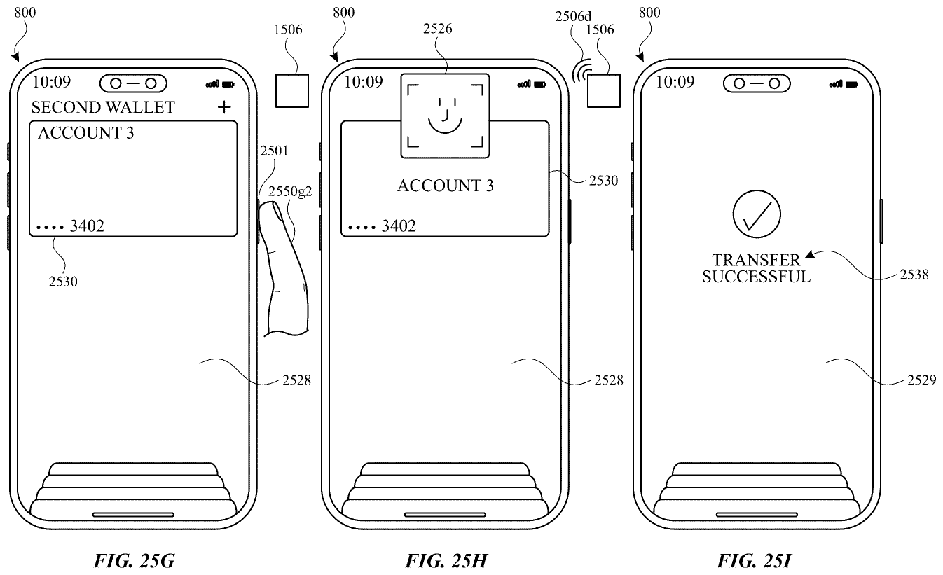

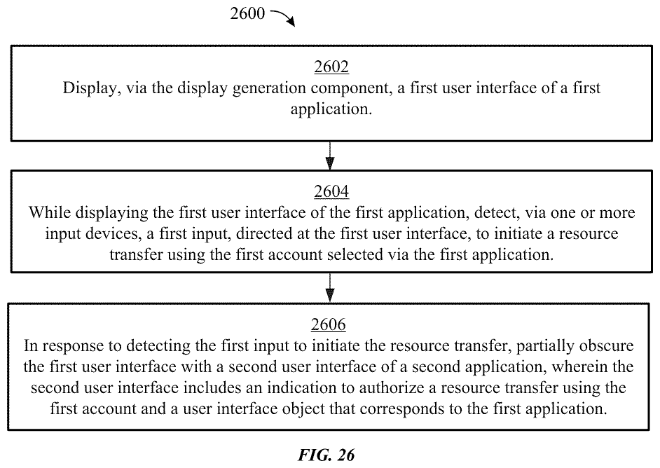

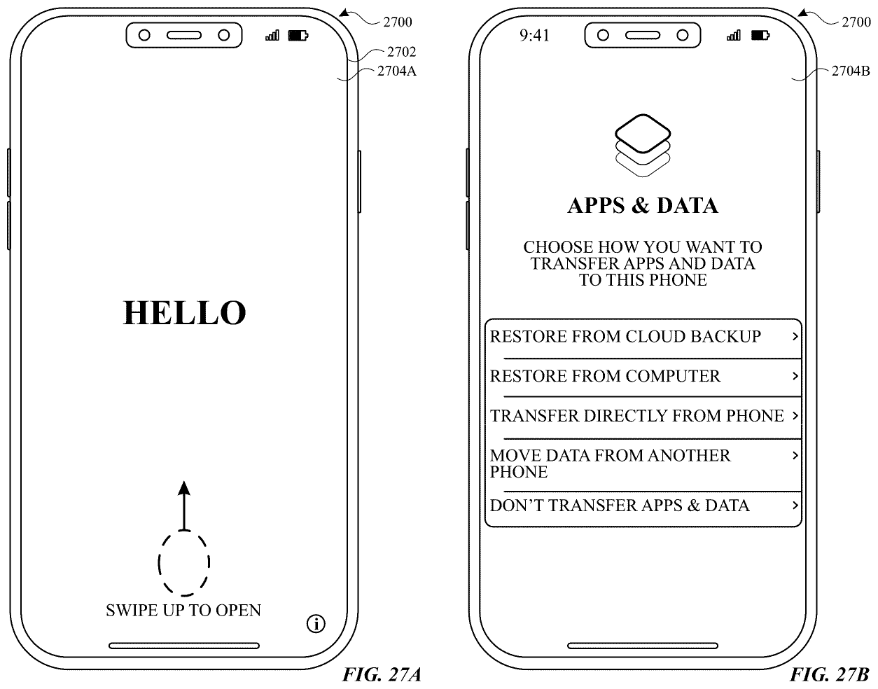

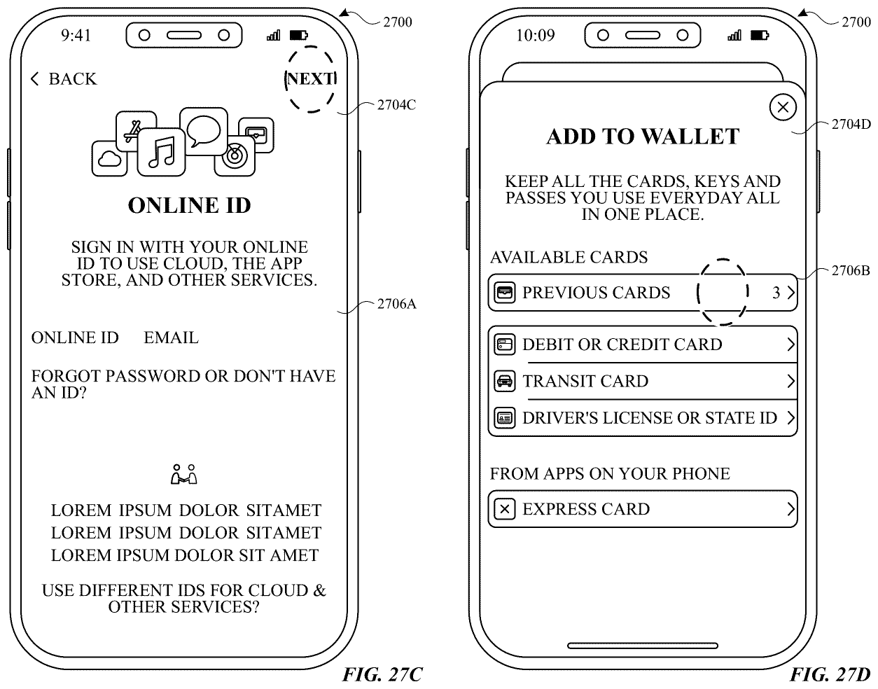

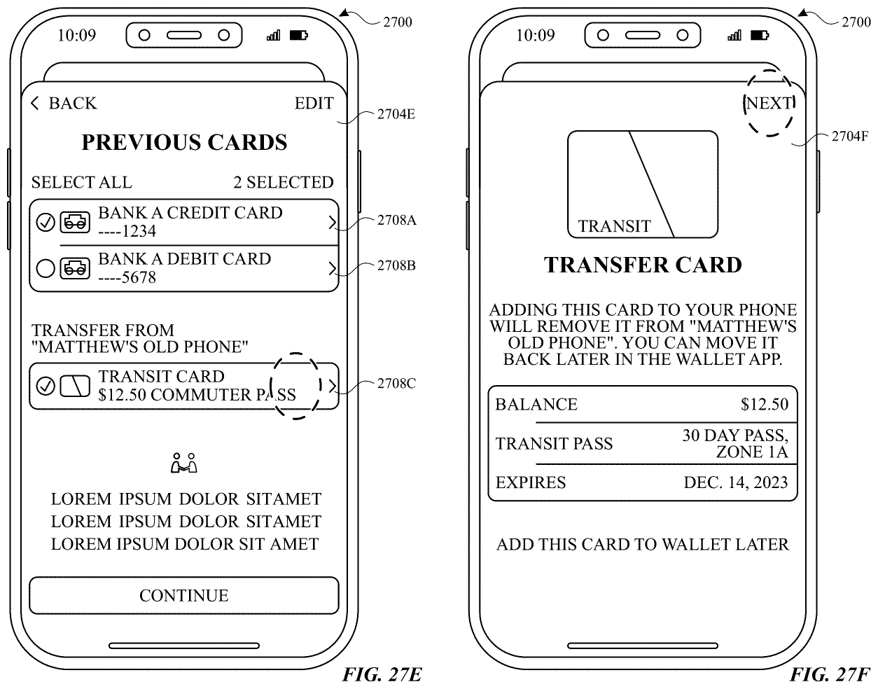

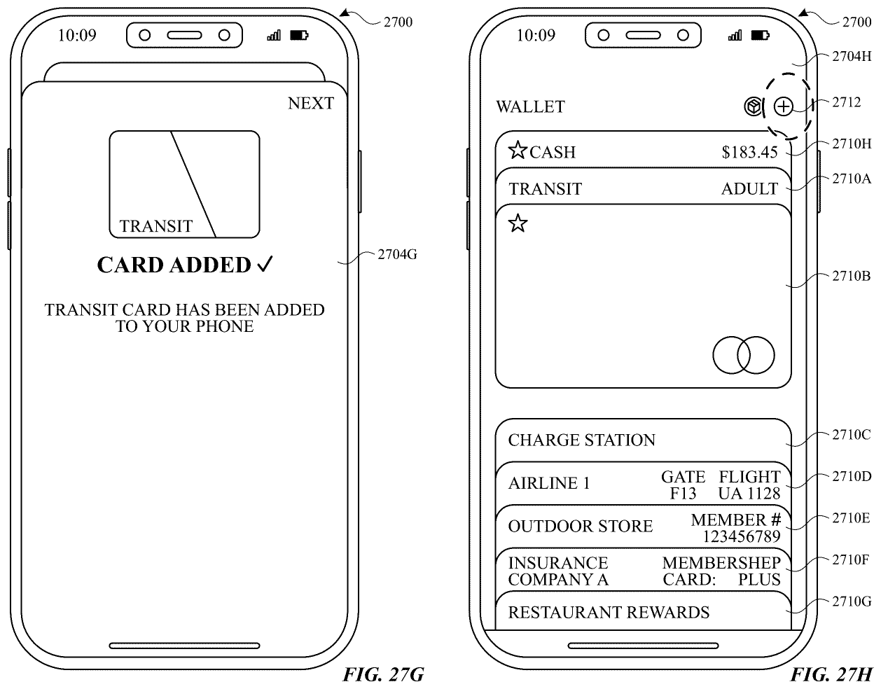

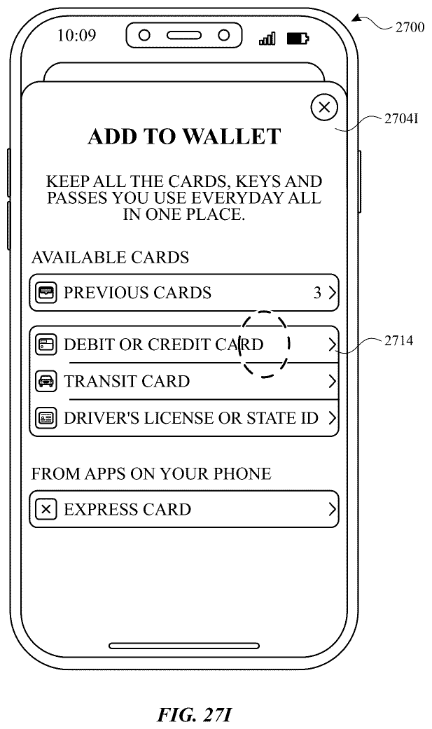

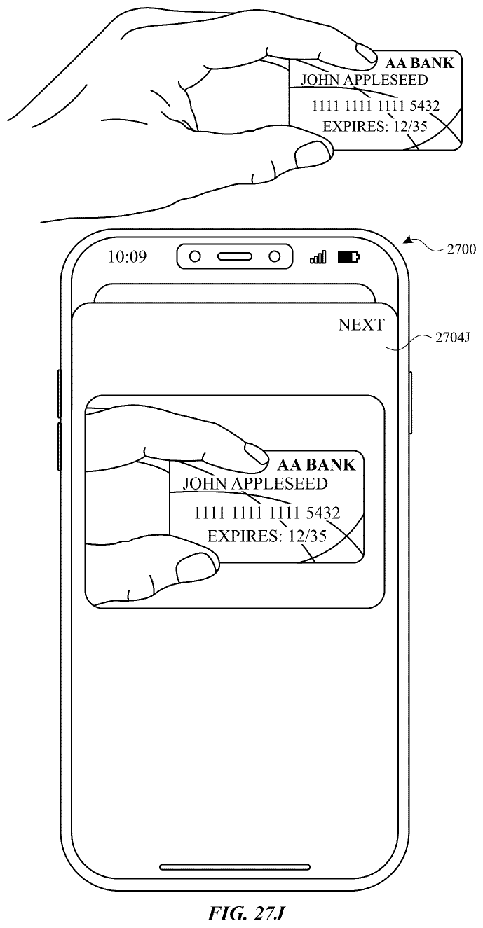

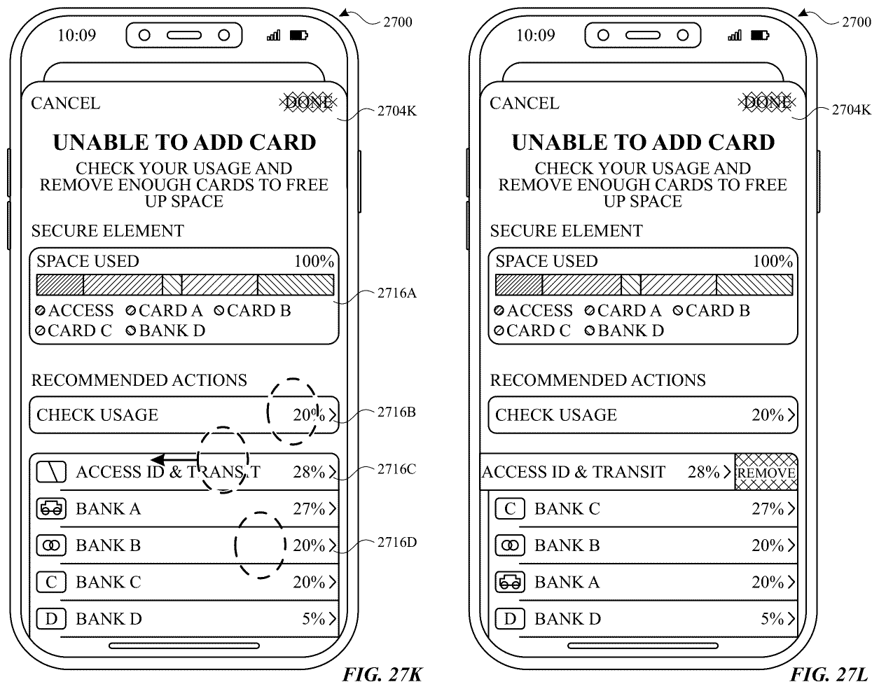

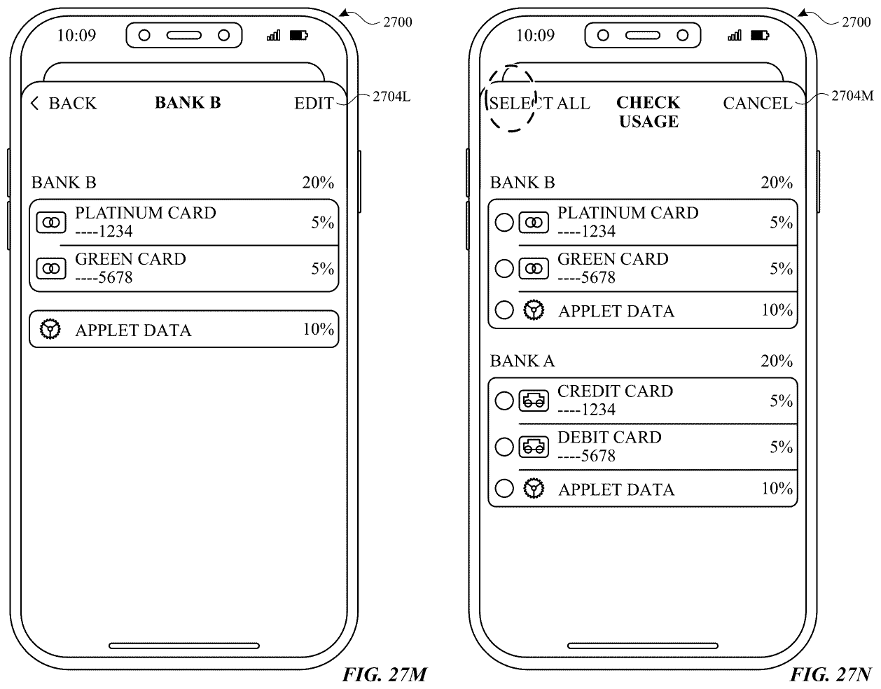

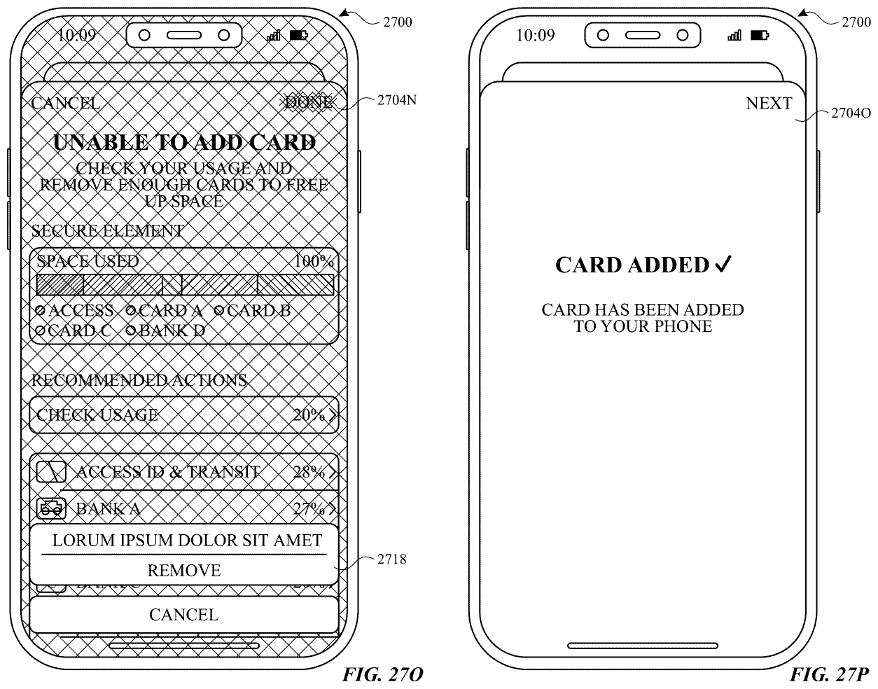

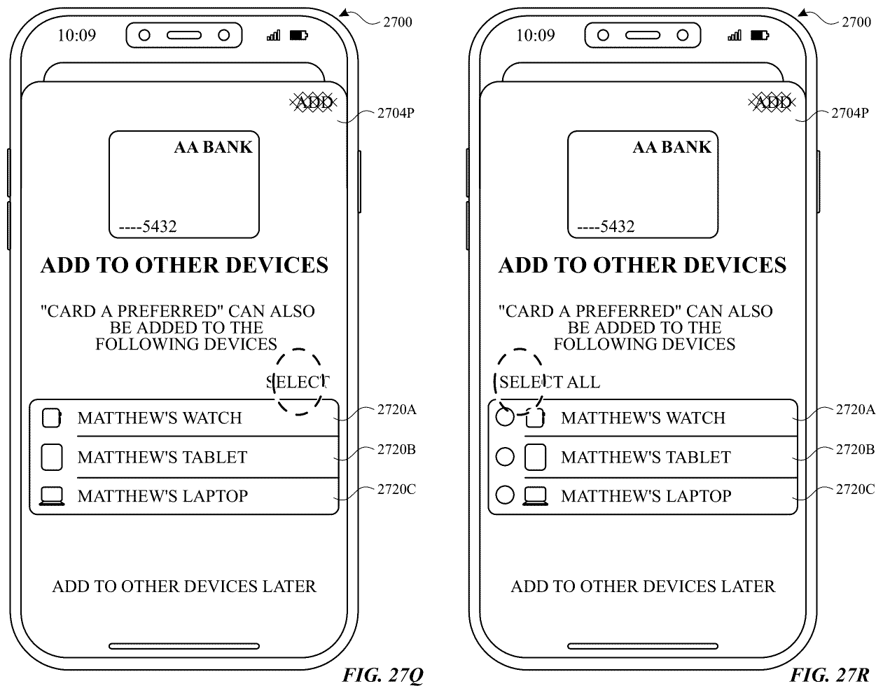

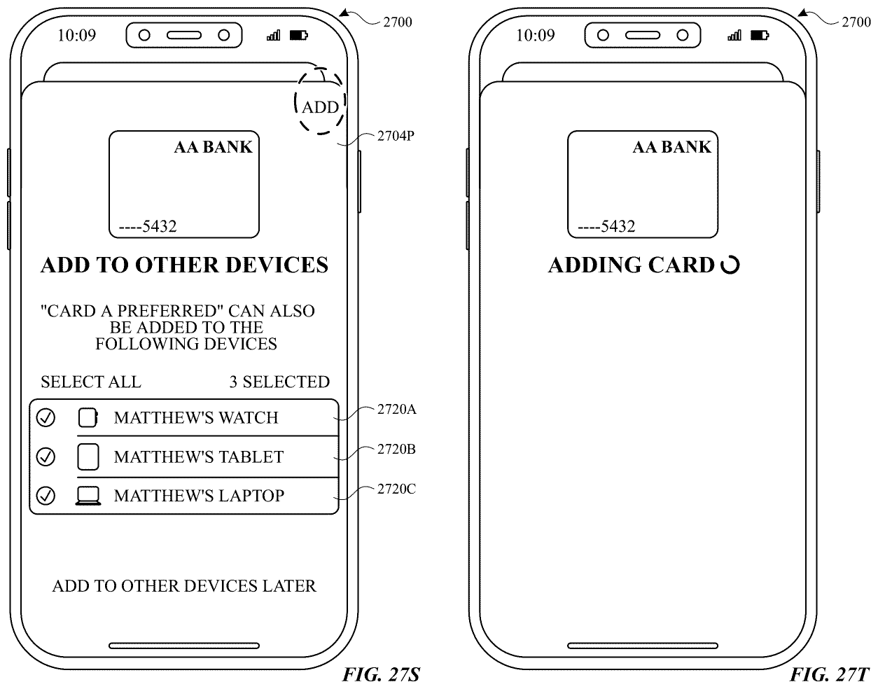

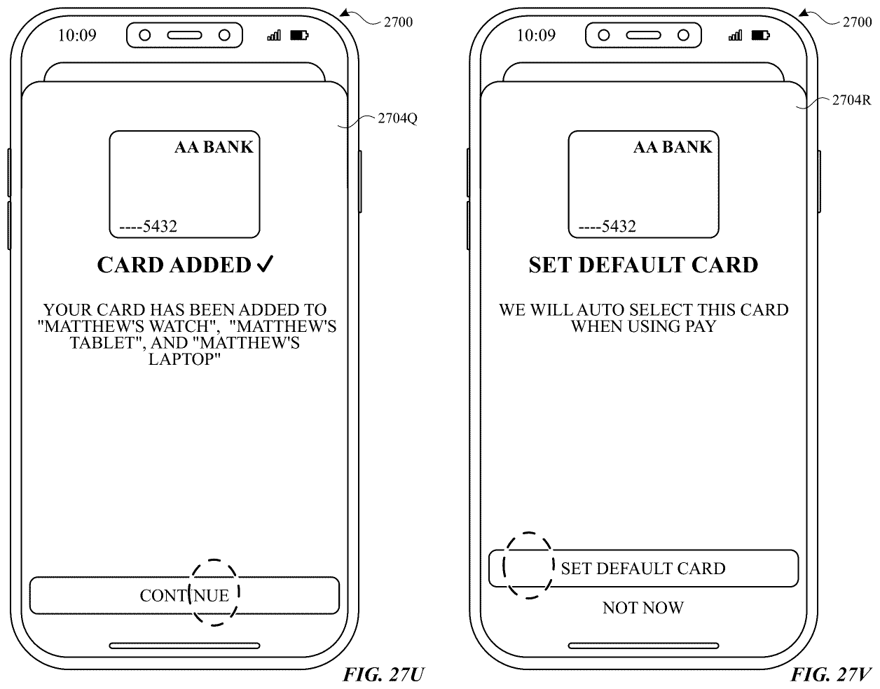

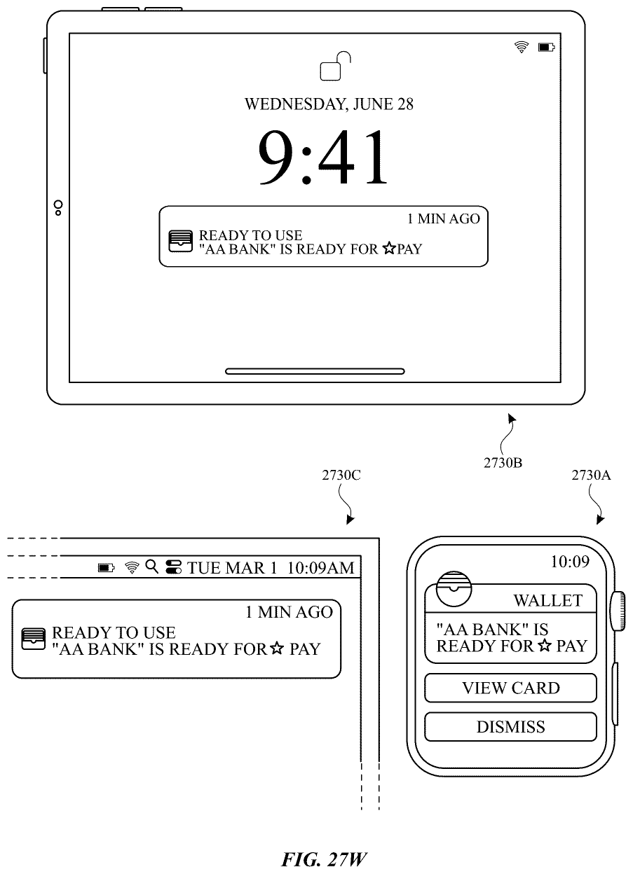

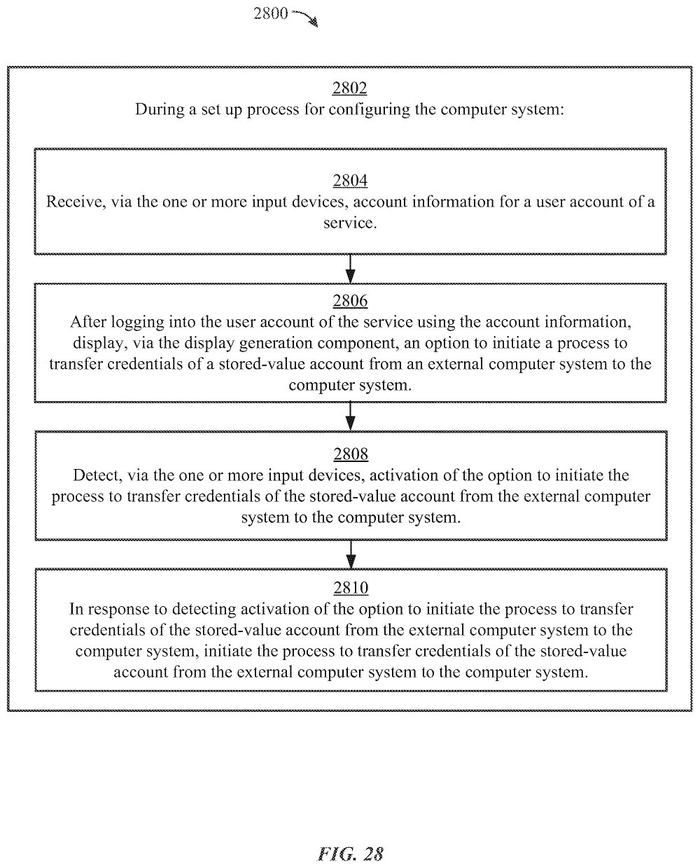

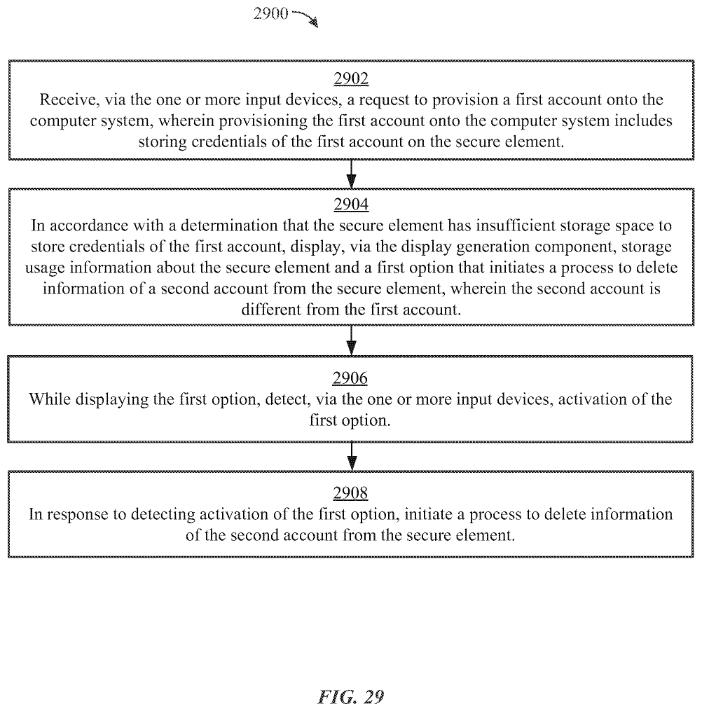

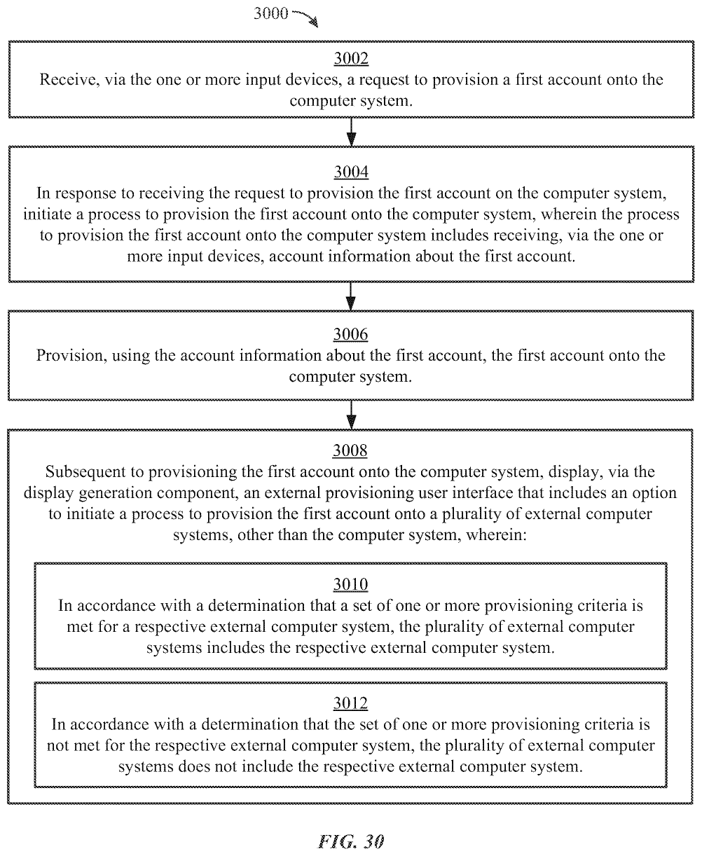

Below, FIGS. 1A-1B, 2, 3, 4A-4B, and 5A-5C devices for performing the techniques for displaying resource transfer user interfaces. FIGS. 6A-6D illustrate exemplary user interfaces for controlling display of updates to memory transfer messages, in accordance with some embodiments. FIGS. 7A-7R illustrate exemplary user interfaces for displaying updates to fund transfer messages, in accordance with some embodiments. FIG. 8 is a flow diagram illustrating a method for displaying a resource transfer message in a communication application, in accordance with some embodiments. The user interfaces in FIGS. 6A-6D and FIGS. 7A-7R are used to illustrate the processes described below, including the processes in FIG. 8. FIGS. 9A-9J illustrate exemplary user interfaces for setting up different types of resource transfer accounts for computer memory, in accordance with some embodiments. FIGS. 10A-10Q illustrate exemplary user interfaces for setting up different types of resource transfer accounts for funds, in accordance with some embodiments. FIGS. 11A-11B are flow diagrams illustrating a method for setting up different types of resource transfer accounts, in accordance with some embodiments. The user interfaces in FIGS. 9A-9J and FIGS. 10A-10Q are used to illustrate the processes described below, including the processes in FIGS. 11A-11B. FIGS. 12A-12D illustrate exemplary user interfaces for different applications authorizing auto-reload transfers for allocation of computer memory, in accordance with some embodiments. FIGS. 13A-13J illustrate exemplary user interfaces for different applications authorizing auto-reload transfers for funds, in accordance with some embodiments. FIG. 14 is a flow diagram illustrating a method for different applications authorizing auto-reload resource transfers, in accordance with some embodiments. The user interfaces in FIGS. 12A-12D and FIGS. 13A-13J are used to illustrate the processes described below, including the processes in FIG. 14. FIGS. 15A-15I illustrate exemplary user interfaces for controlling the display of an account options affordance, in accordance with some embodiments. FIG. 16 is a flow diagram illustrating a method for controlling the display of an account options affordance, in accordance with some embodiments. The user interfaces in FIGS. 15A-15I are used to illustrate the processes described below, including the processes in FIG. 16. FIGS. 17A-17K illustrate exemplary user interfaces for controlling the display of dynamic account information, in accordance with some embodiments. FIG. 18 is a flow diagram illustrating a method for controlling display of dynamic account information, in accordance with some embodiments. The user interfaces in FIGS. 17A-17K are used to illustrate the processes described below, including the processes in FIG. 18. FIGS. 19A-19E illustrate exemplary user interfaces for initiating a return of computer memory via different applications, in accordance with some embodiments. FIGS. 20A-20R illustrate exemplary user interfaces for initiating a return of a physical item via different applications, in accordance with some embodiments. FIG. 21 is a flow diagram illustrating a method for initiating a return via different applications, in accordance with some embodiments. The user interfaces in FIGS. 19A-19E and 20A-20R are used to illustrate the processes described below, including the processes in FIG. 21. FIGS. 22A-22D illustrate exemplary user interfaces for linking a computer transfer account with an external account, in accordance with some embodiments. FIGS. 23A-23T illustrate exemplary user interfaces for linking a payment transfer account with an external account, in accordance with some embodiments. FIG. 24 is a flow diagram illustrating a method for linking a resource account with an external account, in accordance with some embodiments. The user interfaces in FIGS. 22A-22D and 23A-23T are used to illustrate the processes described below, including the processes in FIG. 24. FIGS. 25A-25I illustrate exemplary user interfaces for releasing secured information, in accordance with some embodiments. FIG. 26 is a flow diagram illustrating a method for releasing secured information, in accordance with some embodiments. The user interfaces in FIGS. 25A-25I are used to illustrate the processes described below, including the processes in FIG. 26. FIGS. 27A-27W illustrate exemplary user interfaces for provisioning accounts onto computer systems, in accordance with some embodiments. FIG. 28 is a flow diagram illustrating a method for provisioning an account onto a computer system in accordance with some embodiments. FIG. 29 is a flow diagram illustrating a method for provisioning an account onto a computer system in accordance with some embodiments. FIG. 30 is a flow diagram illustrating a method for provisioning an account onto a computer system in accordance with some embodiments. The user interfaces in FIGS. 27A-27W are used to illustrate the processes described below, including the processes in FIGS. 28-30.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, streamlining how user interfaces of different applications interact, providing a state of a resource account and/or resource transfer, controlling how user interfaces are displayed during a set up process of a resource account, providing user interface features that improve how resources are transferred between different devices, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

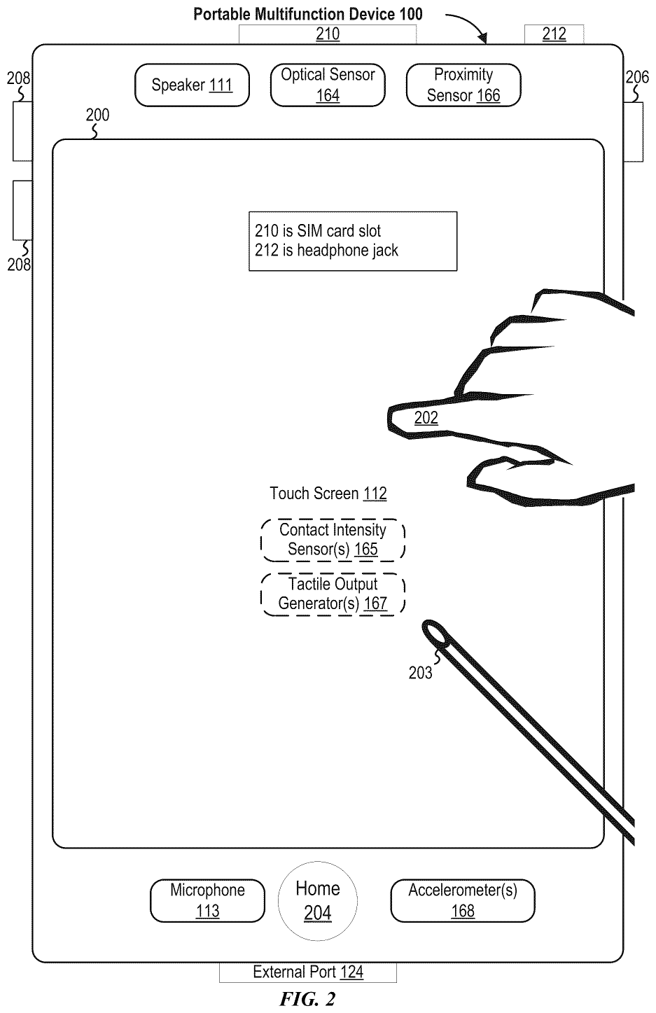

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

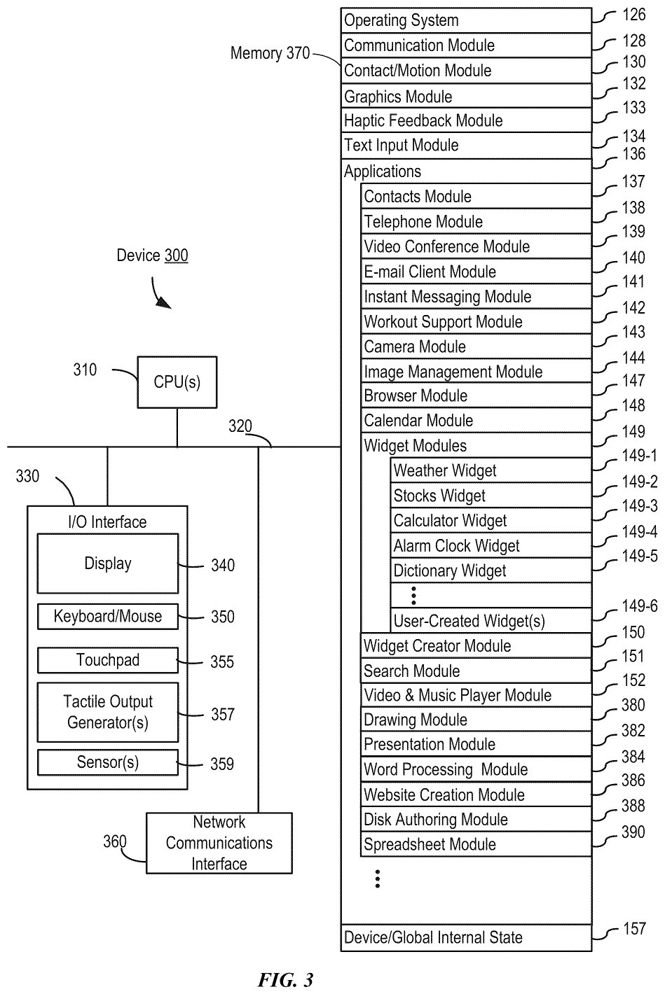

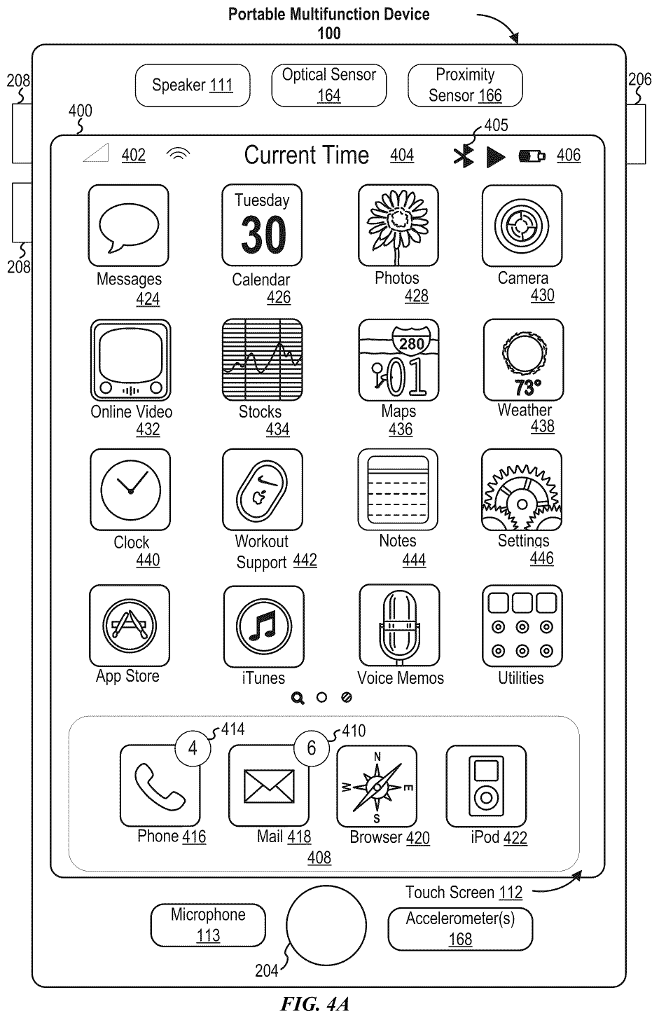

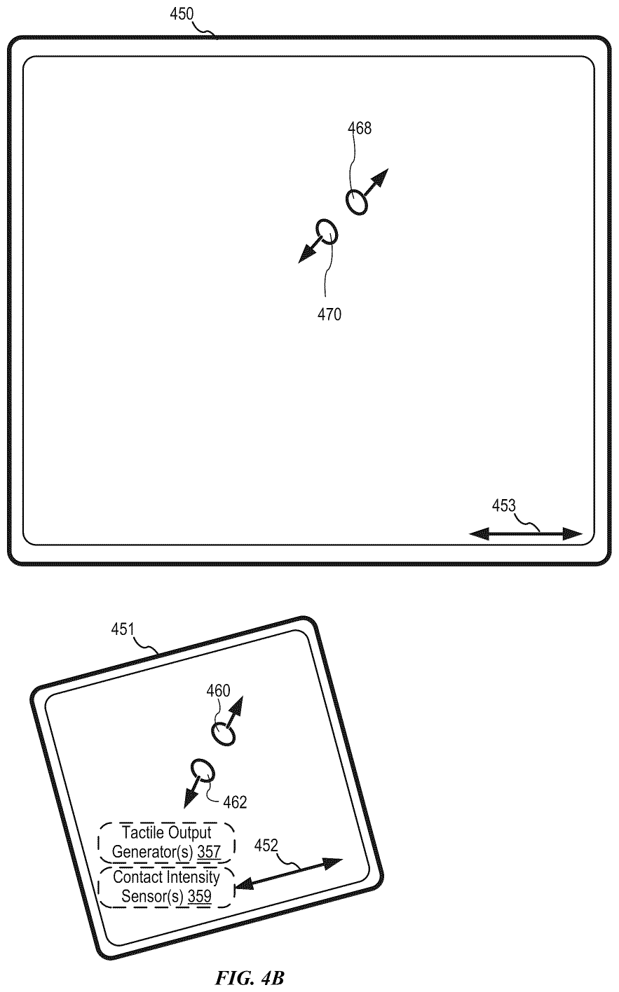

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

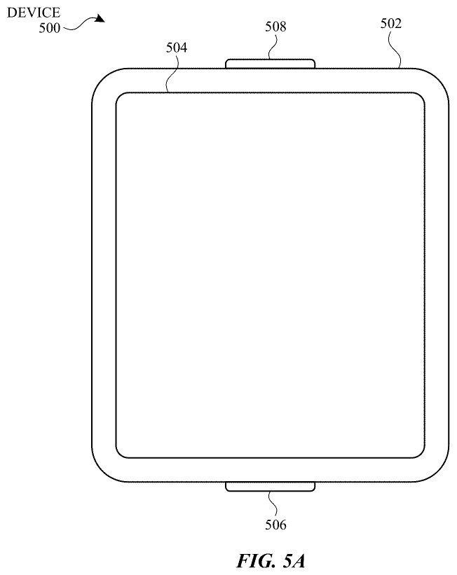

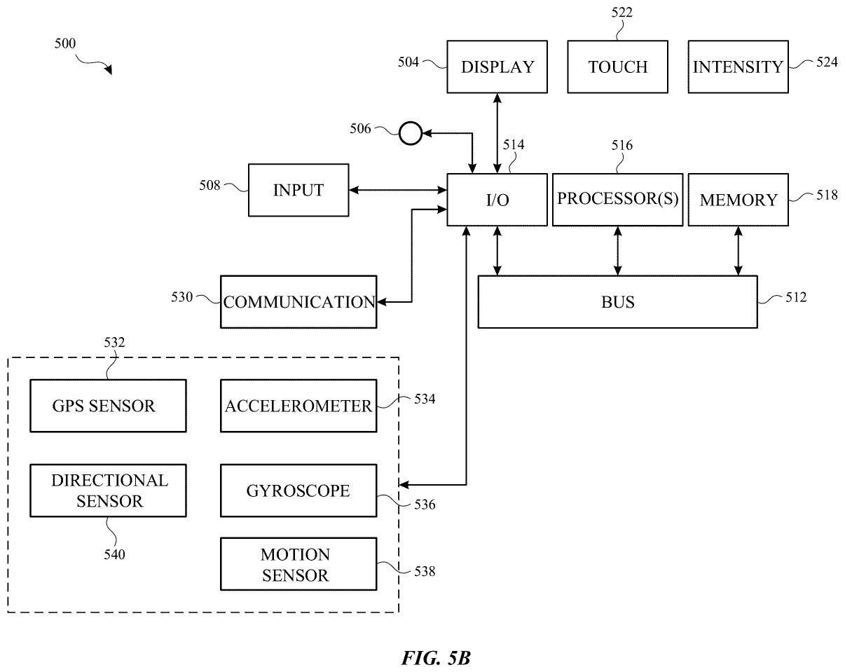

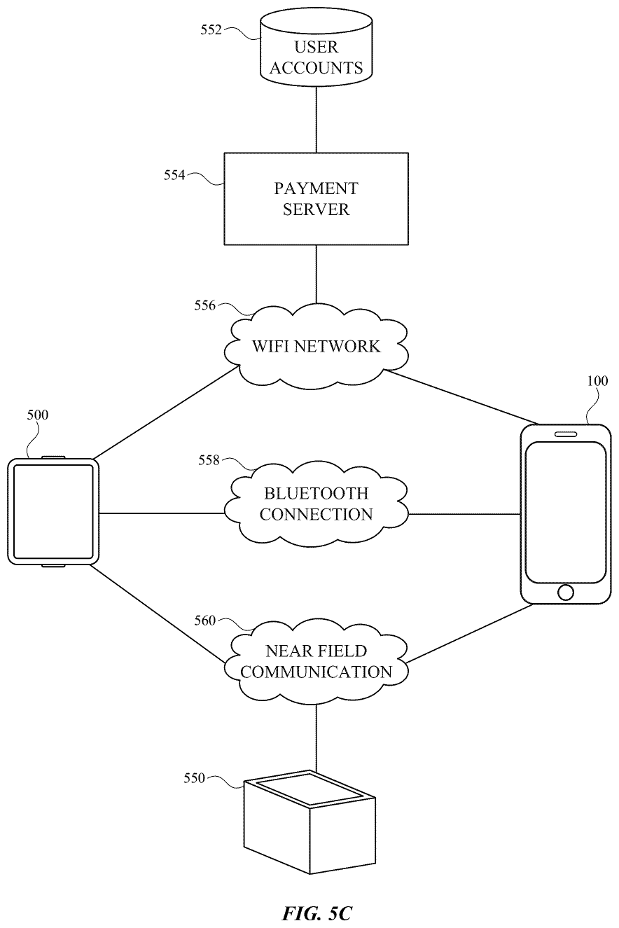

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 800, 1100, 1400, 1600, 1800, 2100, 2400, and 2600 (FIGS. 8, 11A-11B, 14, 16, 18, 21, 24, and 26). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates exemplary devices connected via one or more communication channels to participate in a transaction in accordance with some embodiments. One or more exemplary electronic devices (e.g., devices 100, 300, and 500) are configured to optionally detect input (e.g., a particular user input, an NFC field) and optionally transmit payment information (e.g., using NFC). The one or more electronic devices optionally include NFC hardware and are configured to be NFC-enabled.

The electronic devices (e.g., devices 100, 300, and 500) are optionally configured to store payment account information associated with each of one or more payment accounts. Payment account information includes, for example, one or more of: a person's or company's name, a billing address, a login, a password, an account number, an expiration date, a security code, a telephone number, a bank associated with the payment account (e.g., an issuing bank), and a card network identifier. In some embodiments, payment account information includes include an image, such as a picture of a payment card (e.g., taken by the device and/or received at the device). In some embodiments, the electronic devices receive user input including at least some payment account information (e.g., receiving user-entered credit, debit, account, or gift card number and expiration date). In some embodiments, the electronic devices detect at least some payment account information from an image (e.g., of a payment card captured by a camera sensor of the device). In some embodiments, the electronic devices receive at least some payment account information from another device (e.g., another user device or a server). In some embodiments, the electronic device receives payment account information from a server associated with another service for which an account for a user or user device previously made a purchase or identified payment account data (e.g., an app for renting or selling audio and/or video files).

In some embodiments, a payment account is added to an electronic device (e.g., device 100, 300, and 500), such that payment account information is securely stored on the electronic device. In some embodiments, after a user initiates such process, the electronic device transmits information for the payment account to a transaction-coordination server, which then communicates with a server operated by a payment network for the account (e.g., a payment server) to ensure a validity of the information. The electronic device is optionally configured to receive a script from the server that allows the electronic device to program payment information for the account onto the secure element.

In some embodiments, communication among electronic devices 100, 300, and 500 facilitates transactions (e.g., generally or specific transactions). For example, a first electronic device (e.g., 100) can serve as a provisioning or managing device, and can send notifications of new or updated payment account data (e.g., information for a new account, updated information for an existing account, and/or an alert pertaining to an existing account) to a second electronic device (e.g., 500). In another example, a first electronic device (e.g., 100) can send data to a second election device, wherein the data reflects information about payment transactions facilitated at the first electronic device. The information optionally includes one or more of: a payment amount, an account used, a time of purchase, and whether a default account was changed. The second device (e.g., 500) optionally uses such information to update a default payment account (e.g., based on a learning algorithm or explicit user input).

Electronic devices (e.g., 100, 300, 500) are configured to communicate with each other over any of a variety of networks. For example, the devices communicate using a Bluetooth connection 558 (e.g., which includes a traditional Bluetooth connection or a Bluetooth Low Energy connection) or using a WiFi network 556. Communications among user devices are, optionally, conditioned to reduce the possibility of inappropriately sharing information across devices. For example, communications relating to payment information requires that the communicating devices be paired (e.g., be associated with each other via an explicit user interaction) or be associated with a same user account.

In some embodiments, an electronic device (e.g., 100, 300, 500) is used to communicate with a point-of-sale (POS) payment terminal 550, which is optionally NFC-enabled. The communication optionally occurs using a variety of communication channels and/or technologies. In some embodiments, electronic device (e.g., 100, 300, 500) communicates with payment terminal 550 using an NFC channel 560. In some embodiments, payment terminal 550 communicates with an electronic device (e.g., 100, 300, 500) using a peer-to-peer NFC mode. Electronic device (e.g., 100, 300, 500) is optionally configured transmit a signal to payment terminal 550 that includes payment information for a payment account (e.g., a default account or an account selected for the particular transaction).

In some embodiments, proceeding with a transaction includes transmitting a signal that includes payment information for an account, such as a payment account. In some embodiments, proceeding with the transaction includes reconfiguring the electronic device (e.g., 100, 300, 500) to respond as a contactless payment card, such as an NFC-enabled contactless payment card, and then transmitting credentials of the account via NFC, such as to payment terminal 550. In some embodiments, subsequent to transmitting credentials of the account via NFC, the electronic device reconfigures to not respond as a contactless payment card (e.g., requiring authorization before again reconfigured to respond as a contactless payment card via NFC).

In some embodiments, generation of and/or transmission of the signal is controlled by a secure element in the electronic device (e.g., 100, 300, 500). The secure element optionally requires a particular user input prior to releasing payment information. For example, the secure element optionally requires detection that the electronic device is being worn, detection of a button press, detection of entry of a passcode, detection of a touch, detection of one or more option selections (e.g., received while interacting with an application), detection of a fingerprint signature, detection of a voice or voice command, and or detection of a gesture or movement (e.g., rotation or acceleration). In some embodiments, if a communication channel (e.g., an NFC communication channel) with another device (e.g., payment terminal 550) is established within a defined time period from detection of the input, the secure element releases payment information to be transmitted to the other device (e.g., payment terminal 550). In some embodiments, the secure element is a hardware component that controls release of secure information. In some embodiments, the secure element is a software component that controls release of secure information.

In some embodiments, protocols related to transaction participation depend on, for example, device types. For example, a condition for generating and/or transmitting payment information can be different for a wearable device (e.g., device 500) and a phone (e.g., device 100). For example, a generation and/or transmission condition for a wearable device includes detecting that a button has been pressed (e.g., after a security verification), while a corresponding condition for a phone does not require button-depression and instead requires detection of particular interaction with an application. In some embodiments, a condition for transmitting and/or releasing payment information includes receiving particular input on each of multiple devices. For example, release of payment information optionally requires detection of a fingerprint and/or passcode at the device (e.g., device 100) and detection of a mechanical input (e.g., button press) on another device (e.g., device 500).

Payment terminal 550 optionally uses the payment information to generate a signal to transmit to a payment server 554 to determine whether the payment is authorized. Payment server 554 optionally includes any device or system configured to receive payment information associated with a payment account and to determine whether a proposed purchase is authorized. In some embodiments, payment server 554 includes a server of an issuing bank. Payment terminal 550 communicates with payment server 554 directly or indirectly via one or more other devices or systems (e.g., a server of an acquiring bank and/or a server of a card network).

Payment server 554 optionally uses at least some of the payment information to identify a user account from among a database of user accounts (e.g., 552). For example, each user account includes payment information. An account is, optionally, located by locating an account with particular payment information matching that from the POS communication. In some embodiments, a payment is denied when provided payment information is not consistent (e.g., an expiration date does not correspond to a credit, debit or gift card number) or when no account includes payment information matching that from the POS communication.

In some embodiments, data for the user account further identifies one or more restrictions (e.g., credit limits); current or previous balances; previous transaction dates, locations and/or amounts; account status (e.g., active or frozen), and/or authorization instructions. In some embodiments, the payment server (e.g., 554) uses such data to determine whether to authorize a payment. For example, a payment server denies a payment when a purchase amount added to a current balance would result in exceeding an account limit, when an account is frozen, when a previous transaction amount exceeds a threshold, or when a previous transaction count or frequency exceeds a threshold.

In some embodiments, payment server 554 responds to POS payment terminal 550 with an indication as to whether a proposed purchase is authorized or denied. In some embodiments, POS payment terminal 550 transmits a signal to the electronic device (e.g., 100, 300, 500) to identify the result. For example, POS payment terminal 550 sends a receipt to the electronic device (e.g., 100, 300, 500) when a purchase is authorized (e.g., via a transaction-coordination server that manages a transaction app on the user device). In some instances, POS payment terminal 550 presents an output (e.g., a visual or audio output) indicative of the result. Payment can be sent to a merchant as part of the authorization process or can be subsequently sent.

In some embodiments, the electronic device (e.g., 100, 300, 500) participates in a transaction that is completed without involvement of POS payment terminal 550. For example, upon detecting that a mechanical input has been received, a secure element in the electronic device (e.g., 100, 300, 500) releases payment information to allow an application on the electronic device to access the information (e.g., and to transmit the information to a server associated with the application).

In some embodiments, the electronic device (e.g., 100, 300, 500) is in a locked state or an unlocked state. In the locked state, the electronic device is powered on and operational but is prevented from performing a predefined set of operations in response to the user input. The predefined set of operations may include navigation between user interfaces, activation or deactivation of a predefined set of functions, and activation or deactivation of certain applications. The locked state may be used to prevent unintentional or unauthorized use of some functionality of the electronic device or activation or deactivation of some functions on the electronic device. In the unlocked state, the electronic device 100 is power on and operational and is not prevented from performing at least a portion of the predefined set of operations that cannot be performed while in the locked state.

When the device is in the locked state, the device is said to be locked. In some embodiments, the device in the locked state may respond to a limited set of user inputs, including input that corresponds to an attempt to transition the device to the unlocked state or input that corresponds to powering the device off.

In some embodiments, a secure element is a hardware component (e.g., a secure microcontroller chip) configured to securely store data and/or an algorithm. In some embodiments, the secure element provides (or releases) secure information, such as payment information (e.g., an account number and/or a transaction-specific dynamic security code). In some embodiments, the secure element provides (or releases) the secure information (e.g., payment information) in response to the device receiving authorization, such as a user authentication (e.g., fingerprint authentication; passcode authentication; detecting double-press of a hardware button when the device is in an unlocked state, and optionally, while the device has been continuously on a user's wrist since the device was unlocked by providing authentication credentials to the device, where the continuous presence of the device on the user's wrist is determined by periodically checking that the device is in contact with the user's skin). For example, the device detects a fingerprint at a fingerprint sensor (e.g., a fingerprint sensor integrated into a button) of the device. The device determines whether the fingerprint is consistent with a registered fingerprint. In accordance with a determination that the fingerprint is consistent with the registered fingerprint, the secure element provides (or releases) payment information. In accordance with a determination that the fingerprint is not consistent with the registered fingerprint, the secure element forgoes providing (or releasing) payment information.

Attention is now directed towards embodiments of user interfaces (“UI”) and associated processes that are implemented on an electronic device, such as portable multifunction device 100, device 300, or device 500.

FIGS. 6A-6D illustrate exemplary user interfaces for displaying updates to memory transfer messages, in accordance with some embodiments. The user interfaces in these figures are used to illustrate the processes described below, including the processes in FIG. 8.

At FIG. 6A, Jane's device 600 has initiated a recurring memory transfer, which includes sending a representation of the recurring memory transfer to John's device 700 through a communication application (e.g., an email application and/or an instant messaging application). Jane's device 600 and John's device 700 display recurring memory transfer messages 654a and 654b in communication application interfaces 738a and 738b to indicate a recurring transfer of computer memory. For example, Jane's device 600 displays recurring memory transfer message 654a in message transcript 740a of communication application interface 738a. John's device 700 displays recurring memory transfer message 654b in message transcript 740b of communication application interface 738b. As described in greater detail with respect to FIGS. 7A-7R, recurring memory transfer messages 654a and 654b include transfer details 656a, indicating an amount of memory for the recurring memory transfer, a frequency of the recurring transfer, an account (e.g., an account of an email application and/or an account of a gaming application), a start date, title, and emoji. Message transcripts 740a and 740b also include messages 658a and 658b (e.g., “Enjoy!”) sent with (or after) recurring memory transfer messages 654a and 654b. In some embodiments, Jane's device 600 and/or John's device 700 includes one or more components or features of device 100, device 300, device 500, or device 900.

At FIG. 6B, time has passed and Jane's device 600 has sent another recurring memory transfer to John's device 700. Recurring memory transfer messages 662a and 662b are displayed in message transcripts 740a and 740b. Recurring memory transfer messages 662a and 662b includes transfer details 656b, which includes similar types of information as transfer details 656a. As depicted, recurring memory transfer messages 662a and 662b are separated from recurring memory transfer messages 654a and 654b by messages 658a and 658b.

At FIG. 6C, Jane's device 600 has detected user input to modify the recurring memory transfer of memory transfer messages 654a and 654b, as described in greater detail with respect to FIGS. 7A-7R. In response, Jane's device 600 displays, in message compose region 752, representation 672 of the update to recurring memory transfer associated with recurring memory transfer message 654a (and/or recurring memory transfer message 654b). Representation 672 of the update to the recurring memory transfer includes transfer details 656c, which includes an update to a frequency parameter from weekly to monthly. While the frequency parameter is depicted as the only parameter that has changed, other parameters are optionally changed. Jane's device 600 detects input 650c (e.g., a touch input, an air gesture, a mouse click, a gaze, and/or a speech input) directed at send affordance 746. In response to detecting input 650c Jane's device 600 sends a message update with transfer details 656c.

At FIG. 6D, in response to detecting that a message update has been sent, Jane's device 600 updates recurring memory transfer message 654a with transfer details 656c. Similarly, John's device 700 updates recurring memory transfer message 654b with transfer details 656c. For example, recurring memory transfer messages 654a and 654b have been updated to indicate that the recurring memory transfer occurs monthly as opposed to weekly. As depicted, sending the message update with memory transfer details 656c does not cause a new message to be displayed in the message transcripts (e.g., does not include displaying a new message below messages 658a and 658b and/or recurring memory transfer messages 662a and 662b).

FIGS. 7A-7R illustrate exemplary user interfaces for controlling display of updates to fund transfer messages, in accordance with some embodiments. The user interfaces in these figures are used to illustrate the processes described below, including the processes in FIG. 8.

At FIG. 7A, Jane's device 600 displays, via display 601, account representation 704 of a payment account of a wallet application. In some embodiments, the payment account is associated with a financial account such that Jane can send and receive payments to other devices and/or other accounts, such as a payment account on John's device 700. Jane's device 600 detects input 750a (e.g., a touch input, an air gesture, a mouse click, a gaze, and/or a speech input) directed at menu affordance 702. In response to detecting input 750a, Jane's device 600 displays recurring payment menu option 706 of FIG. 7B.

At FIG. 7B, Jane's device 600 detects input 750b (e.g., a touch input, an air gesture, a mouse click, a gaze, and/or a speech input) directed at recurring payment menu option 706. In response to detecting input 750b, Jane's device 600 displays recurring payment interface 708.

At FIG. 7C, Jane's device 600 displays recurring payment interface 708. In some embodiments, recurring payment interface 708 allows a user to manage new and/or existing recurring payments. Recurring payment interface 708 includes new recurring payment affordance 710 to initiate a new recurring payment. Jane's device 600 detects input 650c (e.g., a touch input, an air gesture, a mouse click, a gaze, and/or a speech input) directed at new recurring payment affordance 710. In response to detecting input 650c, Jane's device 600 displays contact interface 712 of FIG. 7D.

At FIG. 7D, contact interface 712 includes an indication of a recipient of the new recurring payment, such as John Appleseed. In some embodiments, contact interface 712 allows a user to select a recipient of the new recurring payment. In some embodiments, Jane's device 600 detects an input to send the new recurring payment to a person different from John Appleseed, such as Bob, Sarah, and/or Kim. Jane's device 600 detects input 750d (e.g., a touch input, an air gesture, a mouse click, a gaze, and/or a speech input) directed at new affordance 710 to continue the process of sending the new recurring payment.

At FIG. 7E, Jane's device 600 displays recurring options interface 714 in response to detecting input 750d. Recurring options interface 714 includes representation 721 of an amount of money that will be sent in the new recurring payment (e.g., in each transfer of the recurring payments). In some embodiments, Jane's device 600 detects an input (e.g., a touch input, an air gesture, a mouse click, a gaze, and/or a speech input) on edit affordances 723a and/or 723b to change the amount of money that will be sent in the new recurring payment (e.g., the amount that will be sent with each recurring payment). In such embodiments, in response to detecting the input on edit affordances 723a and/or 723b, Jane's device 600 changes the amount of money that will be sent in the new recurring payment.

At FIG. 7E, recurring options interface 714 further includes start date affordance 716, repeat affordance 718, memo line affordance 720, and emoji affordance 722. Start date affordance 716 allows a user to modify a date or time that the new recurring payment begins. In some embodiments, in response to detecting input 750e1 directed at start date affordance 716, Jane's device 600 displays affordances for changing a starting date and/or start time for the new recurring payment. Repeat affordance 718 allows a user to modify how often the new recurring payment will be made. In some embodiments, in response to detecting input 750e2 directed at repeat affordance 718, Jane's device 600 displays affordances for selecting a frequency of the recurring payment, such as daily, weekly, monthly, a particular hour of the day, and/or some other time frame. Memo line affordance 720 allows a user to add and/or modify a description for the new recurring payment. In some embodiments, in response to detecting input 750e3 directed at memo line affordance 720, Jane's device 600 allows a user to add/edit the description for the new recurring payment (e.g., allowance, lunch money, and/or gas money), for example, via keyboard 724. Emoji affordance 722 allows a user to add an emoji for the new recurring payment. At FIG. 7E, Jane's device 600 detects input 750e4 (e.g., a touch input, an air gesture, a mouse click, a gaze, and/or a speech input) directed at emoji affordance 722.

At FIG. 7F, Jane's device 600 displays emoji interface 724a in response to detecting input 750e4. Emoji interface 724a includes predefined emojis 726 that are pre-configured. In some embodiments, device 600 detects an input that selects a respective predefined emoji. In such embodiments, the selected emoji will be displayed in association with the new recurring payment, as described in greater detail below. At FIG. 7F, Jane's device 600 detects input 750f (e.g., a touch input, an air gesture, a mouse click, a gaze, and/or a speech input) directed at custom emoji affordance 727.

At FIG. 7G, Jane's device 600 displays custom emoji interface 724b in response to detecting input 750f. Custom emoji interface 724b includes background color affordances 728 and frequently used emoji affordances 730. In some embodiments, background color affordances 728 allow a user to select a custom background for a custom emoji. In some embodiments, frequently used emoji affordances 730 includes frequently used emoji icons to select a custom emoji that is overlaid on the custom background. At FIG. 7G, Jane's device 600 detects input 750g1 (e.g., a touch input, an air gesture, a mouse click, a gaze, and/or a speech input) directed at custom background affordance 728a. Jane's device 600 also detects input 750g2 (e.g., a touch input, an air gesture, a mouse click, a gaze, and/or a speech input) directed at custom emoji affordance 730a. Jane's device 600 further detects input 750g3 (e.g., a touch input, an air gesture, a mouse click, a gaze, and/or a speech input) directed at done affordance 732.

At FIG. 7H, Jane's device 600 displays recurring options interface 714 in response to detecting input 750g3. As depicted, Jane's device 600 displays the new recurring payment with a customized emoji that was selected in response to detecting input 750g1 and input 750g2. Jane's device 600 detects input 750h (e.g., a touch input, an air gesture, a mouse click, a gaze, and/or a speech input) directed at next affordance 736. In response to detecting input 750h, Jane's device 600 displays (e.g., automatically and/or without additional user input) new recurring payment representation 742 of the new recurring payment in a new message of a communication application interface 738a. In some embodiments, Jane's device 600 includes new recurring payment representation 742 in message compose region 752, as shown in FIG. 7I.

At FIG. 7I, Jane's device 600 displays communication application interface 738a of a communication application. In some embodiments, the communication application is an email application and/or an instant messaging application. Communication application interfaces 738a and 738b include message transcripts 740a and 740b (respectively) of messages sent between Jane's device 600 and John's device 700. At FIG. 7I, message transcripts 740a and 740b includes messages that were sent prior to sending a message for the new recurring payment. Communication application interface 738a includes message compose region 752. In some embodiments, users can send text and/or images by entering the text and/or images into message compose region 752. At FIG. 7I, Jane's device 600 automatically inserts new recurring payment representation 742 into message compose region 752. New recurring payment representation 742 includes recurring payment details 756a, including a payment amount (e.g., $20), a frequency (e.g., weekly), a description (e.g., allowance), a start date (Friday, January 6), and an emoji (which is the same custom emoji that was selected via emoji interfaces 724a and 724b). Jane's device 600 also displays additional text 744 (“Enjoy!”) to be sent with the new recurring payment representation 742. Jane's device 600 detects input 750i (e.g., a touch input, an air gesture, a mouse click, a gaze, and/or a speech input) directed at send affordance 746.

At FIG. 7J, Jane's device 600 displays authorization interface 745 in response to detecting input 750i. In some embodiments, authorization interface 745 is a semi-transparent overlay on communication application interface 738a. In some embodiments, authorization interface 745 is an interface of an application that is different from the communication application (e.g., authorization interface 745 is an interface of an application that has access to a secure element of Jane's device 600 and the communication application does not have access to the secure element). In some embodiments, communication application interface 738a is dimmed (e.g., faded) while authorization interface 745 is displayed. At FIG. 7J, Jane's device 600 displays indicator 747 to proceed with sending the new recurring payment. In some embodiments, sending the new recurring payment via the communication application optionally requires an input (e.g., double-press of a physical button, a button press, a touch input, an air gesture, a mouse click, a gaze, and/or a speech input) that is not required when sending a message without the new recurring payment. In some embodiments, sending the new recurring payment via the communication application optionally requires additional authentication (e.g., biometric and/or password) even if Jane's device 600 is unlocked. Jane's device 600 detects input 750j (e.g., a double-press of a button, a button press, a touch input, an air gesture, a mouse click, a gaze, and/or a speech input) to authorize sending the new recurring payment.

At FIG. 7K, Jane's device 600 displays allowance recurring payment message 754a in message transcript 740a of communication application interface 738a in response to detecting input 750j and/or in response to the new recurring payment being sent. John's device 700 displays allowance recurring payment message 754b in message transcript 740b of communication application interface 738b. Allowance recurring payment messages 754a and 754b include recurring payment details 756a. Message transcripts 740a and 740b also include messages 758a and 758b of additional text 744 (e.g., “Enjoy!”) sent with (and/or after) the new recurring payment. Notably, recurring payment details 756a includes a start date of Friday, January 6th.

At FIG. 7L, time has passed, and the current day/time is after the start date of the new recurring payment (Friday January 6th). As such, the new recurring payment has started (e.g., the resources are not available until the new recurring payment has started even though a message about the recurring payment is received). In response to detecting that the new recurring payment has started (and/or in response to receiving an indication that funds associated with the recurring payment have been transferred), John's device 700 displays notification 760 that a first payment from the new recurring payment has been received, as shown in FIG. 7L. In some embodiments, notification 760 is a notification from an application (e.g., the wallet application) that is different from the communication application. As such, notification 760 is not displayed in message transcripts 740a and 740b. In some embodiments, notification 760 is a notification from a wallet application indicating that it has received the first payment.

At FIG. 7L, Jane's device 600 (and/or John's device 700) detects that the new recurring payment has started and, in response, updates payment details 756a of recurring payment message 754a (recurring payment message and/or 754b). For example, “Start Date of Friday, January 6” of recurring payment messages 754a and 754b of FIG. 7K has been updated to “On Fridays,” indicating that the allowance will be received every Friday. In some embodiments, payment details 756a are updated with an indication of a day of the week and/or indication of whether the payment is monthly or bi-monthly.

At FIG. 7M, time has passed and Jane's device 600 has sent another recurring payment to John's device 700 (e.g., that recurs with a different frequency as the initial recurring payment). Recurring payment messages 762a and 762b are displayed in message transcripts 740a and 740b. Recurring payment messages 762a and 762b include payment details 756b that includes similar types of information as payment details 756a. As depicted, recurring payment messages 762a and 762b are separated from recurring payment messages 754a and 754b by messages 758a and 758b of additional text 744. In some embodiments, between the first recurring payment (corresponding to recurring payment message 754a) being configured/sent and the second recurring payment (corresponding to payment message 762a) being configured/sent, Jane and John continue their conversation, causing additional textual messages to be displayed in message transcripts 740a and 740b and, as a result, when the second recurring payment (corresponding to recurring payment message 762a) is sent, recurring payment message 754a and recurring payment message 762a are separated by those additional textual messages (as are recurring payment message 754b and recurring payment message 762b).

At FIG. 7N, Jane's device 600 displays recurring payment interface 708 that indicates there are two active recurring payments (e.g., each causing payments to be made at different frequencies and/or for different amounts). Active recurring payments 764 and 766 correspond to the recurring payment of recurring payment message 754a and recurring payment messages 762a, as indicated by having payment details 756a and 756b. Jane's device 600 detects input 750n (e.g., a touch input, an air gesture, a mouse click, a gaze, and/or a speech input) directed at active recurring payment 764.

At FIG. 7O, Jane's device 600 displays edit interface 770 in response to detecting input 750n. Edit interface 770 includes various options to modify various parameters of an active recurring payment (e.g., the selected recurring payment), including amount parameter 768a (e.g., that controls what the amount will be), next payment parameter 768b (e.g., that controls when the next recurring payment will be made), frequency parameter 768c (e.g., that controls how often the recurring payment will be made), payment method parameter 768d (e.g., that controls what account is used to make the recurring payment), and a memo line option 768e (e.g., that modifies a title of the recurring payment memo line affordance 720). Edit interface 770 includes hold affordance 768f to hold (e.g., pause) the recurring payment and cancel affordance 768g to cancel the recurring payment. Jane's device 600 detects a set of one or more inputs 750o (e.g., a touch input, an air gesture, a mouse click, a gaze, and/or a speech input) directed at an affordance to modify frequency parameter 768c.

At FIG. 7P, Jane's device 600 updates frequency parameter 768c from weekly to monthly in response to detecting the set of one or more inputs 750o. Jane's device 600 detects input 750p (e.g., a touch input, an air gesture, a mouse click, a gaze, and/or a speech input) directed at done affordance 732.

At FIG. 7Q, Jane's device 600 displays, in message compose region 752, representation 772 of an update to the recurring payment associated with recurring payment message 754a (and/or recurring payment message 754b) (e.g., in response to detecting inputs 750o and/or 750p). Representation 772 of an update to the recurring payment includes payment details 756c, which includes the updated frequency parameter to monthly (e.g., instead of weekly). While a frequency parameter is depicted as the only parameter changed, other parameters are optionally changed. For example, payment details 756c optionally includes an indication for (and/or updates) an indication of the recurring payment being placed on hold, an indication of the recurring payment being cancelled, an indication of an updated amount for the recurring payment, and/or any other parameter of the edit interface 770. Jane's device 600 detects input 750q (e.g., a touch input, an air gesture, a mouse click, a gaze, and/or a speech input) directed at send affordance 746. In response to detecting input 750q, Jane's device 600 sends a message update with payment details 756c.

At FIG. 7R, in response to detecting that a message update has been sent, Jane's device 600 updates recurring payment message 754a with payment details 756c. Similarly, John's device 700 updates recurring payment message 754b with payment details 756c (e.g., in response to receiving the message update). For example, recurring payment messages 754a and 754b have been updated to indicate that the recurring payment occurs monthly (as opposed to weekly), and that the next payment is on the 3rd of the month. As depicted, sending the message update with payment details 756c does not include displaying a new message in the message transcript (e.g., does not include displaying a new message below messages 758a and 758b and/or below recurring payment messages 762a and 762b).

FIG. 8 is a flow diagram illustrating a method for displaying a resource transfer message in a communication application using a computer system in accordance with some embodiments. Method 800 is performed at a computer system (e.g., 100, 300, 500, 600, 700, 900, and/or 1500) (e.g., a smartphone, a smartwatch, a tablet computer, a laptop computer, a desktop computer, and/or a head mounted device (e.g., a head mounted augmented reality and/or extended reality device)) that is in communication with a display generation component (e.g., 601, 701, 801, and/or 1501). In some embodiments, the computer system is in communication with one or more input devices (e.g., a touch-sensitive surface, a keyboard, a controller, and/or a mouse). In some embodiments, the computer system in communication with one or more cameras (e.g., an infrared camera, a depth camera, and/or a visible light camera). Some operations in method 800 are, optionally, combined, the orders of some operations are, optionally, changed, and some operations are, optionally, omitted.

As described below, method 800 provides an intuitive way for displaying a resource transfer message in a communication application. The method reduces the cognitive burden on a user to view resource transfer messages in a communication application, thereby creating a more efficient human-machine interface. For battery-operated computing devices, enabling a user to view resource transfer messages in a communication application faster and more efficiently conserves power and increases the time between battery charges.

The computer system displays (802), via the display generation component, a transcript of a conversation (e.g., 740a, 740b, 840a, 840b) (e.g., a chat conversation, instant messaging conversation, and/or an email thread) between a first user (e.g., the user associated with Jane's device 600 and/or the user associated with John's device 700) (e.g., a user associated with the computer system) and a second user that is different from the first user (e.g., the user associated with Jane's device 600 and/or the user associated with John's device 700) (e.g., a user associated with a second computer system that initiates a recurring resource transfer). In some embodiments, the second user is associated with a remote computer system, an external computer system, a smartphone, a smartwatch, a tablet computer, a laptop computer, and/or desktop computer, and/or a second computer system different from the first computer system. In some embodiments, the transcript of the conversation is displayed as part of a messaging application. In some embodiments, the computer system initiates the first recurring resource transfer and/or the respective recurring resource transfer. The computer system detects (804) (e.g., while displaying the transcript) first information (e.g., 656a and/or 756a) (e.g., an account number of an account providing the transfer amount, a PIN, and/or a verification code) associated with a first recurring resource transfer (e.g., transfer associated with 654a and/or 756a) (e.g., a recurring transfer of allocated memory, data, a balance, and/or funds) (e.g., a repeated resource transfer and/or persistent resource transfer). In some embodiments, the first recurring resource transfer (and/or first information) is associated with a first set of one or more parameters (e.g., an account number, a recurring transfer amount, a beginning transfer date, a transfer frequency, a transfer title, a transfer icon). In some embodiments, the first information is received from an external computer system. In some embodiments, the first information is generated by the computer system. In response to detecting the first information for the first recurring resource transfer, the computer system displays (806), via the display generation component, a first representation (e.g., 654a, 654b, 754a, and/or 754b) (e.g., alphanumeric text, image, and/or symbol) of the first recurring resource transfer in the transcript of the conversation between the first user and the second user. In some embodiments, the first representation of the first recurring resource transfer is displayed without transferring funds. In some embodiments, the first representation of the first recurring resource transfer includes a representation of the first account, the first recurring transfer amount, the first beginning transfer date, the first transfer frequency, the first transfer title, the first transfer icon. After displaying the representation of the first recurring resource transfer in the transcript of the conversation between the first user and the second user, the computer system detects (808) respective information (e.g., 656b and/or 756b) for a respective recurring resource transfer (e.g., recurring transfer associated with 656b and/or 756b). In some embodiments, the respective recurring resource transfer corresponds to the first recurring resource transfer (e.g., the respective information is an update to the first information for the first recurring resource transfer and/or the first recurring resource transfer has been changed). In some embodiments, the respective information is for a second recurring resource transfer that is different from the first recurring resource transfer (e.g., a new recurring resource transfer has been created). In some embodiments, the respective recurring resource transfer (and/or respective information) is associated with a respective set of one or more parameters. In some embodiments, the respective set of one or more parameters is different from the first set of one or more parameters. In some embodiments, the respective set of one or more parameters includes at least one parameter included in the first set of one or more parameters. In some embodiments, the respective set of one or more parameters includes at least one parameter that is different from a parameter included the first set of one or more parameters. In some embodiments, the respective information is received from an external computer system. In some embodiments, the respective information is generated by the computer system. In response to detecting the respective information for the respective recurring resource transfer, the computer system displays (810), via the display generation component, a respective representation (e.g., 662a, 662b, update to 654a and/or 654b in FIG. 6D, and/or update to 754a and/or 754b in FIG. 7R) of the respective recurring resource transfer in the conversation between the first user and the second user. In some embodiments, the respective representation is displayed in the same (or different) location in the conversation between the first user and the second user (e.g., relative to other messages in the conversation).

In some embodiments, the first recurring resource transfer is a recurring transfer of memory (e.g., 656a) (e.g., memory is allocated from a computer system of the first user to a computer system of the second user). In some embodiments, allocating memory includes making memory available to the computer system (e.g., of the first user or of the second user). In some embodiments, the respective recurring resource transfer is a recurring transfer of memory (e.g., 656b, 656c). In some embodiments, the first memory allocation and/or the respective memory allocation includes an allocation of computer memory (e.g., primary memory (e.g., random access memory (RAM) and/or read-only memory (ROM)) and/or secondary memory (e.g., cloud storage, hard disk drive, solid-state drive, and/or optical drive)). Displaying representations of recurring transfers of memory in the transcript of a conversation between the first user and the second user provides visual feedback of transferred memory allocation and the state of the computer system.

In some embodiments, the first recurring resource transfer is a recurring transfer of funds (e.g., 756a) (e.g., funds are transferred from an account of the first user to an account of the second user). In some embodiments, transferring funds includes making funds available to the computer system (e.g., of the first user or of the second user). In some embodiments, the respective recurring resource transfer is a recurring transfer of funds (e.g., 756b, 756c). In some embodiments, the first transfer of funds and/or the respective transfer of funds includes an allocation of money to an account provisioned on a wallet of the computer system (e.g., of the first user and/or of the second user). Displaying representations of recurring transfers of funds in the transcript of a conversation between the first user and the second user provides visual feedback of transferred funds and the state of the computer system.

In some embodiments, displaying the respective representation of the respective recurring resource transfer in the conversation between the first user and the second user in response to detecting the respective information for the respective recurring resource transfer includes, in accordance with a determination that the respective information is a modification to the first information (e.g., 656c, 756c), updating (e.g., removing, dimming, and/or modifying) the first representation of the first recurring resource transfer (e.g., as depicted in FIGS. 6D and 7R). In some embodiments, the first representation of the first recurring resource transfer is updated to the respective representation of the respective recurring resource. In some embodiments, the first representation of the first recurring resource transfer is at a respective location (e.g., the same location) in the transcript of the conversation before and after the first representation of the first recurring resource transfer is updated (e.g., the first representation of the first recurring resource transfer does not move locations relative to other representations of the transcript of the conversation). In some embodiments, in accordance with a determination that the respective information is not a modification to the first information, forgoing the update of (e.g., removing, dimming, and/or modifying) the first representation in the transcript of the conversation between the first user and the second user (e.g., 662a, 662b, 762a, 762b are displayed as opposed to updating an existing message). In some embodiments, displaying the respective representation of the respective recurring resource transfer in the conversation between the first user and the second user in response to detecting the respective information for the respective recurring resource transfer includes: in accordance with a determination that the respective recurring resource transfer corresponds to the first recurring resource transfer, updating (e.g., removing, dimming, and/or modifying) the first representation of the first recurring resource transfer; and in accordance with a determination that the respective recurring resource transfer does not correspond to the first recurring resource transfer, forgoing updating the first representation of the first recurring resource transfer (and, optionally, displaying a new representation of the respective recurring resource transfer). Conditionally updating the first representation of the first recurring resource transfer performs an operation when a set of conditions has been met without requiring further user input and provides visual feedback of whether there has been an update to the first recurring resource transfer.

In some embodiments, the first representation of the first recurring resource transfer includes a representation of a first status (e.g., as depicted in 656a, 656b, 656c, 756a, 756b, and/or 756c) (e.g., weekly, monthly, hold, paused, and/or cancelled) of the first recurring resource transfer. In some embodiments, the respective representation of the respective recurring resource transfer includes a representation of a second status (e.g., weekly, monthly, hold, paused, and/or cancelled) of the respective recurring resource transfer, wherein the representation of the second status is different from the representation of the first status (e.g., as depicted in 656a, 656b, 656c, 756a, 756b, and/or 756c). Displaying representations of different statuses for the first recurring transfer and respective recurring resource transfer in the transcript of a conversation between the first user and the second user provides visual feedback as to the state of the recurring transfers and the state of the computer system.

In some embodiments, the first representation of the first recurring resource transfer includes a representation of a first parameter of a first parameter type (e.g., as depicted in 656a, 656b, 656c, 756a, 756b, and/or 756c) (e.g., emoji, icon, title, amount of resource transfer, frequency of resource transfer, and/or a start date). In some embodiments, the respective representation of the respective recurring resource transfer includes a representation of a second parameter (e.g., as depicted in 656a, 656b, 656c, 756a, 756b, and/or 756c) (e.g., the same as or different from the first parameter of the first parameter type) of the first parameter type (e.g., as depicted in 656a, 656b, 656c, 756a, 756b, and/or 756c) (e.g., emoji, icon, title, amount of resource transfer, frequency of resource transfer, and/or a start date). Displaying representations of the first parameter type for the first recurring transfer and respective recurring resource transfer in the transcript of a conversation between the first user and the second user provides visual feedback as to the state of the recurring transfers and the state of the computer system.

In some embodiments, displaying the respective representation of the respective recurring resource transfer in the conversation between the first user and the second user in response to detecting the respective information for the respective recurring resource transfer includes, in accordance with a determination that the respective information is for a second recurring resource (e.g., resource transfer of 656b and/or 756b), different from (e.g., independent of and/or separate from) the first recurring resource transfer, maintaining (e.g., retaining, not modifying, and/or not updating) the first representation of the first recurring resource transfer in the transcript of the conversation between the first user and the second user while the respective representation of the respective recurring resource transfer is displayed (e.g., 662a, 662b, 762a, 762b is still displayed in FIGS. 6D and 7R). In some embodiments, while displaying the respective representation of the respective recurring resource transfer, the computer system detects an input to scroll the transcript of the conversation between the first user and the second user and, in response, displays the first representation of the first recurring resource transfer. In some embodiments, the first representation of the first recurring resource is at a location in the transcript of the conversation between the first user and the second user that is different from the location of the respective representation of the respective recurring resource transfer. Conditionally maintaining the first representation of the first recurring resource transfer in the transcript of the conversation performs an operation when a set of conditions has been met without requiring further user input and provides visual feedback that information about a second (different) recurring resource transfer has been detected.

In some embodiments, the respective representation of the respective recurring resource transfer is separated (e.g., spaced apart from) from the first representation of the first recurring resource transfer by a representation of at least a portion of the transcript of the conversation (e.g., as depicted in FIGS. 6D and 7R) (e.g., at least the portion of the transcript (e.g., textual messages sent between the two users) is between the respective recurring resource and the first representation of the first recurring resource transfer). By separating the respective representation of the respective recurring resource transfer from the first representation of the first recurring resource transfer allows a user to view both the conversation and information about recurring payments.

In some embodiments, the first representation of the first recurring resource transfer includes a representation of a first set of parameters (e.g., emoji, icon, title, amount of resource transfer, frequency of resource transfer, and/or a start date) that have been configured by a user (e.g., parameters depicted in 656a, 656b, 656c, 756a, 756b, and/or 756c are user-configurable) (e.g., a user of the computer system, a user of an external computer system, the first user, and/or the second user). In some embodiments, the respective representation includes a representation (e.g., one or more representations) of a respective set of parameters (e.g., emoji, icon, title, amount of resource transfer, frequency of resource transfer, and/or a start date) that have been configured by the user (e.g., parameters depicted in 656a, 656b, 656c, 756a, 756b, and/or 756c are user-configurable). In some embodiments, the first set of parameters and/or the respective set of parameters are user-configurable parameters. In some embodiments, the first set of parameters and/or the respective set of parameters are configurable by the computer system (e.g., of the first user) and are not configurable by a computer system (e.g., of the second user) different from the computer system or vice versa. Displaying representations of a first set of parameters and a respective set of parameters in the transcript of a conversation provides visual feedback as to the state of the recurring transfers and the state of the computer system.

In some embodiments, the first set of parameters includes a first parameter of a third parameter type (e.g., emoji, icon, title, amount of resource transfer, frequency of resource transfer, and/or a start date), and wherein the respective set of parameters includes the first parameter of the third parameter type (e.g., a resource amount, title, and/or icon are the same in both 656a and 656c and/or are the same in both 756a and/or 756c) (e.g., the first set of parameters and the respective set of parameters have at least one of the same parameter of the same parameter type). Including a first parameter of a third parameter type in a first set of parameters and the respective set of parameters provides visual feedback as to the state of the recurring transfers and the state of the computer system.

In some embodiments, the first set of parameters includes a first parameter of a fourth parameter type (e.g., emoji, icon, title, amount of resource transfer, frequency of resource transfer, and/or a start date), and wherein respective set of parameters includes a second parameter, different from the first parameter, of the fourth parameter type (e.g., 656a and 756a indicates a weekly recurring transfer, and 656c and/or 756c indicate a monthly recurring transfer) (e.g., the first set of parameters and the respective set of parameters have at least one different parameter of the same type). In some embodiments, first set of parameters is different from the respective set of parameters. Including a first parameter of a fourth parameter type in a first set of parameters and a second parameter, different from the first parameter, of the fourth parameter type in the respective set of parameters provides visual feedback as to the state of the recurring transfers and the state of the computer system.

In some embodiments, a first resource amount (e.g., 20 GB of 656a and/or $20 of 765a) of the first recurring resource transfer (and/or the respective information for the respective recurring resource transfer) is not available (e.g., for use by the computer system and/or available in an account provisioned in a wallet) until a condition (e.g., a start date parameter and/or temporal condition) that is configured by a respective computer system that initiated the first recurring resource transfer (and/or the respective information for the respective recurring resource transfer) has been satisfied (e.g., 654b and/or 754b are sent but the resources are not available until the resources are deposited into the account as indicated by 760) (e.g., a current date corresponds to a start date of the first recurring resource transfer). Making a resource amount of the first recurring resource transfer unavailable until a condition that is configured by a respective computer system that initiated the first recurring resource transfer improves how recurring transfers are managed.

In some embodiments, after displaying the first representation (or, optionally, the respective recurring resource transfer), the computer system detects that a second resource amount (the same or different from the first amount of resource transfer) of the first recurring resource transfer is available (e.g., as described with respect to FIG. 7L) (e.g., for use by the computer system and/or available in an account provisioned in a wallet). In response to detecting that the second resource amount of the first recurring resource transfer is available, the computer system displays, via the display generation component, an indication (e.g., 760) (e.g., a graphical element and/or a notification) that the second resource amount is available without updating the transcript of the conversation to include a representation (e.g., indication) that the second resource amount is available (e.g., as described and depicted with respect to FIG. 7L). Thus, in some embodiments, the computer system notifies the user of (e.g., via display of an alert at) the computer system that the second resource amount is available without updating the transcript of the conversation to indicate the same, thereby avoiding cluttering the transcript of the conversation. Displaying an indication in response to detecting that the second resource amount of the first recurring resource transfer is available without updating the transcript of the conversation to include a representation that the second resource amount is available declutters the user interface include the transcript of the conversation and improves how visual feedback as to the state of the recurring transfers is provided.

Note that details of the processes described above with respect to method 800 (e.g., FIG. 8) are also applicable in an analogous manner to the methods described below. For example, methods 1100, 1400, 1600, 1800, 2100, 2400, and/or 2600 optionally include one or more of the characteristics of the various methods described above with reference to method 800. For example, methods 1100, 1400, 1600, 1800, 2100, 2400, and/or 2600 include features to display a resource transfer in a communication application described with respect to method 800. For brevity, these details are not repeated herein.

FIGS. 9A-9J illustrate exemplary user interfaces for setting up different types of resource transfer accounts for computer memory, in accordance with some embodiments. The user interfaces in these figures are used to illustrate the processes described below, including the processes in FIGS. 11A-11B.

At FIG. 9A, device 900 displays, on display 801, a user interface to add an account to (e.g., provision the account onto) memory transfer application (and/or device 900). In some embodiments, device 900 is Jane's device 600 and/or John's device 700, and includes one or more components of device 100, device 300, and/or device 500. Device 900 detects input 950a (e.g., a touch input, an air gesture, a mouse click, a gaze, and/or a speech input) directed at add affordance 902.

At FIG. 9B, device 900 displays set-up interface 1004b in response to detecting input 950a. Set-up interface 1004b includes different options in how the computer memory account operates. Providing different options to configure the computer memory account is important because it will impact how resources of the account are transferred using device 900. Set-up interface 1004b includes post-transfer affordance 906. In some embodiments, setting up the account as a post-transfer account allows device 900 to transfer an allocation of memory after the memory has been used and/or at regular intervals (e.g., daily, weekly, and/or monthly). Set-up interface 1004b also includes pre-transfer affordance 908. In some embodiments, setting up the account as a pre-transfer account allows device 900 to schedule memory to be auto reloaded based on user-configured parameters, such as a minimum balance and/or a reload amount. At FIG. 9B, device 900 detects input 950b1 (e.g., a touch input, an air gesture, a mouse click, a gaze, and/or a speech input) directed at post-transfer affordance 906.

At FIG. 9C, in response to detecting input 950b1, device 900 displays user interface 1004c that includes affordance 911 to select computer memory from various accounts that are available through the memory transfer application. Device 900 also displays indication 913 that allocation of the memory will be transferred to a specific account (e.g., a specific user account and/or application). At FIG. 9C, device 900 detects input 950c (e.g., a double-press of a button, a button press, a touch input, an air gesture, a mouse click, a gaze, and/or a speech input) to proceed with setting up the post-transfer account. In response to detecting input 950c, device 900 displays transfer interface 1004e, which is later updated to reflect transfers, as shown in FIG. 9D.

At FIG. 9D, time has passed, and device 900 has transferred an allocation of memory (e.g., 7 GB) from the newly configured computer memory account to a work email account, as depicted by work email transfer 916. Device 900 updates balance details 1012 to indicate that the available memory of the account has decreased based on an allocation of memory being transferred, as indicted by work email transfer 916.

At FIG. 9E, time has passed, and an auto reload has occurred. In some embodiments, the auto reload has occurred at a predetermined time during the day (e.g., midnight and/or noon), predetermined day of the week (e.g., Monday and/or Friday), and/or a predetermined day of the month (e.g., the first day of the month and/or the last day of the month). In some embodiments, the auto reload occurs at a time and/date that is independent of an amount of available resources of the computer memory account reaching a minimum balance. In some embodiments, the amount that is auto reloaded during the transfer is based on the amount of resources used (e.g., transferred to other accounts) during a predetermined time period (e.g., in the last 12 hours, in the last 24 hours, and/or in the last week) (and/or, optionally, since the last auto reload). In response to detecting an auto reload has occurred, device 900 updates transfer interface 1004e. For example, transfer interface 1004e of FIG. 9E includes auto reload transfer 918 that includes auto-reload indicator 1019 and the amount of resource transferred to the computer memory account (e.g., 7 GB). Transfer interface 1004e of FIG. 9E also includes updated balance details 1012 based on the auto-reload transfer. For example, the amount of computer memory is restored to the amount that was available prior to work email transfer 916. In some embodiments, device 900 detects a set of one or more inputs (e.g., a touch input, an air gesture, a mouse click, a gaze, and/or a speech input) including an input 950e1 directed at menu affordance 702 and, in response, displays an account details interface similar to account details interface 1004h of FIG. 10H. In some embodiments, device 900 detects input 950e2 (e.g., a touch input, an air gesture, a mouse click, a gaze, and/or a speech input) directed at balance details affordance 1014 and, in response, displays a computer memory details interface similar to account details interface 1004h of FIG. 10H.

At FIG. 9F, as part of configuring the computer memory account as a pre-transfer account (e.g., based on input 950b1 at FIG. 9B), device 900 displays summary interface 1004j. In some embodiments, device 900 detects input 950f1 (e.g., a touch input, an air gesture, a mouse click, a gaze, and/or a speech input) directed at affordance 930 to initiate a process to set up auto reload. In some embodiments, device 900 detects input 950f2 (e.g., a touch input, an air gesture, a mouse click, a gaze, and/or a speech input) to set up the computer memory account without auto-reload and, in response, displays a transfer interface similar to transfer interface 1004e of FIG. 9I but without auto-reload activated.

At FIG. 9G, device 900 displays parameter interface 1004k in response to detecting input 950f1. Parameter interface 1004k includes graphical element 1032 to select an amount that will be transferred during an auto-reload transfer. Parameter interface 1004k includes graphical element 1034 to select a minimum threshold balance (e.g., 10 GB) (e.g., a remaining amount of computer memory resources left on the account) that will trigger the auto-reload transfer. Device 900 detects input 950g (e.g., a touch input, an air gesture, a mouse click, a gaze, and/or a speech input) directed at turn on affordance 936.

At FIG. 9H, in response to detecting input 950g, device 900 displays an updated summary interface 1004j that includes a summary of the auto-reload parameters, including transfer details 1033 (including the threshold balance of 10 GB) and reload amount indicator 1031. At FIG. 9H, device 900 detects input 950h (e.g., a double-press of a button, button press, a touch input, an air gesture, a mouse click, a gaze, and/or a speech input).

At FIG. 9I, in response to detecting input 950h, device 900 displays transfer interface 1004e. Transfer interface 1004e of FIG. 9I includes deposit transfer 940 and work email transfer 942 in transfer section 1017. Deposit transfer 940 is an initial deposit of computer memory that is user configurable during set up of the pre-transfer account. Work email transfer 942 is a transfer of memory to a work email account (or, optionally, application). Transfer interface 1004e of FIG. 9I includes balance details 1012 that accounts for the currently available computer memory. Based on deposit transfer 940 and work email transfer 942, balance details 1012 indicates that 9 GB in computer memory are available. Auto-reload is active for the computer memory account, as indicated by auto-reload indicator 1038. Device 900 detects that auto-reload is active and that the balance is below the threshold balance of 10 GB. In response, device 900 automatically initiates an auto-reload transfer.

At FIG. 9J, device 900 displays an updated transfer interface 1004e that includes auto-reload transfer 944. Auto-reload transfer 944 is distinguished from deposit transfer 940 (e.g., an initial deposit or other non-auto reload deposits) using auto-reload indicator 1019. Transfer interface 1004e of FIG. 9J also includes updated balance details 1012 of 59 GB that indicates the amount of available computer memory. In some embodiments, device 900 detects input 950j (e.g., a touch input, an air gesture, a mouse click, a gaze, and/or a speech input) directed at add memory affordance 948 and, in response, displays an account details interface similar to account details interface 1004h of FIG. 10H.

FIGS. 10A-10Q illustrate exemplary user interfaces for setting up different auto-reload accounts for funds, in accordance with some embodiments. The user interfaces in these figures are used to illustrate the processes described below, including the processes in FIGS. 11A-11B.

At FIG. 10A, device 900 displays a user interface to add a transit card to a wallet application (e.g., the same wallet application described with respect to FIGS. 7A-7R) and/or device 900. In some embodiments, the user interface to add the transit card is displayed in response to searching for an account, detecting user input requesting to create a new account (e.g., a new transit account for making transit payments), and/or requesting a transit account from a service provider. In some embodiments, device 900 is Jane's device 600 and/or John's device 700, and includes one or more components of device 100, device 300, or device 500. Device 900 detects input 1050a (e.g., a touch input, an air gesture, a mouse click, a gaze, and/or a speech input) directed at add affordance 1002.

At FIG. 10B, device 900 displays set-up interface 1004b in response to detecting input 1050a. Set-up interface 1004b includes different options in how the transit card operates. Providing different options to configure the transit card is important as it will impact how resources will be transferred using device 900. Set-up interface 1004b includes post-paid affordance 1006. In some embodiments, setting up the account as a post-paid account allows device 900 to schedule funds to be auto loaded at regular intervals configured by the service provider (e.g., daily, weekly, and/or monthly). In some embodiments, the post-paid account is a line of credit that is extended to the user of device 900 via the transit card/transit account. Setting up a post-paid account is described in greater detail with respect to FIGS. 10C-10H. Set-up interface 1004b also includes pre-paid affordance 1008. In some embodiments, setting up a pre-paid account allows device 900 to schedule funds to be auto loaded based on user-configured parameters, such as a minimum balance and/or a reload amount. In some embodiments, setting up a pre-paid account allows device 900 to cancel and/or forgot setting up the auto load. In some embodiments, a pre-paid account optionally requires funds to be transferred to the account before the account can be used for services (e.g., transit fares) (e.g., using the funds transferred to the account). In some embodiments, the post-paid account does not require funds to be transferred to the account before the account can be used for services (e.g., transit fares), as described in greater detail below. At FIG. 10B, device 900 detects input 1050b1 (e.g., a touch input, an air gesture, a mouse click, a gaze, and/or a speech input) directed at post-paid affordance 1006.

At FIG. 10C, if the wallet application is not provisioned with a payment card (e.g., a credit card and/or debit card), device 900 displays add-card notification 1009 in response to detecting input 1050b1. For example, add-card notification 1009 indicates that no payment card is available through the wallet application. Add-card notification 1009 includes add-card affordance 1010 that starts a process add a payment card (e.g., for funding the transit card) to the wallet application. Device 900 detects input 1050c (e.g., a touch input, an air gesture, a mouse click, a gaze, and/or a speech input) directed at add-card affordance 1010. In response to detecting input 1050c, device 900 displays a series of user interfaces that allow a user to add a payment card to the wallet application. In some embodiments, device 900 does not display add-card notification 1009 if a payment card is already available through the wallet application. In such embodiments, device 900 displays user interface 1004d of FIG. 10D in response to detecting input 1050c.

At FIG. 10D, device 900 displays user interface 1004d that includes affordance 1011 to select a payment card that is available through the wallet application. Affordance 1011 indicates that Card 2 will be used as a source of the funds for the automatic resource transfer to the transit card (also referred to as the transfer account). Device 900 also displays indication 1013 that funds will be transferred to the transit card. Notably, affordance 1030 of FIG. 10J to initiate a process to set up auto reload amount and/or frequency of the auto-reload is not displayed at FIG. 10D. In some embodiments, setting up an initial source of funds for the automatic resource transfer optionally requires and/or uses user authentication (e.g., biometric information and/or a password). In some embodiments, changing the initial source of funds for the automatic resource transfer to a different source optionally requires the user to reauthentication (e.g., biometric information and/or a password). At FIG. 10D, while displaying indicator 747 to complete the automatic resource transfer set up, device 900 detects input 1050d (e.g., a double-press input, a touch input, an air gesture, a mouse click, a gaze, and/or a speech input) to proceed with setting up the post-paid account. In response to detecting input 1050d, device 900 displays transfer interface 1004e of FIG. 10E.

At FIG. 10E, device 900 displays transfer interface 1004e that includes balance details 1012 and a representation 1015 of the transit card. Because the transit card is set up as a post-paid account, balance details 1012 includes credited funds. In some embodiments, the credited funds are predefined (e.g., are not user configurable and/or are defined by a service provider). In some embodiments the credited funds are a line of credit that is available via the transit card/transit account. Transfer interface 1004e also includes transfer section 1017 that includes recent transfers (e.g., no recent transfers in FIG. 10E).

At FIG. 10F, time has passed, and device 900 has transferred funds (e.g., $7) using the transit card for a bus ticket, as depicted by bus transfer 1016. Device 900 updates balance details 1012 to indicate that the available funds have decreased based on bus transfer 1016.

At FIG. 10G, time has passed, and an auto reload has occurred as depicted by balance details and auto reload transfer 1018. In some embodiments, the auto reload occurs at a predetermined time during the day (e.g., midnight and/or noon), predetermined day of the week (e.g., Monday and/or Friday), and/or a predetermined day of the month (e.g., the first day of the month and/or the last day of the month). In some embodiments, the auto reload occurs at a time and/date that is independent of (e.g., not based on) an amount of available resources reaching a minimum balance. In such embodiments, the predetermined time is optionally not user configurable. In some embodiments, the predetermined time is optionally designated by a service provider of the transit card. In some embodiments, the amount that is auto reloaded during the transfer is based on the amount of resources used during a predetermined time period (e.g., in the last 12 hours, in the last 24 hours, and/or in the last week) (and/or, optionally, since the last auto reload). In response to detecting that an auto reload has occurred, device 900 updates transfer interface 1004e. For example, transfer interface 1004e of FIG. 10G includes auto reload transfer 1018 that includes auto-reload indicator 1019 and the amount of resource (funds) transferred to the transit card (e.g., $7). Transfer interface 1004e of FIG. 10G also includes updated balance details 1012 based on the auto-reload transfer. For example, the amount of credited funds is restored to the amount that was available prior to bus transfer 1016. At FIG. 10G, in some embodiments, device 900 detects a set of one or more inputs (e.g., a touch input, an air gesture, a mouse click, a gaze, and/or a speech input) including an input 1050g1 directed at menu affordance 702. At FIG. 10G, in some embodiments, device 900 detects input 1050g2 (e.g., a touch input, an air gesture, a mouse click, a gaze, and/or a speech input) directed at balance details affordance 1014.

At FIG. 10H, in response to detecting the set of one or more inputs including input 1050g1 and/or in response to detecting input 1050g2, device 900 displays account details interface 1004h. Account details interface 1004h includes details and/or options associated with the transit card. In some embodiments, account details interface 1004h changes based on the state of the account associated with the transit card (e.g., whether the card is pre-paid or post-paid). In some embodiments, account details interface 1004h changes based on whether auto-reloading is authorized via an application different from the wallet application or whether auto-reloading is authorized via the wallet application, as described in greater detail with respect to FIGS. 12A-12D, 13A-13J, and 14. At FIG. 10H, account details interface 1004h includes available credit 1020, restore balance affordance 1021, and transfer source affordance 1024. In some embodiments, device 900 detects input 1050h1 (e.g., a touch input, an air gesture, a mouse click, a gaze, and/or a speech input) directed at restore balance affordance 1021 and, in response, transfers (or, optionally, initiates a process to transfer) an amount of funds needed to restore the creditable funds to the original creditable funds (e.g., $100). In some embodiments, device 900 detects input 1050h2 (e.g., a touch input, an air gesture, a mouse click, a gaze, and/or a speech input) directed at transfer source affordance 1024 and, in response, displays a user interface that includes payment accounts (e.g., card 1, card 3, and/or card 4) that are available via the wallet application to complete the auto reload. In some embodiments, in response to detecting input 1050h2 directed at transfer source affordance 1024, device 900 initiates a process to modify a payment account that is used to complete the auto reload.

At FIG. 10I, in response to detecting input 1050b2 of FIG. 10B to set up a pre-paid account, device 900 displays initial transfer interface 1004i. In some embodiments, initial transfer interface 1004i allows a user to transfer initial funds to the transit card (also referred to as transit account). Device 900 detects input 1050i (e.g., a touch input, an air gesture, a mouse click, a gaze, and/or a speech input) directed at add affordance 1026 and, in response, displays the user interface of FIG. 10J.

At FIG. 10J, device 900 displays summary interface 1004j and indicator 747. In some embodiments, device 900 displays an option to add a card to the wallet application, similar to add-card notification 1009. In such embodiments, a card is not needed to set up the pre-paid account. In some embodiments, the pre-paid account can be auto-reloaded via an application different from a payment account on the wallet application (e.g., via a third-party payment application and/or an application of the service provider of the transit card). In some embodiments, device 900 detects input 1050j1 (e.g., a double-press of a button, a touch input, an air gesture, a mouse click, a gaze, and/or a speech input) to set up the transit payment account without auto-reload and, in response, displays transfer interface 1004e of FIG. 10Q. At FIG. 10J, device 900 detects input 1050j2 (e.g., a touch input, an air gesture, a mouse click, a gaze, and/or a speech input) directed at affordance 1030 to initiate a process to set up auto reload amount and/or frequency of the auto-reload.

At FIG. 10K, device 900 displays parameter interface 1004k in response to detecting input 1050j2. Parameter interface 1004k includes graphical element 1032 to select an amount that will be used to as a source of funds during an auto-reload transfer. Parameter interface 1004k includes graphical element 1034 to select a minimum threshold balance (e.g., a remaining amount of resources left on the account) that will trigger the auto-reload transfer. At FIG. 10K, device 900 detects input 1050k (e.g., a touch input, an air gesture, a mouse click, a gaze, and/or a speech input) directed at turn on affordance 1036.

At FIG. 10L, in response to detecting input 1050k, device 900 displays an updated summary interface 1004j that includes a summary of the auto-reload parameters, including transfer details 1033 (including the threshold balance of $10) and reload amount indicator 1031. In some embodiments, device 900 detects an input directed at transfer details 1033 to initiate a process to modify billing details. In some embodiments, device 900 detects an input directed at reload amount indicator 1031 to display parameter interface 1004k of FIG. 10K. At FIG. 10L, device 900 detects input 1050l (e.g., a button press, a touch input, an air gesture, a mouse click, a gaze, and/or a speech input).

At FIG. 10M, in response to detecting input 1050l, device 900 displays transfer interface 1004e. Transfer interface 1004e of FIG. 10M includes deposit transfer 1040 and train transfer 1042 in transfer section 1017. Deposit transfer 1040 is an initial deposit that was configured at initial transfer interface 1004i of FIG. 10I. Train transfer 1042 is a transfer of funds made for a train ticket using the transit card via device 900. Transfer interface 1004e of FIG. 10M includes balance details 1012 that accounts for the currently available funds. Based on deposit transfer 1040 and train transfer 1042, balance details 1012 indicates that $9 in funds are available. Auto-reload is active for the transit card, as indicated by auto-reload indicator 1038. In some embodiments, when auto-reload is active and that the balance drops below the threshold balance of $10, an auto-reload transfer is automatically initiated to fund the transit card. In some embodiments, device 900 detects that auto-reload is active and that the balance is below the threshold balance of $10. In response, device 900 automatically initiates an auto-reload transfer.

At FIG. 10N, device 900 displays an updated transfer interface 1004e that includes auto-reload transfer 1044. Auto-reload transfer 1044 is distinguished from deposit transfer 1040 (e.g., an initial deposit or other non-auto reload deposits) using auto-reload indicator 1019. Transfer interface 1004e of FIG. 10N also includes updated balance details 1012 of $59 that indicates the amount of available funds for the transit account. In some embodiments, device 900 detects a set of one or more inputs (e.g., a touch input, an air gesture, a mouse click, a gaze, and/or a speech input) including input 1050n1 directed at menu affordance 702. In some embodiments, device 900 detects input 1050n2 (e.g., a touch input, an air gesture, a mouse click, a gaze, and/or a speech input) directed at add money affordance 1048.

At FIG. 10O, in response to detecting the set of one or more inputs including input 1050n1 and/or in response to detecting input 1050n2, device 900 displays account details interface 1004h that has a different state from 1004h of FIG. 10H based on the transit card being set up as first account type (e.g., a pre-paid account) as opposed to a second account type (e.g., a post-paid account). Account details interface 1004h includes balance affordance 1046 indicating a remaining balance of funds. In some embodiments, device 900 detects input 1050o1 (e.g., a touch input, an air gesture, a mouse click, a gaze, and/or a speech input) directed at balance affordance 1046 and, in response, initiates a process to make a deposit to the transit card, where initiating the process to make a deposit includes displaying a user interface similar to initial transfer interface 1004i. At FIG. 10O, device 900 detects input 1050o2 (e.g., a touch input, an air gesture, a mouse click, a gaze, and/or a speech input) directed at auto-reload affordance 1049.

At FIG. 10P, in response to detecting input 1050o2, device 900 displays reload edit interface 1004p. In some embodiments, reload edit interface 1004p includes options to edit an existing auto-reload and/or set-up a new auto reload transfer. As discussed in greater detail with respect to FIGS. 13A-13J, reload edit interface 1004p optionally includes options to edit or set-up a new auto reload transfer using the wallet application and/or an application different from the wallet application (e.g., a transit application and/or a payment application). At FIG. 10P, modify reload edit interface 1004p includes reload amount affordance 1054, minimum balance affordance 1056, payment method affordance 1058, and cancel auto-reload affordance 1060. In some embodiments, device 900 detects input 1050p1 (e.g., a touch input, an air gesture, a mouse click, a gaze, and/or a speech input) directed at reload amount affordance 1054 and, in response, initiates a process to modify a reload amount (e.g., where the process includes displaying graphical element 1032 of FIG. 10K to adjust the reload amount). In some embodiments, device 900 detects input 1050p2 (e.g., a touch input, an air gesture, a mouse click, a gaze, and/or a speech input) directed at minimum balance affordance 1056 and, in response, initiates a process to modify a minimum threshold balance (e.g., where the process includes displaying graphical element 1034 of FIG. 10K to adjust the minimum balance threshold). In some embodiments, device 900 detects input 1050p3 (e.g., a touch input, an air gesture, a mouse click, a gaze, and/or a speech input) directed at payment method affordance 1058 and, in response, initiates a process to modify a payment account (e.g., of the wallet application) that is used to transfer funds during the auto-reload process. In some embodiments, device 900 detects a set of one or more inputs including 1050p4 (e.g., a touch input, an air gesture, a mouse click, a gaze, and/or a speech input) directed at cancel auto-reload affordance 1050p4 and, in response to detecting the set of one or more input in response, cancels the auto-reload process. In some embodiments, cancelling the auto-reload includes receiving an additional user input confirming the cancellation.

At FIG. 10Q, in response to (and/or subsequent to) detecting input 1050j1 of FIG. 10J to set up the transit payment account without activating auto-reload, device 900 displays transfer interface 1004e that includes an auto-reload set-up notification reminding the user can set up auto-reload. As depicted in FIG. 10Q, balance details 1012 indicates $20 of funds are available without setting up auto-reload. This is in contrast to setting up the transit card as a post-paid account that uses auto-reload. At FIG. 10Q, balance details 1012 does not include auto-reload indicator 1038 because auto-reload is not active. In some embodiments, device 900 detects input 1050q directed at set up affordances 1052 and, in response, displays account details interface 1004h with an affordance that initiates a process to set up auto-reload via the wallet application, as described in greater detail with respect to FIGS. 13A-13J.

FIGS. 11A-11B are flow diagrams illustrating a method for setting up different types of resource transfer accounts using a computer system in accordance with some embodiments. Method 1100 is performed at a computer system (e.g., 100, 300, 500, 600, 700, 900, and/or 1500) (e.g., a smartphone, a smartwatch, a tablet computer, a laptop computer, a desktop computer, and/or a head mounted device (e.g., a head mounted augmented reality and/or extended reality device)) that is in communication with a display generation component (e.g., 601, 701, 801, and/or 1501) (e.g., a display controller, a touch-sensitive display system, a monitor, and/or a head mounted display system) and one or more input devices (e.g., 601, 701, 801, and/or 1501) (e.g., a touch-sensitive surface, a keyboard, a controller, a motion sensor, and/or a mouse). Some operations in method 1100 are, optionally, combined, the orders of some operations are, optionally, changed, and some operations are, optionally, omitted.

As described below, method 1100 provides an intuitive way for setting up different types of resource transfer accounts. The method reduces the cognitive burden on a user to set up different types of resource transfer accounts, thereby creating a more efficient human-machine interface. For battery-operated computing devices, enabling a user to set up different types of resource transfer accounts faster and more efficiently conserves power and increases the time between battery charges.

The computer system detects (1102), via one or more input devices, a request (e.g., 950a, 1050a) to add an account (e.g., computer memory account of FIGS. 9A-9J and/or the transit account of FIGS. 10A-10Q)(e.g., transit account, payment account, and/or loyalty account) corresponding to a service provider (e.g., computer memory service provider and/or a transit service provider) (e.g., a transit service provider, a payment service provider, and/or a loyalty service provider). In some embodiments, the request includes a request to provision the account on an electronic wallet of the computer system (e.g., the electronic wallet includes credentials for one or multiple accounts). In some embodiments, the electronic wallet includes credentials for one or more accounts (e.g., a loyalty account, a payment account, a transit account, an electronic credit card, and/or an electronic ticket) different from the account). In response to detecting the request to add the account, the computer system displays (1104) (e.g., concurrently), via the display generation component, a first selectable interface object (1106) (e.g., 906 and/or 1006) (e.g., affordance and/or button) that, when selected, initiates a process to enable the account to participate in a first type of automatic (and, optionally, recurring) resource transfer (e.g., the type of automatic resource transfer described with respect to FIGS. 9F-9J and FIGS. 10I-10Q) (e.g., a pre-load automatic resource transfer, a pre-allocation automatic resource transfer, and/or a prepaid automatic resource transfer) (e.g., without enabling the account to participant in the second type of automatic resource transfer). In some embodiments, the first type of automatic resource transfer is initiated in response to detecting a first trigger. In response to detecting the request to add the account, the computer system displays (1104) (e.g., concurrently), via the display generation component, a second selectable interface object (1108) (e.g., 908 and/or 1008) (e.g., affordance and/or button) that, when selected, initiates a process to enable the account to participate in a second type of automatic (and, optionally, recurring) resource transfer (e.g., the type of automatic resource transfer described with respect to FIGS. 9C-9E and FIGS. 10B-10H) (e.g., a post-load automatic resource transfer, post-allocated, a post-paid automatic resource transfer) (e.g., without enabling the account to participant in the first type of automatic resource transfer); In some embodiments, the second type of automatic resource transfer is initiated in response to detecting a second trigger that is different from the first trigger. While displaying the first selectable interface object and the second selectable interface object, the computer system detects (1110), via the one or more input devices, an input. In response to detecting the input (1112) and in accordance with a determination that the input is directed to the first selectable interface object, the computer system initiates (1114) a first process to enable the account to participate in the first type of automatic resource transfer (e.g., generally described with respect to FIGS. 9F-9J and FIGS. 10I-10Q) (e.g., without initiating a process to enable the account to participant in the second type of automatic resource transfer). The first process includes display (1116), via the display generation component, of a representation of a source for the first type of automatic resource transfer (e.g., 911 and/or 1011). The first process includes display (1118), via the display generation component, of a second user interface object for configuring an amount (e.g., as described with respect to and depicted in FIGS. 9F-9H and 10J-10L) (e.g., an amount of allocated memory, an amount of data, a balance, and/or funds) for an automatic resource transfer (e.g., of the first type). In response to detecting the input (1112) and in accordance with a determination that the input is directed to the second selectable interface object, the computer system initiates (1120) a second process to enable the account to participate in the second type of automatic resource transfer (e.g., generally described with respect to FIGS. 9C-9E and FIGS. 10B-10H) (e.g., without initiating a process to enable the account to participant in the first type of automatic resource transfer). The second process includes displaying (1122), via the display generation component, a representation of a source (e.g., 911 and/or 1011) of the second type of automatic resource transfer without displaying a third user interface object for configuring an amount for an automatic (and, optionally, recurring) resource transfer (e.g., 930 and/or 1030 is not included in FIGS. 9C and 10D) (e.g., of the second type). In some embodiments, a user configures an amount of automatic transfers for the first type of automatic resource transfer. In some embodiments, a user is not able to configure an amount of automatic transfers for the second type of automatic resource transfer. In some embodiments, the second type of automatic resource transfer includes designating (e.g., allocating and/or providing) a set of resources to the first account before the set of resources are used. In some embodiments, an amount of the second type of automatic resource transfer is based on an amount of resources that was used from the set of resources that were designated to the first account. Conditionally displaying a representation of a source for a first or second type of automatic resource transfer with a user interface object for configuring an amount for the automatic resource transfer depending on whether an input is directed at the first selectable interface object or second selectable object performs an operation when a set of conditions has been met without requiring further user input, declutters the user interface, provides visual feedback as the state of (e.g., nature of) the account and/or recurring resource transfer, and improves how resource transfers are managed.

In some embodiments, the first type of automatic resource transfer is a transfer of memory (e.g., a memory allocation), and wherein the second type of automatic resource transfer is a transfer of memory (e.g., as described with respect to FIGS. 9A-9J) (e.g., memory is allocated from a first account or computer system to a different account or computer system). In some embodiments, allocating memory includes making memory available to the computer system. In some embodiments, a transfer of memory includes an allocation of computer memory (e.g., primary memory (e.g., random access memory (RAM) and/or read-only memory (ROM)) and/or secondary memory (e.g., cloud storage, hard disk drive, solid-state drive, and/or optical drive)). Using a first type of automatic resource transfer and a second type of automatic resource transfer to transfer memory improves how computer memory is managed and reduces user input to manually transfer memory.

In some embodiments, the first type of automatic resource transfer is a transfer of funds (e.g., funds are transferred from one account or application to a different account or application), and wherein the second type of automatic resource transfer is a transfer of funds (e.g., as described with respect to FIGS. 10A-10Q). In some embodiments, a transfer of funds includes an allocation of money to and/or from an account provisioned on a wallet of the computer system. Using a first type of automatic resource transfer and a second type of automatic resource transfer to transfer funds improves how funds are managed and reduces user input to manually transfer funds.

In some embodiments, the computer system detects, via the one or more input devices, an input (e.g., 950b2 and/or 1050b2) (e.g., a tap input) directed at the first selectable interface object. In response to the input directed at the first selectable interface object, the computer system initiates the first process to enable the account to participate in the first type of automatic resource transfer. After the account is enabled to participate in the first type of automatic resource transfer, the computer system detects an input to initiate a resource transfer of a first amount (e.g., an input to initiate a resource transfer associated with 942 of FIG. 9I and/or an input to initiate a resource transfer associated with 1042 of FIG. 10N). In response to detecting the input to initiate the resource transfer of the first amount the computer system initiates the resource transfer of the first amount (e.g., initiate a resource transfer associated with 942 of FIG. 9I and/or initiate a resource transfer associated with 1042 of FIG. 10N). In response to detecting the input to initiate the resource transfer of the first amount and in accordance with a determination that initiating the resource transfer of the first amount results in a remaining amount of available resources (e.g., a remaining amount of resources in the account that are available for transfer and/or funds remaining in the account) (e.g., a remaining amount of memory and/or remaining balance of funds) that meets or exceeds (e.g., is below and/or above) a first threshold (e.g., 912 of FIG. 9I indicates balance of 9 GB, which is below the threshold of 10 GB; and/or 1012 of FIG. 10M indicates balance of $8, which is below the threshold of $10) (e.g., a threshold amount of remaining resources) (e.g., a remaining amount of 10 MB, 20 MB, $10, or $20) (e.g., a remaining balance), the computer system initiates an automatic resource transfer of the first type (e.g., initiating an automatic resource transfer associated with the resource transfer representations of 944 and/or 1044) (e.g., an automatic resource transfer is triggered). In some embodiments, initiating the automatic resource transfer of the first type includes initiating a resource transfer from an external account (e.g., a different payment account on the wallet application, a third-party payment application, a bank account) to the account). In some embodiments, the first set of criteria includes a criterion is satisfied when a remaining amount of available resources meets or exceeds (e.g. is below) a threshold amount. In response to detecting the input to initiate the resource transfer of the first amount and in accordance with a determination that initiating the resource transfer of the first amount does not result in a remaining amount of available resources (e.g., a remaining amount of resources in the account that are available for transfer and/or funds remaining in the account) that meets or exceeds the first threshold, the computer system forgoes initiation of the automatic resource transfer of the first type (e.g., in instances where 912 of FIG. 9I indicates that a balance is greater than 10 GB, no automatic resource transfer would have been triggered; and/or in instances where 1012 of FIG. 10M indicates that a balance is more than $10, no automatic resource transfer would have been triggered) (e.g., an automatic resource transfer is not triggered). In some embodiments, the first set of criteria is configurable by a user of the computer system. Conditionally initiating the automatic resource transfer of the first type based on whether a resource transfer of a first amount results in a remaining amount of available resources meets or exceeds a first threshold performs an operation when a set of conditions has been met without requiring further user input and improves how or when automatic resource transfers are initiated.

In some embodiments, the first process includes displaying, via the display generation component, a fourth user interface object (e.g., 934 and/or 1034) for configuring the first threshold (e.g., a threshold for a remaining amount of resources to trigger an automatic resource transfer of the first type). Displaying a fourth user interface object for configuring the first threshold improves how automatic resource transfers are triggered and improves how resource transfers are managed.

In some embodiments, after the account is enabled to participate in the first type of automatic resource transfer and prior to initiating the resource transfer of the first amount, the computer system displays, via the display generation component, a representation of a remaining amount of available resources (e.g., 912 of FIG. 9I indicates balance of 9 GB; and/or 1012 of FIG. 10M indicates balance of $9) (e.g., a remaining amount of resources in the account that are available for transfer and/or funds remaining in the account) (e.g., a balance before initiating the resource transfer of the first amount). After initiating the resource transfer of the resource transfer of the first amount, the computer system updates the representation of the remaining amount of available resources (e.g., 912 of FIG. 9J indicates balance of 59 GB; and/or 1012 of FIG. 10N indicates balance of $59) (e.g., based on the resource transfer of the first amount and/or further based on an amount that was transferred in automatic resource transfer of the first type if the threshold is met or exceeded) (e.g., as described in greater detail with respect to FIGS. 12A-12D and 13A-13J). Updating the representation of the remaining amount of available resources after the resource transfer of the first amount is transferred provides visual feedback as to the state of the account and improves how resource transfers are managed.

In some embodiments, after the account is enabled to participate in the second type of automatic resource transfer, the computer system detects an input (e.g., a tap input, an air gesture, a tap-and-hold input) to initiate a resource transfer of a second amount (e.g., an input to initiate a resource transfer associated with 916 of FIG. 9E and/or an input to initiate a resource transfer associated with 1016 of FIG. 10F). In response to detecting the input to initiate the resource transfer of the second amount, the computer system initiates the resource transfer of the second amount (e.g., initiating the resource transfer associated with 916 of FIG. 9E and/or initiating the resource transfer associated with 1016 of FIG. 10F). Subsequent to initiating the resource transfer of the second amount and in accordance with a determination that a set of criteria is satisfied, wherein the set of criteria includes a criterion that is satisfied when a current date and/or current time corresponds to a respective date and/or a respective time (e.g., as described with respect to FIG. 9E and FIG. 10G) (e.g., a defined date and/or defined time, and/or a date and/or time that is not user configurable), the computer system initiates (e.g., approving and/or facilitating) an automatic resource transfer of the second type (e.g., as described with respect to FIG. 9E and FIG. 10G) (e.g., an automatic resource transfer is triggered). In some embodiments, the set criteria is satisfied independent of a remaining amount of available resources meeting or exceeding the first threshold. Subsequent to initiating the resource transfer of the second amount and in accordance with a determination that that the set of criteria is not satisfied, forgoing initiation of the automatic resource transfer of the second type (e.g., as described with respect to FIG. 9E and FIG. 10G) (e.g., an automatic resource transfer is not triggered). In some embodiments, the second set of criteria is not configurable by a user of the computer system. Conditionally initiating the automatic resource transfer of the second type based on whether a set of criteria that includes a criterion that is satisfied when a current date or current time corresponds to a respective date and/or respective time performs an operation when a set of conditions has been met without requiring further user input and improves how or when automatic resource transfers are initiated.

In some embodiments, initiating the automatic resource transfer of the second type includes initiating an amount of resources that corresponds to an amount of resources used (e.g., transferred from the account and/or allocated from an available amount of resources in the account) during a respective time interval (e.g., as described with respect to FIG. 9E and FIG. 10G) (e.g., in the last week, in the last calendar day, in the last 24 hours). In some embodiments, the respective time interval is not configurable by a user of the computer system. Initiating an amount of resources that corresponds to an amount of resources used during a respective time interval when the automatic resource transfer of the second type is initiated reduces the number of inputs to manually adjust an amount that is transferred, improves how automatic resource transfers are triggered, and improves how resource transfers are managed.

In some embodiments, after the account is enabled to participate in the second type of automatic resource transfer and prior to initiating the resource transfer of the second amount, the computer system displays, via the display generation component, a representation of a remaining amount of available resources that are available during the respective time interval (e.g., as described with respect to FIG. 9E and FIG. 10G). After initiating the resource transfer of the second amount, the computer system updates display of the representation of the remaining amount of available resources (e.g., as described with respect to and depicted in FIG. 9E and FIG. 10G) (e.g., based on the resource transfer of the second amount and/or based on an amount that was transferred in automatic resource transfer of the second type if the set of criteria is satisfied) (e.g., as described in greater detail with respect to FIGS. 12A-12D, 13A-13J, and/or FIG. 14). Updating the representation of the remaining amount of available resources after the resource transfer of the second amount is transferred provides visual feedback as to the state of the account and improves how resource transfers are managed.

In some embodiments, an initial amount of available resources in the account (e.g., an amount of resources available after the account is enabled to participate in the second type of automatic resource transfer and before any resource transfers are made (e.g., to or from the account)) is predefined (e.g., as described with respect to FIG. 10E) (e.g., pre-determined and/or is not configurable by the computer system and/or user) (e.g., by a service provider and/or merchant). Predefining an initial amount of available resources in the account reduces user input and improves how resource transfers are managed.

In some embodiments, the second process includes: in accordance with a determination that a source (e.g., an account and/or an account provisioned on an electronic wallet) of an automatic resource transfer is not accessible (e.g., as described with respect to and depicted in FIG. 10C) (e.g., the computer system cannot access and/or use the resources stored in association with the resource source), the computer system displays, via the display generation component, a third selectable interface object (e.g., 1010) that, when selected, initiates a process to add a source (e.g., gain access to a resource source and/or provision an account to an electronic wallet). In some embodiments, the second process includes: in accordance with a determination that a source of an automatic resource transfer is accessible, forgoing display of the third selectable interface object (e.g., as described with respect to and depicted in FIG. 10C; and/or 1010 is not displayed if the wallet application is provisioned with a payment account). Conditionally displaying a third selectable interface object that, when selected, initiates a process to add a source based on whether a source of an automatic transfer is accessible performs an operation when a set of conditions has been met without requiring further user input and improves a process for enabling an account to participate in automatic resource transfers.

In some embodiments, initiating the first process includes displaying an indication for user authentication (e.g., biometric authentication and/or a user ID and password) to enable the source for the first type of automatic resource transfer (e.g., as described with respect to FIG. 10D). In some embodiments, initiating the second process includes displaying an indication for user authentication (e.g., biometric authentication and/or a user ID and password) to enable the source for the second type of automatic resource transfer. Displaying an indication for a user authentication to enable the source for the first type of automatic resource transfer (or second type of automatic resource transfer) improves a security of the computer system and the security of the source.

In some embodiments, after enabling a first source for the first type of automatic resource transfer (and/or the second type of automatic resource transfer), the computer system detects a request to change the first source to a second source different from the first source and, in response, displays an indication for user authentication (e.g., biometric authentication and/or a user ID and password) to enable the second source for the first type of automatic resource transfer (and/or the second type of automatic resource transfer) (e.g., as described with respect to FIG. 10D). Displaying an indication of a user authentication) to change from a first source to a second source for the first type of automatic resource transfer (or second type of automatic resource transfer) improves a security of the computer system and the security of the source.

Note that details of the processes described above with respect to method 1100 (e.g., FIGS. 11A-11B) are also applicable in an analogous manner to the methods described below. For example, methods 800, 1400, 1600, 1800, 2100, 2400, and/or 2600 optionally include one or more of the characteristics of the various methods described above with reference to method 800. For example, methods 800, 1100, 1400, 1800, 2100, 2400, and/or 2600 include features to setting up different types of resource transfer accounts and/or auto-reload parameters described with respect to method 1100. For brevity, these details are not repeated herein.

FIGS. 12A-12D illustrate exemplary user interfaces for different applications authorizing auto-reload transfers for allocation of computer memory, in accordance with some embodiments. The user interfaces in these figures are used to illustrate the processes described below, including the processes in FIG. 14.

At FIG. 12A, device 900 displays account details interface 1004h for a computer memory account associated with account representation 1202 of a memory manager application. Account details interface 1004h includes auto-reload indicator 1312 that indicates auto-reload is on (e.g., computer memory will automatically be transferred to (allocated to) the computer memory account when available computer memory of the computer memory account falls to or below a threshold balance). Account details interface 1004h further includes balance indication 1310 and add memory affordance 1211. In some embodiments, device 900 detects input 1250a1 (e.g., a touch input, an air gesture, a mouse click, a gaze, and/or a speech input) directed at add memory affordance 1211 and, in response, initiates a process to deposit (e.g., allocate and/or add) memory (e.g., manually) into the computer memory account. Device 900 detects input 1250b2 (e.g., a touch input, an air gesture, a mouse click, a gaze, and/or a speech input) directed to affordance 1313.

At FIG. 12B, in response to detecting input 1250b2, device 900 displays auto-reload options interface 1314. In some embodiments, auto-reload options interface 1314 allows a user to modify and/or set up an auto-reload operation via different applications. For example, auto-reload options interface 1314 includes auto-reload options 1216 for an external memory allocation application (e.g., a third-party memory allocation application and/or an application different from the memory manager application) and auto-reload options 1218 for the memory manager application. At FIG. 12B, auto-reload is active (e.g., enabled) such that allocation of resources are automatically transferred to the computer memory account in response to detecting that a threshold balance has been met. Additionally, auto-reload is currently authorized via the external memory allocation application. Accordingly, auto-reload options interface 1314 includes modify affordance 1222 (e.g., to modify the auto-reload via the external memory allocation application) and set-up affordance 1224 (e.g., to set up auto-reload via the memory manager application). As described herein, auto-reload options interface 1314 changes based what application is authorizing the auto-reload.

At FIG. 12B, device 900 detects input 1250b1 (e.g., a touch input, an air gesture, a mouse click, a gaze, and/or a speech input) directed at modify affordance 1222. In some embodiments, in response to detecting input 1250b1, device 900 initiates a process to modify the auto-reload operation via the external memory allocation application. In such embodiments, the process to modify the auto-reload operation via the external memory allocation application includes displaying an interface of the external memory allocation application that provides affordances for adjusting different parameters of the auto-reload (e.g., a reload amount, minimum balance, payment method, and/or cancelling auto-reload, as described in greater detail with respect to FIG. 13D). Device 900 detects input 1250b2 (e.g., a touch input, an air gesture, a mouse click, a gaze, and/or a speech input) directed at set-up affordance 1224.

At FIG. 12C, device 900 detects that an auto-reload has been authorized via the memory manager application (e.g., auto-reload has been enabled via the memory manager application application). Device 900 displays account details interface 1004h with auto-reload indicator 1312 that indicates auto-reload is on. In some embodiments, device 900 changes account details interface 1004h in response to detecting that the auto-reload is authorized via the memory manager application (e.g., as opposed to the external memory allocation application). For example, account details interface 1004h includes additional auto-reload information 1336 (e.g., indicating the threshold amount that triggers the auto-reload transfer). In some embodiments, device 900 does not change account details interface 1004h. In some embodiments, in response to detecting that the auto-reload has been authorized via the memory manager application, device 900 automatically disables the auto-reload operation authorized by external memory allocation application. Device 900 detects input 1250c (e.g., a touch input, an air gesture, a mouse click, a gaze, and/or a speech input) directed at affordance 1313.

At FIG. 12D, in response to detecting input 1250c, device 900 displays auto-reload options interface 1314 that is updated based on the auto-reload being authorized via the memory manager application (e.g., as opposed to auto-reload options interface 1314 of FIG. 12B that is based on the auto-reload being authorized via the external memory allocation application). For example, auto-reload options 1218 for the memory manager application are displayed without displaying auto-reload options for the external memory allocation application (e.g., auto-reload options 1216 of FIG. 12B) for the external memory allocation application. At FIG. 12D, auto-reload options 1218 for the memory manager application include modify auto-reload affordance 1238. Device 900 detects input 1250d (e.g., a touch input, an air gesture, a mouse click, a gaze, and/or a speech input) directed at modify auto-reload affordance 1238. In some embodiments, in response to detecting input 1250d, device 900 displays an auto-reload parameters interface to modify various parameters for transferring computer memory, similar to auto-reload parameters interface 1333 of FIG. 13D, but for allocating memory. In some embodiments, in response to detecting input 1250d, device 900 initiates a process to modify the auto-reload that is authorized via the memory manager application. In such embodiments, initiating the process to modify the auto-reload that is authorized via the memory manager optionally includes displaying a reload amount affordance (e.g., similar to reload amount affordance 1326), a minimum balance affordance (similar to minimum balance affordance 1328), computer memory source affordance (similar to payment method affordance 1330), and/or an affordance to cancel an auto-reload (similar to affordance 1332).

FIGS. 13A-13J illustrate exemplary user interfaces for different applications authorizing auto-reload transfers for funds, in accordance with some embodiments. The user interfaces in these figures are used to illustrate the processes described below, including the processes in FIG. 14.

At FIG. 13A, device 900 displays transfer interface 1004e for a transit account associated with account representation 1302. The transit account is provisioned on a wallet application having a plurality of accounts (e.g., various payment accounts, loyalty accounts, and/or identification accounts). In some embodiments, the transit account enables device 900 to initiate a transfer of funds using the transit account to pay a transit service provider. In some embodiments, the transit account is a convenience payment account and/or bank payment account used to pay a different service provider, such as a retailer. Transfer interface 1004e includes auto-reload indicator 1304 in balance details area 1305 (e.g., where balance details area 1305 indicates a remaining amount of resources (e.g., funds) that are available for transfer using the transit account). In some embodiments, auto-reload indicator 1304 indicates that an auto-reload operation is enabled (e.g., funds will be transfer to the transit account from a different account on the wallet application and/or an account from an application different from the wallet application (e.g., a 3rd party payment application)).

At FIG. 13A, device 900 displays several representations of deposits to the transit account in transfer section 1017 (e.g., as well as a payment made using the transit account). For example, auto-reload resource transfer 1306 indicates that $50 was automatically transferred to the transit account. As described herein (e.g., with respect to FIGS. 10A-10B and 13D), in some embodiments, a user can configure various parameters for an auto-reload transfer, including a transfer amount (e.g., $50) and/or a minimum balance (e.g., $5). Transfer section 1017 also includes resource transfer 1307 that indicates $10 was deposited to the transit account without using the auto-reload function (e.g., the user manually deposited funds via an input directed to add money affordance 1311 of FIG. 13B). At FIG. 13A, in some embodiments, device 900 detects input 1350a1 (e.g., a touch input, an air gesture, a mouse click, a gaze, and/or a speech input) directed at affordance 1308. In some embodiments, device 900 detects a set of inputs including input 1350a2 (e.g., a touch input, an air gesture, a mouse click, a gaze, and/or a speech input) directed at menu affordance 702.

At FIG. 13B, in response to detecting input 1350a1 (and/or the set of inputs including input 1350a2), device 900 displays account details interface 1004h for the transit account. Account details interface 1004h includes auto-reload indicator 1312 that indicates auto-reload is on. Account details interface 1004h further includes balance indication 1310 and add money affordance 1311. In some embodiments, device 900 detects input 1350b1 (e.g., a touch input, an air gesture, a mouse click, a gaze, and/or a speech input) directed at add money affordance 1311 and, in response, initiates a process for a user to deposit funds (e.g., manually) into the transfer account. In some embodiments, funds that are manually deposited are displayed without an auto-transfer indicator (e.g., resource transfer 1307 is displayed without auto-transfer indicator 1303 in FIG. 13A). Device 900 detects input 1350b2 (e.g., a touch input, an air gesture, a mouse click, a gaze, and/or a speech input) directed to affordance 1313.

At FIG. 13C, in response to detecting input 1350b2, device 900 displays auto-reload options interface 1314. In some embodiments, auto-reload options interface 1314 allows a user to modify or set up an auto-reload operation via different applications. For example, auto-reload options interface 1314 includes auto-reload options 1316 for a transit application (e.g., a 3rd party application, an external payment application, and/or an application different from the wallet application) and auto-reload options 1318 for the wallet application. At FIG. 13C, auto-reload is active (e.g., as described with respect to FIG. 13A). Additionally, auto-reload is currently authorized via the transit application (e.g., enabled using the transit application). Accordingly, auto-reload options interface 1314 includes modify affordance 1322 (e.g., to modify the auto-reload via the transit application) and set-up affordance 1324 (e.g., to set up auto-reload via the wallet application). As described herein, auto-reload options interface 1314 changes based what application was used to authorize the auto-reload. In some embodiments, auto-reload options 1316 and auto-reload options 1318 are displayed as part of a portion of account details interface 1004h. In some embodiments, auto-reload options 1316 and/or auto-reload options 1318 are initially hidden. In such embodiments, in response to detecting an input directed to affordance 1313, device 900 displays, as part of account details interface 1004h at FIG. 12B, auto-reload options 1316 and/or auto-reload options 1318 (e.g., based on what application has authorized the auto-reload, as described herein).

At FIG. 13C, device 900 detects input 1350c1 (e.g., a touch input, an air gesture, a mouse click, a gaze, and/or a speech input) directed at modify affordance 1322. In some embodiments, in response to detecting input 1350c1, device 900 initiates a process to modify the auto-reload operation via the transit application (and not the wallet application). In such embodiments, the process to modify the auto-reload operation via the transit application includes displaying an interface of the transit application that optionally provides affordances for adjusting different parameters of the auto-reload (e.g., a reload amount, minimum balance, payment method, and/or cancelling auto-reload, as described in greater detail with respect to FIG. 13D). Device 900 detects input 1350c2 (e.g., a touch input, an air gesture, a mouse click, a gaze, and/or a speech input) directed at set-up affordance 1324.

At FIG. 13D, in response to detecting input 1350c2 (and/or a set of inputs that include input 1350c2), device 900 displays auto-reload parameters interface 1333 of the wallet application (and not the transit application). In some embodiments, auto-reload parameters include a reload amount (e.g., how many resources will be transferred for each auto-reload transfer), a minimum balance (e.g., threshold balance that will trigger the auto-reload transfer), and/or a payment method (e.g., what account will be used as a source of the funds for the auto-reload transfer). In some embodiments, the account for the payment method is a different account that is provisioned on the wallet application. Auto-reload parameters interface 1333 also includes an option to cancel the auto-reload (e.g., affordance 1332). In some embodiments, affordance 1332 is not displayed in auto-reload parameters interface 1333 during an initial set up process. Accordingly, in some embodiments, affordance 1332 is not displayed at FIG. 13D, which occurs during a set up process of the auto-reload operation using the wallet application.

At FIG. 13D, device 900 detects various inputs directed at auto-reload parameters interface 1333 to initiate a process to modify different parameters of the auto-reload operation. For example, device 900 detects input 1350d1 (e.g., a touch input, an air gesture, a mouse click, a gaze, and/or a speech input) directed at reload amount affordance 1326. In some embodiments, in response to detecting input 1350d1, device 900 displays one or more graphical objects (or, optionally, user interfaces) to set the reload amount (e.g., so as to set the amount of funds that will be transferred to the transit account). Device 900 detects input 1350d2 (e.g., a touch input, an air gesture, a mouse click, a gaze, and/or a speech input) directed at minimum balance affordance 1328. In some embodiments, in response to detecting input 1350d2, device 900 displays one or more graphical objects (or, optionally, user interfaces) to set the minimum balance (e.g., so as to set the minimum balance of funds in the transit account that will trigger the auto-reload transfer). Device 900 detects input 1350d3 (e.g., a touch input, an air gesture, a mouse click, a gaze, and/or a speech input) directed at payment method affordance 1330. In some embodiments, in response to detecting input 1350d3, device 900 displays one or more graphical objects (or, optionally, user interfaces) to set a payment source for the funds that will be transferred to the transit account. Device 900 detects input 1350d4 (e.g., a touch input, an air gesture, a mouse click, a gaze, and/or a speech input) directed at cancel affordance 1332. In some embodiments, in response to detecting input 1350d4, device 900 displays one or more graphical objects (or, optionally, user interfaces) to revoke an authorization for the auto-reload operation. After one or more of the auto-reload parameters are set, device 900 detects a set of one or more inputs including input 1350d5 (e.g., a touch input, an air gesture, a mouse click, a gaze, and/or a speech input) directed at start affordance 1334 to authorize an auto-reload using the wallet application.

At FIG. 13E, device 900 detects that an auto-reload has been authorized via the wallet application (e.g., auto-reload has been enabled via the wallet application). Device 900 displays account details interface 1004h with auto-reload indicator 1312 that indicates auto-reload is on. In some embodiments, device 900 changes account details interface 1004h in response to detecting that the auto-reload is authorized via the wallet application. For example, account details interface 1004h includes additional auto-reload information 1336 (e.g., indicating the threshold amount that triggers the auto-reload transfer). In some embodiments, device 900 does not change account details interface 1004h. In some embodiments, in response to detecting that the auto-reload has been authorized via the wallet application (e.g., at FIG. 13D), device 900 automatically disables the auto-reload operation authorized by the transit application (e.g., such that the wallet application takes over the auto-reload operation (e.g., using a payment account of the wallet application)). Device 900 detects input 1350e (e.g., a touch input, an air gesture, a mouse click, a gaze, and/or a speech input) directed at affordance 1313.

At FIG. 13F, in response to detecting input 1350e, device 900 displays auto-reload options interface 1314 that is updated based on the auto-reload being authorized via the wallet application (e.g., as opposed to auto-reload options interface 1314 of FIG. 13C that is based on the auto-reload being authorized via the transit application). For example, auto-reload options 1318 for the wallet application are displayed without displaying auto-reload options for the transit application (e.g., auto-reload options 1316 of FIG. 13C). At FIG. 13C, auto-reload options 1318 for the wallet application includes modify auto-reload affordance 1338. Device 900 detects input 1350f (e.g., a touch input, an air gesture, a mouse click, a gaze, and/or a speech input) directed at modify auto-reload affordance 1338. In some embodiments, in response to detecting input 1350f, device 900 displays auto-reload parameters interface 1333 of FIG. 13D. In some embodiments, in response to detecting input 1350f, device 900 initiates a process to modify the auto-reload operation that is authorized via the wallet application. In such embodiments, initiating the process to modify the auto-reload operation that is authorized via the wallet application optionally includes displaying reload amount affordance 1326, minimum balance affordance 1328, payment method affordance 1330, and/or affordance 1332 (e.g., as shown in FIG. 13D). In some embodiments, at FIG. 13F, device 900 detects user inputs that deauthorize the auto-reload via the wallet app (e.g., a tap input on 1338 of FIG. 13F, followed by a tap input on 1332 of FIG. 13D).

At FIG. 13G, device 900 detects that an auto-reload operation is disabled (e.g., in response to one or more user inputs, as described above; and/or no auto-reload operations are authorized to transfer funds to the transit account). For example, neither the wallet application nor the transit application are configured for and/or initiating the auto-reload. In some embodiments, auto-reload is disabled in response to an input to cancel the auto-reload, similar to input 1350d2 directed at affordance 1332 of FIG. 13D. In response to detecting that the auto-reload operation is disabled, device 900 updates transfer interface 1004e. For example, transfer interface 1004e of FIG. 13G includes auto-reload indicator 1312 that indicates auto-reload is off. At FIG. 13G, device 900 detects input 1350g (e.g., a touch input, an air gesture, a mouse click, a gaze, and/or a speech input) directed at affordance 1313. In some embodiments, in response to detecting input 1350g, device 900 displays an auto-reload parameters interface, similar to auto-reload parameters interface 1333 of FIG. 13D so the user can set up auto-reload using the wallet application.

At FIG. 13H, in response to detecting input 1350g, device 900 displays auto-reload options interface 1314. Auto-reload options interface 1314 of FIG. 13H is different from auto-reload options interface 1314 of FIG. 13C. For example, auto-reload options interface 1314 of FIG. 13H includes auto-reload options 1318 for the wallet application and does not include auto-reload options 1316 for the transit application. At FIG. 13H, auto-reload options 1318 for the wallet application includes set-up affordance 1324 to set up auto-reload via the wallet application. Notably, device 900 does not display an affordance to set up auto-reload via the transit application. At FIG. 13H, device 900 detects input 1350h (e.g., a touch input, an air gesture, a mouse click, a gaze, and/or a speech input) directed at set-up affordance 1324 and, in response, initiates a process for configuring auto-reload for the transit card via the wallet application. In such embodiments, device 900 optionally displays auto-reload parameters interface 1333 of FIG. 13D.

At FIG. 13I, device 900 detects that an auto-reload operation is disabled and/or not configured (e.g., no auto-reload operations are authorized to transfer funds to the transit account). In response to detecting that an auto-reload operation is disabled and/or not configured, device 900 updates transfer interface 1004e. For example, device 900 no longer displays an auto-reload indicator (e.g., auto-reload indicator 1304 of FIG. 13A).

At FIG. 13J, device 900 displays preauthorized merchant interface 1342. In some embodiments, preauthorized merchant interface 1342 is accessible via a settings menu for the wallet application. Preauthorized merchant interface 1342 includes a set of service providers that are authorized to perform an automatic transfer operation (receive payment from) for one or more accounts (e.g., the transit card) of the wallet application. In some embodiments, the automatic transfer operation includes an auto-reload operation (e.g., to transfer funds from a first respective account in the wallet application to a second respective account (e.g., the transit card) in the wallet application) and/or an auto-pay operation (e.g., transfer funds from the respective account in the wallet application and to a service provider's account). In some embodiments, preauthorized merchant interface 1342 allows the user to cancel and/or deauthorize automatic and/or recurring transfer operations without navigating to an external application.

At FIG. 13J, transit app 1344a corresponds the transit application that is performing auto-reload operations using another account that is provisioned onto device 900 via the wallet application, described at FIGS. 7A-7C. Device 900 detects input 1350j1 (e.g., a touch input, an air gesture, a mouse click, a gaze, and/or a speech input) directed at remove affordance 1346a. In some embodiments, in response to detecting input 1350j1, device 900 initiates a process to cancel (e.g., cancels) the auto-reload operation that is authorized via the transit application (e.g., using recurring payments from a second payment account to fund the transit card). Device 900 optionally detects inputs to cancel other automatic transfer operations for other service providers. For example, device 900 detects input 1350j2 (e.g., a touch input, an air gesture, a mouse click, a gaze, and/or a speech input) directed at remove affordance 1346b for streaming service provider 1344b (e.g., which corresponds to an authorization for recurring payments from a third payment account). In some embodiments, in response to detecting input 1350j2, device 900 initiates a process to cancel (e.g., cancels) an auto-payment operation for the streaming service provider. In some embodiments, cancelling the auto-payment operation for the streaming service provider includes cancelling an auto-payment for an account that is provisioned on the wallet application that is different from the transit account. Thus, preauthorized merchant interface 1342 displays indications of various (e.g., all) authorized recurring payments sourced from various payment accounts provisioned onto device 900 and/or the wallet application, thereby allowing the user of device 900 to quickly see some or all currently authorized recurring payments (from various payment accounts and to various merchants) and, if desired, cancel select (or all) recurring payment authorizations.

FIG. 14 is a flow diagram illustrating a method for different applications authorizing auto-reload resource transfers using a computer system in accordance with some embodiments. Method 1400 is performed at a computer system (e.g., 100, 300, 500, 600, 700, 900, and/or 1500) (e.g., a smartphone, a smartwatch, a tablet computer, a laptop computer, a desktop computer, and/or a head mounted device (e.g., a head mounted augmented reality and/or extended reality device)) that is in communication with a display generation component (e.g., 601, 701, 801, and/or 1501) (e.g., a display controller, a touch-sensitive display system, a monitor, and/or a head mounted display system) and one or more input devices (e.g., 601, 701, 801, and/or 1501) (e.g., a touch-sensitive surface, a keyboard, a controller, a motion sensor, and/or a mouse). Some operations in method 1400 are, optionally, combined, the orders of some operations are, optionally, changed, and some operations are, optionally, omitted.

As described below, method 1400 provides an intuitive way for different applications to authorize auto-reload resource transfers. The method reduces the cognitive burden on a user to use different applications to authorize auto-reload resource transfers, thereby creating a more efficient human-machine interface. For battery-operated computing devices, enabling a user to use different applications to authorize auto-reload resource transfers faster and more efficiently conserves power and increases the time between battery charges.

The computer system displays (1402), via the display generation component, a first user interface (e.g., 1004h of FIGS. 12A, 12C, 13B and/or 13E) of a first application (e.g., memory manager application of FIGS. 12A-12D and/or the wallet application of FIGS. 13A-13J) (e.g., a wallet application and/or a memory management application), wherein the first user interface includes a first selectable interface object (e.g., 1313) (e.g., affordance and/or button) to modify a first future scheduled resource transfer (e.g., a recurring resource transfer) (e.g., a transfer of allocated memory, a transfer data, and/or a transfer funds) for an account (e.g., transit account, payment account, loyalty account) provisioned on the first application (e.g., the computer memory account of memory manager application of FIGS. 12A-12D and/or account of the wallet application of FIGS. 13A-13J); In some embodiments, the first application (e.g., the electronic wallet) includes credentials for one or multiple accounts (e.g., transit account, payment account, loyalty account. In some embodiments, the electronic wallet includes credentials for one or more accounts (e.g., a loyalty account, a payment account, a transit account, an electronic credit card, and/or an electronic ticket) different from the account. In some embodiments, the computer system concurrently displays the first selectable interface with a representation of a state of a future scheduled resource transfer (e.g., active and/or deactivated)). In some embodiments, the first future scheduled resource transfer is scheduled to occur based on a triggering event (e.g., minimum balance and/or date/time). While displaying the first selectable interface object, the computer system detects (1404), via the one or more input devices, an input (e.g., 1250a2, 1250c, 1350b2, and/or 1350e) (e.g., touch input, air gesture, speech input, and/or mouse click) directed at the first selectable interface object. In response to detecting the input directed at the first selectable interface object, the computer system displays (1406), via the display generation component, a second user interface (e.g., 1314), different from the first user interface, of the first application. Displaying the second user interface includes: in accordance with a determination that the first future scheduled resource transfer (e.g., a transfer of allocated memory, a transfer data, and/or a transfer funds) is authorized via (e.g., enabled via, controlled via, scheduled to be transferred via, managed using a setting available via, and/or is activated via) a second application (e.g., the external memory allocation application of FIGS. 12A-12D and/or the transit app of FIGS. 13A-13J) that is different from the first application, displaying (1408) a second selectable interface object (e.g., 1322) (e.g., affordance and/or button) that, when selected, initiates a process to modify (e.g., add, edit, and/or change) the first future scheduled resource transfer via the second application (e.g., as described with respect to FIG. 12B and/or as described with respect to FIG. 13C). In some embodiments, initiating a process to modify the future scheduled resource transfer via the second application includes displaying a respective user interface of the second application. In some embodiments, the respective user interface of the second application includes one or more user interface objects to modify (or, optionally, initiate a process to modify) one or more parameters (e.g., a trigger for the future scheduled resource transfer (e.g., minimum balance and/or date), a resource amount, a resource source, and/or deactivation) for the future scheduled resource transfer. Displaying the second user interface includes: in accordance with a determination that the first future scheduled resource transfer (in some embodiments, the first future scheduled resource transfer is triggered based on an event (e.g., a minimum balance and/or a date/time)) is authorized (e.g., enabled via, controlled by, scheduled to be transferred via, managed using a setting of, and/or is activated via) via the first application (e.g., as described with respect to FIGS. 12D-12E and 13E-13F), displaying (1410), via the display generation component, a third selectable interface object (e.g., 1238 and/or 1338) without displaying the second selectable interface object, wherein the third selectable interface object, when selected, initiates a process to modify (e.g., add, edit, and/or change) the first future scheduled resource transfer via the first application (e.g., as described with respect to FIGS. 12D and 13F). In some embodiments, initiating a process to modify the first future scheduled resource transfer via the first application includes displaying a respective user interface of the first application. In some embodiments the respective user interface of the first application includes one or more user interface objects to modify (or, optionally, initiate a process to modify) one or more parameters (e.g., a trigger for the first future scheduled resource transfer (e.g., minimum balance and/or date), a resource amount, a resource source, and/or deactivation) of the first future scheduled resource transfer. Detecting an input directed at the first selectable interface object while displaying the first user interface for an account of a first application and, in response, conditionally displaying a displaying a second selectable interface object that, when selected, initiates a process to modify the first future scheduled resource transfer via the second application or displaying a third selectable interface object that, when selected, initiates a process to modify the first future scheduled resource transfer via the first application (without displaying the second selectable interface object) based on whether the first future scheduled resource is authorized via the second application or first application performs an operation when a set of conditions has been met without requiring further user input, improves how user interfaces are used to manage resource transfers, and reduces user input to initiate a process to modify a future scheduled resource.

In some embodiments, the first future scheduled resource transfer is a transfer of a first memory allocation (e.g., as described with respect to FIGS. 12A-12D) (e.g., memory is allocated from a computer system of the first user to a computer system of the second user). In some embodiments, allocating memory includes making memory available to the computer system and/or to the first account. In some embodiments, the first memory allocation and/or the respective memory allocation includes an allocation of computer memory (e.g., primary memory (e.g., random access memory (RAM) and/or read-only memory (ROM)) and/or secondary memory (e.g., cloud storage, hard disk drive, solid-state drive, and/or optical drive)). Conditionally displaying a selectable interface object that, when selected, initiates a process to modify a future scheduled resource transfer that includes a memory allocation improves how memory is managed and reduces user input to initiate a process to modify a future scheduled memory transfer.

In some embodiments, the first future scheduled resource transfer is a transfer of funds (e.g., as described with respect to FIGS. 13A-13J) (e.g., funds are transferred from one account provisioned on an electronic wallet of the computer system to a different account provisioned on the electronic wallet and/or the funds are transferred from the second application to the first application). In some embodiments, the transfer of funds includes an allocation of money to an account provisioned on a wallet of the computer system. Conditionally displaying a selectable interface object that, when selected, initiates a process to modify a future scheduled resource transfer that includes a transfer of funds improves how funds are managed and reduces user input to initiate a process to modify a future scheduled fund transfer.

In some embodiments, displaying the second user interface includes: in accordance with the determination that the first future scheduled resource transfer is authorized via the second application (e.g., as described with respect to FIGS. 12B and 13C), displaying (e.g., concurrently with the second selectable interface object), via the display generation component, an authorization interface object (e.g., 1224 and/or 1324) that, when selected, initiates a process to authorize (e.g., activate, set up, begin, and/or initiate) a second future scheduled resource transfer (e.g., having the same or different parameters as the first future scheduled resource transfer) via the first application. Conditionally displaying a set-up interface object that, when selected, initiates a process to set up a respective future scheduled resource transfer via the first application performs an operation when a set of conditions has been met without requiring further user input, improves how resource transfers are managed, and reduces user input to initiate a process to modify the future scheduled resource transfer.

In some embodiments, while the first future scheduled resource transfer is authorized via the second application, the computer system detects, via one or more input devices, an input (e.g., 1250b2, 1350c2, and/or 1350d5) to authorize a second future scheduled resource transfer via the first application. In response to detecting the input to authorize the second future scheduled resource transfer via the first application, the computer system authorizes the second future scheduled resource transfer and cancels (e.g., revokes and/or ends) authorization (e.g., automatically and/or without further user input) of the first future scheduled resource transfer (e.g., as described with respect to FIGS. 12C and 13E). In some embodiments, while the first future scheduled resource transfer is authorized via the first application, the computer system detects that a respective future scheduled resource transfer has been authorized via the second application and, in response, authorizes the respective future scheduled resource transfer and cancels (e.g., revoking and/or ending) authorization (e.g., automatically and/or without further user input) of the first future scheduled resource transfer (e.g., initiating a future scheduled resource transfer via the second application automatically cancels a future scheduled resource from the first application). Detecting an input to authorize a second future scheduled resource transfer via the first application and, in response, authorizing the second future scheduled resource transfer via the first application and revoking authorization of the first future scheduled resource automatically performs an operation without requiring further user input, improves how resource transfers are managed, and reduces user input to initiate a process to revoke the first future scheduled resource transfer.

In some embodiments, initiating a process to modify the first future scheduled resource transfer via a respective application (e.g., the first application and/or the second application) includes displaying, via the display generation component, a resource amount selectable object (e.g., 1326) that, when selected, modifies an amount of resources (e.g., an amount of memory and/or an amount of funds) transferred for the first future scheduled resource transfer (e.g., as described with respect to FIG. 13D) (e.g., as described in greater detail with respect to FIG. 10K) and/or displaying, via the display generation component, a trigger selectable interface object that, when selected, modifies a trigger (e.g., a date/time and/or a remaining balance) for the first future scheduled resource transfer (e.g., as described with respect to FIGS. 10K and 13D). Displaying a resource amount selectable object that, when selected, modifies an amount of resources transferred for the first future scheduled resource transfer and/or a trigger selectable object that, when selected, modifies a trigger for the future scheduled resource transfer improves how user interfaces are used to change future scheduled resource transfers.

In some embodiments, the trigger for the first future scheduled resource transfer is a threshold amount of available resources associated with the account (e.g., as described with respect to FIG. 10K and/or FIGS. 13D and 13F). In some embodiments, the computer system displays, via the display generation component, a first threshold amount of available resources as the trigger for the first future scheduled resource transfer (e.g., as described with respect to FIG. 10K and/or FIGS. 13D and 13F). While displaying the first threshold amount of available resources as the trigger for the first future scheduled resource transfer, the computer system detects, via the one or more input devices, an input (e.g., 1350f) corresponding to a request to modify the first threshold amount (e.g., as described with respect to FIG. 10K and/or FIGS. 13D and 13F). In response to detecting the input corresponding to the request to modify the first threshold amount, the computer system modifies the first threshold amount to a second threshold amount of available resources (e.g., as described with respect to FIG. 10K and/or FIGS. 13D and 13F) (e.g., as described in greater detail with respect to FIG. 10K). Including a threshold amount of available resources associated with the account as the trigger for the first scheduled resource transfer and modifying the first threshold amount of available resources to a second threshold amount of available resources how resource transfers are modified using a user interface.

In some embodiments, in response to detecting the input directed at the first selectable interface object, the computer system (e.g., 900) ceases display of the first user interface (e.g., 1004h is not displayed in FIGS. 12B, 12D, 13C, and/or 13D) (e.g., the second user interface is displayed without the first user interface). In some embodiments, the second user interface replaces the first user interface. In some embodiments, the second user interface replaces a portion of the first user interface (e.g., the second user interface is an unexpanded portion of the first user interface that expands in response to detecting the input directed at the first selectable interface object). Ceasing display of the first user interface in response to detecting the input directed at the first selectable interface object declutters the user interface, provides visual feedback that an input was detected, and improves how a user navigates between user interfaces to control resource transfers.

In some embodiments, the first user interface is displayed in response to detecting an input via a third user interface (e.g., 1004E of FIG. 13A) that includes a representation (e.g., 1304) that future scheduled resource transfers are authorized for the account. In some embodiments, the input on the third user interface is directed to an account details selectable object. In some embodiments, the representation that future scheduled resource transfers are authorized for the account is different from a recurring resource transfer indicator for a respective resource transfer (e.g., a graphical element that indicates that a particular resource transfer was automatically transferred based on a user's pre-authorization). In some embodiments, the computer system concurrently displays the representation that future scheduled resource transfers are authorized with a recurring resource transfer indicator for a respective recurring resource transfer. Displaying the first user interface in response to detecting an input on a third user interface that includes a representation that future scheduled resource transfers are authorized for the account provides visual feedback as to the state of (e.g., nature of) the account and improves how user interfaces are navigated so as to authorize resource transfers.

In some embodiments, the computer system (e.g., 900) displays, via the display generation component, the third user interface, including in accordance with a determination that a respective resource transfer that increases an amount of available resources (e.g., an amount of allocated memory, an amount of data, a balance, and/or funds) for the account is a future scheduled resource transfer (e.g., 1306), displaying a representation of the respective resource transfer with a preauthorization indicator (e.g., 1305) (e.g., a graphical element that indicates that the first resource transfer was automatically transferred and/or is an auto-reload resource transfer). In some embodiments, the computer system displays, via the display generation component, the third user interface, including in accordance with a determination that the respective resource transfer that increases the amount of available resources is not a future scheduled resource transfer (e.g., 1307), the computer system displays, via the display generation component, the representation of the respective resource transfer without the preauthorization indicator (e.g., as depicted in FIG. 13A). Conditionally displaying the respective resource transfer that increased the amount of available resources with or without the preauthorization indicator based on whether the respective resource transfer is a future scheduled resource transfer performs an operation when a set of conditions has been met without requiring further user input, improves how resource transfers are displayed in a user interface, provides visual feedback as to the state of (e.g., nature of) different resource transfers.

In some embodiments, displaying the third user interface includes, in accordance with a determination that the account is enabled to participate for a first type of future scheduled resource transfers (e.g., as described in FIGS. 9A-9J and/or FIGS. 10A-10Q) (and, optionally, recurring resource transfer) (e.g., a pre-load automatic resource transfer, a pre-allocation automatic resource transfer, and/or a prepaid automatic resource transfer), displaying, via the display generation component, a first representation of a first resource balance type (e.g., as depicted for the type of automatic resource transfer described with respect to and depicted in FIGS. 9F-9J and FIGS. 10I-10Q) (e.g., of an amount of resources that are available) (e.g., a resource balance that is based on an amount deposited into the account and/or an amount that is pre-loaded to the account). In some embodiments, displaying the third user interface includes, in accordance with a determination that the account is enable to participate in a second type of future scheduled resource transfers (e.g., a post-load automatic resource transfer, post-allocated, a post-paid automatic resource transfer), different from the first type of future scheduled resource transfers, displaying, via the display generation component, a second representation of a second resource balance type (e.g., of an amount of resources that are available) (e.g., a balance that is based on a line-of-credit allocated to the account and/or an amount that is post-loaded to the account) (e.g., as described in greater detail with respect to FIGS. 9A-9J, 10A-10Q, and FIGS. 11A-11B) that is different from the first resource balance type (e.g., the type of automatic resource transfer described with respect to and depicted in FIGS. 9C-9E and FIGS. 10B-10H). Conditionally including a first representation of a first resource balance type or a second representation of a second resource balance type different from the first resource balance type depending on whether the account is enabled to participate in a first type or second type of future scheduled resource transfer performs an operation when a set of conditions has been met without requiring further user input, provides visual feedback of available resources, provides visual feedback as the state of (e.g., nature of) the account, and improves how resource transfers are managed.

In some embodiments, the account is for a first service provider (e.g., the transit service provider associated with the transit app of FIG. 13J) (e.g., vendor, merchant, and/or financial company). In some embodiments, after displaying the second user interface, the computer system displays, via the display generation component, a fourth user interface (e.g., 1342). In some embodiments, displaying the fourth user interface includes displaying a first cancel authorization selectable interface object (e.g., 1346a) that initiates a process to cancel (e.g., terminate and/or revoke) an authorization (e.g., approval and/or permission) to cancel a respective future scheduled resource transfer (e.g., the same as or different from the first future scheduled resource transfer) to the first service provider and a second cancel authorization selectable interface object (e.g., 1346b) that initiates a process to cancel (e.g., terminate and/or revoke) an authorization (e.g., approval and/or permission) for a respective future scheduled resource transfer to a second service provider that is different from the first service provider. The computer system detects a set of one or more inputs that includes an input (e.g., 1350j1 and/or 1350j2) directed to a respective cancel authorization interface object. In some embodiments, the set of one or more inputs includes an input directed to a confirmation selectable interface object that confirms the cancellation. In response to detecting the set of one or more inputs and in accordance with a determination that the respective cancel authorization interface object is the first cancel authorization selectable interface object, the computer system cancels the respective future scheduled resource transfer to the first service provider (e.g., as described with respect to FIG. 13J). In response to detecting the set of one or more inputs and in accordance with a determination that the respective cancel authorization interface object is the second cancel authorization selectable interface object, cancelling the respective future scheduled resource transfer to the second service provider (e.g., as described with respect to FIG. 13J). Displaying a fourth user interface that includes a first cancellation selectable interface object and a second cancellation selectable interface object while detecting an input and, in response, cancelling authorization for a first service provider or a second service provider performs an operation when a set of conditions has been met without requiring further user input, provides visual feedback of available resources and reduces the number of inputs to cancel authorization for different service providers.

In some embodiments, after modifying (e.g., changing and/or cancelling authorization of) the first future scheduled resource transfer via a respective application (e.g., the first application and/or the second application), the computer system (e.g., 900) displays, via the display generation component, the first user interface, including, in accordance with a determination that a respective future scheduled resource transfer (e.g., the first future scheduled resource transfer and/or any future resource transfers) is authorized (e.g., future scheduled resource transfers are authorized), displaying the first selectable interface object (e.g., as depicted in FIG. 13B). In some embodiments, after modifying (e.g., changing and/or cancelling authorization of) the first future scheduled resource transfer via a respective application (e.g., the first application and/or the second application), the computer system displays, via the display generation component, the first user interface, including, in accordance with a determination that the respective future scheduled resource transfer is not authorized (e.g., future scheduled resource transfers are not authorized), forgoing display of the first selectable interface object (e.g., as described with respect to FIG. 13G, input 1350g optionally causes an auto-reload parameters interface, similar to auto-reload parameters interface 1333 of FIG. 13D, to be displayed as opposed to auto-reload options interface 1314 of FIG. 13H). Conditionally displaying the first user interface with or without the first selectable interface object depending on whether a future scheduled resource transfer is active performs an operation when a set of conditions has been met without requiring further user input, declutters the user interface, provides visual feedback as the state of (e.g., nature of) the account and/or future scheduled resource transfer, and improves how user interfaces are used to manage resource transfers.

In some embodiments, displaying the second user interface includes, in accordance with the determination that the respective future scheduled resource transfer is not authorized (e.g., future scheduled resource transfers are not authorized), displaying a first set-up selectable interface object (e.g., 1324) that, when selected, initiates a process to authorize a fourth future scheduled resource transfer via the first application without displaying a second set-up selectable interface object (e.g., there are no auto-reload options 1316 for the transit application displayed in FIG. 13H) that, when selected, initiates a process to authorize a fifth future scheduled resource transfer (e.g., the same as and/or different from the fourth future scheduled resource transfer) via the second application. Displaying a first set-up selectable interface object that, when selected, initiates a process to authorize a fourth future scheduled resource transfer via the first application while not displaying a second set-up selectable interface object that, when selected, initiates a process to authorize a fifth future scheduled resource transfer via the second application declutters the user interface, provides visual feedback as the state of (e.g., nature of) the account and/or future scheduled resource transfer, and improves how user interfaces are used to manage resource transfers.

Note that details of the processes described above with respect to method 1400 (e.g., FIG. 14) are also applicable in an analogous manner to the methods described below/above. For example, methods 800, 1100, 1600, 1800, 2100, 2400, and/or 2600 optionally include one or more of the characteristics of the various methods described above with reference to method 1400. For example, methods 800, 1100, 1600, 1800, 2100, 2400, and/or 2600 include user interfaces to allow different applications to authorize auto-reload resource transfers. Additionally, a user interface of methods 800, 1100, 1600, 1800, 2100, 2400, and/or 2600 optionally includes affordances to modify and/or set-up a future scheduled resource transfer via different applications. For brevity, these details are not repeated herein.

FIGS. 15A-15I illustrate exemplary user interfaces for controlling display of an options affordance, in accordance with some embodiments. The user interfaces in these figures are used to illustrate the processes described below, including the processes in FIG. 16. In some embodiments, device 1500 is a smartwatch and/or smartphone. In some embodiments, device 1500 includes one or more components of device 100, device 300, device 500, Jane's device Jane's device 600, and/or John's device 700.

At FIG. 15A, device 1500 displays, via display 1501, account interface 1510a of a resource application. In some embodiments, the resource application is a wallet application (or, optionally, a computer memory manager application). Account interface 1510a includes representation 1502a for account A (e.g., a payment account, a stored-value account, a transit account, a secure access card) and representation 1502b for account B (e.g., a payment account, a stored-value account, a transit account, a secure access card). In some embodiments, account A and/or account B are different accounts that are optionally used to transfer funds, to transfer allocation of computer memory, and/or to display a code to gain access to a secured location (e.g., a ticket QR code similar to QR code of FIG. 17F). In some embodiments, representation 1502a and/or representation 1502b includes text or images identifying the account. In some embodiments, representation 1502a and/or representation 1502b includes dynamic information as described in greater detail with respect to FIGS. 17A-17K.

At FIG. 15A, device 1500 displays transfer indicator 1504 that indicates how to initiate a resource transfer operation (e.g., a transfer of funds and/or computer memory). Notably, account interface 1510a does not include account menu affordance 1514 of FIG. 15C. At FIG. 15A, device 1500 detects input 1550a1 (e.g., a swipe input, a touch input, an air gesture, a mouse click, a gaze, and/or a speech input) and/or input 1550a2 (e.g., rotation of rotatable device 1503). Device 1500 detects input 1550a3 (e.g., a double-press of a button, a button press, a touch input, an air gesture, a mouse click, a gaze, and/or a speech input) to initiate the resource transfer operation using account A.

At FIG. 15B, in response to detecting input 1550a3, device 1500 initiates the resource transfer operation by authorizing information (e.g., an account number, an account ID, and password) associated with account A to be transferred (e.g., transmitted). For example, device 1500 (e.g., while display representation 1502a) initiates wireless communication 1508 (e.g., short-range radio field, a near-field communication (NFC), and/or Wi-Fi communication) with terminal 1506 (e.g., NFC terminal and/or computer system terminal, such as 550, as shown in FIG. 5C). In some embodiments, terminal 1506 includes one or more components of device 100, device 300, or device 500. In some embodiments, terminal 1506 is a transaction terminal, a transit terminal, a secure access terminal such as a wireless badge reader for reading wireless identification information and determining whether to provide access to a secure resource/location (e.g., unlocking a door, unlocking a computer terminal, or the like) based on the identification information transferred via wireless communication 1508. At FIG. 15B, device 1500 displays transfer sent interface 1510b with indicator 1512 to indicate a status of the transfer. In some embodiments, indicator 1512 indicates that the resource transfer is complete.

At FIG. 15C, in response to detecting input 1550a1 and/or 1550a2, device 1500 scrolls representation 1502a of account A and representation 1502b of account B. Additionally, in response to detecting input 1550a1 and/or 1550a2, device 1500 displays account menu affordance 1514 and, optionally, ceases displaying transfer indicator 1504. As described in greater detail herein, in some embodiments, account menu affordance 1514 allows a user to manage accounts of the resource application. At FIG. 15C, device 1500 detects a continuation of input 1550a1 (e.g., continued movement of a gesture) and/or 1550a2 (e.g., continued rotation of rotatable device 1503).

At FIG. 15D, in response to detecting the continuation of input 1550a1 and/or 1550a2, device 1500 displays representation 1502b of account B in a location that was previously occupied by representation 1502a of account A (as depicted in FIG. 15A). In some embodiments, the location of representation 1502b is an arming location, where a representation of an account at that location indicates that that particular account will be armed (e.g., used) to transfer resources (e.g., once authorized, such as with a double-press (e.g., 1550d2) of the button). Additionally, device 1500 displays representation 1502c of account C (e.g., a payment account, a stored-value account, a transit account, a secure access card). As depicted, device 1500 no longer displays representation 1502a of account A. At FIG. 15D, device 1500 detects input 1550d1 (e.g., a touch input, an air gesture, a mouse click, a gaze, and/or a speech input) directed at account menu affordance 1514. Device 1500 detects input 1550d2 (e.g., a button press, a touch input, an air gesture, a mouse click, a gaze, and/or a speech input) to initiate a transfer operation. In some embodiments, in response to detecting input 1550d2, device initiates a transfer operation (e.g., authorizes for a transfer) using account B that is similar to the transfer operation of account A described with respect to FIG. 15B. Notably, this occurs without displaying transfer indicator 1504 (e.g., because a threshold amount of time has not passed (e.g., since the input was detected and/or since representation 1502b of account B has been displayed at the arming location on the display).

At FIG. 15E, device 1500 detects that a threshold amount of time has passed (e.g., 2 seconds, 5 seconds, 10 seconds) since detecting an input (e.g., a scrolling input) (or, optionally, since displaying representation 1502b of account B in the arming location). In response to detecting that the threshold amount of time has passed, device 1500 displays account interface 1510a with transfer indicator 1504 and without account menu affordance 1514, as shown in FIG. 15E. In some embodiments, device 1500 ceases to display account menu affordance 1514 after a first amount of time has passed without user input that navigates the user interface and device 1500 starts to display transfer indicator 1504 after a second amount of time (same or different from the first amount of time) has passed without user input that navigates the user interface. In some embodiments, while displaying account interface 1510a without account menu affordance 1514, device 1500 detects input 1550e1 and, in response, does not display account menu interface 1510f of FIG. 15F. At FIG. 15E, device 1500 detects input 1550e2 (e.g., a double-press of a button, a button press, a touch input, an air gesture, a mouse click, a gaze, and/or a speech input) to initiate (e.g., authorize) a resource transfer operation. In some embodiments, in response to detecting 1550e2, device 1500 initiates and/or authorizes a resource transfer operation using resources of account B. In some embodiments, device 1500 detects a threshold amount of time has passed since the resource transfer is complete (or, optionally, detects that a sent interface similar to transfer sent interface 1510b, has been displayed for a threshold amount of time). In such embodiments, device 1500 displays (e.g., re-displays) account interface 1510a of FIG. 15D, which includes account menu affordance 1514.

At FIG. 15F, in response to detecting input 1550d1 of FIG. 15D, device 1500 displays account menu interface 1510f. In some embodiments, account menu interface 1510f provides control options to control accounts of the resource application. Account menu interface 1510f includes default account affordance 1516, add account affordance 1518, and expired account affordance 1520. Device 1500 detects input 1550f1 (e.g., a touch input, an air gesture, a mouse click, a gaze, and/or a speech input) directed at default account affordance 1516. In some embodiments, in response to detecting input 1550f1, device 1500 initiates a process to designate a default account. In some embodiments, the default account is displayed in the arming location at the launch of the resource application described with respect to FIGS. 15G-15H. Device 1500 detects input 1550f2 (e.g., a touch input, an air gesture, a mouse click, a gaze, and/or a speech input) directed at add account affordance 1518. In some embodiments, in response to detecting input 1550f2, device 1500 initiates a process to add an account to the resource application. Device 1500 detects input 1550f3 (e.g., a touch input, an air gesture, a mouse click, a gaze, and/or a speech input) directed at expired account affordance 1520. In some embodiments, in response to detecting input 1550f3, device 1500 initiates a process to display expired accounts. In such embodiments, the expired accounts are optionally expired passes (e.g., tickets) or other types of expired accounts.

At FIG. 15G, device 1500 displays application interface 1510g that includes different application icons to display (e.g., launch) a respective application. At FIG. 15G, device 1500 detects input 1550g (e.g., a touch input, an air gesture, a mouse click, a gaze, and/or a speech input) directed at icon 1522 that represents the resource application.

At FIG. 15H, in response to detecting input 1550g, device 1500 displays account interface 1510a that includes account menu affordance 1514. In some embodiments, account menu affordance 1514 is displayed at an initial display of account interface 1510a in response to detecting input 1550g and/or after a transfer is completed (e.g., as described with respect to FIG. 15E). Additionally, account interface includes representation 1502d of account D in the arming location (e.g., in response to a user configuring account D as the default account).

At FIG. 15I, device 1500 detects that a threshold amount of time has passed (e.g., 2 seconds, 5 seconds, 10 seconds) since detecting an input (e.g., a scrolling input) (or, optionally, since displaying representation 1502d of account D in the arming location). In response to detecting that the threshold amount of time has passed, device 1500 displays account interface 1510a with transfer indicator 1504 and without account menu affordance 1514.

FIG. 16 is a flow diagram illustrating a method for controlling the display of an account options affordance using a computer system in accordance with some embodiments. Method 1600 is performed at a computer system (e.g., 100, 300, 500, 600, 700, 900, and/or 1500) (e.g., a smartphone, a smartwatch, a tablet computer, a laptop computer, a desktop computer, and/or a head mounted device (e.g., a head mounted augmented reality and/or extended reality device)) that is in communication with a display generation component (e.g., 601, 701, 801, and/or 1501) (e.g., a display controller, a touch-sensitive display system, a monitor, and/or a head mounted display system) and one or more input devices (e.g., 601, 701, 801, and/or 1501) (e.g., a touch-sensitive surface, a keyboard, a controller, a motion sensor, and/or a mouse). Some operations in method 1600 are, optionally, combined, the orders of some operations are, optionally, changed, and some operations are, optionally, omitted.

As described below, method 1600 provides an intuitive way to display an account options affordance. The method reduces the cognitive burden on a user for managing options for various accounts, thereby creating a more efficient human-machine interface. For battery-operated computing devices, enabling a user to manage various accounts faster and more efficiently conserves power and increases the time between battery charges.

The computer system displays (1602), via the display generation component, a user interface (e.g., 1510a) of an electronic wallet (e.g., of the computer system) including a representation of a first account (e.g., 1502a) (e.g., transit account, payment account, and/or loyalty account) and an indication for authorizing a resource transfer (e.g., 1504) (e.g., a transfer of allocated memory, a transfer data, and/or a transfer funds) (e.g., using the first account) (e.g., an indication for authorizing a transfer of a resource associated with the first account) (e.g., an indication corresponding to an action for a user to perform to authorize a resource transfer) (and, optionally) (and, optionally, while not displaying a first selectable interface object that, when selected, displays a second user interface object for managing a set of one or more accounts of the electronic wallet). While displaying the user interface of the electronic wallet, the computer system detects (1604), via the one or more input devices, a respective input (e.g., 1550a1, 1550a2, and/or 1550a3) (e.g., a gesture, a mouse click, a speech input, a button press). In response to detecting the respective input (1606) and in accordance with a determination that the respective input corresponds to a request to authorize a resource transfer using the first account (e.g., 1550a3), the computer system authorizes (1608) the resource transfer using the first account without displaying a first selectable interface object (e.g., 1514) (e.g., scroll and/or shift) that, when selected, displays a second user interface object (e.g., 1516, 1518, and/or 1520) for managing a set of one or more accounts (e.g., a loyalty account, a payment account, a transit account, an electronic credit card, and/or an electronic ticket) of the electronic wallet. In some embodiments, authorizing the resource transfer using the first account includes causing credentials of the first account to be communicated to a second (e.g., different or external) computer system. In response to detecting the respective input (1606) and in accordance with a determination that the respective input corresponds to a request to navigate the user interface of the electronic wallet (1610) (e.g., 1550a1 and 1550a2), the computer system displays (1612), via the display generation component, the first selectable interface object and ceases display (1614) of the indication for authorizing the resource transfer (e.g., as depicted in FIG. 15C) (e.g., using the first account) (and/or forgoing authorization of the resource transfer using the first account). Conditionally displaying the first selectable interface object that, when selected, displays the second user interface object for managing the set of one or more accounts based on whether the respective input corresponds to a request to authorize a resource transfer or a request to navigate the user interface of the electronic wallet performs an operation when a set of conditions has been met without requiring further user input, declutters the user interface, improves how accounts are managed.

In some embodiments, the resource transfer includes transferring allocation of memory (e.g., the resource application of FIGS. 15A-15I is a computer memory manager application) (e.g., allocation of memory is transferred from one account to a different account and/or from one computer system to a different computer system). For example, a user moves a memory allocation of 500 MB from a first user account to a second user account (e.g., that is running out of memory) on the same server or service. Using the computer system to transfer memory improves how computer memory is managed.

In some embodiments, the resource transfer includes transferring funds (e.g., the resource application of FIGS. 15A-15I is an electronic wallet) (e.g., funds are transferred from one account, application, and/or computer system to a different account, application, or computer system). In some embodiments, a transfer of funds includes an allocation of money to and/or from an account provisioned on a wallet of the computer system. Using the computer system to transfer funds improves how funds are managed or transferred.

In some embodiments, the computer system detects, via the one or more input devices, an input (e.g., 1550d1) (e.g., an air gesture, a tap input, and/or a tap-and-hold input) directed at the first selectable interface object. In response to detecting the input directed at the first selectable interface object, the computer system displays, via the display generation component, the second user interface object for managing the set of one or more accounts of the electronic wallet (e.g., as depicted in FIG. 15F). The computer system detects, via the one or more input devices, an input (e.g., 1550f1, 1550f2, and/or 1550f3) (e.g., an air gesture, a tap input, and/or a tap-and-hold input) directed at the second user interface object. In response to detecting the input directed at the second user interface object, initiating a process to manage the set of one or more accounts of the electronic wallet (e.g., as described with respect to FIG. 15F). In some embodiments, initiating the process to manage the set of one or more accounts of the electronic wallet includes setting a default account. In some embodiments, initiating the process to manage the set of one or more accounts of the electronic wallet includes adding a new account to the electronic wallet. In some embodiments, initiating the process to manage the set of one or more accounts of the electronic wallet includes to view expired accounts. Initiating a process to manage the set of one or more accounts of the electronic wallet in response to detecting an input directed at the second user interface object improves how accounts are managed in the electronic wallet.

In some embodiments, a representation of a second account (e.g., 1502d), different from the first account, of the one or more accounts is not displayed when the input directed at the first user interface object is detected, and wherein initiating a process to manage the set of one or more accounts of the electronic wallet includes initiating a process to manage the second account (e.g., setting 1502d as a default account described with respect to FIG. 15F and FIG. 15H) (e.g., changing a default account from the first account to the second account). Initiating a process to manage the second account when the representation of the second account is not displayed when the input is directed to the first user interface object was detected improves how accounts are managed in the electronic wallet.

In some embodiments, in response to detecting the respective input and in accordance with the determination that the respective input corresponds to the request to navigate the user interface of the electronic wallet, the computer system scrolls (e.g., shifts and/or moves) the user interface (e.g., as depicted in FIGS. 15C-15D) and displays, via the display generation component, a representation of a third account that is different from the first account (e.g., as depicted in FIGS. 15C-15D). In some embodiments, the representation of the third account is not being displayed when the respective input is detected. Scrolling the user interface and displaying a representation of a third account that is different from the first account in response to detecting the respective input and in accordance with the determination that the respective input corresponds to the request to navigate the user interface of the electronic wallet provides visual feedback that input was detected and reduces the number of inputs needed to switch between the first account and the third account.

In some embodiments, while the representation of the third account is displayed (e.g., as described with respect to FIGS. 15D-15E) and in accordance with a determination that a first set of criteria is satisfied (e.g., as described with respect to FIGS. 15D-15E), the computer system displays, via the display generation component, an indication for authorizing a resource transfer (e.g., as depicted in FIG. 15E) (e.g., using the third account) and ceases display of the first selectable interface object (e.g., as depicted in FIG. 15E). While the representation of the third account is displayed (e.g., as described with respect to FIGS. 15D-15E) and in accordance with a determination that the first set of criteria is not satisfied, the computer system maintains display of the first selectable interface object without displaying the indication for authorizing the resource transfer (e.g., as described with respect to FIGS. 15D-15E) (e.g., using the third account). In some embodiments, while the indication for authorizing the resource transfer using the third account is not displayed, the computer system detects an input corresponding to a request to authorize the resource transfer using the third account and, in response, authorizes the resource transfer using the third account (e.g., a resource transfer is authorized independent of displaying the indication for authorizing the resource transfer). Conditionally displaying the first selectable interface object with or without displaying the indication for authorizing the resource transfer when the first set of criteria is satisfied performs an operation when a set of conditions has been met without requiring further user input, declutters the user interface, and provides visual feedback about to how to authorize a transaction using the third account.

In some embodiments, the first set of criteria includes a criterion that is satisfied when no input has been detected via the one or more input devices for a threshold amount of time (e.g., as described with respect to FIGS. 15D-15E) (e.g., 1 second, 2 seconds, 5 seconds). In some embodiments, the criterion is satisfied when no input of a first type (e.g., touch input directed at the display generation component and/or a rotation of a rotatable input device) is detected (e.g., the criterion is not satisfied when no input of a second type has been detected). Conditionally displaying the first selectable interface object with or without displaying the indication for authorizing the resource transfer using the third account using a criterion that is satisfied when no input has been detected via the one or more input devices for a threshold amount of time performs an operation when a set of conditions has been met without requiring further user input, declutters the user interface, and provides visual feedback about to how to authorize a transaction using the third account.

In some embodiments, while the indication for authorizing the resource transfer using the third account is displayed, the computer system detects an input that corresponds to a request to authorize a resource transfer (e.g., 1550e2) (e.g., using the third account). In response to detecting the input that corresponds to a request to authorize a resource transfer (e.g., using the third account), authorizing the resource transfer using the third account (e.g., as described with respect to FIG. 15E). In some embodiments, authorizing the resource transfer using the third account includes releasing information from a secure element of the computer system and/or communicating information about the third account. Authorizing the resource transfer using the third account in response to detecting the input that corresponds to a request to authorize a resource transfer using the third account while the indication for authorizing the resource transfer is displayed improves how resource transfers are managed using the computer system.

In some embodiments, after the representation of the third account is displayed, detect, via one or more input devices, an input (e.g., 1550e1) (e.g., an air gesture, a tap input, and/or a tap-and-hold input) directed at the first selectable interface object. In response to detecting the input directed at the first selectable interface object, the computer system displays, via the display generation component, the second user interface object for managing the set of one or more accounts of the electronic wallet (e.g., as described with respect to FIG. 15E). Displaying the second user interface object for managing the set of one or more accounts of the electronic wallet in response to detecting the input directed at the first selectable interface object provides visual feedback that input was detected and reduces the number of inputs to initiate a process to manage the set of one or more accounts of the electronic wallet.

In some embodiments, authorizing the resource transfer using the first account includes initiating a communication of information corresponding to the first account (e.g., as described with respect to FIG. 15B) (e.g., an account number, an account ID, and password). Initiating the communication of information for the first account after the resource transfer has been authorized improves the security of the computer system and/or account.

In some embodiments, in response to detecting the respective input and in accordance with the determination that the respective input corresponds to the request to navigate the user interface of the electronic wallet, the computer system scrolls (e.g., shifting and/or moving) (e.g., at least partially) the representation of the first account (e.g., as depicted in FIGS. 15A, 15C, and 15D). Scrolling the representation of the first account in response to detecting the respective input and in accordance with the determination that the respective input corresponds to the request to navigate the user interface of the electronic wallet provides visual feedback that input was detected.

In some embodiments, a portion of a representation of a fourth account (e.g., 1502b), different from the first account (e.g., the same as or different from the second account and/or the third account), is not being displayed when the respective input is detected. In some embodiments, in response to detecting the respective input and in accordance with the determination that the respective input corresponds to the request to navigate the user interface of the electronic wallet, the computer system displays, via the display generation component, the portion of the representation of the fourth account (e.g., as depicted in FIGS. 15A, 15C, and 15D). In some embodiments, in response to detecting the respective input and in accordance with the determination that the respective input corresponds to the request to navigate the user interface of the electronic wallet, the computer system ceases to display a portion of the representation of the first account as the portion of the representation of the fourth account begins to be displayed. Displaying a portion of the representation of the fourth account that was previously not displayed in response to detecting the respective input and in accordance with the determination that the respective input corresponds to the request to navigate the user interface of the electronic wallet performs an operation when a set of conditions has been met without requiring further user input, declutters the user interface, and provides visual feedback that input was detected.

In some embodiments, an input of a first type (e.g., 1550a3) (e.g., and/or an input detected via a first input device) (e.g., a button press and/or mechanical switch) corresponds to the request to authorize a resource transfer using the first account. In some embodiments, an input of a second type (e.g., 1550a1) corresponds to the request to navigate the user interface of the electronic wallet, wherein the second type is different from the first type (e.g., and/or an input detected via a second input device different from the first input device) (e.g., a gesture directed at the display generation component and/or a tap). Conditionally displaying the first selectable interface object while not displaying the first selectable interface object and displaying the first selectable interface object or ceasing display of the indication for authorizing the resource transfer using the first account based on different input types performs an operation when a set of conditions has been met without requiring further user input, declutters the user interface, and provides visual feedback that input of a particular type was detected.

Note that details of the processes described above with respect to method 1600 (e.g., FIG. 16) are also applicable in an analogous manner to the methods described below/above. For example, methods 800, 1100, 1400, 1800, 2100, 2400, and/or 2600 optionally include one or more of the characteristics of the various methods described above with reference to method 1600. For example, methods 800, 1100, 1400, 1800, 2100, 2400, and/or 2600 include features to display an account options menu and/or transferring resources described with respect to method 1600. For brevity, these details are not repeated herein.

FIGS. 17A-17K illustrate exemplary user interfaces for controlling display of dynamic account information, in accordance with some embodiments. The user interfaces in these figures are used to illustrate the processes described below, including the processes in FIG. 18.

At FIG. 17A, device 1500 is in a low-power mode. For example, display 1501 is in a low-power mode and/or dimmed (e.g., darkened). Device 1500 detects input 1750a (e.g., a touch input, an air gesture, a mouse click, a gaze, and/or a speech input) directed at display 1501 (e.g., a touchscreen). In some embodiments, while device 1500 is displaying (e.g., while not in the low-power mode) a watch face (e.g., with clock element 1705) and without displaying representations 1702a-1702b, and device 1500 receives user input (e.g., a crown rotation and/or a swipe up input) and, in response, displays user interface 1710b, as shown in FIG. 17B, by reducing the size of clock element 1705 (to the size shown in FIG. 17B), shifting clock element 1705 (to the location shown in FIG. 17B), and starting to display representations 1702a-1702b.

At FIG. 17B, in response to detecting input 1750a, device 1500 displays watch face interface 1710b that includes clock element 1705 of a current time. In some embodiments, device 1500 is a smartphone and/or a head-mounted device. In such embodiments, watch face interface 1710b is a home screen interface that includes an indication of a current time. At FIG. 17B, device 1500 is not in a lower power mode, as indicated by display 1501 not being dimmed. In some embodiments, clock element 1705 of the current time is a digital indication of time. In some embodiments, clock element 1705 of the current time is an analog indication of time including an hour hand and a minute hand.

At FIG. 17B, watch face interface 1710b includes one or more representations accounts (e.g., a payment account, a stored-value account, a transit account, a secure access card) for a resource application (a wallet application or a computer memory manager application). Representation 1702a of hotel account is optionally displayed based a current context (e.g., time and/or location). In some embodiments, device 1500 detects that a current geographical location corresponds to a geographical location of the hotel. Representation 1702a of hotel account includes static information region 1708. In some embodiments, static information region 1708 does not change in response to detecting a change in context (e.g., time, geographic location, calendar information, and/or electronic communications). In some embodiments, static information region 1708 includes a name of a service provider for the account, an expiration date of the account, and/or other information associated with the account that does not change based on a change in context. Representation 1702a further includes icon 1704. The appearance of icon 1704 depicts a type of information that is displayed in response to selecting a representation of an account, as described in further detail with respect to FIG. 17F. Icon 1704 of FIG. 17B depicts that a barcode will be displayed. Watch face interface 1710b further includes representation 1702b of a fitness account. In some embodiments, a user can manually scroll through the representations of accounts of watch face interface 1710b (e.g., via a touch input, an air gesture, a mouse click, a gaze, a speech input, and/or rotation of rotatable device 1503).

At FIG. 17C, device 1500 detects a change in context from the context of device 1500 of FIG. 17B. In response to detecting the change in context, device 1500 updates watch face interface 1710b stops displaying representation 1702a and displays representation 1702b of an airline account having ticket information. Representation 1702b includes static information region 1708 that includes a type of account (e.g., airline ticket) and information associated with the account (e.g., departure airport and arrival airport). Representation 1702b further includes dynamic information region 1712. In some embodiments, dynamic information region 1712 includes information that changes based on the context. In some embodiments, dynamic information region 1712 is updated with information that is relevant given the context. In some embodiments, device 1500 detects one or more timing thresholds and/or location thresholds have been met with respect a time and/or location of an event (or multiple events) to detect a change in context. In some embodiments, device 1500 detects that a take-off time for a flight is within a threshold amount of time (e.g., 1 hour and/or 2 hours). In some embodiments, to detect a change in context, device 1500 detects that an airport location is beyond a threshold distance (e.g., 0.5 mile and/or 1 mile) of the current location of device 1500. In some embodiments, in response to detecting a change in context, device 1500 automatically changes the information displayed in dynamic information region 1712 separate from (e.g., without and/or independent of) receiving new information for the account.

At FIG. 17C, device 1500 also prioritizes representation 1702b over other accounts, like representation 1702b of fitness account, based on a time of a flight (e.g., 1:15) and a current time (e.g., 12:15). In some embodiments, device 1500 prioritizes representation 1702b over other accounts based on a current location of device 1500 (e.g., relative to a location of an airport for the flight). Representation 1702b further includes icon 1704 that is described in greater detail with respect to FIG. 17E. In some embodiments, prioritizing representations of accounts based on context notifies the user of relevant accounts without detecting an input from the user of device 1500. At FIG. 17C, device 1500 detects input 1750c (e.g., a touch input, an air gesture, a mouse click, a gaze, and/or a speech input) directed at representation 1702b.

At FIG. 17D, device 1500 detects a change in context (e.g., the current time is 12:45 and/or a current location of device 1500 is at the airport). In some embodiments, to detect a change in context, device 1500 detects that a boarding time is within a threshold amount of time (e.g., 1 hour and/or 2 hours) of the current time. In some embodiments, to detect a change in context, device 1500 detects that a location of the airport is within a threshold distance (e.g., 0.5 mile and/or 1 mile) of the current location of device 1500. In response to detecting the change in context, device 1500 updates dynamic information region 1712 with gate information (e.g., gate D12). In some embodiments, updating dynamic information region provides relevant information about the account to the user without requiring further input from the user (e.g., to open the account and/or open the application to view the account). At FIG. 17D, Device 1500 detects input 1750d (e.g., a touch input, an air gesture, a mouse click, a gaze, and/or a speech input) directed at representation 1702b.

At FIG. 17E, device 1500 detects a change in context (e.g., the current time is 1:00 and/or a current location of device 1500 is near the gate of a departure flight). In some embodiments, to detect a change in context, device 1500 detects that a boarding time is within a threshold amount of time (e.g., 15 minutes and/or 30 minutes hours) of the current time. In some embodiments, to detect a change in context, device 1500 detects that a boarding location is within a threshold distance (e.g., 0.5 mile and/or 1 mile) of the current location of device 1500. In response to detecting the change in context, device 1500 updates dynamic information region 1712 with boarding group information (e.g., boarding group A). Representation 1702b includes icon 1704 that is different from icon 1704 of FIG. 17B. In some embodiments, icon 1704 depicts what type of account information will be displayed in response to detecting an input directed at a respective representation of an account. Icon 1704 depicts that a quick response (QR) code will be displayed. At FIG. 17E, device 1500 detects input 1750e (e.g., a touch input, an air gesture, a mouse click, a gaze, and/or a speech input) directed at representation 1702b.

At FIG. 17F, in response to detecting input 1750e of FIG. 17E, input 1750c of FIG. 17C, and/or input 1750d of FIG. 17D and if the airline account of representation 1702 includes ticket information for a single person (e.g., not more than one person), device 1500 displays account information interface 1710f of FIG. 17F. Notably, account information interface 1710f of FIG. 17F does not include indicators 1716 that are depicted in FIG. 17G. Account information interface 1710f includes representation 1714 of machine readable optical code (e.g., QR code and/or barcode) for Amy's ticket. In some embodiments, representation 1714 is scanned by scanner of an external computer system to verify a user's credentials so as to allow physical access to secured areas and/or transfer resources. In some embodiments, information of representation 1714 cannot be deciphered and/or understood by a human. In some embodiments, the machine readable optical code is a one-dimensional optical code (e.g., barcode) that use parallel lines to represent data and/or two-dimensional (e.g., matrix) optical codes (e.g., QR codes) that use rectangles, dots, and/or hexagons to represent data. In some embodiments, device 1500 detects input 1750f1 (e.g., a touch input, an air gesture, a mouse click, a gaze, and/or a speech input) and/or input 1750f2 (e.g., rotation of rotatable device 1503) and, in response, displays a summary section similar to the summary section 1720 of FIG. 17I. In some embodiments, device 1500 does not display a summary section similar to the summary section 1720 of FIG. 17I in response to detecting input 1750f1 and/or input 1750f2.

At FIG. 17G, in response to detecting input 1750e of FIG. 17E, input 1750c of FIG. 17C, and/or input 1750d of FIG. 17D and if the airline account of representation 1702 includes ticket information for multiple people (e.g., more than one passenger and/or attendee of the event), device 1500 displays account information interface 1710f of FIG. 17G that includes indicators 1716 to indicate that multiple tickets are available. Device also displays representation 1714 of the machine readable optical code (e.g., QR code and/or barcode) for Amy's ticket. In some embodiments, device 1500 detects swipe input 1750g1 (e.g., a touch input, an air gesture, a mouse click, a gaze, and/or a speech input) and/or input 1750g2 (e.g., rotation of rotatable device 1503).

At FIG. 17H, in response to detecting swipe input 1750g1 and/or 1750g2, device 1500 displays representation 1718 of machine readable optical code (e.g., QR code and/or barcode) for John's ticket. Additionally, device 1500 updates indicators 1716 to indicate that the second ticket is being displayed. Device 1500 detects swipe input 1750h1 (e.g., a touch input, an air gesture, a mouse click, a gaze, and/or a speech input) and/or input 1750h2 (e.g., rotation of rotatable device 1503).

At FIG. 17I, in response to detecting swipe input 1750h1 and/or input 1750h2, device 1500 displays a summary section 1720. Summary section 1720 includes a more complete view of the information displayed in dynamic information region 1712 and static information region 1708. For example, summary section 1720 includes departure time (e.g. 1:15), gate information (e.g., D12), group information (e.g., group A), and seat information (e.g., 24). In some embodiments, device 1500 detects swipe input 1750i1 (e.g., a touch input, an air gesture, a mouse click, a gaze, and/or a speech input) and, in response, displays a summary section for John's ticket information similar to summary section 1720. At FIG. 17I, device 1500 detects input 1750i2 (e.g., button press, press of rotatable device 1503, a touch input, an air gesture, a mouse click, a gaze, and/or a speech input) corresponding to a request to display watch face interface 1710b.

At FIG. 17J, in response to detecting input 1750i2, device 1500 displays watch face interface 1710b that includes an update to dynamic information region 1712. In some embodiments, the update to dynamic information region is in response device 1500 detecting a change of context (e.g., a current time is after a boarding time and/or a change in location).

At FIG. 17K, device 1500 detects a change in context. In response, device 1500 displays representation 1702c of a concert ticket. Representation 1702c includes static information region 1708 that includes a type of an account (e.g., concert ticket) and a band performing at the event. Representation 1702c also includes dynamic information region 1712 that indicates that doors will open at 6:30 PM. In some embodiments, device 1500 updates dynamic information region 1712 of representation 1702c to include a concert venue, a stage number, and/or a time for another band to take the stage.

FIG. 18 is a flow diagram illustrating a method for controlling display of dynamic account information using a computer system in accordance with some embodiments. Method 1400 is performed at a computer system (e.g., 100, 300, 500, 600, 700, 900, and/or 1500) (e.g., a smartphone, a smartwatch, a tablet computer, a laptop computer, a desktop computer, and/or a head mounted device (e.g., a head mounted augmented reality and/or extended reality device)) that is in communication with a display generation component (e.g., 601, 701, 801, and/or 1501) (e.g., a display controller, a touch-sensitive display system, a monitor, and/or a head mounted display system) and one or more input devices (e.g., 601, 701, 801, and/or 1501) (e.g., a touch-sensitive surface, a keyboard, a controller, a motion sensor, and/or a mouse). Some operations in method 1800 are, optionally, combined, the orders of some operations are, optionally, changed, and some operations are, optionally, omitted.

As described below, method 1800 provides an intuitive way for controlling display of dynamic account information. The method reduces the cognitive burden on a user to view account information, thereby creating a more efficient human-machine interface. For battery-operated computing devices, enabling a user to view account information faster and more efficiently conserves power and increases the time between battery charges.

The computer system receives (1802) data corresponding to a first account (e.g., account associated with 1702b and/or 102c) (e.g., an electronic ticket, transit account, payment account, and/or loyalty account) provisioned on an electronic wallet (e.g., the electronic wallet described with respect to FIGS. 17A-17K) (e.g., the electronic wallet includes credentials for one or multiple accounts) (in some embodiments, the electronic wallet includes credentials for one or more accounts (e.g., a loyalty account, a payment account, a transit account, an electronic credit card, and/or an electronic ticket) different from the first account), the data including first information (e.g., 1708), second information (e.g., information displayed in 1712 of FIGS. 17C-17E) that is different from the first information, and third information (e.g., information displayed in 1712 of FIGS. 17C-17E) that is different from the first information and the second information. Subsequent to receiving the data, the computer system detects (1804), via the one or more input devices, a request to display a representation of the first account (e.g., 1750a) (e.g., based on the received data) (e.g., an input to display an electronic wallet, a wrist-raise, a request to display a watch face user interface that includes a representation of a first account). In response to detecting the request to display the representation of the first account, the computer system displays (1806), via the display generation component, the representation of the first account based on the received data. Displaying the representation of the first account (e.g., using the received data) includes displaying (1808) the first information (e.g., static and/or unchanging) at a first display location (e.g., 1708) (e.g., portion and/or area). Displaying the representation of the first account (e.g., using the received data) includes, in accordance with a determination that a first set of criteria is satisfied, displaying (1810) the second information at a second display location that is different from the first display location (e.g., 1712 in FIG. 7C) (e.g., without displaying the third information). Displaying the representation of the first account (e.g., using the received data) includes, in accordance with a determination that a second set of criteria is satisfied, displaying (1812) the third information at the second display location (e.g., 1712 in FIGS. 7D and/or 17E) (e.g., without displaying the second information), wherein the second set of criteria is different from the first set of criteria. In some embodiments, the first set of criteria and/or second set of criteria are not satisfied based on receiving updates to the first account. Displaying first information at a first display location and conditionally displaying the second information or the third information at the second location depending on whether the first set of criteria or the second set of criteria, different from the first set of criteria, is satisfied performs an operation when a set of conditions has been met without requiring further user input, improves how representations of accounts are displayed, and declutters the user interface.

In some embodiments, the first account is an electronic ticket (e.g., as described with respect to FIGS. 17B-17J) (e.g., credentials for an electronic ticket and/or credentials for an electronic pass). In some embodiments, the electronic ticket provides a physical access right to a secured area (e.g., an area that where access is restricted). In some embodiments, the electronic ticket provides an access right to a physical location (e.g., a room, a building, a plane, a train, a venue). Displaying information for an electronic ticket and conditionally displaying different information for the electronic ticket depending on whether the first set of criteria or the second set of criteria, different from the first set of criteria, is satisfied performs an operation when a set of conditions has been met without requiring further user input, improves how representations of electronic tickets are displayed, and declutters the user interface.

In some embodiments, the first set of criteria includes a first time criterion that is satisfied when a current time (e.g., date, day, month, hour, minute, and/or second) has met (e.g., is within and/or satisfies) a first time threshold (e.g., a threshold date, a threshold day, a threshold month, 3 hours, 2 hours, 1 hour, 30 minutes) relative (e.g., before and/or after) to a time of a first event (e.g., as described with respect to FIGS. 17C-17E and 17J). In some embodiments, the second set of criteria includes a second time criterion that is satisfied when the current time has met a second time threshold, different from the first time threshold, relative to the time of the first event (e.g., as described with respect to FIGS. 17C-17E and 17J). Conditionally displaying the second information or the third information at the second display location depending on whether different time thresholds have been met relative to a time of a first event performs an operation when a set of conditions has been met without requiring further user input, improves how representations of accounts are displayed by displaying relevant information, and declutters the user interface.

In some embodiments, the first set of criteria includes a first time criterion that is satisfied when a current time (e.g., date, day, month, hour, minute, and/or second) has met (e.g., is within and/or satisfies) a first time threshold (e.g., a threshold date, a threshold day, a threshold month, 3 hours, 2 hours, 1 hour, 30 minutes) relative (e.g., before and/or after) to a time of a first event (e.g., a time threshold for take-off as described with respect to FIGS. 17C-17E and 17J) (e.g., a boarding time for a flight, a concert, a convention, a conference, and/or a meeting) (e.g., boarding time of a flight, departure time, landing time, start of a concert, a time of when a band takes a stage, and/or a time of a meeting). In some embodiments, the first time threshold is before (or, optionally after) the time of the event. In some embodiments, the second set of criteria includes a second time criterion that is satisfied when the current time has met a second time threshold, different from the first time threshold, relative to a time of a second event (e.g., a flight time for the flight and/or a landing time for the flight) that is different from the first event (e.g., a time threshold for boarding as described with respect to FIGS. 17C-17E and 17J). In some embodiments, the second time threshold is before (or, optionally after) the time of the event. In some embodiments, the first time threshold is a first time range (e.g., two hours to one hours) relative to the time of the event and the second time threshold is a second time range (e.g., 59 minutes to 1 second) relative to the time of the event. In some embodiments, the first time range includes a time not included in the second time range and/or vice versa. In some embodiments, the first time range is different than the second time range. In some embodiments, the first time range does not overlap with the second time range. Conditionally displaying the second information or the third information at the second display location depending on whether different time thresholds relative to the time of an event have been met performs an operation when a set of conditions has been met without requiring further user input, improves how representations of accounts are displayed by displaying relevant information, and declutters the user interface.

In some embodiments, the first set of criteria includes a first physical location criterion that is satisfied when a current physical location (e.g., a current geographical location (e.g., estimated or detected)) of the computer system is within a first threshold distance (e.g., 10 miles, 5 miles, and/or 1 mile) relative to a physical location of a third event (e.g., device 1500 is at the airport as described with respect to FIGS. 17C-17E and 17J) (e.g., the same or different from the first event and/or second event) (e.g., a flight, a concert, a convention, a conference, and/or a meeting). In some embodiments, the second set of criteria includes a second physical location criterion that is satisfied when the current physical location is within a second threshold distance (e.g., 10 miles, 5 miles, and/or 1 mile), different from the first threshold distance, relative to the physical location of the third event (e.g., device 1500 is near a boarding gate as described with respect to FIGS. 17C-17E and 17J). In some embodiments, the first threshold distance is a first range of physical locations (e.g., 10 miles to 5 miles; and/or 9 miles to 4 miles) relative to the physical location of the event and the second threshold distance threshold is a second range of physical locations (e.g., 4 miles to 3 miles; and/or 3 miles to 1 mile) relative to the location of the third event. In some embodiments, the first threshold distance includes a distance not included in the second threshold distance and/or vice versa. Conditionally displaying the second information or the third information at the second display location depending on whether different threshold distances have been met performs an operation when a set of conditions has been met without requiring further user input, improves how representations of accounts are displayed, and declutters the user interface.

In some embodiments, the second information is a first type of contextual information (e.g., airport address, boarding time, gate information, and/or boarding information described with respect to FIGS. 17C-17E and 17J) (e.g., location information (e.g., address, gate, stage number, room number) and/or time information (e.g., departure time, arrival time, boarding time, door opening time, and/or time that a band takes a stage) for a fourth event (the same as or different from the first event, second event, and/or third event). In some embodiments, the third information is a second type of contextual information, different from the first type of contextual information, for the fourth event (e.g., airport address, boarding time, gate information, and/or boarding information described with respect to FIGS. 17C-17E and 17J). In some embodiments, the first account includes credentials (e.g., an electronic ticket and/or authorization code) for the fourth event (e.g., a flight, a concert, a convention, a conference, and/or a meeting). Conditionally displaying different contextual information for the fourth event at the second display location depending on whether the first or second set of criteria has been satisfied performs an operation when a set of conditions has been met without requiring further user input, improves how representations of accounts are displayed, and declutters the user interface.

In some embodiments, concurrently the computer system displays, via the display generation component, the first information at the first display location with the second information at the second display location (e.g., as depicted in FIGS. 17C-17E and 17J). After concurrently displaying the first information at the first display location with the second information at the second display location and in accordance with a determination that the second set of criteria is satisfied, the computer system concurrently displays the first information at the first display location with the third information at the second display location (e.g., as depicted in FIGS. 17C-17E and 17J). In some embodiments, after concurrently displaying the first information at the first display location with the second information at the second display location and in accordance with a determination that the second set of criteria is not satisfied, the computer system continues to concurrently display the first information at the first display location with the second information at the second display location. Concurrently displaying the first information at the first display location with the third information at the second display location after concurrently displaying the first information at the first display location with the second information at the second display location when the second set of criteria is satisfied performs an operation when a set of conditions has been met without requiring further user input, updates representation of accounts to display relevant information about the account, and declutters the user interface.

In some embodiments, the computer system detects, via the one or more input devices, an input directed at the representation of the first account (e.g., 150c, 1750d, and/or 1750e). In response to detecting the input directed at the representation of the first account, the computer system displays, via the display generation component, a representation (e.g., a QR code, a bar code, text, and/or image) of a first electronic ticket (e.g., 1714). In some embodiments, the representation of the first electronic ticket is a machine-readable optical code (e.g., where information regarding the first electronic ticket is undecipherable to a human observer and/or where information regarding the first electronic ticket cannot be interpreted by a human observer). In response to detecting the input directed at the representation of the first account and in accordance with a determination that the first account corresponds to (e.g., includes credentials for and/or is tied to) at least two electronic tickets for a fifth event (the same as or different from the first event, the second event, the third event, and/or fourth event), the computer system displays, via the display generation component, a graphical element (e.g., 1716) (e.g., symbol, shapes, text, and/or image) indicating that a second electronic ticket is available (e.g., as described with respect to and depicted in FIGS. 17F-17I) (e.g., for display and/or for use). In response to detecting the input directed at the representation of the first account and in accordance with a determination that the first account does not correspond to at last two electronic tickets for the fifth event, the computer system forgoes display of the graphical element (e.g., as described with respect to and depicted in FIG. 17F). Displaying a representation of a first electronic ticket while conditionally displaying a graphical element indicating a second electronic ticket is available based on whether the first account corresponds to at least two electronic tickets for an event performs an operation when a set of conditions has been met without requiring further user input and provides visual feedback about the state of the account and/or computer system.

In some embodiments, while displaying the representation of the first electronic ticket, the computer system detects, via the one or more input devices, an input (e.g., 150g1, 1750d2) (e.g., a swipe gesture, an air gesture, a speech input, and/or a rotation of a rotatable device) (e.g., corresponding to a request to scroll) to access the second electronic ticket (e.g., shift a user interface in a direction and/or shift to a new portion of a user interface). In response to detecting the input to access the second electronic ticket (e.g., corresponding to the request to scroll), the computer system displays, via the display generation component, a representation (e.g., a QR code, a bar code, text, and/or image) of the second electronic ticket (e.g., as depicted in FIGS. 17G-17H) (e.g., without displaying the representation of the first electronic ticket). In some embodiments, the graphical element is updated to indicate the change from the first electronic ticket to the second electronic ticket. Displaying a representation of the second electronic ticket in response to detecting the input declutters the user interface and provides visual feedback that input was detected.

In some embodiments, displaying the representation of the first account is in accordance with a third set of criteria that includes a criterion that is satisfied when the first account is prioritized over a second account (e.g., as described with respect to and depicted in FIGS. 17B-17C) (e.g., information for the first account is likely more relevant and/or is likely more urgent than the second account) (or, optionally, a complication). In some embodiments, a position of the representation of the first account in a user interface is higher up (and/or above) a position of a representation of the second account. Displaying the representation of the first account based on a third set of criteria that includes a criterion that is satisfied when the first account is prioritized over a second account performs an operation when a set of conditions has been met without requiring further user input, updates the display of representations of accounts based on a relevancy, and provides visual feedback about the state of the account and/or computer system.

In some embodiments, the first account is prioritized over the second account based on a current time relative to (e.g., before and/or after) a time of a sixth event corresponding to the first account and relative to a time of a seventh event corresponding to the second account (e.g., as described with respect to FIGS. 17B-17C). In some embodiments, the current time is closer to the time of the event corresponding to the first account than the time of an event corresponding to the second account. Prioritizing the first account over the second account based on a current time relative a time of an event corresponding to the first account and a time of an event corresponding to the second account a performs an operation when a set of conditions has been met without requiring further user input, updates the display of representations based on a relevancy, and provides visual feedback about the state of the account and/or computer system.

In some embodiments, the first account is prioritized over the second account based on a physical location of the computer system relative to (e.g., being closer to or further from) a physical location of an eighth event (e.g., the same as or different from the sixth event) corresponding to the first account and relative to a physical location of an eighth event (e.g., the same as or different from the seventh event) corresponding to the second account (e.g., as described with respect to FIGS. 17B-17C). In some embodiments, physical location of the computer system is closer to the physical location of the event corresponding to the first account than the physical location of an event corresponding to the second account. Prioritizing the first account over the second account based on a physical location of the computer system relative to a physical location of an event corresponding to the first account and relative to a physical location of an event corresponding to the second account performs an operation when a set of conditions has been met without requiring further user input, updates the display of representations based on a relevancy, and provides visual feedback about the state of the account and/or computer system.

In some embodiments, displaying the representation of the first account includes, in accordance with a determination that the first account corresponds to a first authentication type (e.g., a first type of credentials to be authenticated and/or a first type of account information) (e.g., a QR code, barcode, and/or a code for near-field communication (NFC)), displaying, via the display generation component, a first graphical element (e.g., 1704 of FIG. 17B) (e.g., image and/or text) indicating that the first account corresponds to the first authentication type. In some embodiments, the first graphical element is displayed at a third display location different from the first display location and the second display location. In some embodiments, displaying the representation of the first account includes, in accordance with a determination that the first account corresponds to a second authentication type (e.g., a QR code, barcode, and/or a code for near-field communication (NFC)), different from the first authentication type, displaying, via the display generation component, a second graphical element (e.g., 1704 of FIG. 17C) (e.g., image and/or text) indicating that the first account corresponds to the second authentication type. In some embodiments, the second graphical element is displayed at a third display location. Conditionally displaying a first graphical element indicating that the first account corresponds to the first authentication type or a second graphical element indicating that the first account corresponds to the second authentication type depending on whether first account corresponds to a first authentication type or a second authentication type performs an operation when a set of conditions has been met without requiring further user input, improves how representations of accounts are displayed, and provides visual feedback as to the state of the account and/or computer system.

In some embodiments, while displaying a representation of a respective authentication type (e.g., 1704 of FIG. 17E) (e.g., first authentication type and/or the second authentication type) (e.g., a QR code, barcode, and/or NFC) corresponding to the first account, the computer system detects, via the one or more input devices, an input (e.g., 1570e) (e.g., a touch input, an air gesture, a speech input, and/or mouse click) directed at the representation of the first account. In response to detecting the input directed at the representation of the first account, the computer system displays, via the display generation component, a representation (e.g., 1714) (e.g., image and/or text) of the respective authentication type (e.g., a representation of a QR code and/or a representation of a barcode). Displaying a representation of the respective authentication type in response to detecting the input directed at the representation of the first account that includes a representation of a respective authentication type provides visual feedback of a state of the account or the computer system and provides visual feedback that input was detected.

Note that details of the processes described above with respect to method 1800 (e.g., FIG. 18) are also applicable in an analogous manner to the methods described below/above. For example, methods 800, 1100, 1400, 1600, 2100, 2400, and/or 2600 optionally include one or more of the characteristics of the various methods described above with reference to method 1800. For example, methods 800, 1100, 1400, 1600, 2100, 2400, and/or 2600 include user interfaces that display of dynamic account information. For brevity, these details are not repeated herein.

FIGS. 19A-19E illustrate exemplary user interfaces for initiating a return of an allocation of computer memory, in accordance with some embodiments. The user interfaces in these figures are used to illustrate the processes described below, including the processes in FIG. 21.

At FIG. 19A, device 900 displays recent order interface 2010b that includes representations 1906a-1906c of recent memory allocation transfers (e.g., transfers of memory allocation from a first account to a second account). Device 900 detects input 1950a1 (e.g., a touch input, an air gesture, a mouse click, a gaze, and/or a speech input) directed at representation 1906a of an order for allocation of computer memory from one vendor (e.g., Best Cloud Service). Device 900 detects input 1950b2 (e.g., a touch input, an air gesture, a mouse click, a gaze, and/or a speech input) directed at representation 1906b of an order for allocation of computer memory from a different vendor (e.g., Puffy Cloud Service).

At FIG. 19B, in response to detecting input 1950a1, device 900 displays order detail interface 2010c for the order of computer memory. Order detail interface 2010c includes information 2008 that the allocation of computer memory was transferred and order number 2011. Order detail interface 2010c also includes return section 2012 that includes return affordance 2014. Device 900 detects input 1950b (e.g., a touch input, an air gesture, a mouse click, a gaze, and/or a speech input) directed at return affordance 2014.

At FIG. 19C, in response to detecting input 1950b, device 900 displays interface 1916 of an application corresponding to the vendor of Best Cloud Service. Device 900 automatically enters order number 2011 and information 2018 (e.g., account ID 1234). Device 900 detects input 1950c (e.g., a touch input, an air gesture, a mouse click, a gaze, and/or a speech input) directed at start return affordance 1922 to initiate a return of the allocation of computer memory (e.g., back from the second account to the first account).

At FIG. 19D, in response to detecting input 1950b2 of FIG. 19A, device 900 displays order detail interface 2010c for computer memory from a different vendor. Order detail interface 2010c of FIG. 20E includes order number 2011 for the order of allocation of computer memory from Puffy Cloud Service and return section 2012. Device 900 detects input 1950d (e.g., a touch input, an air gesture, a mouse click, a gaze, and/or a speech input) directed at return affordance 2014.

At FIG. 19E, in response to detecting input 1950d, device 900 displays web-browser interface 1926. Device 900 automatically enters information corresponding to the order number 2011 and information 2018 (account ID 1234). Device 900 detects input 1950e (e.g., a touch input, an air gesture, a mouse click, a gaze, and/or a speech input) to initiate a return of the allocation of computer memory (e.g., back from the second account to the first account).

FIGS. 20A-20R illustrate exemplary user interfaces for initiating a return of physical item, in accordance with some embodiments. The user interfaces in these figures are used to illustrate the processes described below, including the processes in FIG. 21.

At FIG. 20A, device 900 displays interface 2010a of a wallet application (e.g., the same wallet application as described herein, such as the wallet application of as described herein). Interface 2010a includes representations 2004a-2004d of multiple accounts (e.g., a payment account, a stored-value account, a transit account, and/or a secure access card) that are provisioned onto device 900 and/or the wallet application. Interface 2010a includes order affordance 2002 for orders using resources from one or more accounts of the wallet application. Device 900 detects input 2050a (e.g., a touch input, an air gesture, a mouse click, a gaze, and/or a speech input) directed at order affordance 2002.

At FIG. 20B, in response to detecting input 2050a, device 900 displays recent order interface 2010b that includes representations 2006a-2006c of recent orders. Device 900 detects input 2050b1 (e.g., a touch input, an air gesture, a mouse click, a gaze, and/or a speech input) directed at representation 2006a of an order for shoes from one vendor (e.g., Shoes Place). Device 900 detects input 2050b2 (e.g., a touch input, an air gesture, a mouse click, a gaze, and/or a speech input) directed at representation 2006b of an order for a jacket from a different vendor (e.g., Puffy Jackets). Device 900 detects input 2050b3 (e.g., a touch input, an air gesture, a mouse click, a gaze, and/or a speech input) directed at representation 2006c of an order for a purse from yet different vendor (e.g., Purse Store).

At FIG. 20C, in response to detecting input 2050b1, device 900 displays order detail interface 2010c for the order for shoes. Order detail interface 2010c includes information 2008 that the item was delivered and order number 2011. Order detail interface 2010c also includes return section 2012 that includes return affordance 2014 and information about returning an item, including time remaining to return an item and return policy from the vendor. Device 900 detects input 2050c (e.g., a touch input, an air gesture, a mouse click, a gaze, and/or a speech input) directed at return affordance 2014. In some embodiments, providing return affordance 2014 reduces the time spent by a user to navigate through different user interfaces to initiate a return. As described herein, device 900 updates order detail interface 2010c at different portions or stages of the return of an item to surface relevant details regarding the return, which is especially helpful on devices having a limited size of display (e.g., a display of a smartphone).

At FIG. 20D, in response to detecting input 2050c, device 900 displays interface 2016 of an application corresponding to the vendor of Shoe Place. In some embodiments, device 900 displays an interface, prior to interface 2016, that includes an affordance corresponding to a request to initiate the return via a web-browser and an affordance corresponding to a request to initiate the return via the application corresponding to the vendor Shoe Place. At FIG. 20D, device 900 automatically enters information corresponding to the return (e.g., order number 2011), information 2018 (e.g., a username (e.g., TBD7@email.com), and/or a password (e.g., XXXXXX)). initiates a process to return the shoes. In some embodiments, device 900 does not display an order number, the username, and/or the password of FIG. 20D. In such embodiments, device 900 displays a graphical object (e.g., an affordance, a drop down selection menu, and/or a text entry field) to continue (or, optionally, complete) the process of initiating the return. Device 900 detects input 2050d (e.g., a touch input, an air gesture, a mouse click, a gaze, and/or a speech input) directed at start return affordance 2022 to initiate a return of shoes. In some embodiments, in response to detecting input 2050d, device 900 displays other interfaces (e.g., a confirmation interface and/or further details interface to enter additional information about the return) as part of the return process. In some embodiments, in response to detecting that the process to initiate a return is completed (e.g., user has confirmed that he or she wants to return the item), device 900 displays an order detail interface that includes an indication that a return has been initiated, similar to order detail interface 2010c of FIG. 20G.

At FIG. 20E, in response to detecting input 2050b2 of FIG. 20B, device 900 displays order detail interface 2010c for the puffy jackets order. Order detail interface 2010c of FIG. 20E includes order number 2011 for the puffy jackets order and return section 2012. Device 900 detects input 2050c (e.g., a touch input, an air gesture, a mouse click, a gaze, and/or a speech input) directed at return affordance 2014. In some embodiments, device 900 detects a set of one or more inputs that includes input 2050e (e.g., a touch input, an air gesture, a mouse click, a gaze, and/or a speech input) directed at return affordance 2014 initiate a return of the puffy jacket.

At FIG. 20F, in response to detecting input 2050c, device 900 displays web-browser interface 2026 (e.g., an application different from the wallet application). In some embodiments, device 900 displays an interface, prior to web-browser interface 2026, that includes an affordance corresponding to a request to initiate the return via the web-browser and an affordance corresponding to a request to initiate the return via the application corresponding to the vendor Puffy Jacket's. At FIG. 20F, device 900 automatically enters information corresponding to the return (e.g., order number 2011 and information 2018 (a zip code (e.g., 94501)) into a page of the web-browser. In some embodiments, device 900 displays a graphical object (e.g., an affordance, a drop down entry, and/or a text entry field) continue (or, optionally, complete) the process of initiating the return. Device 900 detects input 2050f1 (e.g., a touch input, an air gesture, a mouse click, a gaze, and/or a speech input) directed at start return affordance 2022 to initiate a return of the puffy jacket. In some embodiments, in response to detecting input 2050f1, device 900 displays other interfaces (e.g., a confirmation interface and/or further details interface to enter additional information about the return) as part of the return process. In some embodiments, device 900 detects input 2050f2 (e.g., a touch input, an air gesture, a mouse click, a gaze, and/or a speech input) directed to done affordance 2031 of FIG. 20F after the return has been initiated via the web-browser application. In such embodiments, device 900 displays updated order detail interface 2010c of FIG. 20G that includes indication 2032.

At FIG. 20G, device 900 detects that a return for the puffy jacket has been initiated (e.g., device 900 detects that the process to initiate a return is completed, that the user has confirmed that he or she wants to return the puffy jacket, and/or receives information from a server indicating that a return process has been initiated). In response to detecting that a return for the puffy jacket has been initiated, device 900 updates order detail interface 2010c to include indication 2032 that the return has been initiated. Device 900 also updates return section 2012. For example, return section 2012 does not include return affordance 2014 and/or the time remaining to initiate a return.

At FIG. 20H, device 900 displays drop-off notification 2034 overlaid on unlocked-screen interface 2010h. In some embodiments, device 900 displays drop-off notification 2034 to as a reminder that the puffy jacket needs to be dropped off (e.g., in-store and/or at a shipping location) in order to continue the return of the puffy jacket. In some embodiments, device 900 displays drop-off notification 2034 within a threshold of time (e.g., 1 day, 2 days, and/or 5 days) of detecting an event associated with the return (e.g., detecting the return has been initiated and/or detecting that a packaging label is available for the return). At FIG. 20H, device 900 detects input 2050h (e.g., a touch input, an air gesture, a mouse click, a gaze, and/or a speech input) directed at drop-off notification 2034.

At FIG. 20I, in response to detecting input 2050h, device 900 displays order detail interface 2010c, which has been updated by device 900 (e.g., in response to detecting that drop-off information is available). Device 900 updates order detail interface 2010c to include a return label affordance for one or more shipping companies. For example, order detail interface 2010c includes post office return label affordance 2036 (e.g., corresponding to a label for shipping puffy jackets with one postal company) and/or postal company return label affordance 2038 (e.g., corresponding to a label for shipping puffy jackets with a different postal company). In some embodiments, order detail interface 2010c includes a single return label affordance (e.g., post office return label affordance 2036 or postal company return label affordance 2038). Device 900 detects input 2050i1 (e.g., a touch input, an air gesture, a mouse click, a gaze, and/or a speech input) directed at post office return label affordance 2036. In some embodiments, in response to detecting input 2050i1, device 900 displays a user interface including a return label for shipping the puffy jacket via one postal company. Device 900 detects input 2050i2 (e.g., a touch input, an air gesture, a mouse click, a gaze, and/or a speech input) directed postal company return label affordance 2038. In some embodiments, in response to detecting input 2050i2, device 900 displays a user interface including a return label for shipping the puffy jacket via a different postal company. In some embodiments, providing shipping label affordances in order detail interface 2010c reduces the time spent by a user to navigate through different user interfaces to find a return label.

At FIG. 20J, device 900 displays return sent notification 2040 overlaid on unlocked-screen interface 2010h. In some embodiments, device 900 displays sent notification 2040 to notify a user that the puffy jacket return has been shipped to the vendor Puffy Jackets. At FIG. 20J, device 900 detects input 2050j (e.g., a touch input, an air gesture, a mouse click, a gaze, and/or a speech input) directed at return sent notification 2040.

At FIG. 20K, in response to detecting input 2050j, device 900 displays an updated order detail interface 2010c. Device 900 updates order detail interface 2010c to include indication 2042 that the puffy jacket has been sent to the vendor Puffy Jackets in response to receiving information (e.g., from the vendor and/or post office) that the item has been dropped off. Device 900 also updates order detail interface 2010c to remove post office return label affordance 2036 and removes postal company return label affordance 2038.

At FIG. 20L, in response to detecting that the return is processing, device 900 updates order detail interface 2010c to include indication 2044 that the return of the puffy jacket is processing. Device 900 also updates order detail interface 2010c to include message section 2046 that includes a message from the vendor indicating the status of a refund is pending.

At FIG. 20M, in response to detecting that a return is completed, device 900 updates order detail interface 2010c to include indication 2048 that the return of the puffy jacket is completed. Device 900 also updates message section 2046 to include a message from the vendor indicating that the refund has issued.

At FIG. 20N, in response to detecting input 2050b3 of FIG. 20B, device 900 displays order detail interface 2010c for the order of a purse that has not been delivered (and/or picked up). As such, device 900 displays return section 2012 of order detail interface 2010c without return affordance 2014. In some embodiments, device 900 displays order detail interface 2010c without return affordance 2014 in response to detecting that the purse has not been delivered. As depicted, order detail interface 2010c of FIG. 20N has arrival indicator 2054 to indicate an expected delivery date and/or time.

At FIG. 20O, device 900 displays transfer interface 1004e for a payment account that was used to purchase the shoes associated with the representation 2006a of FIG. 20B. Transfer interface 1004e is similar to transfer interface 1004e of FIGS. 9A-9J and FIGS. 10A-10Q but has a different state. Transfer section 1017 includes representation 2056 of the funds transferred to the vendor to purchase the shoes and representation 2058 of funds that are transferred to the payment account based on returning the shoes. In some embodiments, the funds that are transferred to the payment account based on returning the shoes are depicted as its own representation (e.g., representation 2058). The funds that are transferred to the payment account based on returning the shoes are depicted in the representation of the transfer that was used purchase the shoes (e.g., representation 2056). In some embodiments, device 900 detects input 2051o1 (e.g., a touch input, an air gesture, a mouse click, a gaze, and/or a speech input) directed at representation 2058. Device 900 detects input 2051o2 (e.g., a touch input, an air gesture, a mouse click, a gaze, and/or a speech input) directed at representation 2056. In some embodiments, device 900 displays interface 2010p of FIG. 20P in response to detecting input 2051o1 or input 2051o2. In some embodiments, device 900 displays receipt interface 2010q of FIG. 20Q and FIG. 20R in response to detecting input 2051o1 and input 2051o2, respectively.

At FIG. 20P, in some embodiments, in response to detecting input 2051o1 or input 2051o2, device 900 displays interface 2010p. In some embodiments, representation 2056 and representation 2058 are not concurrently displayed in transfer section 1017, making it difficult for a user to find related transactions. Interface 2010p includes transfer activity (e.g., purchases and/or returns) corresponding to an item. For example, representation 2062 corresponds a resource transfer to the vendor to purchase the shoes and representation 2060 corresponds a resource transfer from the vendor to the payment account for returning the shoes. Device 900 detects input 2051p1 (e.g., a touch input, an air gesture, a mouse click, a gaze, and/or a speech input) directed at representation 2062 (e.g., corresponding to payment to vendor). Device 900 detects input 2051p2 (e.g., a touch input, an air gesture, a mouse click, a gaze, and/or a speech input) directed at representation 2060 (e.g., corresponding to a refund from the vendor). In some embodiments, device 900 displays receipt interface 2010q of FIG. 20Q and FIG. 20R in response to detecting input 2051p1 and input 2051p2, respectively.

At FIG. 20Q, in response to detecting input 2050o1 of FIG. 20O (or input 2051p1 of FIG. 20P), device 900 displays receipt interface 2010q. Receipt interface 2010q includes order details, including, in some embodiments, information that is helpful to facilitate a return of the item. For example, receipt interface 2010q includes map 2068 of the vendor's geographic location, barcode 2070 (e.g., that can be scanned in order for a vendor scan to bring up the order), and representations 2072a and 2072b for items associated with the purchase. Device 900 detects input 2050q (e.g., a touch input, an air gesture, a mouse click, a gaze, and/or a speech input) directed to share affordance 2066. In some embodiments, in response to detecting input 2050q, device 900 initiates a process to communicate some (if not all) of the information of receipt interface 2010q to a different device. In some embodiments, communicating the information of receipt interface 2010q to a different device is helpful if a user of a different device needs the receipt to return the item on behalf of the user of device 900.

At FIG. 20R, in response to detecting input 2050o2 of FIG. 20O (or input 2051p2 of FIG. 20P), device 900 displays receipt interface 2010q. Device 900 updates receipt interface 2010q to include information 2074 corresponding to a refund for returning the shoes and an updated barcode 2076 for an updated receipt. Device 900 detects input 2050r (e.g., a touch input, an air gesture, a mouse click, a gaze, and/or a speech input) directed to share affordance 2066. In some embodiments, in response to detecting input 2050r, device 900 initiates a process to communicate some (if not all) of the information of receipt interface 2010q of FIG. 20R to a different device. In some embodiments, communicating the information of receipt interface 2010q of FIG. 20R to a different device is helpful if the user of device 900 returns an item on behalf of another user and needs to send a receipt of the return.

FIG. 21 is a flow diagram illustrating a method for initiating a return via different applications using a computer system in accordance with some embodiments. Method 2100 is performed at a computer system (e.g., 100, 300, 500, 600, 700, 900, and/or 1500) (e.g., a smartphone, a smartwatch, a tablet computer, a laptop computer, a desktop computer, and/or a head mounted device (e.g., a head mounted augmented reality and/or extended reality device)) that is in communication with a display generation component (e.g., 601, 701, 801, and/or 1501) (e.g., a display controller, a touch-sensitive display system, a monitor, and/or a head mounted display system) and one or more input devices (e.g., 601, 701, 801, and/or 1501) (e.g., a touch-sensitive surface, a keyboard, a controller, a motion sensor, and/or a mouse). Some operations in method 2100 are, optionally, combined, the orders of some operations are, optionally, changed, and some operations are, optionally, omitted.

As described below, method 2100 provides an intuitive way for initiating a return via different applications. The method reduces the cognitive burden on a user for initiate a return using different applications, thereby creating a more efficient human-machine interface. For battery-operated computing devices, enabling a user to initiate a return via different applications faster and more efficiently conserves power and increases the time between battery charges.

The computer system displays (2102), via the display generation component, a user interface (e.g., 2010b) of an electronic wallet (e.g., the wallet application of FIGS. 20A-20R) (e.g., the electronic wallet includes credentials for one or multiple accounts (e.g., transit account, payment account, loyalty account)), the user interface including a representation of a first resource transfer (e.g., 1900da, 19006b, 2006a, and/or 2006b) (e.g., a resource transfer involving a first transfer of resources for a first item) and a representation of a second resource transfer (e.g., 1900da, 19006b, 2006a, and/or 2006b) (e.g., a resource transfer involving a first transfer of resources for a first item); In some embodiments, the first resource transfer and the second resource transfer are associated with a first account provisioned on the electronic wallet (e.g., the first and second resource transfer was made using the same account). In some embodiments, the first resource transfer is associated with a first account provisioned on the electronic wallet and the second resource transfer is associated with a second account, different from the first account, provisioned on the electronic wallet. In some embodiments, the electronic wallet includes credentials for one or more accounts (e.g., the first and second account) (e.g., a loyalty account, a payment account, a transit account, an electronic credit card, and/or an electronic ticket). While displaying the user interface, the computer system detects (2104), via the one or more input devices, a selection of a respective resource transfer. In response (2106) to detecting the selection of the respective resource transfer and in accordance with a determination that a first set of criteria is satisfied and that the respective resource transfer corresponds to the first resource transfer, the computer system displays (2108), via the display generation component, a first user interface object (e.g., 2014 of FIG. 19B and/or FIG. 19D; 2014 of FIG. 20C and/or FIG. 20E) (e.g., an affordance and/or button) that (e.g., when activated) initiates a process to return (e.g., give back and/or transfer back) a first item (e.g., computer memory of FIGS. 19A-19E, the shoes of FIGS. 20C-20D, and/or the puffy jacket of FIGS. 20E-20M) (e.g., an electronic product, a physical product, merchandise, service, and/or goods), wherein initiating the process to return the first item includes displaying a first user interface of a first application (e.g., the interface of 1916, 1926, 2016, and/or 2026)(e.g., a web browser and first vendor's application) that is different from the electronic wallet. In response (2106) to detecting the selection of the respective resource transfer and in accordance with a determination that a second set of criteria is satisfied and that the respective resource transfer corresponds to the second resource transfer, the computer system displays (2110), via the display generation component, a second user interface object (e.g., 2014 of FIG. 19B and/or FIG. 19D; 2014 of FIG. 20C and/or FIG. 20E) (e.g., an affordance and/or button) that (e.g., when activated) initiates a process to return a second item (e.g., computer memory of FIGS. 19A-19E, the shoes of FIGS. 20C-20D, and/or the puffy jacket of FIGS. 20E-20M) (e.g., different from the first item) (in some embodiments, the first item is purchased from a first vendor and the second item is purchased from a second vendor different from the first vendor), wherein initiating the process to return the second item includes displaying a second user interface of a second application (e.g., a web browser and second vendor's application) that is different from the electronic wallet and the first application (e.g., the interface of 1916, 1926, 2016, and/or 2026). Conditionally initiating a process to return a first item, which includes displaying a first user interface of a first application that is different from the wallet application, or a process to return a second item, which includes displaying a second user interface of a second application that is different from the wallet application and the first application, depending on whether the selection of the respective resource transfer corresponds to the first user interface object or the second user interface object performs an operation when a set of conditions has been met without requiring further user input and improves user interfaces for returning an item.

In some embodiments, initiating the process to return the first item includes causing first information (e.g., 2011 and/or 2018) corresponding the first resource transfer (e.g., order information associated with the first resource transfer, information for identifying the first resource transfer, and/or authentication information for the first resource transfer) to be entered into (e.g., transferred to, added to, and/or inserted into a user interface of) (e.g., automatically, without user input) the first application. In some embodiments, initiating the process to return the second item includes causing second information (e.g., 2011 and/or 2018) corresponding the second resource transfer (e.g., order information associated with the second resource transfer, information for identifying the second resource transfer, and/or authentication information for the second resource transfer) to be entered into (e.g., transferred to, added to, and/or inserted into a user interface of) (e.g., automatically, without user input) the second application. Including causing first information corresponding the first resource transfer to be entered into the first application in the process to return the first item and including causing second information corresponding the second resource transfer to be entered into the second application reduces the number of inputs to perform an operation.

In some embodiments, after a return of the first item has been initiated, the computer system displays, via the display generation component, a notification (e.g., 2034 and/or 2040) (e.g., a user interface selectable object and/or a graphical element) (e.g., corresponding to a status of the initiated return). The computer system detects, via the one or more input devices, an input (e.g., 2050h and/or 2050j) (e.g., a tap input, an air gesture, a speech input, and/or mouse click) directed at the notification. In response to detecting the input directed at the notification, the computer system displays, via the display generation component, information (e.g., as depicted in FIGS. 20I and 20K) (e.g., a map of drop-off locations, a status of a return, and/or a return label) corresponding to the return of the first item. In some embodiments, the notification corresponds to a reminder to drop-off the first item at a drop-off location. Displaying information corresponding to the return of the first item in response to detecting the input directed at the notification improves user interfaces for returning an item and provides visual feedback that input was detected.

In some embodiments, after a return of the first item (or, optionally, the second item) has been initiated and while displaying the user interface of the electronic wallet that includes the representation of the first resource transfer and the representation of the second resource transfer, the computer system detects, via the one or more input devices, a selection of the first resource transfer (e.g., an input similar to 2050b1 and/or 2050b2 after the return has been initiated) (or, optionally, the second resource transfer). In response to detecting the selection of the first resource transfer, the computer system displays, via the display generation component, a status of the return of the first item (e.g., 2032, 2042, and/or 2048) (e.g., a countdown to return the item, a status of whether the item has been delivered to the vendor, a status of whether the vendor has accepted the return, and/or a status of a refund for the return) (or, optionally, the second item) without displaying the first user interface object that initiates the process to return the first item (e.g., as depicted in FIGS. 20I, 20K, and/or 20M) (or, optionally, while not displaying the second user interface object that initiates the process to return the second item). Displaying a status of the initiated return of the first item while not displaying the first user interface object that initiates the process to return the first item in response to detecting a selection of the first resource transfer after the return of the first item has been initiated declutters the user interface and improves user interfaces for returning an item.

In some embodiments, after a return of the first item (or, optionally, the second item) has been initiated (e.g., and prior to drop-off) (e.g., and while displaying the user interface of the electronic wallet that includes the representation of the first resource transfer and the representation of the second resource transfer), the computer system detects, via the one or more input devices, a first selection of the first resource transfer (e.g., an input similar to 2050b1 and/or 2050b2 after the return has been initiated) (or, optionally, the second resource transfer). In response to detecting the first selection of the first resource transfer, the computer system displays, via the display generation component, a second user interface of the electronic wallet (e.g., 2010C of FIG. 20I), wherein displaying the second user interface of the electronic wallet includes displaying a representation (e.g., image, text, and/or symbol) of a drop-off location (e.g., a postal office and/or a vendor's storefront) overlaid on a map (e.g., a representation of a map) while not displaying the first user interface object that initiates the process to return the first item (e.g., as depicted in FIG. 20I) (or, optionally, while not displaying the second user interface object that initiates the process to return the second item). Displaying a second user interface of the wallet application that includes a representation of a drop-off location overlaid on the map while not displaying the first user interface object that initiates the process to return the first item in response to detecting the first selection of the first resource transfer after the return of the first item has been initiated declutters the user interface and improves user interfaces for returning an item.

In some embodiments, after a return of the first item (or, optionally, the second item) has been initiated, the computer system receives information indicating the first item has been dropped off (e.g., as described with respect to FIG. 20K) (e.g., released to a postal office and/or a vendor's storefront and/or provided to a postal office and/or a vendor's storefront). After receiving the information indicating the first item has been dropped off (e.g., and while displaying the user interface of the electronic wallet that includes the representation of the first resource transfer and the representation of the second resource transfer), the computer system detects, via the one or more input devices, a second selection of the first resource transfer (e.g., an input similar to 2050b1 and/or 2050b2 after the return has been initiated). In response to detecting the second selection of the first resource transfer, the computer system displays, via the display generation component, the second user interface that includes a status of the return of the first item (e.g., 2042) (and/or a description of the first item) without including the representation of the drop-off location overlaid on the map and without including the first user interface object that initiates the process to return the first item (e.g., as depicted in FIG. 20K). Displaying a second user interface of the wallet application without the representation of a drop-off location overlaid on the map without displaying the first user interface object that initiates the process to return the first item in response to detecting the second selection of the first resource after receiving the information indicating the first item has been dropped off declutters the user interface and improves user interfaces for returning an item.

In some embodiments, after a return of the first item (or, optionally, the second item) has been initiated (e.g., and while displaying the user interface of the electronic wallet that includes the representation of the first resource transfer and the representation of the second resource transfer), the computer system detects, via the one or more input devices, a third selection of the first resource transfer (e.g., an input similar to 2050b1 and/or 2050b2 after the return has been initiated). In response to detecting the third selection of the first resource transfer, the computer system displays, via the display generation component, a third user interface (e.g., 2010c of FIG. 20I) including a fourth user interface object (e.g., 2036 and/or 2038) that, when selected, initiates a process to access a return label (e.g., a shipping label for a return and/or a packaging identifier for the return) without displaying the first user interface object. In some embodiments, initiating the process to access a return label includes displaying the return label. Detecting a third selection of the first resource transfer after the return of the first item has been initiated and, in response, displaying a third user interface including a fourth user interface object, that when selected, initiates a process to access a return label and without the first user interface object declutters the user interface and improves user interfaces for returning an item.

In some embodiments, after a return of the first item (or, optionally, the second item) has been initiated, the computer system receives information indicating the first item has been dropped off (e.g., as described with respect to FIG. 20K) (e.g., released to a postal office and/or a vendor's storefront and/or provided to a postal office and/or a vendor's storefront). After receiving the information indicating the first item has been dropped off (e.g., and while displaying the user interface of the electronic wallet that includes the representation of the first resource transfer and the representation of the second resource transfer), the computer system detects, via the one or more input devices, a fourth selection of the first resource transfer (e.g., an input similar to 2050b1 and/or 2050b2 after the return has been initiated). In response to detecting the fourth selection of the first resource transfer, the computer system displays, via the display generation component, the third user interface that includes a status of the return of the first item (and/or a description of the first item) without the fourth user interface object and without the first user interface object (e.g., as depicted in FIG. 20K). Displaying a second user interface of the wallet application that without the representation of a drop-off location overlaid on the map while not displaying the first user interface object that initiates the process to return the first item in response to detecting the second selection of the first resource after receiving the information indicating the first item has been dropped off declutters the user interface and improves user interfaces for returning an item.

In some embodiments, the first set of criteria includes a first criterion that is met when that the first item is delivered (e.g., 2006a and 2006b of FIG. 20B indicates the items have been delivered). In some embodiments, the second set of criteria includes a second criterion that is met when the second item is delivered (e.g., 2006a and 2006b of FIG. 20B indicates the items have been delivered). In some embodiments, in response to detecting the selection of the respective resource transfer and in accordance with a determination that the first set of criteria is not satisfied and that the respective resource transfer corresponds to the first resource transfer, the computer system displays, via the display generation component, a representation (e.g., an image and/or text) of an expected (e.g., anticipated and/or estimated) delivery time (e.g., date and/or time of day) for the first item without displaying the first user interface object (e.g., 2010c as depicted in FIG. 20N). In some embodiments, in response to detecting the selection of the respective resource transfer and in accordance with a determination that the second set of criteria is not satisfied and that the respective resource transfer corresponds to the second resource transfer, the computer system displays, via the display generation component, a representation (e.g., an image and/or text) of an expected delivery date (e.g., estimated date or time and/or anticipated date or time) for the second item without displaying the second user interface object (e.g., 2010c as depicted in FIG. 20N). In some embodiments, the expected delivery time is a delivery to a home address. In some embodiments, the expected delivery time is an in-store delivery (e.g., food is ready at the country and/or groceries are ready for pickup). Conditionally displaying a representation of an expected delivery date for the first item and forgoing display of the first user interface object the first item and conditionally displaying a representation of an expected delivery date for the second item and forgoing display of the second user interface object based on whether the first or second item (respectively) has been delivered performs an operation when a set of conditions has been met without requiring further user input and improves user interfaces for returning an item.

In some embodiments, the computer system displays a first representation (e.g., 2010q, 2068, 2070, 2072a, 2072b, 2064a, 2064b, and/or 2074) (e.g., including image, text, selectable interface objects, a map, a receipt number, time of order, an order number, and/or a description of items associated with the first resource transfer) of the first resource transfer (e.g., in a user interface of the wallet application). While displaying the first representation, detecting, via the one or more input devices, a request to transmit (e.g., 2066) (e.g., communicate, share, and/or send) a representation of the first resource transfer (e.g., with a respective computer system different from the computer system). In response to detecting the request to transmit the representation of the first resource transfer, the computer system transmits a second representation (e.g., image and/or text, a map, a receipt number, time of order, an order number, and/or a description of items associated with the first resource transfer) corresponding to the first resource transfer. In some embodiments, the second representation includes a first portion (e.g., 2010q, 2068, 2070, 2072a, 2072b, 2064a, 2064b, and/or 2074) (e.g., an image, a map for a location of a vendor, text, and/or a selectable object) of the first representation without including a second portion of the first representation (e.g., 2010q, 2068, 2070, 2072a, 2972b, 2064a, 2064b, and/or 2074) (e.g., some but not all portions first representation is transmitted). In some embodiments, the first representation includes information about to the first resource transfer that is not included in the second representation (e.g., the first set of data includes information about resource transfer that is not included in the second set of data). In some embodiments, the second representation does not include information about to the first resource transfer that is not included in the first representation (e.g., the first representation is a detailed than the second representation). Transmitting a second representation corresponding to the first resource transfer where the second representation includes a first portion of the first representation without including a second portion of the first representation, in response to detecting the request to transmit the representation of the first resource improves user interfaces for returning an item and conserves bandwidth.

In some embodiments, the computer system displays, via the display generation component, a representation (e.g., 2056, 2062 and/or 2064a) (e.g., image, text, and/or selectable interface objects) of the first resource transfer. In some embodiments, the representation includes an amount of resources included in the first resource transfer. After displaying the displaying the representation of the first resource transfer (e.g., in a user interface of the wallet application), the computer system receives a return resource transfer (e.g., an amount of resources returned and/or an amount of resources transferred back to an account provisioned on the electronic wallet) for the first item (e.g., shoes of FIGS. 20Q-20R have been returned) (e.g., the return has been processed and approved by the vendor and/or the first item has been returned to the vendor). After receiving the return resource transfer for the first item, the computer system updates the representation of the first resource transfer to include an update to the first resource transfer based on the return resource transfer (e.g., 2056 is updated to account for the return amount of $73.22 of 2058; 2056 includes a total 30.21 that accounts for the return amount and the purchase amount; 2060, 2062, 2074, and/or 2064). In some embodiments, the return resource transfer is displayed as a separate resource transfer (e.g., is displayed in a representation that is different from the representation of the first resource transfer). Updating the representation of the first resource transfer to include an update to the first resource transfer based on return resource transfer after receiving the return resource transfer for the first item provides visual feedback of the state of the return.

In some embodiments, the representation of the first resource transfer is concurrently displayed with a representation of a third resource transfer (e.g., the cars rideshare resource transfer of FIG. 20O) that is different from the first resource transfer (e.g., the third resource transfer is a separate resource transfer and/or the third resource transfer was made at a different time (e.g., calendar day or time of day) than the first resource transfer); In some embodiments, the first resource transfer is displayed with a plurality of resource transfers. In some embodiments, prior to receiving the return resource transfer for the first item, the representation of the first resource transfer includes a representation of a first amount of resources for the first resource transfer (e.g., 2058 includes $110.43). In some embodiments the representation of the first amount of resources for the first resource transfer is displayed in a first display location. In some embodiments, the updated representation of the first resource transfer includes a representation of an updated amount of resources (e.g., 2056 is updated with the return amount of $73.22 of 2058 and/or a total 30.21 that accounts for the return amount and the purchase amount) (e.g., that is based on the first amount and an amount of resources returned; and/or the representation of first amount of resources is updated to account for an updated amount of resources that are returned). In some embodiments, the return amount is displayed in a representation of return resource transfer that is different from the first resource transfer. In some embodiments the representation of the updated amount of resources corresponding is displayed in at least a portion of the first display location. In some embodiments, the representation of the updated amount of resources replaces the representation of the first amount of resources. Including a representation of a first amount of resources for the first resource transfer in the representation of the first resource transfer prior to receiving the return resource transfer for the first item and including a representation of an updated amount of resources in the updated representation of the first resource provides visual feedback of the state of the return and improves user interfaces for returning an item.

Note that details of the processes described above with respect to method 2100 (e.g., FIG. 21) are also applicable in an analogous manner to the methods described below/above. For example, methods 800, 1100, 1400, 1600, 1800, 2400, and/or 2600 optionally include one or more of the characteristics of the various methods described above with reference to method 2100. For example, methods 800, 1100, 1400, 1600, 1800, 2400, and/or 2600 include affordances to initiate a return via different applications. For brevity, these details are not repeated herein.

FIGS. 22A-22D illustrate exemplary user interfaces for linking a computer transfer account with an external account, in accordance with some embodiments. The user interfaces in these figures are used to illustrate the processes described below, including the processes in FIG. 24.

At FIG. 22A, device 900 displays transfer interface 1004e for a memory account associated with account representation 2203. Transfer interface 1004e of FIG. 22A includes transfer section 1017 that includes transfer representations 2204a and 2204b. Transfer representations 2204a and 2204b are representations of memory transfers that are performed via the memory account (or, optionally, via a memory application associated with a respective user ID). In some embodiments, the memory transfers are transferred via device 900 (or, optionally, another device that also has the memory account provisioned on the memory application corresponding to the same user ID as the memory application of device 900). Transfer interface 1004e of FIG. 23A includes selectable graphical element 2302 indicating that the memory account can be synchronized with an external account managed by the service provider of the memory account. In some embodiments, synchronizing the memory account provides additional memory account information, provides additional memory transfers, and/or allows memory transfers to be shared with a different application (e.g., a memory tracking application), as described herein. At FIG. 22A, device 900 is not sharing data of the transfers in transfer section 1017 with a different application (e.g., a different application downloaded on device 900 or an application that is not maintained by the entity providing of the memory account account). In some embodiments, device 900 detects input 2250a1 (e.g., a touch input, an air gesture, a mouse click, a gaze, and/or a speech input) directed at selectable graphical element 2302. In such embodiments, in response to detecting input 2250a1, device 900 initiates a process to link the memory account to an external account (e.g., as described in greater detail with respect to FIGS. 23A-23E).

At FIG. 22B, device 900 detects that the memory account is linked to the external account. In response to detecting that the signature credit account is linked, device 900 displays transfer representation 2204c, which was previously not displayed prior to linking the memory account. In some embodiments, transfer representation 2304c corresponds to a memory transfer that was not made by the memory application. Device 900 also updates transfer interface 1004e to include balance information 2314. Balance information 2314 includes a memory account activity (e.g., a total amount of memory used and/or a remaining amount of memory available).

At FIG. 22C, device 900 displays sync interfaces 2310i (e.g., in response to detecting a set of one or more inputs including an input directed at menu affordance 702 of FIG. 22B). Sync interface 2310i includes sync affordance 2330 to initiate a process to activate and/or deactivate the link with the external account. Sync interface 2310i also includes application sharing region 2332a that includes an indication of what applications have access to data (e.g., transfers) of the memory account. Sync interface 2310i further includes application sharing region 2332b that includes an indication of what applications are enabled to receive data of the memory account. In some embodiments, application sharing region 2332b is not displayed. As depicted, the memory application has access to the data while acme memory manager does not have access. Device 900 detects input 2250c1 (e.g., a touch input, an air gesture, a mouse click, a gaze, and/or a speech input) directed at sync affordance 2330. In some embodiments, device 900 detects input 2350c2 directed at representation 2231 of acme memory manager to initiate a process to share account data with acme memory manager.

At FIG. 22D, in response to detecting input 2350c1, device 900 removes the link to the external account. In response to detecting the link to the external account has been removed, device 900 disables (e.g., does not provide) the option to share account data, as depicted by device 900 no longer displaying application sharing regions 2332a-2332b.

FIGS. 23A-23T illustrate exemplary user interfaces for linking a payment transfer account with an external account, in accordance with some embodiments. The user interfaces in these figures are used to illustrate the processes described below, including the processes in FIG. 24.

At FIG. 23A, device 900 displays transfer interface 1004e for the signature credit account associated with account representation 2303. Transfer interface 1004e of FIG. 23A is similar to displays transfer interface 1004e of FIGS. 10A-10Q but has a different state (e.g., is for a different account). Transfer interface 1004e of FIG. 23A includes transfer section 1017 that includes transfer representations 2304a-2304c. Transfer representations 2304a-2304c are representations of fund transfers that are performed via the signature credit account (or, optionally, via a wallet application associated with a respective user ID). In some embodiments, the fund transfers are transferred via device 900 (or, optionally, another device that also has the signature credit account provisioned on a wallet application corresponding to the same user ID as the wallet application of device 900). Transfer interface 1004e of FIG. 23A includes selectable graphical element 2302 indicating that the signature credit account can be synchronized with an external account managed by the service provider of the signature credit account. In some embodiments, synchronizing the signature credit account provides additional payment account information, provides additional transfers, and/or allows transfers to be shared with a different application (e.g., a financial tracking application), as described herein. At FIG. 23A, device 900 is not sharing data of the transfers in transfer section 1017 with a different application (e.g., a different application downloaded on device 900 or an application that is not maintained by the financial entity providing of the signature credit account). Device 900 detects input 2350a1 (e.g., a touch input, an air gesture, a mouse click, a gaze, and/or a speech input) directed at selectable graphical element 2302. Device 900 detects a set of one or more inputs including input 2350a2 (e.g., a touch input, an air gesture, a mouse click, a gaze, and/or a speech input) directed at menu affordance 702.

At FIG. 23B, in response to detecting input 2350a1 (or, optionally, the set of inputs one or more inputs including input 2350a2) device 900 displays account details interface 1004h for the signature credit account. Account details interface 1004h includes link affordance 2306. In some embodiments, link affordance 2306 is not displayed when the signature credit account is linked (e.g., synchronized) with the external account. Device 900 detects input 2350b (e.g., a touch input, an air gesture, a mouse click, a gaze, and/or a speech input) directed at link affordance 2306.

At FIG. 23C, device 900 displays interface 2310c including notification 2308 that the wallet application will have access to information available on the external account. In some embodiments, device 900 optionally configures what information the wallet application will have on the external account in response to detecting an input on interface 2310c (or a different interface). Device 900 detects input 2350c (e.g., a touch input, an air gesture, a mouse click, a gaze, and/or a speech input) directed at continue affordances 2312.

At FIG. 23D, device 900 displays a web-browser application that includes user interface 2310d of the service provider of the signature credit account. User interface 2310d includes a request for user authentication 2311 (e.g., username, password, and/or biometric information).

At FIG. 23E, device 900 detects that the signature credit account is linked to the external account. In response to detecting that the signature credit account is linked, device 900 displays transfer representation 2304d, which was previously not displayed prior to linking the signature credit account. In some embodiments, transfer representation 2304d corresponds to a fund transfer that was not made by the wallet application. In such embodiments, transfer representation 2304d optionally corresponds to a fund transfer using a physical card. In such embodiments, transfer representation 2304d optionally corresponds to a fund transfer using an application other than the wallet application (e.g., manually entering signature credit account details via a web-browser and/or through a third-party financial application). Device 900 also displays graphical element 2320 indicating the amount of time has passed since the signature credit account was synchronized with the external account.

At FIG. 23E, in response to detecting that the signature credit account is linked, device 900 updates transfer interface 1004e to include balance information 2314. Balance information 2314 includes a credit limit and payment account activity (e.g., a total amount of funds transferred using the account whether the transfer was made via the wallet application or otherwise). Balance information 2314 further includes a payment due date and a minimum payment due. Device 900 further updates transfer interface 1004e to include loyalty information 2318 (e.g., credit card points and/or loyalty card points). Device 900 detects input 2350e1 (e.g., a touch input, an air gesture, a mouse click, a gaze, and/or a speech input) directed at balance information 2314. Device 900 detects a set of one or more inputs including input 2350e2 directed at menu affordance 702.

At FIG. 23F, in some embodiments, device 900 detects that a payment is past due. In response to detecting that a payment is past due, device 900 displays graphical element 2322 indicating that the payment is past due. Device 900 detects input 2350f (e.g., a touch input, an air gesture, a mouse click, a gaze, and/or a speech input) directed at balance information 2314.

At FIG. 23G, in response to detecting input 2350e1 (and/or input 2350f), device 900 displays account balance interface 2310g. Account balance interface 2310g includes an expanded view 2324 of balance information 2314. In some embodiments, expanded view 2324 includes the same information (or, optionally, different information (e.g., more or less information)) that is included in balance information 2314. Account balance interface 2310g includes pay bill affordance 2326. In some embodiments, device 900 detects input 2350g (e.g., a touch input, an air gesture, a mouse click, a gaze, and/or a speech input) and, in response, initiates a process to transfer funds to pay off a current balance.

At FIG. 23H, in response to detecting the set of one or more inputs including input 2350e2, device 900 displays account details interface 1004h. Device 900 has updated account details interface 1004h to include an indicate that the account is linked and a manage affordance 2328. Device 900 detects input 2350h (e.g., a touch input, an air gesture, a mouse click, a gaze, and/or a speech input) directed at manage affordance 2328.

At FIG. 23I, in response to detecting input 2350h, device 900 displays sync interfaces 2310i. Sync interface 2310i includes sync affordance 2330 to initiate a process to activate and/or deactivate the link with the external account. Sync interface 2310i also includes sync history affordance 2336. In some embodiments, in response to detecting an input directed at history affordance 2336, device 900 displays information about when the signature credit account was synchronized to the external account. Sync interface 2310i also includes application sharing region 2332a that includes an indication of what applications have access to data (e.g., data regarding an amount of resources transferred, data for a date of transfer, data for balance information, and other data of associated with the account and/or transfers) of the signature credit account. Sync interface 2310i also includes application sharing region 2332b that includes an indication of what applications are enabled (e.g., have an option) to receive data (e.g., transfers) of the signature credit account. In some embodiments, application sharing region 2332b is not displayed. As depicted, the wallet application has access to the data while acme books (e.g., a financial/account tracking application) does not have access. As discussed in greater detail below, linking the signature credit account to the external account enables (e.g., allows an option of) sharing account data. Device 900 detects input 2350i1 (e.g., a touch input, an air gesture, a mouse click, a gaze, and/or a speech input) directed at sync affordance 2330. Device 900 detects input 2350i2 directed at representation 2331 of acme books to initiate a process to share account data with acme books. In some embodiments, in response to detecting input 2350i2, device 900 initiates a process to share account data with acme books. In some embodiments, device 900 detects a request from acme books to initiate a process to share account data with acme books. In such embodiments, device 900 detects an input via a user interface of acme books to send the request to the wallet application initiate a process to share account data.

At FIG. 23J, in response to detecting input 2350i1, device 900 displays notification 2333 indicating that new data (e.g., any fund transfers made outside of the wallet application) will not be included in transfer section 1017 (though fund transfers made via the wallet application will still be displayed in transfer section 1017). Device 900 detects input 2350j directed at turn off affordance 2334.

At FIG. 23K, in response to detecting input 2350j (or, optionally, a set of one or more inputs including 2350i1), device 900 removes the link to the external account. In response to detecting the link to the external account has ended, device 900 disables (e.g., does not provide) the option to share account data, as depicted by device 900 no longer displaying application sharing regions 2332a-2332b.

At FIG. 23L, after the signature credit account has been linked and after the link has been ended, device 900 still displays transfer representation 2304d, which was added to transfer interface 1004e in response to linking the signature credit account to the external account. In some embodiments, a user has to manually remove transfer representation 2304d and/or delete any data that was downloaded in response to synchronizing the signature credit account with the external account. In some embodiments, while the signature credit account is no longer linked to the external account, device 900 no longer downloads new transfer data from the external account (though device 900 still communicates new transfer data made via the wallet application to the service provider of the signature credit account to maintain service of the account). In some embodiments, while the signature credit is no longer linked, device 900 detects a new resource transfer (e.g., a new payment) using the signature credit account. In such embodiments, device 900 displays a representation of the new resource transfer in transfer section 1017 and does not share the new transfer data with Acme books.

At FIG. 23M, device 900 displays notification 2337 that acme books is requesting access data of the wallet application. In some embodiments, device 900 displays notification 2337 in response to detecting input 2350i2 of FIG. 23I. In some embodiments, device 900 displays notification 2337 in response to detecting a request that was initiated by a different application (e.g., the acme book application). Device 900 detects input 2350m (e.g., a touch input, an air gesture, a mouse click, a gaze, and/or a speech input) directed at select account affordance 2338.

At FIG. 23N, in response to detecting input 2350m, device 900 displays account selection interface 2310n. In some embodiments, account selection interface 2310n allows a user to select an account of the wallet application that is linked to an external account. At FIG. 23N, account selection interface 2310n includes affordance 2340a for bank payment account and affordance 2340b for the signature credit account (e.g., signature credit). Affordance 2340a is displayed because bank payment account is linked to an external account. Affordance 2340b is displayed because the signature credit account is linked to the external account (as described with respect to FIG. 23I). In some embodiments, affordances 2340a and 2340b allow a user to select which account will be shared with the acme books application. While affordance 2340b is selected, device 900 detects input 2350n (e.g., a touch input, an air gesture, a mouse click, a gaze, and/or a speech input) directed at next affordances 2339.

At FIG. 23O, device 900 displays sharing details interface 2310o. Sharing details interface 2310o includes a description of what account data will be shared with the acme books application. In some embodiments, sharing details interface 2310o includes an affordance to initiate a process of modifying what account data will be shared with acme books. In such embodiments, device 900 optionally limits sharing of a first type of account data (e.g., account details, account type, payment info, account balances, transaction history, merchant information, spending activity) while allowing the sharing of a second type of account data different from the first type of account data (e.g., account details, account type, payment info, account balances, transaction history, merchant information, spending activity). Device 900 detects input 2350o (e.g., a touch input, an air gesture, a mouse click, a gaze, and/or a speech input) directed at done affordance 2342 to complete the process of sharing account data with acme books. In response to detecting input 2350o, device 900 begins sharing account data with acme books. In some embodiments, sharing account data with acme books allows a user to use features and/or options of the acme book application (which may not be available in the wallet application) to further manage and/or view account data.

At FIG. 23P, device 900 detects that a threshold amount of time (e.g., one week, one month, two months, and one year) has passed since the signature credit account has been linked (and/or since a previous notification has been displayed). In response to detecting that the threshold amount of time has passed since the signature credit account has been linked, device 900 displays notification 2344a indicating whether the user of device 900 would like to continue to link the signature credit account to the external account. In some embodiments, device 900 detects input 2350p1 (e.g., a touch input, an air gesture, a mouse click, a gaze, and/or a speech input) directed at notification 2344a and, in response, initiates a process to modify the link to the external account (e.g., via sync interface 2310i).

At FIG. 23P, device 900 detects that a threshold amount of time (e.g., one week, one month, two months, and one year) of sharing account data with the acme books application has passed (e.g., since account data was initially shared and/or since a previous notification that account data is being shared with acme books). In response to detecting that the threshold amount of time of sharing account data with the acme books application has passed, device 900 displays notification 2344b indicating whether the user of device 900 would like to continue to share the account data with the acme books application. Device 900 detects input 2350p2 (e.g., a touch input, an air gesture, a mouse click, a gaze, and/or a speech input) directed at notification 2344b.

At FIG. 23Q, in response to detecting input 2350q2, device 900 displays privacy interface 2310q. In some embodiments, privacy interface 2310q includes various privacy options for accounts in the wallet application. At FIG. 23Q, privacy interface 2310q includes sharing privacy region 2352 that indicates what accounts of the wallet application are (or are not) sharing account data with the acme books application. In some embodiments, device 900 detects input 2350q1 (e.g., a touch input, an air gesture, a mouse click, a gaze, and/or a speech input) directed at signature credit affordance 2351 and, in response, initiates a process to modify (e.g., cancel and/or change) what account data of the signature credit account is being shared with the acme credit application.

At FIG. 23Q, privacy interface 2310q includes linked section 2348 that indicates what account of the wallet application are (or are not) linked to an external account. In some embodiments, the bank card account and the signature credit account are linked. Privacy interface 2310q further includes sync history section 2346 that indicates when the bank card account and the signature credit account were last updated. Device 900 detects input 2550q2 (e.g., a touch input, an air gesture, a mouse click, a gaze, and/or a speech input) directed at unlink all affordance 2349. In some embodiments, in response to detecting input 2550q2, device 900 unlinks all linked accounts that are associated with a service provider (e.g., the service provider of the bank card account and the signature credit account). In some embodiments, device 900 detects input 2550q3 (e.g., a touch input, an air gesture, a mouse click, a gaze, and/or a speech input) directed at payment account affordance 2347. In such embodiments, in response to detecting 2550q3, device 900 initiates a process to unlink the signature credit account with the external account (e.g., while maintaining the link of the bank card).

At FIGS. 23R-23T, in some embodiments, transfer interface 1004e and account balance interface 2310g include different affordances and/or information for different account types. As described in greater detail below, transfer interface 1004e and/or account balance interface 2310g for a first type of account (e.g., bank payment account of FIGS. 23R-23T) includes affordances and/or information that are different from affordances and/or information of transfer interface 1004e and/or account balance interface 2310g for a second type of account (e.g., signature credit account of FIGS. 23A-23L) different from the first type of account.

At FIG. 23R, device 900 displays transfer interface 1004e for the bank card account of the wallet application. In some embodiments, transfer interface 1004e of FIG. 23R includes selectable graphical element 2302 because the bank card account is not linked to an external account. Transfer interface 1004e of FIG. 23R also includes transfer representations 2356a-2356c that are fund transfers that are made via the wallet application. In some embodiments, the bank payment account is a debit payment account. In some embodiments, the signature credit account of FIGS. 23A-23L is a credit card payment account. Device 900 detects input 2350r (e.g., a touch input, an air gesture, a mouse click, a gaze, and/or a speech input) directed at selectable graphical element 2302 to initiate a process to link the bank card account with an external account (e.g., similar to the process described above with respect to FIGS. 23A-23L).

At FIG. 23S, bank payment account is linked to an external account. In response to detecting that the bank card is linked to the external account, device 900 updates transfer interface 1004e to include transfer representation 2356d that was previously not included. In some embodiments, transfer representation 2356d corresponds to a fund transfer that is made outside of the wallet application (e.g., via a physical card and/or via a different application). Device 900 also updates transfer interface 1004e to include balance information 2314 for the bank card account. Balance information 2314 of FIG. 23S includes one type of information that is different from the type of information included in balance information 2314 of FIG. 23E based on the bank card account of FIG. 23S being a different type of account than the signature credit account of FIG. 23E. Balance information 2314 of FIG. 23S includes an amount of funds that has been deposited into the account (e.g., as opposed to a line of credit). At FIG. 23S, device 900 detects input 2350s1 (e.g., a touch input, an air gesture, a mouse click, a gaze, and/or a speech input) directed at balance information 2314. Device 900 detects a set of one or more inputs including input 2350s2 (e.g., a touch input, an air gesture, a mouse click, a gaze, and/or a speech input) directed at menu affordance 702.

At FIG. 23T, in response to detecting input 2350s1 (or, optionally, the set of one or more inputs including input 2350s2), device 900 displays account balance interface 2310g. Account balance interface 2310g of FIG. 23T is different from account balance interface 2310g of FIG. 23G. Account balance interface 2310g of FIG. 23T includes transfer affordance 2360, deposit affordance 2362, and expanded view 2324 of balance information 2314. In some embodiments, device 900 detects input 2350t1 (e.g., a touch input, an air gesture, a mouse click, a gaze, and/or a speech input) directed at transfer affordance 2360 and, in response, initiates a process to transfer the available funds (e.g., $421.55) to a different account. In some embodiments, device 900 detects input 2350t2 (e.g., a touch input, an air gesture, a mouse click, a gaze, and/or a speech input) directed at deposit affordance 2362 and, in response, initiates a process to deposit funds into the bank card account (e.g., to increase an amount of available funds). In some embodiments, the process to transfer the available funds to a different account and/or the process to deposit funds into the bank card account includes displaying a user interface of an application (e.g., a web-browser application and/or an application corresponding to service provider of the bank card account) that is different from the wallet application.

FIG. 24 is a flow diagram illustrating a method for linking a resource account with an external account using a computer system in accordance with some embodiments. Method 2400 is performed at a computer system (e.g., 100, 300, 500, 600, 700, 900, and/or 1500) (e.g., a smartphone, a smartwatch, a tablet computer, a laptop computer, a desktop computer, and/or a head mounted device (e.g., a head mounted augmented reality and/or extended reality device)) that is in communication with a display generation component (e.g., 601, 701, 801, and/or 1501) (e.g., a display controller, a touch-sensitive display system, a monitor, and/or a head mounted display system) and one or more input devices (e.g., 601, 701, 801, and/or 1501) (e.g., a touch-sensitive surface, a keyboard, a controller, a motion sensor, and/or a mouse). Some operations in method 2400 are, optionally, combined, the orders of some operations are, optionally, changed, and some operations are, optionally, omitted.

As described below, method 2400 provides an intuitive way for linking a resource account with an external account. The method reduces the cognitive burden on a user to link a resource account with an external account, thereby creating a more efficient human-machine interface. For battery-operated computing devices, enabling a user to link a resource account with an external account faster and more efficiently conserves power and increases the time between battery charges.

While (2402) a first set of one or more resource transfers (e.g., 2204a, 2204b, 2304a, 2304b, and/or 2304c) associated with a first account (e.g., the account associated with 2303 and/or 2203) (e.g., transit account, payment account, and/or loyalty account) provisioned on an electronic wallet (e.g., the electronic wallet includes credentials for one or multiple accounts) (in some embodiments, the electronic wallet includes credentials for one or more accounts (e.g., a loyalty account, a payment account, a transit account, an electronic credit card, and/or an electronic ticket) different from the account)) are not enabled for sharing with (e.g., communicating with and/or sending to) a respective application (e.g., 2204a, 2204b, 2304a, 2304b, and/or 2304c are not enabled for sharing when an account is not linked, as depicted in FIG. 23K) (e.g., an application of the computer system, a third party application, and/or a resource transfer application), the computer system displays (2404), via the display generation component, the first set of one or more resource transfers in a first user interface (e.g., as depicted in FIG. 23A and FIG. 22A) of the electronic wallet, wherein the first set of one or more resource transfers were performed (e.g., initiated by and/or executed in part by) via the first account provisioned on the electronic wallet (e.g., 2304a, 2304b, and/or 2304c were performed via the wallet application of FIGS. 23A-23T) (and, optionally, via the computer system), wherein the first user interface does not include a second set of one or more resources transfers (e.g., 2204c, 2304d) (e.g., associated with the first account). While (2402) the first set of one or more resource transfers associated with the first account provisioned on the electronic wallet (e.g., the electronic wallet includes credentials for one or multiple accounts) (in some embodiments, the electronic wallet includes credentials for one or more accounts (e.g., a loyalty account, a payment account, a transit account, an electronic credit card, and/or an electronic ticket) different from the account)) are not enabled for sharing with (e.g., communicating with and/or sending to) the respective application, the computer system detects (2406), via the one or more input devices, a request to link (e.g., 2306 and/or 2350c) (e.g., connect and/or tie) the first account with a first external account (e.g., a third-party account, a remotely stored account, and/or an account maintained external to the electronic wallet). While (2408) the first account is linked with the first external account, the computer system displays (2410), via the display generation component, the first set of one or more resource transfers (2412) in the first user interface of the electronic wallet (e.g., as depicted in FIG. 23E). While (2408) the first account is linked with the first external account, the computer system displays (2410), the second set of one or more resource transfers (2414) in the first user interface of the electronic wallet, wherein the second set of one or more resource transfers were not performed via the first account provisioned on the electronic wallet (e.g., as described with respect to FIG. 23E) (and, optionally, via the computer system) (e.g., the resource transfer was performed using a physical card associated with the first account, the resource transfer was performed using an application different from the electronic wallet, and/or the electronic wallet was not accessed to perform the resource transfer). While (2408) the first account is linked with the first external account, the computer system enables (1416) (e.g., allows and/or permits) the first set of one or more resource transfers and the second set of one or more resource transfers for sharing with the respective application (e.g., as depicted in FIG. 23I). In some embodiments, enabling the first set of one or more resource transfers and the second set of one or more resource transfers for sharing with the respective application includes enabling an option to share the first set of one or more resource transfers and the second set of one or more resource transfers (e.g., the computer system provides an option to activate or deactivate sharing). In some embodiments, enabling the first set of one or more resource transfers and the second set of one or more resource transfers for sharing with the respective application includes activating the sharing of the first set of one or more resource transfers and the second set of one or more resource transfers with the respective application. In some embodiments, the computer system displays an indication that the first set of one or more resource transfers and the second set of one or more resource transfers are enabled for sharing with the respective application. Displaying the first set of one or more resource transfers in the first user interface of the electronic wallet and the second set of one or more resource transfers in the first user interface of the electronic wallet, where the second set of one or more resource transfers were not performed via the first account provisioned on the electronic wallet, and enabling the first set of one or more resource transfers and the second set of one or more resource transfers for sharing with the respective application while the first account is linked with the first external account improves communication of resource transfers between different applications and external accounts and provides visual feedback of a state of an account provisioned on the electronic wallet.

In some embodiments, an amount of available resources (e.g., as depicted in FIGS. 22A, 23A, and/or 23R) (e.g., a balance of remaining resources and/or resources that are accessible) that correspond to the first account is not displayed in the first user interface of the electronic wallet while the first account is not linked with the first external account. In some embodiments, while the first account is linked with the first external account, the computer system displays, via the display generation component and in the first user interface, the amount of available resources corresponding to the first account (e.g., as depicted in FIGS. 22B, 23E, and/or 23S). Displaying an amount of available resources corresponding to the first account while the first account is linked with the first external account that was previously not displayed improves communication of resource transfers between different applications and external accounts and provides visual feedback of a state of an account provisioned on the electronic wallet.

In some embodiments, after (e.g., while) the first account is linked with the first external account, the computer system detects, via the one or more input devices, a request (e.g., 2351i and/or 2350j) (e.g., a gesture, a speech input, and/or a mouse click) to unlink (e.g., remove the link to and/or cancel the link to) the first account from the first external account. In response to detecting the request to unlink the first account from the first external account, the computer system unlinks the first account from the first external account (e.g., as described with respect to FIGS. 23I-23L) and displays, via the display generation component, the second set of one or more resource transfers in the first user interface of the electronic wallet without the computer system displays, in the first user interface, the amount of available resources corresponding to the first account (e.g., as depicted in FIG. 23L) (e.g., the resource transfers that were added to the first user interface when the first account was linked to the first external account will remain after the first account is unlinked). In some embodiments, the computer system detects an input to remove the second set of one or more resource transfers and, in response, removes the second set of one or more resource transfers from the first user interface of the electronic wallet (e.g., a user manually removes the second set of one or more resource transfers). Detecting the request to unlink the first account from the first external account and, in response, displaying the second set of one or more resource transfers in the first user interface of the electronic wallet without displaying the amount of available resources corresponding to the first account declutters the user interface and provides visual feedback of a state of an account provisioned on the electronic wallet.

In some embodiments, after unlinking the first account from the first external account, the computer system detects a first resource transfer using the first account provisioned on the electronic wallet (e.g., as described with respect to FIG. 23L). In some embodiments, the computer system displays, via the display generation component and based on detecting the first resource transfer using the first account provisioned on the electronic wallet, the first resource transfer in the first user interface of the electronic wallet without enabling the first resource transfer for sharing with the respective application (e.g., as described with respect to FIG. 23L). In some embodiments, in accordance with a determination that the first account is linked to the first external account, the computer system enables a respective resource transfer for sharing with the respective application. In some embodiments, in accordance with a determination that the first account is not linked to the first external account, the computer system forgoes enabling the respective resource transfer for sharing with the respective application. Detecting, after unlinking the first account, the first resource transfer using the first account provisioned on the electronic wallet and displaying the first resource transfer in the first user interface of the electronic wallet without enabling the first resource transfer for sharing with the respective application improves the security of sharing the first resource transfer with other applications.

In some embodiments, detecting the request to unlink the first account from the first external account includes detecting an input (e.g., 2350q2) directed at a first selectable interface object (e.g., a button and/or affordance) that, when selected, unlinks a second account, different from the first account, from a second external account, different from the first external account. In some embodiments, the first account and the second account correspond to a respective service provider (e.g., as described with respect to FIG. 23Q) (e.g., a bank and/or credit card company). In some embodiments, the computer system unlinks the second account from the second external account in response to detecting the input directed at the selectable interface object. Including an input directed at the first selectable interface object that unlinks both a first account from the first external account and a second account from a second external account, where the first account and the second account correspond to a respective service provider declutters the user interface and decreases the number of inputs to perform an operation.

In some embodiments, while the first account is linked to the first external account, the computer system detects, via the one or more input devices, a request to view first account information (e.g., 2450f and/or 2350s1) (e.g., including an input directed at the first user interface of the electronic wallet). In response to detecting the request to view first account information, the computer system displays, via the display generation component, a second user interface of the electronic wallet (e.g., 2310g of FIGS. 23F and 23T). In some embodiments, displaying the second user interface of the electronic wallet includes, in accordance with a determination that the first account corresponds to a first type of account, displaying a second selectable interface object (e.g., 2362) (e.g., a button and/or affordance) that, when selected, initiates a process to deposit a resource amount into the first account (e.g., to be used after the resources are deposited). In some embodiments, displaying the second user interface of the electronic wallet includes, in accordance with a determination that the first account corresponds to a second type of account that is different from the first type of account, displaying a third selectable interface object (e.g., 2326) (e.g., a button and/or affordance) that, when selected, initiates a process to transfer a resource amount for a balance of resources that are due (e.g., have been used and/or that were credited to the first account). In some embodiments, initiating a process to deposit a resource amount into the first account includes displaying a first application different from the electronic wallet. In some embodiments, initiating a process to transfer a resource amount for a balance of resources that are due includes displaying a second application different from the electronic wallet and/or the first application. Detecting the request to view first account information and, in response, conditionally displaying the second selectable interface object that, when selected, initiates a process to deposit a resource amount into the first account or the third selectable interface object that, when selected, initiates a process to transfer a resource amount for a balance of resources that are due depending on whether the first account corresponds to the first account type or the second account type performs an operation when a set of conditions has been met without requiring further user input.

In some embodiments, detecting the request to view first account information includes detecting an input (e.g., 2450f and/or 2350s1) (e.g., gesture, speech input, and/or mouse click) directed at a fourth selectable interface object (e.g., 2314 of FIG. 23S and/or FIG. 23E) in the first user interface of the electronic wallet. The computer system displays, via the display generation component, the first user interface of the electronic wallet, wherein displaying the first user interface of the electronic wallet includes, in accordance with a determination that the first account is linked to the first external account, displaying, via the display generation component, the fourth selectable interface object in the first user interface of the electronic wallet (e.g., as depicted in FIG. 23S and/or FIG. 23E). In some embodiments, displaying the first user interface of the electronic wallet includes, in accordance with a determination that the first account is unlinked to the first external account, forgoing display of the fourth selectable interface object (e.g., as depicted in FIG. 23A and FIG. 23L). Conditionally displaying the fourth selectable interface object depending on whether the first account is linked to the first external account performs an operation when a set of conditions has been met without requiring further user input and declutters the user interface.

In some embodiments, the computer system displays, via the display generation component, the first user interface of the electronic wallet, wherein displaying the first user interface of the electronic wallet includes, in accordance with a determination that the first account is linked to the first external account, displaying a first graphical object (e.g., image and/or text) (e.g., in the first user interface of the wallet application) indicating that a resource transfer is overdue (e.g., 2322) (e.g., memory transfer is past due and/or funds transfer is past due). In some embodiments, displaying the first user interface of the electronic wallet includes, in accordance with a determination that the first account is unlinked to the first external account, forgoing display of the first graphical object (e.g., as depicted in FIG. 23A and FIG. 23L, balance information and/or due date are not displayed) (e.g., even if a resource transfer is overdue). Conditionally displaying a first graphical object indicating that a resource transfer is overdue depending on whether the first account is linked to the first external account performs an operation when a set of conditions has been met without requiring further user input, declutters the user interface, and provides visual feedback of the state of the account.

In some embodiments, displaying the first user interface of the electronic wallet further includes in accordance with the determination that the first account is linked to the first external account, displaying a second graphical object (e.g., the due date of 2316 in FIGS. 23E-23F) (e.g., image and/or text), different from the first graphical object, indicating that when the resource transfer is due (e.g., displaying the first user interface of the electronic wallet includes displaying two separate indications, one for a due date and one for when the resource transfer is past due). In some embodiments, in accordance with the determination that the first account is unlinked to the first external account, the computer system forgoes display of the first graphical object. In some embodiments, the first graphical object is displayed in a first location and the second graphical object is displayed at a second location that is different from the first location. Conditionally displaying a second graphical object, different from the first graphical object, indicating that when the resource transfer is due depending on whether the first account is linked to the first external account performs an operation when a set of conditions has been met without requiring further user input, declutters the user interface, and provides visual feedback of the state of the account.

In some embodiments, after activating (e.g., starting and/or initiating once the resource transfers are enabled for sharing) a sharing of the first set of one or more resource transfers and the second set of one or more resource transfers for sharing with the respective application, the computer system detects a threshold amount of time (1 hour, 12 hours, 1 day, 7 days, and/or 1 month) has passed (e.g., as described with respect to FIG. 23P). In response to detecting the threshold amount of time has passed, the computer system displays, via the display generation component, a graphical object (e.g., 2344b) (e.g., notification, button, and/or affordance) corresponding to (e.g., a reminder about and/or a notification regarding) the sharing of the first set of one or more resource transfers and the second set of one or more resource transfers with the respective application. Detecting, after activating a sharing of the first and second set of resource transfers, the threshold amount of time has passed and, in response, displaying a graphical object corresponding to the sharing of the first set of one or more resource transfers and the second set of one or more resource transfers with the respective application maintains security of sharing data between applications by ensuring that a user's data is not shared when the user has forgotten he or she has activated sharing and provides visual feedback of the state of the account.

Note that details of the processes described above with respect to method 2400 (e.g., FIG. 24) are also applicable in an analogous manner to the methods described below/above. For example, methods 800, 1100, 1400, 1600, 1800, 2100 and/or 2600 optionally include one or more of the characteristics of the various methods described above with reference to method 2400. For example, methods 800, 1100, 1400, 1600, 1800, 2100 and/or 2600 include user interfaces that link a resource account to an external application. Methods 800, 1100, 1400, 1800, 2100 and/or 2600 also optionally include interfaces for sharing transfer data with applications that are different from the resource application provisioned with the account. For brevity, these details are not repeated herein.

FIGS. 25A-25I illustrate exemplary user interfaces for releasing secured information, in accordance with some embodiments. The user interfaces in these figures are used to illustrate the processes described below, including the processes in FIG. 26.

At FIG. 25A, device 900 displays application icon 2502 corresponding to a first wallet application and application icon 2504 for a second wallet application. As described herein, device 900 optionally has different wallet applications. In some embodiments, the first wallet application has access to a secure element (e.g., as described in detail above) while the second wallet application does not have access to the secure element. In such embodiments, device 900 displays graphical user interfaces and/or graphical elements while authorizing a resource transfer via the first wallet application that are different from graphical user interfaces and/or graphical elements while authorizing a resource transfer via the second wallet application. In some embodiments, resource transfers are initiated by the first and/or second wallet application by causing device 900 to transfer account details (e.g., account information and/or resource amount) to a terminal, such as terminal 1506. In some embodiments, resource transfers are initiated by the first and/or second wallet application by causing device 900 to transfer account details (e.g., login and/or password) to a secure website.

At FIG. 25A, in some embodiments, device 900 detects input 2550a1 (e.g., a touch input, an air gesture, a mouse click, a gaze, and/or a speech input) directed at application icon 2502. In some embodiments, device 900 detects input 2250a2 (e.g., a touch input, an air gesture, a mouse click, a gaze, and/or a speech input) directed at application icon 2504. In some embodiments, device 900 detects input 2250a3 (e.g., a button press directed at hardware button 2501, a touch input, an air gesture, a mouse click, a gaze, and/or a speech input) to initiate a resource transfer. In some embodiments, device 900 detects short-range radio field 2506a of terminal 1506.

At FIG. 25B, in response to various inputs described herein, device 900 displays account interface 2514 of the first wallet application (or, in some embodiments, a computer memory manager as described herein). In some embodiments, the first wallet application is a third-party application (e.g., not an application provided by the manufacturer of device 900). Account interface 2514 includes account representation 2508 corresponding to account 1 that is provisioned on the first wallet application and/or on device 900. In some embodiments, account representation 2508 is in an arming location such that a user can use account 1 to transfer account information (e.g., URL address and/or account number) wirelessly to terminal 1506 to so as transfer resources (e.g., of funds and/or computer memory). In some embodiments, device 900 displays account interface 2514 in response to detecting input 2550a1. In some embodiments, device 900 initiates a transfer of account details of account 1 in response to detecting input 2550b1 (e.g., a touch input, an air gesture, a mouse click, a gaze, and/or a speech input) detected via the account interface 2514. In some embodiments, device 900 initiates the transfer of account details of account 1 in response to detecting that device 900 is within a short-range radio field of terminal 1506. In some embodiments, device 900 initiates the transfer of account details of account 1 in response to other inputs. In some embodiments, device 900 initiates a process to transfer of account details of account 1 in response detecting an input directed at account representation 2508. In some embodiments, device 900 initiates the process to transfer account details of account 1 in response to detecting an input directed at hardware button 2501 (e.g., while account representation 2508 is displayed and/or while an interface of a different application than the first wallet application is displayed).

At FIG. 25B, in some embodiments, the first wallet application is a default wallet application. In some embodiments, the default wallet application is a wallet application that is selected by the user as a default wallet application. In some embodiments, device 900 displays account interface 2514 (and/or initiates a resource transfer using the first wallet application) in response to detecting that the first wallet application is a default wallet application and one or more triggers (e.g., detecting a particular input, such as input 2550a3, and/or detecting short-range radio field 2506b of terminal 1506).

At FIG. 25B, in some embodiments, account 1 of the first wallet application is a default account of the first wallet application. In some embodiments, the default account is selected by the user to be the default account. In some embodiments, device 900 displays account representation 2508 in the arming location in response to detecting that account 1 is the default account and one or more triggers (e.g., detecting a particular input, such as input 2250a3, and/or detecting short-range radio field 2506c of terminal 1506).

At FIG. 25C, in response to detecting input 2550b2, device 900 displays account representation 2510 corresponding to account 2. In some embodiments, account representation 2510 is in an arming location such that resources associated with account 2 are used when a resource transfer is initiated. In some embodiments, in response to detecting input 2550c (e.g., a touch input, an air gesture, a mouse click, a gaze, and/or a speech input) directed at 2512, device 900 initiates a process to transfer account details associated with account 2 as part of a resource transfer. In some embodiments, the first wallet application does not have access to the secure element, and therefore cannot cause the release of the account details (e.g., account number, expiration, and/or account holder's name) associated with account 2 from the secure element, and therefore must rely on the second wallet application, which does have access to the secure element and can cause the secure element to release account details associated with account 2.

At FIGS. 25D-25E, device 900 displays various interfaces during a process to authorize the resource transfer (or, optionally, a process to authenticate the user of device 900) to cause the secure element to release the account details associate with account 2. At FIG. 25D, device 900 displays authentication interface 2520 and fades (e.g., darkens, dims, fades, and/or blurs) account interface 2514, as depicted by double-hatching 2516. In some embodiments, authentication interface 2520 is a user interface from a different application (e.g., authentication application and/or the second wallet application) than the first wallet application. In some embodiments, authentication interface 2520 (and, optionally, the fading of account interface 2514) indicates that the first wallet application is relying on a different application (e.g., the second wallet application) to access secured data (e.g., account information, account credentials, biometric data, and/or password) from a secure element of device 900 (e.g., a secure hardware element that cannot be accessed by the first wallet application). In some embodiments, device 900 displays authentication interface 2520 (and/or fades account interface 2514) in response to detecting that a resource transfer has been initiated. In some embodiments, authentication interface 2520 is a semi-transparent interface. In some embodiments, device 900 uses the application of the authentication interface 2520 to access the secured data, which is then provided to the first wallet application and/or terminal 1506.

At FIG. 25D, account interface 2514 includes graphical element 2518 corresponding to the first wallet application. Graphical element 2518 includes an image of an icon associated with the first wallet application and/or text associated with the first wallet application. In some embodiments, the image of the icon identifying the first wallet application is displayed while text identifying the first wallet application is not displayed and vice versa. Graphical element 2518 further identifies an account being used to transfer resources (e.g., “Account 2”). In some embodiments, graphical element 2518 does not include an indication the account being used to transfer resources. Graphical element 2518 optionally includes an image, colors, shapes, and/or alphanumeric text elements associated with the first application (and/or account 2). In some embodiments, providing graphical element 2518 helps a user understand that the first application is using authentication information from another application to perform a transfer.

At FIG. 25D, account interface 2514 further includes graphical element 2522 to indicate how to continue with the resource transfer. Graphical element 2522 includes text and a rectangle indicating a button press (or, optionally, a different type of input) is optionally required to continue with the resource transfer. Device 900 detects input 2550d (e.g., a button press, a touch input, an air gesture, a mouse click, a gaze, and/or a speech input) directed at hardware button 2501.

At FIG. 25E, in response to detecting input 2550d, device 900 updates authentication interface 2520 to include authentication indicator 2526. In some embodiments, authentication indicator 2526 indicates that user authentication information (e.g., biometric information and/or password information) needs to be (and/or has been) confirmed. Thus, device 900 enables the user to use the first wallet application to select an account (e.g., second account at FIG. 25C). Because the first wallet application does not have access to the secure element, the first wallet application identifies the selected account (e.g., second account) to the second wallet application and requests that the second wallet application proceed with the transfer (e.g., cause the secure element to release the account information of the selected account (and not of any other account)). As shown in FIG. 25E, a user interface of the second wallet application partially obscures the user interface of the first wallet application, thereby providing the user with visual feedback that the first wallet application has requested that information be released from the secure element and that the user can proceed with the request by providing information (e.g., biometric authentication) to the second wallet application (e.g., because the second wallet application is a trusted and/or first-party application).

At FIG. 25F, the process to authorize the resource transfer has ended (or, optionally, device 900 has authenticated the user). After authorizing (e.g., using the second wallet application) the resource transfer (and/or in response to detecting that the resource transfer has been authorized), device 900 displays graphical element 2540 indicating a status of transferring account details (e.g., complete, failed, and/or pending). For example, the second wallet application transmits information back to the first wallet application indicating that the information was released and/or transmitted for the requested account (e.g., the second account). As depicted, device 900 displays graphical element 2540 in account interface 2514. In some embodiments, graphical element 2540 is displayed in a user interface of the first application that is different from account interface 2514. Additionally, device 900 has stopped fading account interface 2514, as depicted by the lack of double-hatching 2516 in FIG. 25F. Device 900 also stops displaying authentication interface 2520.

At FIG. 25G, device 900 displays account interface 2528 of the second wallet application. As described in more detail below, device 900 displays account interface 2528 in response to various inputs and under specific conditions. Account interface 2528 includes account representation 2530 of account 3 that is provisioned on the second wallet application. Account representation 2530 is in the arming location such that resources from account 3 will be used when a resource transfer is initiated. In some embodiments, device scrolls to a different account in response to detecting a scrolling input (e.g., touch-and-drag input and/or a swipe gesture) (e.g., similar to input 2550b2) on account interface 2528. Device 900 detects inputs 2550g (e.g., a button press directed at hardware button 2501, touch input, an air gesture, a mouse click, a gaze, and/or a speech input) to initiate a process to transfer resources using account 3. In some embodiments, account details associated with account 3 are transferred to terminal 1506 in response authenticating the user. In some embodiments, account details associated with account 3 are transferred in response to device 900 being within communication via with terminal 1506 via short-range radio field 2506d.

At FIG. 25G, in some embodiments, device 900 displays account interface 2528 in response to detecting input 2550a2 of FIG. 25A. In some embodiments, in response to detecting input 2550a3 of FIG. 25A and if the second wallet application is set as the default wallet application, device 900 displays account interface 2528 (e.g., as opposed to account interface 2514 of the first application). In some embodiments, while the first wallet application is set as the default wallet application, device 900 detects, via short-range radio field 2506a of terminal 1506, a request for payment of a respective account (e.g., account 3) of the second wallet application. In such embodiments, in response to detecting short-range radio field 2506a, device 900 displays account interface 2528 of at least one of FIGS. 25G-25I (e.g., as opposed to account interface 2514 of at least one of FIGS. 25B-25F). In some embodiments, account 3 is not provisioned on the first wallet application. In some embodiments, account 3 is provisioned on the first wallet application. In some embodiments, short-range radio field 2506a identifies a type of account that corresponds to the type of account of account 3 (e.g., an account of a specific service provider (e.g., transit pass and/or a payment account)). At FIG. 25H, a process to authorize the resource transfer (or, optionally, a process to authenticate the user of device 900) has been initiated. During the process to authorize the resource transfer, device 900 displays authentication indicator 2526. Device 700 optionally does not fade account interface 2528 (as depicted by the lack of double-hatching 2516 in FIG. 25H). In some embodiments, device 700 does not fade account interface 2528 because the second wallet application has access to authentication data and/or the second wallet application does not have to authenticate a user via a different application. In some embodiments, because the second wallet application is a trusted and/or first-party application and has access to the secure element, transactions performed using the second wallet application do not use the assistances of the first wallet application (e.g., the third-party wallet application).

At FIG. 25I, in response to detecting that a resource is successful, device 900 displays confirmation interface 2529. Confirmation interface 2529 includes graphical element 2538 to indicate that the transfer of account details was successful.

FIG. 26 is a flow diagram illustrating a method for releasing secured information using a computer system in accordance with some embodiments. Method 2600 is performed at a computer system (e.g., 100, 300, 500, 600, 700, 900, and/or 1500) (e.g., a smartphone, a smartwatch, a tablet computer, a laptop computer, a desktop computer, and/or a head mounted device (e.g., a head mounted augmented reality and/or extended reality device)) that is in communication with a display generation component (e.g., 601, 701, 801, and/or 1501) (e.g., a display controller, a touch-sensitive display system, a monitor, and/or a head mounted display system) and one or more input devices (e.g., 601, 701, 801, and/or 1501) (e.g., a touch-sensitive surface, a keyboard, a controller, a motion sensor, and/or a mouse). Some operations in method 2600 are, optionally, combined, the orders of some operations are, optionally, changed, and some operations are, optionally, omitted.

As described below, method 2600 provides an intuitive way for accessing secured information. The method reduces the cognitive burden on a user for accessing secured information, thereby creating a more efficient human-machine interface. For battery-operated computing devices, enabling a user to accessing secured information faster and more efficiently conserves power and increases the time between battery charges.

The computer system displays (2602), via the display generation component, a first user interface (e.g., 2514) of a first application (e.g., the first wallet application of FIG. 25A) (e.g., a wallet application provisioned with a set of accounts and/or a first wallet application). While displaying the first user interface of the first application, the computer system detects (2604), via one or more input devices, a first input (e.g., 2550b1 and/or 2550c; input 2550b2 to switch to an account that is used to initiate a resource transfer; input 2550b2 to place account 2 in the arming location; and/or an input directed account representation 2508 so as to select account 1) (e.g., a gesture to select a first account followed by a tap input on a continue option), directed at the first user interface, to initiate a resource transfer using the first account selected (e.g., account 1 of FIG. 25B and/or account 2 of FIG. 25C) (e.g., via user input from among a plurality of accounts at a user interface (e.g., the first user interface) of the first application) via the first application. In response to detecting the first input to initiate the resource transfer, the computer system partially obscures (2606) (e.g., 2516 and/or as depicted in FIGS. 25D-25E) (e.g., decreases visibility of and/or not completely obscuring) of the first user interface (e.g., at least a portion of the first user interface) with (e.g., by displaying via an overlay) a second user interface (e.g., 2520) of a second application (e.g., the application associated with 2520) (e.g., an application having access to release information from a secure element of the computer system and/or an application having authentication data to authorize the transaction), wherein the second user interface includes an indication to authorize (e.g., 2522 and/or 2524) (e.g., a graphical element that indicates how to authorize) a resource transfer (e.g., a transfer of allocated memory, data, a balance, and/or funds) using the first account and a user interface object (e.g., the image and/or text of 2518) (e.g., an image and/or text) that corresponds to (e.g., identifies) the first application (e.g., as depicted in FIGS. 25D-25E). In some embodiments, the partially obscuring the first user interface includes blurring the first user interface. In some embodiments, at least a portion of the second user interface is a transparent (e.g., semi-transparent and/or having an opacity value that is less than 100%) user interface overlaid on a portion of the first user interface. In some embodiments, in response to detecting the first input to initiate the resource transfer, the first application transmits information identifying the first account from among the plurality of accounts to the second application. In some embodiments, the computer system receives user inputs (e.g., tap and/or swipe inputs) to select the first account from among the plurality of accounts. Detecting an input to initiate a resource transfer and, in response, partially obscuring the first user interface with a second user interface of a second application, where the second user interface includes an indication to authorize a resource transfer using the first account and further includes a user interface object that corresponds to the first application provides visual feedback about the state of an account, improves the security of transferring resources by reducing the risk of unintended resource transfers, provides visual feedback that the user is about to authorize a resource transfer, and provides visual feedback of what application is being authorized via the second application.

In some embodiments, the resource transfer includes transferring memory (e.g., as described with respect to FIG. 25A) (e.g., memory is transferred from one account to a different account and/or from one computer system to a different computer system). Using the computer system to transfer memory improves how computer memory is managed.

In some embodiments, the resource transfer includes transferring funds (e.g., as described with respect to FIG. 25A) (e.g., (e.g., funds are transferred from one account, application, and/or computer system to a different account, application, or computer system). In some embodiments, a transfer of funds includes an allocation of money to and/or from an account provisioned on a wallet of the computer system. Using the computer system to transfer funds improves how funds are managed or transferred.

In some embodiments, the computer system detects a request to transfer resources (e.g., 2550a3 and/or 2506a) (e.g., a NFC request, a button press, and/or a gesture). In response to detecting the request to transfer resources and in accordance with a determination that the first application is set as a default resource transfer application (e.g., the first wallet application of FIG. 25A) (e.g., a user-preferred resource transfer application and/or a user-configurable setting designating a resource transfer application), the computer system displays, via the display generation component, the first user interface of the first application (e.g., as described with respect to FIGS. 25B and 25G). In response to detecting the request to transfer resources and in accordance with a determination that a third application (e.g., the second wallet application of FIG. 25A) (e.g., the same as or different from the second application), different from the first application, is set as the default resource transfer application, the computer system displays, via the display generation component, a third user interface of the third application (e.g., as described with respect to FIGS. 25B and 25G) (e.g., without displaying a user interface of the first application). In some embodiments, the third user interface of the third application includes a first account (e.g., a set of one or more accounts) that is different from (or, optionally, the same as) the first account of the first application. In some embodiments, the request to transfer resources is detected while the computer system is not displaying a user interface of the first application and/or a user interface of the third application. Conditionally displaying the first user interface of the first application or a third user interface of a third application based on whether the first application or the third application is set as a default resource transfer setting performs an operation when a set of conditions has been met without requiring further user input and provides visual feedback that a request has been detected.

In some embodiments, the computer system detects (e.g., via one or more antennas) an RF field (e.g., 2506) corresponding to a request to transfer resources (e.g., as described with respect to FIGS. 25B and 25G). In response to detecting the RF field corresponding to the request to transfer resources and in accordance with a determination that a first set of one or more criteria is satisfied, the computer system displays, via the display generation component, the first user interface of the first application (e.g., as described with respect to FIGS. 25B and 25G). In response to detecting the RF field corresponding to the request to transfer resources and in accordance with a determination that a second set of one or more criteria, different from the first set of one or more criteria, is satisfied, the computer system displays, via the display generation component, a user interface of the second application (e.g., an electronic wallet application that is different from the first application) that is different from the first application (e.g., as described with respect to FIGS. 25B and 25G). Conditionally displaying the first user interface of the first application or a user interface of a second application based on whether the first or second set of one or more criteria is satisfied performs an operation when a set of conditions has been met without requiring further user input and provides visual feedback that a request has been detected.

In some embodiments, the second set of one or more criteria includes a criterion that is satisfied when the computer system detects first data via the RF field (e.g., as described with respect to FIG. 25G, 2506 has information requesting account 3 of the second wallet application). In some embodiments, when the second application is set as the default resource transfer application, the computer system still automatically uses (e.g., displays a user interface of and/or transmits information based on) the second application without using the first application when the computer system detects first data via the RF field. In some embodiments, the first data identifies that the RF field is generated by a contactless terminal of a transit system (e.g., a turn style of a transit system for gaining access to transit (e.g., a train and/or bus). In some embodiments, the first data identifies a particular account that is stored on the electronic wallet of the computer system. In some embodiments, when the second set of one or more criteria is satisfied, the computer system provides account information (e.g., of the requested/identified account) in response to detecting the RF field without the computer system requiring additional user input (e.g., without requiring authentication and/or further authorization). Using the second account when the computer system detects the first data via the RF field enables the computer system to automatically select the appropriate application for the appropriate type of transaction, thereby reducing the number of inputs required to access the appropriate application.

In some embodiments, the computer system displays, via the display generation component, a user interface (e.g., 2528) of the second application. While displaying the user interface of the second application, the computer system detects, via one or more input devices (e.g., a button of the electronic device), an input (e.g., a double-press of the button) to initiate a resource transfer using the first account (e.g., 2550g and/or an input directed at 2530) (e.g., via the second application). In some embodiments, the first account is provisioned on the first application and the second application (e.g., the same payment account and/or payment card account) can be provision on two different wallet applications. In response to detecting the input to initiate the resource transfer using the first account (e.g., via the second application), the computer system initiates (e.g., transmitting via NFC and/or authorizing to transmit) the resource transfer using the first account without obscuring (e.g., partially or fully) the user interface of the second application with a user interface of an application that is different from the second application (e.g., as depicted in FIGS. 25G-25I). Detecting an input to initiate a resource transfer using the first account and, in response, initiating the resource transfer using the first account without obscuring the user interface of the second application with a user interface of an application that is different from the second account provides visual feedback that the application does not have to access a different application to authorize the resource transfer.

In some embodiments, at least a portion (e.g., some but not all) of the second user interface of the second application is transparent (e.g., translucent and/or semi-transparent) layer (e.g., as depicted in FIGS. 25D-25E) (e.g., includes a first amount of transparency that is greater than zero and/or the translucent layer is partially see-through). Displaying at least a portion the second user interface of the second application as a translucent layer provides visual feedback that an account of a different application is being used to authorize the resource transfer.

In some embodiments, partially obscuring the first user interface with the second user interface of the second application includes partially fading (e.g., dimming and/or darkening) (e.g., the first user interface is still visible but is partially faded) the first user interface (e.g., as described with respect to FIGS. 25D-25E). Partially obscuring the first user interface by fading provides visual feedback that an account of a different application is being used to authorize the resource transfer.

In some embodiments, the user interface object that corresponds to the first application (and/or second user interface of the second application) is overlaid on a portion (e.g., the same as or different from a first portion of the first user interface) of the first user interface that is faded (e.g., as depicted in FIGS. 25D-25E). Overlaying the user interface object that corresponds to the first application on a portion the first user interface by fading provides visual feedback that an account of a different application is being used to authorize the resource transfer.

In some embodiments, in response to detecting authorization of the resource transfer (e.g., the resource transfer is authorized via the second application and/or the resource transfer is authorized by a user of the computer system), the computer system ceases to partially obscure the first user interface (e.g., as depicted in FIG. 25F) and displays, via the display generation component, the first user interface (e.g., as depicted in FIG. 25F). In some embodiments, the computer system displays a representation of the first account in the first user interface. In some embodiments, the computer system detects an input to authorize the resource transfer using the first account. Detecting the resource transfer is authorized and, in response, ceasing to partially obscure the first user interface and displaying the first user interface provides visual feedback that authorization of the resource transfer is complete.

In some embodiments, in response to detecting the authorization of the resource transfer, the computer system ceases display of the user interface object that corresponds to the first application (e.g., as depicted in FIG. 25F). Detecting the resource transfer is authorized and, in response, ceasing display of the user interface object that corresponds to the first application provides visual feedback that authorization of the resource transfer is complete.

In some embodiments, the first account is selected via the first application based on a default account setting (e.g., as described with respect to FIG. 25B) (e.g., a pre-assigned account and/or a predetermined account). In some embodiments, the first user interface is displayed in response to a request to initiate a process for transferring resources (e.g., a request that is detected while not displaying the first user interface and/or is detected while not displaying a user interface of the first application). In some embodiments, the first user interface automatically includes (e.g., without user input and/or without any intervening inputs) a respective account that is set as a default account (e.g., a pre-assigned account and/or a predetermined account) including: in accordance with a determination that the first account is set as the default account, the respective account is the first account, and in accordance with a determination that a fifth account, different from the first account, is set as the default account, the respective account is the fifth account. In some embodiments, the computer system detects an input (e.g., input from a user) to designate the first account as a default account set by the user (e.g., using a setting for predetermined account and/or using a setting for a prioritized account). Automatically selecting the first account via the first application based on a default account setting performs an operation when a set of conditions has been met without requiring further user input and reduces user input to navigate through accounts.

In some embodiments, the first application does not have access to a secure element of the computer system (e.g., as described with respect to FIGS. 25D-25E) (e.g., the first application cannot cause the secure element to release information and/or data (e.g., account information)). In some embodiments, the second application has access to the secure element of the computer system (e.g., as described with respect to FIGS. 25D-25E) (e.g., the second application can cause (e.g., with proper user authentication and/or authorization) the secure element to release information and/or data (e.g., account information)). In some embodiments, because the first application does not have access to the secure element of the computer system, the first application relies on the second application to cause the secure element of the computer system to release information (e.g., account information) to be transmitted (e.g., as part of a transition). Preventing the first application access to the secure element and allowing the second application access to the secure element improves the security of the computer system and prevents unauthorized applications from improperly accessing sensitive information.

In some embodiments, while displaying the first user interface of the first application, the computer system detects, via one or more input devices and via the first user interface of the first application (e.g., using the first user interface), an input (e.g., 2550b2) (e.g., tap and/or swipe inputs) selecting a first account from among a plurality of accounts (e.g., provisioned on the first application). In some embodiments, the first application includes credentials for one or more accounts (e.g., a loyalty account, a payment account, a transit account, an electronic credit card, and/or an electronic ticket. Detecting an input selecting a first account from among a plurality of accounts via the first user interface of the first application provides options to select which account, from among a plurality of accounts, will be used for a resource transfer.

Note that details of the processes described above with respect to method 2600 (e.g., FIG. 26) are also applicable in an analogous manner to the methods described below/above. For example, methods 800, 1100, 1400, 1600, 1800, 2100 and/or 2400 optionally include one or more of the characteristics of the various methods described above with reference to method 2600. For example, methods 800, 1100, 1400, 1600, 1800, 2100 and/or 2400 include user interfaces that display user interfaces when accessing secured information. Methods 800, 1100, 1400, 1600, 1800, 2100 and/or 2400 also optionally include interfaces and accounts provisioned multiple resource applications on one device. For brevity, these details are not repeated herein.

FIGS. 27A-27W illustrate exemplary user interfaces for provisioning accounts onto computer systems, in accordance with some embodiments.

FIG. 27A illustrates computer system 2700 that includes display 2702 and a secure element for storing credentials and/or software (e.g., applet) for participating in transactions (e.g., payment transactions to transfer funds and/or key transactions to unlock a physic lock). Computer system 2700 has been newly purchased and does not include any user-specific settings. After being turned on, computer system 2700 initiates a setup process to configure computer system 2700, as shown in FIGS. 27A-27G. At FIG. 27A, as part of the setup process, computer system 2700 welcomes 2704 the user and provides instructions for proceeding with the setup process. Computer system 2700 detects a swipe up input and proceeds to user interface 2704B, at FIG. 27B. At FIG. 27B, as part of the setup process, user interface 2704 enables the user to specify how computer system 2700 should be configured (e.g., the source of data for configuring computer system 2700). At FIG. 27C, as part of the setup process, computer system 2700 displays user interface 2704C that includes text field 2706A for entering user account information (login/password) for a service. Computer system 2700 receives the user account information and then detects a tap input on “next” button to log into the service with the user account and to proceed with the setup process.

At FIG. 27D, as part of the setup process, computer system 2700 displays user interface 2704D for provisioning one or more accounts (e.g., payment accounts, transit accounts, identification accounts, and/or key accounts) onto computer system 2700. Computer system 2700 detects a tap input on previous cards option 2706B and, in response, proceeds to previous cards user interface 2704E, as shown in FIG. 27E. Previous cards user interface 2704E identifies a plurality of accounts that are associated with the user account of the service (e.g., accounts that are (and/or were previously) provisioned onto other devices logged into the service with the user account. Account identifiers 2708A-2708B are grouped together and corresponds to accounts that can be provisioned onto computer system 2700 without removing the accounts from other devices that are logged into the service with the user account. Account identifier 2708C is displayed separately from account identifiers 2708A-2708B. Account identifier 2708C corresponds to a stored-value account. In some embodiments, in order to provision the stored-value account onto computer system 2700, the stored-value account should be removed from the respective computer system (an external computer system) on which it is currently provisioned. For example, when the user is setting up computer system 2700 as a new phone, the user may wish to provision multiple accounts (including moving the stored-value account) from the user's previous (old) phone, which the user will no longer be using. At FIG. 27E, computer system 2700 has received tap inputs on 2708A and 2708C to select the accounts corresponding to those account identifiers (and not on account identifier 2708B). Computer system 2700 then detects activation of (e.g., a tap input on) the continue button.

In some embodiments, in response to detecting activation of the continue button, computer system 2700 provisions the account corresponding to 2708A onto computer system 2700 without initiating a request to remove the account corresponding to 2708A from any external computer system and/or computer system 2700 provisions the stored-value account corresponding to account identifier 2708C onto computer system 2700, including initiating a request to remove the stored-value account corresponding to account identifier 2708C from the external computer system on which it is currently provisioned. In some embodiments, computer system 2700 provisions the stored-value account onto computer system 2700 only after the stored-value account has been removed from the external computer system.

In some embodiments, in response to detecting activation of the continue button, computer system 2700 displays confirmation user interface 2704F, which includes details about the stored-value card corresponding to account identifier 2708C. For example, confirmation user interface 2704F includes an identifier (e.g., “Matthew's Old Phone”) of the external device on which the stored-value account is currently provisioned. For another example, confirmation user interface 2704F includes an amount of the value (e.g., $12.50) stored on the stored-value account, pass information (e.g., “30-day pass”) stored on the stored-value account, and/or expiration information (e.g., Dec. 14, 2023). In response to detecting activation of the next button, computer system 2700 provisions the stored-value account corresponding to account identifier 2708C onto computer system 2700, including initiating a request to remove the stored-value account corresponding to account identifier 2708C from the external computer system on which it is currently provisioned (e.g., “Matthew's Old Phone”) and subsequently provisioning the stored-value account onto computer system 2700. In this way, users setting up new devices are guided to configure their new device with both non-stored-value accounts and stored-value accounts. At FIG. 27G, in response to provisioning the stored-value account corresponding to account identifier 2708C onto computer system 2700, computer system 2700 displays a confirmation that the stored-value account has been provisioned onto computer system 2700. With the stored-value account provisioned onto computer system 2700, compute system 2700 can be used (e.g., via NFC) to perform a transaction (e.g., transfer of funds) using the stored value account. In some embodiments, this process does not require user inputs at the external computer system from which the stored-value account was moved.

At FIG. 27H, computer system 2700 has detected one or more user inputs and, in response, displays wallet user interface 2704H of a wallet application of the computer system. As shown in FIG. 27H, the stored-value account is provisioned on computer system 2700, as represented by card 2710A, and the non-stored-value account is also provisioned on computer system 2700, as represented by card 2710B. As shown in FIG. 27H, the computer system has received additional inputs (e.g., after provisioning the stored-value account) and, in response, additional accounts have been provisioned onto computer system 2700. For example, cards 2710B-2710H correspond to respective accounts that have been provisioned onto computer system 2700.

At FIG. 27H, computer system 2700 detects activation of add account option 2712 and, in response, initiates a process to provision an additional account onto computer system 2700 by displaying user interface 2704I, at FIG. 27I. At FIG. 27I, user interface 2704I includes options for various types of accounts. Computer system 2700 detects activation of option 2714 and, in response, computer system 2700 requests information about the account, as shown in FIG. 27J. At FIG. 27J, computer system 2700 uses a camera of computer system 2700 to scan information about a transaction card that is placed into a field of view of the camera. At FIG. 27J, computer system 2700 scans the card (and/or receives users inputs) to provision the account (e.g., AA account) corresponding to the card onto computer system 2700 and determines that the secure element of the computer system does not have enough memory to store the credentials and/or software (e.g., applet) for the account (e.g., AA account) corresponding to the card and, in response, computer system 2700 displays storage space user interface 2704K, as shown in FIG. 27K.

At FIG. 27K, storage space user interface 2704K provides storage information about the secure element of the computer system. Percentage bar graph 2716A shows what percentage of the memory of the secure element is used and/or available, and also optionally shows what percentage is being used by which card (or by which type of card). Check usage option 2716B, when activated, causes computer system 2700 to display recommendations user interface 2704M, which includes recommendations for accounts to delete from the secure element, as shown in FIG. 27N. At FIG. 27N, computer system 2700 optionally receives selection of the select all option following by selection of a delete option and, in response, displays delete confirmation user interface 2704N at FIG. 27O to confirm that the selected accounts should be deleted from the secure element. In some embodiments, at FIG. 27K, computer system 2700 detects a swipe gesture on ID and transit option 2716C and, in response, displays a remove affordance, as shown in FIG. 27L. Activation of the remove affordance causes the accounts in that category to be deleted (e.g., after getting confirmation using delete confirmation user interface 2704N at FIG. 27O). In some embodiments, at FIG. 27K, computer system 2700 detects activation of Bank B option 2716D. Bank B option 2716D corresponds to accounts that are grouped together based on being in the same category and/or using the same software (e.g., application) stored in the secure element. In response to detecting activation of Bank B option 2716D, computer system 2700 displays user interface 2704L, as shown in FIG. 27M. At FIG. 27M, computer system detects activation of the edit option, which enables the user to then select different accounts (each taking up 5% of memory) and/or the applet (taking up 10% of memory) for deletion. For example, the user can select to delete the one of the accounts and not the other, thereby freeing up 5% of memory. However, if the user selects to delete the applet, both accounts will be deleted as both accounts rely on the same applet to operate.

At FIG. 27O, computer system 2700 is displaying delete confirmation user interface 2704N at FIG. 27O to confirm that the selected account(s) should be deleted from the secure element. In response to detecting activation of remove option 2718, computer system 2700 deletes the selected accounts and/or applets from the memory of the secure element, thereby freeing up spaces for additional accounts and/or applets to be stored. In some embodiments, after (e.g., in response to) deleting the accounts and/or applets from the memory of the secure element, computer system 2700 proceeds to provision the new account (e.g., AA account from FIG. 27J) on computer system 2700 by storing credentials of the account (e.g., AA account) in the secure element. As shown at FIG. 27P, computer system 2700 displays a confirmation 2704O that the account (e.g., AA account) has been provisioned onto computer system 2700. As a results, the newly provisioned account (e.g., AA account) can be used to participate (e.g., via NFC) in a transaction using computer system 2700, but the removed accounts can no longer be used to participate (e.g., via NFC) in a transaction using computer system 2700.

At FIG. 27Q, computer system 2700 displays external devices user interface 2704P. In some embodiments, external devices user interface 2704P is displayed in response to detecting that the account (e.g., AA account) has been provisioned onto computer system 2700 (e.g., is displayed instead of and/or in addition to confirmation 2704O at FIG. 27P. In some embodiments, external devices user interface 2704P is automatically displayed a predetermined amount of time after displaying confirmation 2704O at FIG. 27P. In some embodiments, computer system 2700 receives user input while displaying confirmation 2704O at FIG. 27P and, in response, displays external devices user interface 2704P. External devices user interface 2704P identifies a plurality of external devices 2720A-2720C that are logged into the same user account (e.g., as logged into at FIG. 27C) of the service as computer system 2700 and, optionally, that do not already have the account (e.g., AA account) (e.g., the account that was just provisioned onto computer system 2700) provisioned.

At FIGS. 27Q-27S, computer system 2700 detects one or more user inputs to select multiple external devices (e.g., 2720A-2720C) from among the plurality of external devices 2720A-2720C that are logged into the same user account of the service as computer system 2700. At FIG. 27S, computer system 2700 detects activation of the add option and, in response, initiates a process to provision the account (e.g., AA account) onto the selected external devices (e.g., corresponding to options 2720A-2720C), as shown in FIG. 27T. In some embodiments, the process to provision the account (e.g., AA account) onto the selected external devices does not require any additional user inputs at the selected external devices and/or at computer system 2700. In some embodiments, computer system 2700 displays confirmation user interface 2704Q confirming that the account (e.g., AA account) has been provisioned onto the selected external devices. At FIG. 27U, computer system 2700 detects activation of the continue option and, response, displays default selection user interface 2704R. Default selection user interface 2704R enables the user to select whether the newly provisioned account (e.g., AA account) should be the default transaction account (e.g., payment account) for computer system 2700. In some embodiments, computer system 2700 detects activation of the set default card option and, in response, sets the newly provisioned account (e.g., AA account) as the default transaction account for computer system 2700. In some embodiments, in response to detecting activation of the set default card option, computer system 2700 initiates a process to set the newly provisioned account (e.g., AA account) as the default transaction account for the select multiple external devices (e.g., 2720A-2720C selected at FIGS. 27Q-27S). In some embodiments, the process to set the newly provisioned account (e.g., AA account) as the default transaction account for the select multiple external devices does not require any additional user inputs at the selected external devices and/or at computer system 2700. At FIG. 27W, external devices 2730A-2730C, which correspond to selected external devices 2720A-2720C respectively, have been automatically provisioned with the new account (e.g., AA account) and can now use the new account to participant in transactions (e.g., payment transactions).

FIG. 28 is a flow diagram illustrating a method for provisioning an account onto a computer system in accordance with some embodiments. Method 2800 is performed at a computer system (e.g., 100, 300, 500, 600, 700, 900, 1500, and/or 2700) (e.g., a smartphone, a tablet computer, a laptop computer, a desktop computer, and/or a head mounted device (e.g., a head mounted augmented reality and/or extended reality device)) that is in communication with a display generation component (e.g., 2702) (e.g., a display controller, a touch-sensitive display system, a monitor, and/or a head mounted display system) and one or more input devices (e.g., a touch-sensitive surface, a keyboard, a controller, and/or a mouse) (In some embodiments, the computer system in communication with one or more cameras (e.g., an infrared camera, a depth camera, and/or a visible light camera)). Some operations in method 2800 are, optionally, combined, the orders of some operations are, optionally, changed, and some operations are, optionally, omitted.

As described below, method 2800 provides an intuitive way for provisioning an account onto a computer system. The method reduces the cognitive burden on a user for provisioning accounts, thereby creating a more efficient human-machine interface. For battery-operated computing devices, enabling a user to provision accounts faster and more efficiently conserves power and increases the time between battery charges.

During a setup process (2802) (e.g., an initial set up process for a new computer system (e.g., a newly purchased device) and/or a set up process after the computer system has been reset) for configuring the computer system, the computer system (e.g., 2700) receives (2804), via the one or more input devices (e.g., touch-sensitive surface and/or wired or wireless interface (e.g., NFC, Bluetooth, and/or Wifi interfaces)), account information (e.g., login, password, and/or account access token) for a user account of a service (e.g., for a cloud service and/or for an online service that provides storage space). In some embodiments, the account information is received directly (e.g., via NFC, Bluetooth, and/or WiFi) from an external computer system (e.g., the user's previous primary phone). In some embodiments, the current computer system is being set up to replace the external computer system (and/or to become the user's primary phone).

During the setup process (2802), after logging into the user account of the service using the account information, the computer system (e.g., 2700) displays (2806), via the display generation component, an option to initiate a process to transfer credentials of a stored-value account from an external computer system (e.g., the user's previous primary phone) to the computer system.

During the setup process (2802), the computer system (e.g., 2700) detects (2808), via the one or more input devices, activation of the option to initiate the process to transfer credentials of the stored-value account from the external computer system to the computer system.

During the setup process (2802), in response to detecting activation of the option to initiate the process to transfer credentials of the stored-value account from the external computer system to the computer system, the computer system (e.g., 2700) initiates (2810) the process to transfer credentials of the stored-value account from the external computer system to the computer system.

In some embodiments, the stored-value account stores key information for accessing a secure physical location (e.g., unlocking a door of a room or building). In some embodiments, the stored-value account stores funds (e.g., monetary value). In some embodiments, the service identifies that the stored-value account is available for transfer. In some embodiments, transferring credentials includes deleting from external (old) computer system and adding to (new) computer system (e.g., 2700). In some embodiments, the process to transfer credentials of the stored-value account includes displaying an identifier (e.g., name) of the external (old) computer system (e.g., “Johnny's Phone 12”) on which the stored-value account is current provisioned and displaying a value (e.g., amount of funds) currently stored on the stored-value account. In some embodiments, transferring credentials requires external (old) computer system to be within wireless communication range (NFC, BLE, and/or Wifi) of the new device. In some embodiments, the transfer uses the direct wireless communication. In some embodiments, the computer system (e.g., 2700) includes an option to transfer credentials of another stored-value account from another device to the new device (e.g., move cards from various devices to the new device). In some embodiments, the computer system (e.g., 2700) includes an option to transfer credentials of third stored-value account from old device to the new device (e.g., move multiple cards from the old device to the new device). In some embodiments, the computer system (e.g., 2700) includes an option to provision credentials of other accounts onto the computer system (e.g., 2700) that are provisioned onto the old device without deleting the credentials from the old device. In some embodiments, the setup process includes configuring access to a wireless network (Wifi and/or cellular network). In some embodiments, the external (old) computer system is currently logged into the user account of the service (e.g., using the same credentials). In some embodiments, the external (old) computer system is not currently logged in but was previously logged into the user account of the service. In some embodiments, the option to transfer credentials is only presented if the external (old) computer system is currently logged into the service (e.g., in communication with the service). In some embodiments, the option to initiate a process to transfer credentials of a stored-value account is based on the external device and the new device being the same type of device (e.g., both devices are phones). In some embodiments, an option to move a stored-value account stored on a watch is not presented because the watch is a different type of device as compared to the computer system, which is a phone.

Note that details of the processes described above with respect to method 2800 (e.g., FIG. 28) are also applicable in an analogous manner to the methods described below/above. For example, methods 800, 1100, 1400, 1600, 1800, 2100, 2400, 2600, 2900, and/or 3000 optionally include one or more of the characteristics of the various methods described above with reference to method 2800. For example, methods 800, 1100, 1400, 1600, 1800, 2100, 2400, 2600, 2900, and/or 3000 are performed on the same computer system. For another example, methods 800, 1100, 1400, 1600, 1800, 2100, 2400, 2600, 2900, and/or 3000 optionally include displaying the various interfaces described. For brevity, these details are not repeated herein.

FIG. 29 is a flow diagram illustrating a method for provisioning an account onto a computer system in accordance with some embodiments. Method 2900 is performed at a computer system (e.g., 100, 300, 500, 600, 700, 900, 1500, and/or 2700) (e.g., a smartphone, a tablet computer, a laptop computer, a desktop computer, and/or a head mounted device (e.g., a head mounted augmented reality and/or extended reality device)) that is in communication with a display generation component (e.g., 2702) (e.g., a display controller, a touch-sensitive display system, a monitor, and/or a head mounted display system), a secure element, and one or more input devices (e.g., a touch-sensitive surface, a keyboard, a controller, and/or a mouse) (In some embodiments, the computer system in communication with one or more cameras (e.g., an infrared camera, a depth camera, and/or a visible light camera)). In some embodiments, the secure element hosts a specially designed program (e.g., an applet) to manage credentials of an electronic wallet of the computer system. The secure element optionally also includes applets certified by payment networks or card issuers. Account data (e.g., credit, debit, prepaid, and/or stored-value card data) is sent from the payment network or card issuer encrypted to the program hosted by the secure element using keys that are known only to the payment network or card issuer and the program's security domain. This data is stored within these programs and is protected using secure features of the secure element. During a transaction, a terminal (e.g., a contactless terminal) communicates directly with the secure element through the one or more input devices (e.g., an NFC controller over a dedicated hardware bus). Some operations in method 2900 are, optionally, combined, the orders of some operations are, optionally, changed, and some operations are, optionally, omitted.

As described below, method 2900 provides an intuitive way for provisioning an account onto a computer system. The method reduces the cognitive burden on a user for provisioning accounts, thereby creating a more efficient human-machine interface. For battery-operated computing devices, enabling a user to provision accounts faster and more efficiently conserves power and increases the time between battery charges.

The computer system (e.g., 2700) receives (2902), via the one or more input devices, a request to provision a first account onto the computer system (and/or an electronic wallet of the computer system), wherein provisioning the first account onto the computer system includes storing credentials (e.g., account information and/or account number) of the first account on the secure element.

In accordance with (e.g., and, optionally, in response to receiving the request to provision the first account onto the computer system) a determination that the secure element has insufficient storage space to store credentials (and/or software (e.g., an applet)) of the first account (and/or that the secure element has less than a minimum threshold amount of storage space), the computer system (e.g., 2700) displays (2904), via the display generation component, storage usage information (e.g., usage, total space, (percentage and/or absolute value (e.g., in MB)) used space) about the secure element and a first option that initiates a process to delete information (e.g., credentials and/or the specially designed program) of a second account from the secure element, wherein the second account is different from the first account;

While displaying the first option, the computer system (e.g., 2700) detects (2906), via the one or more input devices, activation of (e.g., a tap input on and/or a swipe input on) the first option.

In response to detecting activation of the first option, the computer system (e.g., 2700) initiates (2908) a process to delete information (e.g., credentials and/or the specially designed program) of the second account from the secure element.

In some embodiments, the computer system (e.g., 2700) determines (e.g., in response to receiving the request to provision the first account onto the computer system) that the secure element has insufficient storage space to store credentials of the first account (e.g., memory of the secure element is full or nearly full). In some embodiments, if there is sufficient storage space on the secure element, the computer system (e.g., 2700) forgoes display of the storage usage information (e.g., usage, total space, (percentage and/or absolute value (e.g., in MB)) used space) about the secure element. In some embodiments, if there is sufficient storage space on the secure element, the computer system (e.g., 2700) forgoes displaying the first option that initiates a process to delete information (e.g., credentials and/or the specially designed program) of the second account from the secure element.

In some embodiments, if there is sufficient storage space on the secure element, the computer system (e.g., 2700) proceeds with the process to provision the first account onto the computer system. In some embodiments, if there is insufficient storage space on the secure element, the computer system (e.g., 2700) displays a second option (concurrently with the first option) that (when activated) initiates a process to delete information (e.g., credentials and/or the specially designed program) of the second account from the secure element. In some embodiments, after deleting to make space on the secure element, the computer system (e.g., 2700) provisions the first account onto the computer system (including storing credentials of the first account on the secure element). In some embodiments, the first option corresponds to a plurality of accounts that includes the second account. In some embodiments, initiating the process to delete information (e.g., credentials and/or the specially designed program) of the second account from the secure element includes displaying usage information specific to the second account and usage information specific to an account, different from the second account, of the plurality of accounts. In some embodiments, initiating the process to delete information (e.g., credentials and/or the specially designed program) of the second account from the secure element includes displaying usage information of data shared between the second account and the different account (e.g., an applet that is used by both accounts). In some embodiments, software for a wallet application that is used to transmit credentials of account is stored in memory that is not a part of (different from) the secure element. In some embodiments, access to the secure element is limited to system operations (e.g., secure system operations) of the computer system (e.g., 2700).

Note that details of the processes described above with respect to method 2900 (e.g., FIG. 29) are also applicable in an analogous manner to the methods described below/above. For example, methods 800, 1100, 1400, 1600, 1800, 2100, 2400, 2600, 2900, and/or 3000 optionally include one or more of the characteristics of the various methods described above with reference to method 2900. For example, methods 800, 1100, 1400, 1600, 1800, 2100, 2400, 2600, 2800, and/or 3000 are performed on the same computer system. For another example, methods 800, 1100, 1400, 1600, 1800, 2100, 2400, 2600, 2900, and/or 3000 optionally include displaying the various interfaces described. For brevity, these details are not repeated herein.

FIG. 30 is a flow diagram illustrating a method for provisioning an account onto a computer system in accordance with some embodiments. Method 3000 is performed at a computer system (e.g., 100, 300, 500, 600, 700, 900, 1500, and/or 2700) (e.g., a smartphone, a tablet computer, a laptop computer, a desktop computer, and/or a head mounted device (e.g., a head mounted augmented reality and/or extended reality device)) that is in communication with a display generation component (e.g., 2702) (e.g., a display controller, a touch-sensitive display system, a monitor, and/or a head mounted display system) and one or more input devices (e.g., a touch-sensitive surface, a keyboard, a controller, and/or a mouse) (In some embodiments, the computer system in communication with one or more cameras (e.g., an infrared camera, a depth camera, and/or a visible light camera) and/or a secure element). Some operations in method 3000 are, optionally, combined, the orders of some operations are, optionally, changed, and some operations are, optionally, omitted.

As described below, method 3000 provides an intuitive way for provisioning an account onto a computer system. The method reduces the cognitive burden on a user for provisioning accounts, thereby creating a more efficient human-machine interface. For battery-operated computing devices, enabling a user to provision accounts faster and more efficiently conserves power and increases the time between battery charges.

The computer system (e.g., 2700) receives (3002), via the one or more input devices, a request to provision a first account onto the computer system (and/or an electronic wallet of the computer system). In some embodiments, provisioning the first account onto the computer system includes storing credentials (e.g., account information and/or account number) of the first account on a secure element of the computer system.

In response to receiving the request to provision the first account on the computer system (e.g., 2700), the computer system (e.g., 2700) initiates (3004) a process to provision the first account onto the computer system, wherein the process to provision the first account onto the computer system includes receiving, via the one or more input devices (e.g., a camera of the computer system and/or a touchscreen of the computer system), account information (e.g., credentials, account information, expiration date, and/or account holder's name) about the first account.

The computer system (e.g., 2700) provisions (3006) (e.g., by storing credentials of the first account onto a secure element of the computer system), using the account information about the first account, the first account onto the computer system (and/or an electronic wallet of the computer system) (e.g., 2700).

Subsequent to (e.g., in response to) provisioning the first account onto the computer system (e.g., 2700), the computer system (e.g., 2700) displays (3008), via the display generation component, an external provisioning user interface that includes an option (e.g., one option or multiple options) to initiate a process to provision the first account onto a plurality of external computer systems (e.g., automatically provision without requiring additional user inputs at the external computer systems), other than the computer system, wherein: in accordance with a determination that a set of one or more provisioning criteria is met for a respective external computer system (different from the computer system), the plurality of external computer systems includes (3010) the respective external computer system; and in accordance with a determination that the set of one or more provisioning criteria is not met for the respective external computer system, the plurality of external computer systems does not include (3012) the respective external computer system.

In some embodiments, the external provisioning user interface displays identifiers (e.g., names of devices, make and/or models of devices, memory storage of devices, and/or color of devices) of the plurality of external computer systems. In some embodiments, the computer system is logged into a user account of a service while provisioning the first account onto the computer system and the set of one or more provisioning criteria includes a criterion that is met when the respective external computer system is logged into the user account of the service (and, optionally, currently in communication with the service). In some embodiments, the set of one or more provisioning criteria includes a criterion that is met when the first account is not already provisioned onto the respective external computer system. In some embodiments, the set of one or more provisioning criteria includes a criterion that is met when the respective external computer system includes a respective hardware component (e.g., includes a secure element). In some embodiments, the set of one or more provisioning criteria includes a criterion that is met when the respective external computer system includes respective software (e.g., a respective operating system (e.g., that meets or exceeds a specific version number) and/or electronic wallet software (e.g., that meets or exceeds a specific version number)). In some embodiments, the set of one or more provisioning criteria includes a criterion that is met when the respective external computer system is selected (e.g., manually selected and/or not deselected after being automatically selected) for provisioning (e.g., on external provisioning user interface). In some embodiments, initiating the process to provision the first account onto a plurality of external computer systems includes automatically provisioning the first account onto the plurality of external computer systems without requiring additional user inputs at the plurality of external computer systems. In some embodiments, the external provisioning user interface does not include an option to initiate a process to provision a second account onto one or more external computer systems. In some embodiments, after (e.g., in response to) a second account is provisioned onto the computer system, the computer system (e.g., 2700) prompts the user to provision the second account onto a second plurality of external devices of the user (e.g., selected based on meeting the set of one or more provisioning criteria.

Note that details of the processes described above with respect to method 3000 (e.g., FIG. 30) are also applicable in an analogous manner to the methods described below/above. For example, methods 800, 1100, 1400, 1600, 1800, 2100, 2400, 2600, 2900, and/or 3000 optionally include one or more of the characteristics of the various methods described above with reference to method 3000. For example, methods 800, 1100, 1400, 1600, 1800, 2100, 2400, 2600, 2900, and/or 3000 are performed on the same computer system. For another example, methods 800, 1100, 1400, 1600, 1800, 2100, 2400, 2600, 2900, and/or 3000 optionally include displaying the various interfaces described. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve how resource transfer user interfaces are displayed. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve how resource transfer user interfaces are displayed. Accordingly, use of such personal information data enables users to have calculated control of how resource transfer user interfaces are displayed. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of improve displaying resource transfer user interfaces, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, resource transfer user interfaces can be displayed to users by inferring preferences based on non-personal information data or a bare minimum amount of personal information, such as the content being requested by the device associated with a user, other non-personal information available to the resource transfer services, or publicly available information.

1-175. (canceled)

176. A computer system configured to communicate with a display generation component, comprising:
one or more processors; and
memory storing one or more programs configured to be executed by the one or more processors, the one or more programs including instructions for:
displaying, via the display generation component, a transcript of a conversation between a first user and a second user that is different from the first user;
detecting first information associated with a first recurring resource transfer;
in response to detecting the first information for the first recurring resource transfer, displaying, via the display generation component, a first representation of the first recurring resource transfer in the transcript of the conversation between the first user and the second user;
after displaying the representation of the first recurring resource transfer in the transcript of the conversation between the first user and the second user, detecting respective information for a respective recurring resource transfer; and
in response to detecting the respective information for the respective recurring resource transfer, displaying, via the display generation component, a respective representation of the respective recurring resource transfer in the conversation between the first user and the second user.

177. The computer system of claim 176, wherein:
the first recurring resource transfer is a recurring transfer of memory; and
the respective recurring resource transfer is a recurring transfer of memory.

178. The computer system of claim 176, wherein:
the first recurring resource transfer is a recurring transfer of funds; and
the respective recurring resource transfer is a recurring transfer of funds.

179. The computer system of claim 176, wherein displaying the respective representation of the respective recurring resource transfer in the conversation between the first user and the second user in response to detecting the respective information for the respective recurring resource transfer includes:
in accordance with a determination that the respective information is a modification to the first information, updating the first representation of the first recurring resource transfer; and
in accordance with a determination that the respective information is not a modification to the first information, forgoing the update of the first representation in the transcript of the conversation between the first user and the second user.

180. The computer system of claim 179, wherein:
the first representation of the first recurring resource transfer includes a representation of a first status of the first recurring resource transfer; and
the respective representation of the respective recurring resource transfer includes a representation of a second status of the respective recurring resource transfer, wherein the representation of the second status is different from the representation of the first status.

181. The computer system of claim 180, wherein:
the first representation of the first recurring resource transfer includes a representation of a first parameter of a first parameter type; and
the respective representation of the respective recurring resource transfer includes a representation of a second parameter of the first parameter type.

182. The computer system of claim 176, wherein displaying the respective representation of the respective recurring resource transfer in the conversation between the first user and the second user in response to detecting the respective information for the respective recurring resource transfer includes:
in accordance with a determination that the respective information is for a second recurring resource, different from the first recurring resource transfer, maintaining the first representation of the first recurring resource transfer in the transcript of the conversation between the first user and the second user while the respective representation of the respective recurring resource transfer is displayed.

183. The computer system of claim 176, wherein:
the respective representation of the respective recurring resource transfer is separated from the first representation of the first recurring resource transfer by a representation of at least a portion of the transcript of the conversation.

184. The computer system of claim 176, wherein:
the first representation of the first recurring resource transfer includes a representation of a first set of parameters that have been configured by a user; and
the respective representation includes a representation of a respective set of parameters that have been configured by the user.

185. The computer system of claim 184, wherein the first set of parameters includes a first parameter of a third parameter type, and wherein the respective set of parameters includes the first parameter of the third parameter type.

186. The computer system of claim 184, wherein the first set of parameters includes a first parameter of a fourth parameter type, and wherein respective set of parameters includes a second parameter, different from the first parameter, of the fourth parameter type.

187. The computer system of claim 176, wherein a first resource amount of the first recurring resource transfer is not available until a condition that is configured by a respective computer system that initiated the first recurring resource transfer has been satisfied.

188. The computer system of claim 176, further comprising:
after displaying the first representation, detecting that a second resource amount of the first recurring resource transfer is available; and
in response to detecting that the second resource amount of the first recurring resource transfer is available, displaying, via the display generation component, an indication that the second resource amount is available without updating the transcript of the conversation to include a representation that the second resource amount is available.

189. A non-transitory computer-readable storage medium storing one or more programs configured to be executed by one or more processors of a computer system that is in communication with a display generation component, the one or more programs including instructions for:
displaying, via the display generation component, a transcript of a conversation between a first user and a second user that is different from the first user;
detecting first information associated with a first recurring resource transfer;
in response to detecting the first information for the first recurring resource transfer, displaying, via the display generation component, a first representation of the first recurring resource transfer in the transcript of the conversation between the first user and the second user;
after displaying the representation of the first recurring resource transfer in the transcript of the conversation between the first user and the second user, detecting respective information for a respective recurring resource transfer; and
in response to detecting the respective information for the respective recurring resource transfer, displaying, via the display generation component, a respective representation of the respective recurring resource transfer in the conversation between the first user and the second user.

190. A method, comprising:
at a computer system that is in communication with a display generation component:
displaying, via the display generation component, a transcript of a conversation between a first user and a second user that is different from the first user;
detecting first information associated with a first recurring resource transfer;
in response to detecting the first information for the first recurring resource transfer, displaying, via the display generation component, a first representation of the first recurring resource transfer in the transcript of the conversation between the first user and the second user;
after displaying the representation of the first recurring resource transfer in the transcript of the conversation between the first user and the second user, detecting respective information for a respective recurring resource transfer; and
in response to detecting the respective information for the respective recurring resource transfer, displaying, via the display generation component, a respective representation of the respective recurring resource transfer in the conversation between the first user and the second user.
